(19) United States
(12) Patent Application Publication
(10) Pub. No.: US 2025/0055581 A1
(43) Pub. Date: Feb. 13, 2025

(54) METHOD AND APPARATUS FOR CHANNEL STATE INFORMATION REPORTING FOR SIMULTANEOUS MULTI-PANEL TRANSMISSION IN WIRELESS COMMUNICATION SYSTEM

(71) Applicant: Samsung Electronics Co., Ltd., Gyeonggi-do (KR)

(72) Inventors: Seongmok LIM, Gyeonggi-do (KR); Kyoungmin PARK, Gyeonggi-do (KR); Ameha Tsegaye ABEBE, Gyeonggi-do (KR); Youngrok JANG, Gyeonggi-do (KR); Hyoungju JI, Gyeonggi-do (KR); Kyungjun CHOI, Gyeonggi-do (KR)

(21) Appl. No.: 18/793,058

(22) Filed: Aug. 2, 2024

(30) Foreign Application Priority Data
Aug. 3, 2023 (KR) 10-2023-0101839
May 16, 2024 (KR) 10-2024-0063995

(51) Int. Cl. H04B 17/318; H04B 7/06

(52) U.S. Cl. CPC H04B 17/328; H04B 7/06968

(57) ABSTRACT

The disclosure relates to a 5G or 6G communication system for supporting higher data transfer rates. The disclosure relates to the operation of a terminal and abase station in a wireless communication system and, more specifically to, an uplink reference signal transmission and reception method in a wireless communication system and an apparatus capable of performing the same. The disclosure provides an apparatus and a method capable of effectively providing services in a mobile communication system. A method performed a terminal includes receiving at least one reference signal transmitted from a base station, generating, based on the received at least one reference signal, a beam report to support simultaneous multi-panel transmission, and transmitting the beam report to the base station.

### CROSS-REFERENCE TO RELATED APPLICATIONS

This application is based on and claims priority under 35 U.S.C. § 119 to Korean Patent Application Nos. 10-2023-0101839 and 10-2024-0063995, which were filed in the Korean Intellectual Property Office on Aug. 3, 2023, and May 16, 2024, respectively, the entire content of each of which is incorporated herein by reference.

### BACKGROUND

### 1. Field

The disclosure relates generally to a wireless communication system, and more particularly, to a method and apparatus for performing group-based beam reporting to support a simultaneous multi-panel transmission technique in a wireless communication system.

### 2. Description of Related Art

Fifth generation (5G) mobile communication technologies define broad frequency bands such that high transmission rates and new services are possible and can be implemented not only in sub 6 gigahertz (GHz) bands such as 3.5 GHz, but also in above 6 GHz bands referred to as millimeter wave (mmWave) bands including 28 GHz and 39 GHz bands. It has also been considered to implement sixth generation (6G) mobile communication technologies, referred to as beyond 5G systems, in terahertz (THz) bands such as 95 GHz to 3 THz bands, to realize transmission rates fifty times faster than 5G mobile communication technologies and ultra-low latencies one-tenth of 5G.

Since the initial stage of 5G mobile communication technologies, to support services and to satisfy performance requirements in connection with enhanced mobile broadband, (eMBB), ultra reliable & low latency communications (URLLC), and massive machine-type communications (mMTC), there has been ongoing standardization regarding beamforming and massive multiple input multiple output (MIMO) for alleviating radio-wave path loss and increasing radio-wave transmission distances in mmWave, numerology (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large-capacity data transmission and a polar code for highly reliable transmission of control information, layer 2 (L2) pre-processing, and network slicing for providing a dedicated network customized to a specific service.

Currently, there is ongoing discussion regarding improvement and performance enhancement of initial 5G mobile communication technologies in view of services to be supported by 5G mobile communication technologies, and there has been physical layer standardization regarding technologies such as vehicle to everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR user equipment (UE) power saving, non-terrestrial network (NTN) which is UE-satellite direct communication for securing coverage in an area in which communication with terrestrial networks is impossible, and positioning.

Moreover, there has been ongoing standardization in wireless interface architecture/protocol fields regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access channel (2-step RACH) for simplifying NR random access procedures. There also has been ongoing standardization in system architecture/service fields regarding a 5G baseline architecture (for example, service based architecture or service based interface) for combining network functions virtualization (NFV) and software-defined networking (SDN) technologies, and mobile edge computing (MEC) for receiving services based on UE positions.

If such 5G mobile communication systems are commercialized, connected devices that have been exponentially increasing will be connected to communication networks. It is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed realty (MR), and the like (XR=AR+VR+MR), 5G performance improvement and complexity reduction by utilizing artificial intelligence (AI) and machine learning (ML), AI service support, metaverse service support, and drone communication.

Such development of 5G mobile communication systems will serve as a basis for developing not only new waveforms for securing coverage in terahertz bands of 6G mobile communication technologies, full dimensional MIMO (FD-MIMO), multi-antenna transmission technologies such as array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

A wireless communication system is advancing to a broadband wireless communication system for providing high-speed and high-quality packet data services using communication standards, such as high-speed packet access (HSPA) of the third generation partnership project (3GPP), LTE (long-term evolution or evolved universal terrestrial radio access (E-UTRA)), LTE-advanced (LTE-A), LTE-Pro, high-rate packet data (HRPD) of 3GPP2, ultra-mobile broadband (UMB), institute of electrical and electronics engineers (IEEE) 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink refers to a radio link via which a user equipment (UE) or a mobile station (MS) transmits data or control signals to a base station (BS) or eNode B, and the downlink refers to a radio link via which the base station transmits data or control signals to the UE. The above multiple access scheme may separate data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include eMBB communication, mMTC, URLLC, and the like.

eMBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. The 5G communication system must provide an increased user-perceived data rate to the UE, as well as the maximum data rate. To satisfy such requirements, transmission/reception technologies including a further enhanced MIMO transmission technique are required to be improved. The data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC has requirements, such as support of connection of a large number of UEs in a cell, enhancement coverage of UEs, improved battery time, a reduction in the cost of a UE, and the like, to effectively provide the Internet of Things. Since the Internet of Things provides communication functions while being provided to various sensors and various devices, it must support a large number of UEs (e.g., 1,000,000 UEs/km²) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be inexpensively configured and may require a very long battery life-time such as 10 to 15 years because it is difficult to frequently replace the battery of the UE.

URLLC is a cellular-based mission-critical wireless communication service. For example, URLLC may be used for services such as remote control for robots or machines, industrial automation, unmanned aerial vehicles, remote health care, and emergency alert. Thus, URLLC must provide communication with ultra-low latency and ultra-high reliability. For example, a service supporting URLLC must satisfy an air interface latency of less than 0.5 ms and may also require a packet error rate of 10′ or less. Therefore, for the services supporting URLLC, a 5G system must provide a transmit time interval (TTI) shorter than those of other services, and also may require a design for assigning a large number of resources in a frequency band to secure reliability of a communication link.

The eMBB, URLLC, and mMTC services may be multiplexed and transmitted in a single system. In this case, different transmission/reception techniques and transmission/reception parameters may be used between services to satisfy different requirements of the respective services.

To receive a physical downlink shared channel (PDSCH) from a plurality of transmission and reception points (TRPs), a UE may use non-coherent joint transmission (NC-JT).

A 5G wireless communication system may support all services having very short transmission latency, requiring a high connectivity density, and requiring a high transmission rate unlike the conventional system. In a wireless communication network including a plurality of cells, transmission and reception points (TRPs), or beams, coordinated transmission between respective cells, TRPs, and/or beams may satisfy various service requirements by increasing the strength of a signal received by the UE or efficiently controlling interference between the cells, TRPs, and/or beams.

Joint transmission (JT) is a representative transmission technology for coordinated communication and may increase the strength of a signal received by the UE or throughput by transmitting signals to one UE through different cells, TRPs, and/or beams. A channel between respective cells, TRPs, and/or beam and the UE may have different characteristics, and NC-JT supporting non-coherent precoding between respective cells, TRPs, and/or beams may need individual precoding, MCS, resource allocation, and TCI indication according to the channel characteristics for each link between respective cells, TRPs, and/or beam and the UE.

The NC-JT may be applied to at least one of a PDSCH, a PDCCH, a physical uplink shared channel (PUSCH), and a physical uplink control channel (PUCCH). In PDSCH transmission, transmission information such as precoding, MCS, resource allocation, and TCI may be indicated through DL DCI, and should be independently indicated for each cell, TRP, and/or beam for the NC-JT. This is a significant factor that increases payload required for DL DCI transmission, which tends to have a negative impact on reception performance of a PDCCH for transmitting the DCI. Accordingly, to support JT of the PDSCH, there is a need in the art for a method and apparatus employing a carefully designed tradeoff between an amount of transmitted DCI information and reception performance of control information.

### SUMMARY

The disclosure has been made to address at least the above-mentioned problems and/or disadvantages and to provide at least the advantages described below.

Accordingly, an aspect of the disclosure is to provide an apparatus and a method capable of effectively providing services in a mobile communication system.

In accordance with an aspect of the disclosure, a method of a terminal in a wireless communication system includes receiving at least one reference signal transmitted from a base station, generating, based on the received at least one reference signal, a beam report to support simultaneous multi-panel transmission, and transmitting the generated beam report to the base station.

### BRIEF DESCRIPTION OF THE DRAWINGS

The above and other aspects, features, and advantages of the disclosure will be more apparent from the following detailed description taken in conjunction with the accompanying drawings, in which:

FIG. 1 illustrates a basic structure of a time-frequency domain in a wireless communication system according to an embodiment;

FIG. 2 illustrates a structure of a frame, a subframe, and a slot in a wireless communication system according to an embodiment;

FIG. 3 illustrates a BWP configuration in a wireless communication system according to an embodiment;

FIG. 4 illustrates radio protocol structures of a base station and a UE in single cell, carrier aggregation, and dual connectivity situations in a wireless communication system according to an embodiment;

FIG. 5 illustrates a base station beam allocation according to transmission configuration indicator (TCI) state configuration in a wireless communication system according to an embodiment;

FIG. 6 illustrates a beam application time that is considerable when using a unified TCI method in a wireless communication system according to an embodiment;

FIG. 7 illustrates a medium access control (MAC) control element (CE) structure for activation and indication of a joint TCI state or separate DL or UL TCI states in a wireless communication system according to an embodiment;

FIG. 8 illustrates a frequency domain resource allocation (FDRA) of a PDSCH or PUSCH in a wireless communication system according to an embodiment;

FIG. 9 illustrates a virtual resource block-to-physical resource block (VRB-PRB) interleaving scheme of a PDSCH during an FDRA type-1 resource allocation according to an embodiment;

FIG. 10 illustrates a time domain resource allocation with regard to a PDSCH in a wireless communication system according to an embodiment;

FIG. 11 illustrates a MAC CE for PUCCH resource group-based spatial relation activation in a wireless communication system according to an embodiment;

FIG. 12 illustrates a PUSCH repeated transmission type B in a wireless communication system according to an embodiment;

FIG. 13 illustrates a method for determining an available slot during PUSCH repetition type A transmission by a UE in a 5G system according to an embodiment;

FIG. 14 illustrates a method for determining a configured time domain window (C-TDW) and an actual TDW (A-TDW) for performing simultaneous channel estimation during PUSCH transmissions in a wireless communication system according to an embodiment;

FIG. 15 illustrates a MAC CE structure including a single piece of power headroom report (PHR) information according to an embodiment;

FIG. 16 illustrates a MAC CE structure including multiple pieces of PHR information according to an embodiment;

FIG. 17 illustrates a configuration of antenna ports and a resource allocation for cooperative communication in a wireless communication system according to an embodiment;

FIG. 18 illustrates an example for a configuration of downlink control information (DCI) for cooperative communication in a wireless communication system according to an embodiment;

FIG. 19 illustrates a process for beam configuration and activation with regard to a PDSCH according to an embodiment;

FIG. 20 illustrates an enhanced PDSCH TCI state activation/deactivation MAC-CE structure according to an embodiment;

FIG. 21 illustrates another MAC-CE structure for activating and indicating multiple joint TCI states or a separate DL or UL TCI state in a wireless communication system according to an embodiment;

FIG. 22 illustrates a MAC-CE structure for activating and indicating multiple joint TCI states or a separate DL or UL TCI state in a wireless communication system according to an embodiment;

FIG. 23 illustrates a UE structure using multiple panels according to an embodiment;

FIG. 24 illustrates a first example of a panel operation method by a UE configured by two or more panels according to an embodiment;

FIG. 25 illustrates a second example of a panel operation method by a UE configured by two or more panels according to an embodiment;

FIG. 26 illustrates an operation in which a UE configured by two or more panels simultaneously transmits and receives an uplink and downlink channels according to an embodiment;

FIG. 27 illustrates a UE that performs simultaneous transmission with four different transmission beams by using four panels according to an embodiment;

FIG. 28 illustrates a method by which a UE determines a reference signal resource group by using four different reference signal resource sets according to an embodiment;

FIG. 29 illustrates a method in which a UE determines four reference signal resources as one group by using two different reference signal resource sets according to an embodiment;

FIG. 30 illustrates a UE according to an embodiment; and

FIG. 31 illustrates a base station according to an embodiment.

### DETAILED DESCRIPTION

Hereinafter, embodiments of the disclosure will be described in detail with reference to the accompanying drawings.

In describing the embodiments, descriptions related to technical contents well-known in the relevant art and not associated directly with the disclosure will be omitted for the sake of clarity and conciseness.

For the same reason, in the accompanying drawings, some elements may be exaggerated, omitted, or schematically illustrated. The size of each element does not completely reflect the actual size. In the respective drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure. Throughout the specification, the same or like reference signs indicate the same or like elements. The terms which will be described below are terms defined in consideration of the functions in the disclosure, and may be different according to users, intentions of the users, or customs. Therefore, the definitions of the terms should be made based on the contents throughout the specification.

An element included in the disclosure is expressed in the singular or the plural according to the embodiment. However, the singular form or plural form is selected appropriately to the presented situation for the convenience of description, and the disclosure is not limited by elements expressed in the singular or the plural form. Therefore, either an element expressed in the plural may also include a single element or an element expressed in the singular may also include multiple elements.

The embodiments of the disclosure described and shown in the specification and the drawings are merely specific examples that have been presented to easily explain the technical contents of embodiments of the disclosure and help understanding of embodiments of the disclosure, and are not intended to be limiting such that other variants based on the technical idea of the disclosure may be implemented. Embodiments herein may be employed in combination, as necessary. For example, a part of one embodiment of the disclosure may be combined with a part of another embodiment to operate a base station and a terminal. As an example, a part of a first embodiment of the disclosure may be combined with a part of a second embodiment to operate a base station and a terminal. Moreover, although the above embodiments have been described based on the frequency division duplex (FDD) LTE system, other variants based on the technical idea of the embodiments may also be implemented in other communication systems such as time division duplex (TDD) LTE, and 5G, or NR systems.

In the drawings, the order of the description does not always correspond to the order in which steps of each method are performed, and the order relationship between the steps may be changed or the steps may be performed in parallel.

Alternatively, some elements may be omitted and only some elements may be included therein without departing from the essential spirit and scope of the disclosure.

In addition, some or all of the contents of each embodiment may be implemented in combination without departing from the essential spirit and scope of the disclosure.

The contents of the disclosure may be applied to FDD) and TDD systems. As used herein, upper layer signaling is a method for transferring signals from a base station to a UE by using a downlink data channel of a physical layer, or from the UE to the base station by using an uplink data channel of the physical layer, and may also be referred to as RRC signaling, packet data convergence protocol (PDCP) signaling, or MAC-CE.

Herein, the UE may use various methods to determine whether to apply cooperative communication, such as a physical downlink control channel (PDCCH) that allocates a PDSCH to which cooperative communication is applied have a specific format, or PDCCH(s) that allocates a PDSCH to which cooperative communication is applied include a specific indicator indicating whether to apply cooperative communication, or PDCCH(s) that allocates a PDSCH to which cooperative communication is applied are scrambled by a specific RNTI, or cooperative communication application is assumed in a specific range indicated by an upper layer. Hereinafter, it will be assumed for the sake of descriptive convenience that an NC-JT case refers to when the UE receives a PDSCH to which cooperative communication is applied, based on conditions similar to those described above.

Determining priority between A and B may be variously described as selecting an entity having a higher priority according to a predetermined priority rule and performing an operation corresponding thereto, or omitting or dropping operations regarding an entity having a lower priority.

Hereinafter, for the sake of descriptive convenience, a cell, a transmission point, a panel, a beam, and/or a transmission direction which can be distinguished through an upper layer/L1 parameter such as a TCI state or spatial relation information, a cell ID, a TRP ID, or a panel ID may be described as a TRP, a beam, or a TCI state as a whole. Therefore, when actually applied, a TRP, a beam, or a TCI state may be appropriately replaced with one of the above terms.

The UE may use various methods to determine whether to apply cooperative communication, for example, PDCCH(s) that allocates a PDSCH to which cooperative communication is applied have a specific format, or PDCCH(s) that allocates a PDSCH to which cooperative communication is applied include a specific indicator indicating whether to apply cooperative communication, or PDCCH(s) that allocates a PDSCH to which cooperative communication is applied are scrambled by a specific RNTI, or cooperative communication application is assumed in a specific range indicated by an upper layer.

A base station refers to an entity that allocates resources to a terminal, and may be at least one of a gNode B, a gNB, an eNode B, a node B, a base station (BS), a radio access unit, a base station controller, or a node on a network. A terminal may include a user equipment (UE), a mobile station (MS), a cellular phone, a smartphone, a computer, or a multimedia system capable of performing a communication function. A 5G system will be described herein by way of example, but the embodiments of the disclosure may also be applied to other communication systems having similar technical backgrounds or channel types. Examples of such communication systems may include LTE or LTE-A mobile communication systems and mobile communication technologies developed beyond 5G. Therefore, based on determinations by those skilled in the art, the embodiments of the disclosure may be applied to other communication systems through some modifications without significantly departing from the scope of the disclosure.

The terms which will be described below are terms defined in consideration of the functions in the disclosure, and may be different according to users, intentions of the users, or customs. Therefore, the definitions of the terms should be made based on the contents throughout the specification.

In the following description, upper layer signaling may correspond to at least one of the following signaling types.
Master information block (MIB)
System information block (SIB) or SIB X (X=1, 2, . . . )
Radio resource control (RRC)
MAC CE

In addition, layer 1 (L1) signaling may correspond to at least one signaling method among signaling methods using the following physical layer channels or signaling, or a combination of one or more thereof.
A PDCCH
The DCI
UE-specific DCI
Group common DCI
Common DCI
Scheduling DCI (for example, DCI used for the purpose of scheduling downlink or uplink data)
Non-scheduling DCI (for example, DCI not used for the purpose of scheduling downlink or uplink data)
The PUCCH
Uplink control information (UCI)

Determining priority between A and B may be described herein as selecting an entity having a higher priority according to a predetermined priority rule and performing an operation corresponding thereto or omitting or dropping operations regarding an entity having a lower priority.

As used herein, the term slot may generally refer to a specific time unit corresponding to a transmit time interval (TTI), may specifically refer to a slot used in a 5G NR system, or may refer to a slot or a subframe used in a 4G LTE system.

In the following description, a base station is an entity that allocates resources to terminals, and may be at least one of a gNode B, an eNode B, a Node B, a base station (BS), a wireless access unit, abase station controller, and anode on a network. A terminal may include a user equipment (UE), a mobile station (MS), a cellular phone, a smartphone, a computer, or a multimedia system capable of performing a communication function. In the disclosure, a downlink (DL) refers to a radio link via which a base station transmits a signal to a terminal, and an uplink (UL) refers to a radio link via which a terminal transmits a signal to a base station. Furthermore, in the following description, LTE or LTE-A systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, the 5G may be the concept that covers the exiting LTE, LTE-A, and other similar services. In addition, based on determinations by those skilled in the art, the disclosure may also be applied to other communication systems through some modifications without significantly departing from the scope of the disclosure.

In the following description, the term “a/b” may be understood as at least one of a and b.

### NR Time-Frequency Resources

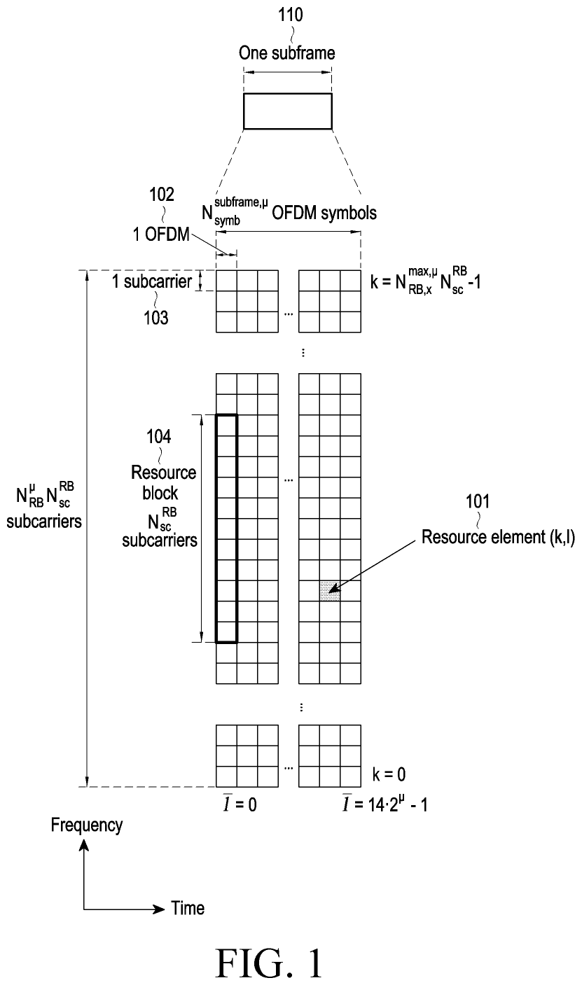

FIG. 1 illustrates a basic structure of a time-frequency domain, which is a radio resource domain used to transmit data or control channels, in a 5G system according to an embodiment.

Referring to FIG. 1, the horizontal axis denotes a time domain, and the vertical axis denotes a frequency domain. The basic unit of resources in the time and frequency domains is a resource element (RE) 101, which may be defined as one orthogonal frequency division multiplexing (OFDM) symbol 102 along the time axis and one subcarrier 103 along the frequency axis. In the frequency domain, N_{SC}^{RB} (for example, 12) consecutive REs may constitute one resource block (RB) 104. In the time domain, one subframe 110 may include multiple OFDM symbols 102. For example, the length of one subframe may be 1 ms.

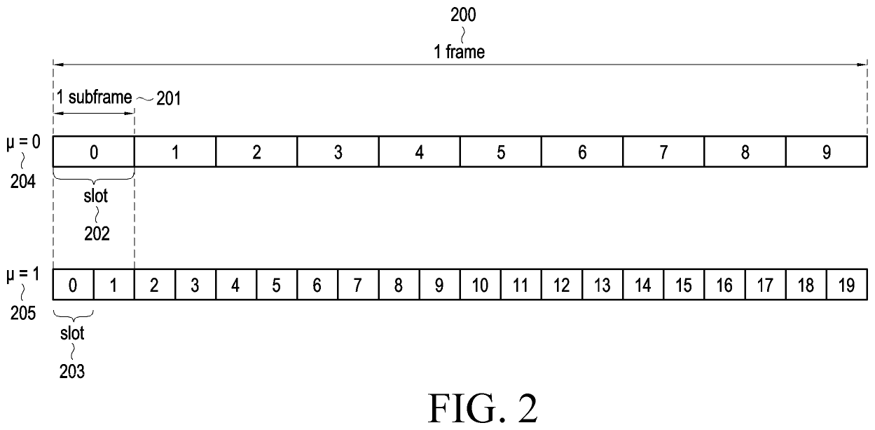

FIG. 2 illustrates a structure of a frame, a subframe, and a slot in a wireless communication system according to an embodiment.

Referring to FIG. 2, provided is a structure of a frame 200, a subframe 201, and a slot 202. One frame 200 may be defined as 10 ms. One subframe 201 may be defined as 1 millisecond (ms), and thus one frame 200 may include a total often subframes 201. One slot 202 or 203 may be defined as 14 OFDM symbols (that is, the number of symbols per one slot N_{symb}^{slot}=14). One subframe 201 may include one or multiple slots 202 and 203, and the number of slots 202 and 203 per one subframe 201 may vary depending on configuration values p for the subcarrier spacing 204 or 205. The example in FIG. 2 illustrates when the subcarrier spacing configuration value is μ=0 (204), and when μ=1 (205). In the case of μ=0 (204), one subframe 201 may include one slot 202, and in the case of μ=1 (205), one subframe 201 may include two slots 203. That is, the number of slots per one subframe Nₛₗₒₜ^{sunframe,μ} may differ depending on the subcarrier spacing configuration value μ, and the number of slots per one frame Nₛₗₒₜ^{frame,μ} may differ accordingly. Nₛₗₒₜ^{sunframe,μ} and Nₛₗₒₜ^{frame,μ} may be defined according to each subcarrier spacing configuration p as in Table 1 below.

TABLE 1

| μ | N_{symb}^{slot} | Nₛₗₒₜ^{frame,μ} | Nₛₗₒₜ^{sunframe,μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

Next, bandwidth part (BWP) configuration in a 5G communication system will be described in detail with reference to the accompanying drawings.

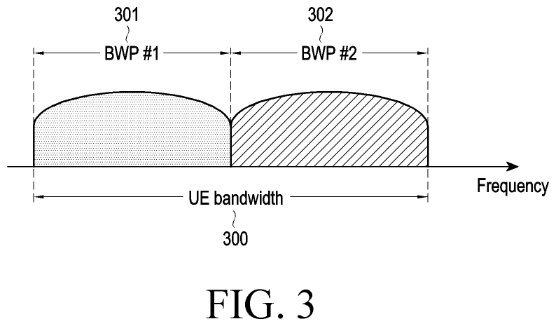

FIG. 3 illustrates a BWP configuration in a wireless communication system according to an embodiment.

Referring to FIG. 3, a UE bandwidth 300 is configured to include two BWPs, that is, BWP #1 301 and BWP #2 302. A base station may configure one or multiple BWPs for a UE and may configure the following pieces of information with regard to each BWP as given in Table 2 below.

TABLE 2

| BWP ::= | SEQUENCE { |
|---|---|
| bwp-Id | BWP-Id, |
| (bandwidth part identifier) | |
| locationAndBandwidth | INTEGER (1..65536), |
| (bandwidth part location) | |
| subcarrierSpacing | ENUMERATED {n0, n1, n2, |
| n3, n4, n5}, | |
| (subcarrier spacing) | |
| cyclicPrefix | ENUMERATED { extended |

```
    }
    (cyclic prefix)
}
```

The above example is not limiting, and various additional parameters related to the BWP may be configured for the UE. The base station may transfer the configuration information to the UE through upper layer signaling, such as RRC signaling. One configured BWP or at least one BWP among multiple configured BWPs may be activated. Whether the BWP configured for the UE is activated may be transferred from the base station to the UE semi-statically through RRC signaling, or dynamically through DCI.

Before an RRC connection is established, an initial BWP for initial access may be configured for the UE by the base station through a MIB. More specifically, the UE may receive configuration information regarding a control resource set (CORESET) and a search space which may be used to transmit a PDCCH for receiving system information (which may correspond to remaining system information (RMSI) or SIB1 necessary for initial access through the MIB in the initial access step. Each of the CORESET and the search space configured through the MIB may be considered identity (ID) 0. The base station may notify the UE of configuration information, such as frequency allocation information, time allocation information, and numerology, regarding control resource region #0 through the MIB. In addition, the base station may notify the UE of configuration information regarding the monitoring cycle and occasion with regard to CORESET #0, that is, configuration information regarding search space #0, through the MIB. The UE may consider that a frequency domain configured by CORESET #0 acquired from the MIB is an initial BWP for initial access. The ID of the initial BWP may be considered to be 0.

The BWP-related configuration supported by 5G may be used for various purposes.

If the bandwidth supported by the UE is smaller than the system bandwidth, this may be supported through the BWP configuration. For example, the base station may configure the frequency location (configuration information 2) of the BWP for the UE, so that the UE can transmit/receive data at a specific frequency location within the system bandwidth.

The base station may configure multiple BWPs for the UE for the purpose of supporting different numerologies. For example, to support a UE's data transmission/reception using both a subcarrier spacing of 15 kHz and a subcarrier spacing of 30 kHz, two BWPs may be configured as subcarrier spacings of 15 kHz and 30 kHz, respectively. Different BWPs may be subjected to frequency division multiplexing (FDM), and if data is to be transmitted/received at a specific subcarrier spacing, the BWP configured as the corresponding subcarrier spacing may be activated.

In addition, The base station may configure BWPs having different sizes of bandwidths for the UE for the purpose of reducing power consumed by the UE. For example, if the UE supports a substantially large bandwidth, for example, 100 MHz, and always transmits/receives data with the corresponding bandwidth, a substantially large amount of power consumption may occur. Particularly, it may be substantially inefficient from the viewpoint of power consumption to unnecessarily monitor the downlink control channel with a large bandwidth of 100 MHz in the absence of traffic. To reduce power consumed by the UE, the base station may configure a BWP of a relatively small bandwidth (for example, a BWP of 20 MHz) for the UE. The UE may perform a monitoring operation in the 20 MHz BWP in the absence of traffic and may transmit/receive data with the 100 MHz BWP as instructed by the base station if data has occurred.

In connection with the BWP configuring method, UEs, before being RRC-connected, may receive configuration information regarding the initial BWP through an MIB in the initial access step. Specifically, a UE may have a CORESET configured for a downlink control channel which may be used to transmit DCI for scheduling an SIB from the MIB of a physical broadcast channel (PBCH). The bandwidth of the CORESET configured by the MIB may be considered as the initial BWP, and the UE may receive, through the configured initial BWP, a PDSCH through which an SIB is transmitted. The initial BWP may be used not only for the purpose of receiving the SIB, but also for other system information (OSI), paging, random access, or the like.

### BWP Change

If a UE has one or more BWPs configured therefor, the base station may indicate, to the UE, to change (or switch or transition) the BWPs by using a BWP indicator field inside DCI. For example, if the currently activated BWP of the UE is BWP #1 301 in FIG. 3, the base station may indicate BWP #2 302 with a BWP indicator inside DCI, and the UE may change the BWP to BWP #2 302 indicated by the BWP indicator inside received DCI.

As described above, DCI-based BWP changing may be indicated by DCI for scheduling a PDSCH or a PUSCH, and thus, upon receiving a BWP change request, the UE needs to be able to receive or transmit the PDSCH or PUSCH scheduled by the corresponding DCI in the changed BWP with no problem. To this end, requirements for the delay time (T_{BWP}) required during a BWP change are specified in standards and may be defined given in Table 3 below.

TABLE 3

| | NR Slot | BWP switch delay T_{BWP} (slots) | |
|---|---|---|---|
| μ | length (ms) | Type 1^{Note 1} | Type 2^{Note 1} |
| 0 | 1 | 1 | 3 |
| 1 | 0.5 | 2 | 5 |
| 2 | 0.25 | 3 | 9 |
| 3 | 0.125 | 6 | 18 |

Note 1:
Depends on UE capability.
Note 2:
If the BWP switch involves changing of SCS, the BWP switch delay is determined by the larger of the SCS before BWP switch and the SCS after BWP switch.

The requirements for the BWP change delay time support type 1 or type 2, depending on the capability of the UE. The UE may report the supportable BWP change delay time type to the base station.

If the UE has received DCI including a BWP change indicator in slot n, according to the above-described requirement regarding the BWP change delay time, the UE may complete a change to the new BWP indicated by the BWP change indicator at a timepoint not later than slot n+T_{BWP}, and may transmit/receive a data channel scheduled by the corresponding DCI in the newly changed BWP. If the base station wants to schedule a data channel by using the new BWP, the base station may determine time domain resource allocation regarding the data channel, based on the UE's BWP change delay time (T_{BWP}). That is, when scheduling a data channel by using the new BWP, the base station may schedule the corresponding data channel after the BWP change delay time, in connection with the method for determining time domain resource allocation regarding the data channel. Accordingly, the UE may not expect that the DCI that indicates a BWP change will indicate a slot offset (K0 or K2) value smaller than the BWP change delay time (T_{BWP}).

If the UE has received DCI (for example, DCI format 1_1 or 0_1) indicating a BWP change, the UE may perform no transmission or reception during a time interval from the third symbol of the slot used to receive a PDCCH including the corresponding DCI to the start point of the slot indicated by a slot offset (K0 or K2) value indicated by a time domain resource allocation indicator field in the corresponding DCI. For example, if the UE has received DCI indicating a BWP change in slot n, and if the slot offset value indicated by the corresponding DCI is K, the UE may perform no transmission or reception from the third symbol of slot n to the symbol before slot n+K (for example, the last symbol of slot n+K−1).

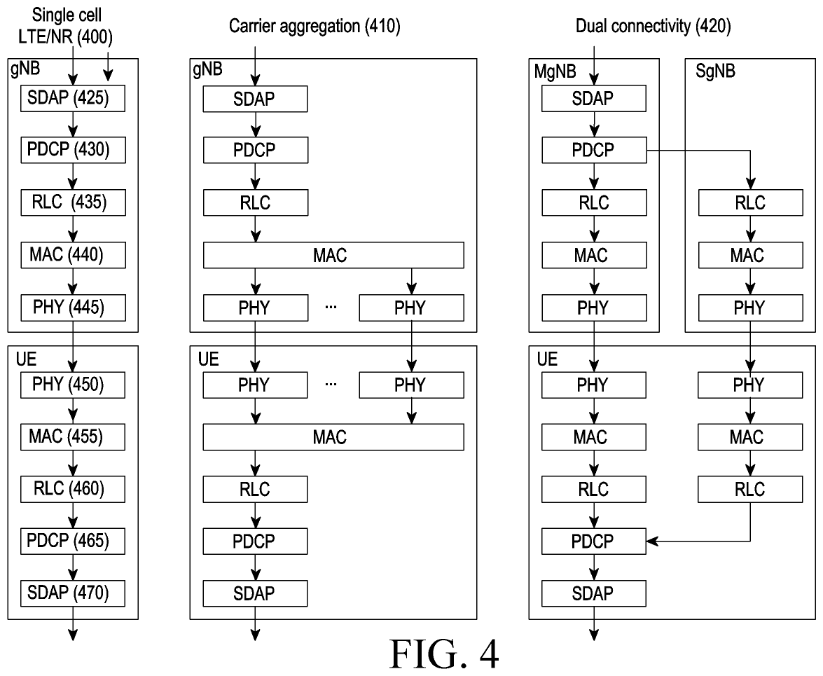

FIG. 4 illustrates radio protocol structures of a base station and a UE in single cell, carrier aggregation (CA), and dual connectivity (DC) situations according to an embodiment.

Referring to FIG. 4, a radio protocol of a next-generation mobile communication system includes an NR service data adaptation protocol (SDAP) 425 and 470, an NR PDCP 430 and 465, an NR radio link control (RLC) 435 and 460, an NR MACs 440 and 455, and a physical (PHY) layer 445 and 450 on each of UE and NR base station sides.

The main functions of the NR SDAP 425 or 470 may include at least one of transfer of user plane data, mapping between a QoS flow and a DRB for both DL and UL, marking a QoS flow ID in both DL and UL packets, and reflective QoS flow to DRB mapping for the UL SDAP PDUs.

With regard to the SDAP layer device, the UE may be configured, through an RRC message, whether to use the header of the SDAP layer device or whether to use functions of the SDAP layer device for each PDCP layer device or each bearer or each logical channel, and if an SDAP header is configured, the non-access stratum (NAS) QoS reflection configuration 1-bit indicator (NAS reflective QoS) and the AS QoS reflection configuration 1-bit indicator (AS reflective QoS) of the SDAP header may be indicated so that the UE can update or reconfigure mapping information regarding the QoS flow and data bearer of the uplink and downlink. The SDAP header may include QoS flow ID information indicating the QoS. The QoS information may be used as data processing priority, scheduling information, etc. for smoothly supporting services.

The main functions of the NR PDCP 430 or 465 may include at least one of the following functions.
Robust header compression (ROHC) and decompression
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in uplink

The above-mentioned reordering of the NR PDCP device refers to reordering PDCP PDUs received from a lower layer in an order based on the PDCP sequence number (SN) and may include transferring data to an upper layer in the reordered sequence. Alternatively, the reordering of the NR PDCP device may include instantly transferring data without considering the order, may include recording PDCP PDUs lost as a result of reordering, may include reporting the state of the lost PDCP PDUs to the transmitting side, and may include requesting retransmission of the lost PDCP PDUs.

The main functions of the NR RLC 435 or 460 may include at least one of the following functions.
Transfer of upper layer PDUs
In-sequence delivery of upper layer PDUs
Out-of-sequence delivery of upper layer PDUs
Error Correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

The above-mentioned in-sequence delivery of the NR RLC device refers to delivering RLC SDUs, received from the lower layer to the upper layer in sequence. The in-sequence delivery of the NR RLC device may include, if one original RLC SDU is segmented into multiple RLC SDUs and the segmented RLC SDUs are received, reassembling the RLC SDUs and delivering the reassembled RLC SDUs, may include reordering the received RLC PDUs with reference to the RLC sequence number (SN) or PDCP sequence number (SN), may include recording RLC PDUs lost as a result of reordering, may include reporting the state of the lost RLC PDUs to the transmitting side, and may include requesting retransmission of the lost RLC PDUs. The in-sequence delivery of the NR RLC device may include, if there is a lost RLC SDU, successively delivering only RLC SDUs before the lost RLC SDU to the upper layer, and may include, if a predetermined timer has expired although there is a lost RLC SDU, successively delivering all RLC SDUs received before the timer was started to the upper layer. Alternatively, the in-sequence delivery of the NR RLC device may include, if a predetermined timer has expired although there is a lost RLC SDU, successively delivering all RLC SDUs received until now to the upper layer. The in-sequence delivery of the NR RLC device may include processing RLC PDUs in the received order (regardless of the sequence number order, in the order of arrival) and delivering same to the PDCP device regardless of the order (out-of-sequence delivery), and may include, in the case of segments, receiving segments which are stored in a buffer or which are to be received later, reconfiguring same into one complete RLC PDU, processing, and delivering same to the PDCP device. The NR RLC layer may include no concatenation function, which may be performed in the NR MAC layer or replaced with a multiplexing function of the NR MAC layer.

The above-mentioned out-of-sequence delivery of the NR RLC device refers to instantly delivering RLC SDUs received from the lower layer to the upper layer regardless of the order, may include, if multiple RLC SDUs received, into which one original RLC SDU has been segmented, are received, reassembling and delivering the same, and may include storing the RLC SN or PDCP SN of received RLC PDUs, and recording RLC PDUs lost as a result of reordering.

The NR MAC 440 or 455 may be connected to multiple NR RLC layer devices configured in one UE, and the main functions of the NR MAC may include some of functions below.
Mapping between logical channels and transport channels
Multiplexing/demultiplexing of MAC SDUs
Scheduling information reporting
Error correction through hybrid automatic repeat request (HARQ)
Priority handling between logical channels of one UE
Priority handling between UEs by means of dynamic scheduling
MBMS service identification
Transport format selection
Padding

The NR PHY layer 445 or 450 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer.

The detailed structure of the radio protocol structure may be variously changed according to the carrier (or cell) operating scheme. For example, when the base station transmits data to the UE, based on a single carrier (or cell), the base station and the UE may use a protocol structure having a single structure with regard to each layer, such as 400. When the base station transmits data to the UE, based on carrier aggregation (CA) 410 which uses multiple carriers in a single TRP, the base station and the UE may use a protocol structure which has a single structure up to the RLC, but multiplexes the PHY layer through a MAC layer. Alternatively, when the base station transmits data to the UE, based on dual connectivity (DC) 420 which uses multiple carriers in multiple TRPs, the base station and the UE may use a protocol structure which has a single structure up to the RLC, but multiplexes the PHY layer through a MAC layer.

### Release (Rel)-15/16 TCI State

### Quasi Co-Location (QCL), TCI State

In a wireless communication system, one or more different antenna ports (which may be replaced with one or more channels, signals, and combinations thereof, but in the following description of the disclosure, will be referred to as different antenna ports, as a whole, for the sake of convenience) may be associated with each other by a QCL configuration as in Table 4 below. A TCI state is for announcing the QCL relation between a PDCCH (or a PDCCH DRMS) and another RS or channel, and the description that a reference antenna port A (reference RS #A) and another target antenna port B (target RS #B) are QCLed with each other means that the UE is allowed to apply some or all of large-scale channel parameters estimated in the antenna port A to channel measurement form the antenna port B. The QCL needs to be associated with different parameters according to the situation such as 1) time tracking influenced by average delay and delay spread, 2) frequency tracking influenced by Doppler shift and Doppler spread, 3) radio resource management (RRM) influenced by average gain, or 4) beam management (BM) influenced by a spatial parameter. Accordingly, four types of QCL relations are supported in NR as in Table 4 below.

TABLE 4

| QCL type | Large-scale characteristics |
|---|---|
| A | Doppler shift, Doppler spread, average delay, delay spread |
| B | Doppler shift, Doppler spread |
| C | Doppler shift, average delay |
| D | Spatial Rx parameter |

The spatial RX parameter may refer to some or all of various parameters as a whole, such as angle of arrival (AoA), power angular spectrum (PAS) of AoA, angle of departure (AoD), PAS of AoD, transmit/receive channel correlation, transmit/receive beamforming, and spatial channel correlation.

The QCL relations may be configured for the UE through RRC parameter TCI-state and QCL-info as in Table 9 below. In Table 5 below, the base station may configure one or more TCI states for the UE, thereby informing of a maximum of two types of QCL relations (qcl-Type1, qcl-Type2) regarding the RS that refers to the ID of the TCI state, that is, the target RS. Each piece of QCL information (QCL-Info) that each TCI state may include the serving cell index and the BWP index of the reference RS indicated by the corresponding QCL information, the type and ID of the reference BS, and a QCL type as in Table 4 above.

TABLE 5

| | |
|---|---|
| TCI-State ::= | SEQUENCE { |
| tci-StateId | TCI-StateId, |

(ID of corresponding TCI state)

| | |
|---|---|
| qcl-Type1 | QCL-Info, |

(QCL information of first reference RS of RS (target RS) referring to
corresponding TCI state ID)

| | |
|---|---|
| qcl-Type2 | QCL-Info |

```
        OPTIONAL, -- Need R
  (QCL information of second reference RS of RS (target RS) referring to
corresponding TCI state ID)
  ...
}
```

| | |
|---|---|
| QCL-Info ::= | SEQUENCE { |
| cell | ServCellIndex |

```
      OPTIONAL, -- Need R
  (serving cell index of reference RS indicated by corresponding QCL
information)
```

| | |
|---|---|
| bwp-Id | BWP-Id |

```
          OPTIONAL, -- Cond CSI-RS-Indicated
  (BWP index of reference RS indicated by corresponding QCL information)
```

| | |
|---|---|
| referenceSignal | CHOICE { |
| csi-rs | NZP- |

```
CSI-RS-ResourceId,
    ssb
  SSB-Index
    (one of CSI-RS ID or SSB ID indicated by corresponding QCL
information)
  },
```

| | |
|---|---|
| qcl-Type | ENUMERATED |

{typeA, typeB, typeC, typeD},
...
}

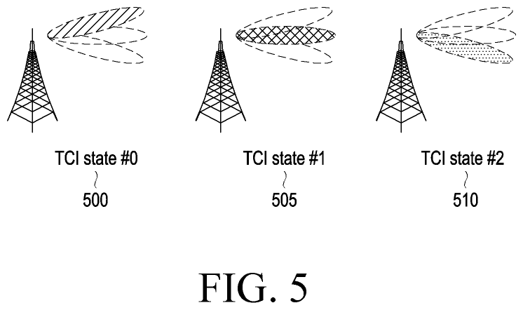

FIG. 5 illustrates abase station beam allocation according to TCI state configuration.

Referring to FIG. 5, the base station may transfer information regarding N different beams to the UE through N different TCI states. For example, in the case of N=3 as in FIG. 5, the base station may configure qcl-Type2 parameters included in three TCI states 500, 505, and 510 in QCL type D while being associated with CSI-RSs or SSBs corresponding to different beams, thereby notifying that antenna ports referring to the different TCI states 500, 505, and 510 are associated with different spatial Rx parameters (that is, different beams).

Tables 6 to 9 below enumerate valid TCI state configurations according to the target antenna port type.

Table 6 below enumerates valid TCI state configurations when the target antenna port is a CSI-RS for tracking (TRS). The TRS may refer to an NZP CSI-RS for which no repetition parameter is configured, and trs-Info of which is configured as “true”, among CRI-RSs. In Table 6, configuration no. 3 may be used for an aperiodic TRS. Valid T state configurations when the target antenna port is a CSI-RS for tracking (TRS) are shown.

TABLE 6

| Valid TCI | | | | |
|---|---|---|---|---|
| state | | | DL RS 2 | qcl-Type2 |
| Configuration | DL RS 1 | qcl-Type1 | (If configured) | (If configured) |
| 1 | SSB | QCL- | SSB | QCL-TypeD |
| | | TypeC | | |
| 2 | SSB | QCL- | CSI-RS (BM) | QCL-TypeD |
| | | TypeC | | |
| 3 | TRS | QCL- | TRS (same as | QCL-TypeD |
| | (periodic) | TypeA | DL RS 1) | |

Table 7 below enumerates valid Tc state configurations when the target antenna port is a CSI-RS for CSI. The CSI-RS for CSI may refer to an NZP CSI-RS which has no parameter indicating repetition (for example, repetition parameter) configured therefor, and trs-Info of which is not configured as “true”, among CRI-RSs. Table 7 relates to valid TC state configurations when the target antenna port is a CSI-RS for CSI.

TABLE 7

| Valid TCI | | | | |
|---|---|---|---|---|
| state | DL | | DL RS 2 | qcl-Type2 |
| Configuration | RS 1 | qcl-Type1 | (If configured) | (If configured) |
| 1 | TRS | QCL-TypeA | SSB | QCL-TypeD |
| 2 | TRS | QCL-TypeA | CSI-RS for BM | QCL-TypeD |
| 3 | TRS | QCL-TypeA | TRS (same as | QCL-TypeD |
| | | | DL RS 1) | |
| 4 | TRS | QCL-TypeB | | |

Table 8 below enumerates valid TC state configurations when the target antenna port is a CSI-RS for beam management (BM) (which has the same meaning as CSI-RS for L1 RSRP reporting). The CSI-RS for BM refers to an NZP CSI-RS which has a repetition parameter configured to have a value of “on” or “off”, and trs-Info of which is not configured as “true”, among CRI-RSs. Table 8 relates to valid TCI state configurations when the target antenna port is a CSI-RS for BM (for L1 RSRP reporting).

TABLE 8

| Valid TCI | | | DL RS 2 | qcl-Type2 |
|---|---|---|---|---|
| state | DL | | (If | (If |
| Configuration | RS 1 | qcl-Type1 | configured) | configured) |
| 1 | TRS | QCL- | TRS (same as | QCL-TypeD |
| | | TypeA | DL RS 1) | |
| 2 | TRS | QCL- | CSI-RS (BM) | QCL-TypeD |
| | | TypeA | | |
| 3 | SS/PBCH | QCL- | SS/PBCH Block | QCL-TypeD |
| | Block | TypeC | | |

Table 9 below enumerates valid TC state configurations when the target antenna port is a PDCCH DMRS. Table 9 relates to valid Tc state configurations when the target antenna port is a PDCCH DMRS.

TABLE 9

| Valid | | | | |
|---|---|---|---|---|
| TCI state | DL | | DL RS 2 | qcl-Type2 |
| Configuration | RS 1 | qcl-Type1 | (If configured) | (If configured) |
| 1 | TRS | QCL-TypeA | TRS (same as | QCL-TypeD |
| | | | DL RS 1) | |
| 2 | TRS | QCL-TypeA | CSI-RS (BM) | QCL-TypeD |
| 3 | CSI-RS | QCL-TypeA | CSI-RS (same | QCL-TypeD |
| | (CSI) | | as DL RS 1) | |

Table 10 below enumerates valid TC state configurations when the target antenna port is a PDSCH DMRS. Table 10 relates to valid TCI state configurations when the target antenna port is a PDSCH DMRS.

TABLE 10

| Valid | | | | |
|---|---|---|---|---|
| TCI state | DL | | DL RS 2 | qcl-Type2 |
| Configuration | RS 1 | qcl-Type1 | (If configured) | (If configured) |
| 1 | TRS | QCL- | TRS | QCL-TypeD |
| | | TypeA | | |
| 2 | TRS | QCL- | CSI-RS (BM) | QCL-TypeD |
| | | TypeA | | |
| 3 | CSI-RS | QCL- | CSI-RS (CSI) | QCL-TypeD |
| | (CSI) | TypeA | | |

According to a representative QCL configuration method based on Tables 6 to 10 above, the target antenna port and reference antenna port for each step are configured and operated such as “SSB”->“TRS”->“CSI-RS for CSI, or CSI-RS for BM, or PDCCH DMRS, or PDSCH DMRS”. Accordingly, it is possible to assist in the UE's receiving operation by associating statistical characteristics that can be measured from the SSB and TRS with respective antenna ports.

### Rel-17 Unified TCI State

### Unified TCI State

Hereinafter, a method for single TCI state indication and activation based on a unified TCI scheme is described. The unified TCI scheme may refer to a scheme for unifying and managing, as the TCI state, the transmission and reception beam management scheme divided into the TCI state scheme used in the downlink reception and the spatial relation information scheme used in the uplink transmission of the UE in the existing Rel-15/16. Accordingly, when indicated from a base station based on the unified TC scheme, the UE may perform beam management using the TCI state even for the uplink transmission. If the UE is configured with the higher layer signaling TCI-State having tci-stateId-r17 from the base station, the UE may perform an operation based on the unified TC scheme by using the corresponding TCI-State. The TCI-State may include two types of a joint TCI state or a separate TCI state.

The first type is the joint TCI state, and the UE may be indicated from the base station with the TCI state to be applied to both the uplink transmission and the downlink reception through one TCI-State. If the UE is indicated with TCI-State based on the joint TCI state, the UE may be indicated with a parameter to be used for downlink channel estimation using an RS corresponding to qcl-Type1 of the corresponding joint TCI state-based TCI-State, and a parameter to be used as a downlink reception beam or a reception filter using an RS corresponding to qcl-Type2. If the UE is indicated with TCI-State based on the joint TCI state, the UE may be indicated with a parameter to be used as an uplink transmission beam or a transmission filter using the RS corresponding to qcl-Type2 of the corresponding joint DL/UL TCI state-based TCI-State. When the UE is indicated with the joint TCI state, the UE may apply the same beam to the uplink transmission and the downlink reception.

The second type is the separate TCI state, and the UE may be indicated from the base station individually with a UL TCI state to be applied to the uplink transmission and a DL TCI state to be applied to the downlink reception. If the UE is indicated with the UL TCI state, the UE may be indicated with a parameter to be used as an uplink transmission beam or a transmission filter using a reference RS or a source RS configured in the corresponding UL TCI state. If the UE is indicated with the DL TCI state, the UE may be indicated with a parameter to be used for downlink channel estimation using the RS corresponding to qcl-Type1 configured in the corresponding DL TCI state, and a parameter to be used as a downlink reception beam or a reception filter using the RS corresponding to qcl-Type2.

If the UE is indicated together with the DL TCI state and the UL TCI state, the UE may be indicated with a parameter to be used as the uplink transmission beam or the transmission filter by using the reference RS or the source RS configured in the corresponding UL TCI state. If the UE is indicated with the DL TCI state and the UL TCI state together, the UE may be indicated with a parameter to be used for the downlink channel estimation using the RS corresponding to qcl-Type1 configured in the corresponding DL TCI state, and the parameter to be used as the downlink reception beam or the reception filter using the RS corresponding to qcl-Type2. When the reference RSs or the source RSs configured in the DL TCI state and the UL TCI state indicated to the UE are different, the UE may individually apply the beam for the uplink transmission and the downlink reception based on the indicated UL TCI state and DL TCI state, respectively.

The UE may be configured from the base station with up to 128 joint TCI states for each specific BWP in a specific cell through higher layer signaling. In addition, up to 64 or 128 DL TCI states of the separate TCI state may be configured for each specific BWP in a specific cell through higher layer signaling based on a UE capability report. The DL TCI state of the separate TCI state and the joint TCI state may use the same higher layer signaling structure. For example, if 128 joint TCI states are configured and 64 DL TCI states are configured in the separate TCI state, 64 DL TCI states may be included in 128 joint TCI states.

Up to 32 or 64 UL TCI states of the separate TCI state may be configured for each specific BWP in a specific cell through higher layer signaling based on a UE capability report, the UL TCI state of the separate TCI state and the joint TCI state may use the same higher layer signaling structure, like the relationship of the DL TCI state of the separate TCI state and the joint TCI state, and the UL TCI state of the separate TCI state may use a different higher layer signaling structure from that of the joint TCI state and the DL TCI state of the separate TCI state.

As described above, use of the different or the same higher layer signaling structure may be defined in the standard and may be distinguished through a higher layer signaling configured by the base station, based on a UE capability report containing information of whether to use one of the two types supported by the UE.

The UE may receive a transmission and reception beam-related indication in the unified TCI manner using one of the joint TCI state and the separate TCI state configured from the base station. The UE may be configured from the base station whether to use one of the joint TCI state and the separate TCI state through higher layer signaling.

The UE may receive the transmission and reception beam-related indication using one scheme selected from the joint TCI state and the separate TCI state through higher layer signaling. The transmission and reception beam indication method from the base station may include two methods of a MAC-CE based indication method and a MAC-CE based activation and DCI based indication method.

When the UE receives the transmission and reception beam-related indication using the joint TCI state through the higher layer signaling, the UE may perform a transmission and reception beam application operation by receiving a MAC-CE indicating the joint TCI state from the base station, and the base station may schedule, to the UE, reception of PDSCH including the corresponding MAC-CE through the PDCCH. If the MAC-CE includes one joint TCI state, the UE may determine an uplink transmission beam or a transmission filter, and a downlink reception beam or a reception filter by using the joint TCI state indicated from 3 ms after PUCCH transmission including HARQ-acknowledgement (HARQ-ACK) information indicating whether the PDSCH including the corresponding MAC-CE is successfully received.

If the MAC-CE includes two or more joint TCI states, the UE may identify the plurality of the joint TCI states indicated by the MAC-CE corresponding to respective codepoints of the TCI state field of DCI format 1_1 or 1_2 and activate the indicated joint TCI state, from 3 ms after PUCCH transmission including HARQ-ACK information indicating whether the PDSCH including the corresponding MAC-CE is successfully received. Thereafter, the UE may receive DCI format 1_1 or 1_2 and apply one joint TCI state indicated by the TCI state field of the corresponding DCI to the uplink transmit and downlink reception beams. DCI format 1_1 or 1_2 may or may not include downlink data channel scheduling information (with or without DL assignment).

When the UE receives the transmission and reception beam-related indication using the separate TCI state through higher layer signaling, the UE may perform the transmission and reception beam application operation by receiving the MAC-CE indicating the separate TCI state from the base station, and the base station may schedule, to the UE, reception of PDSCH including the corresponding MAC-CE through the PDCCH. If the MAC-CE includes one separate TCI state set, the UE may determine an uplink transmission beam or a transmission filter, and a downlink reception beam or a reception filter by using the separate TCI states included in the separate TCI state set indicated from 3 ms after PUCCH transmission including HARQ-ACK information indicating whether the corresponding PDSCH is successfully received. The separate TCI state set may indicate one or multiple separate TCI states of one codepoint of the TCI state field in DCI format 1_1 or 1_2. One separate TCI state set may include one DL TCI state, may include one UL TCI state, or may include one DL TCI state and one UL TCI state.

If the MAC-CE includes two or more separate TCI state sets, the UE may identify the plurality of the separate TCI state sets indicated by the MAC-CE corresponding to respective codepoints of the TCI state field of DCI format 1_1 or 1_2 and activate the indicated separate TCI state set, from 3 ms after transmission of PUCCH including HARQ-ACK information indicating whether the corresponding PDSCH is successfully received. each codepoint of the TCI state field of DCI format 1_1 or 1_2 may indicate one DL TCI state, one UL TCI state, or one DL TCI state and one UL TCI state. The UE may receive DCI format 1_1 or 1_2 and apply the separate TCI state set, indicated by the TCI state field of the corresponding DCI, to the uplink transmit and downlink reception beams. DCI format 1_1 or 1_2 may or may not include downlink data channel scheduling information (with or without DL assignment).

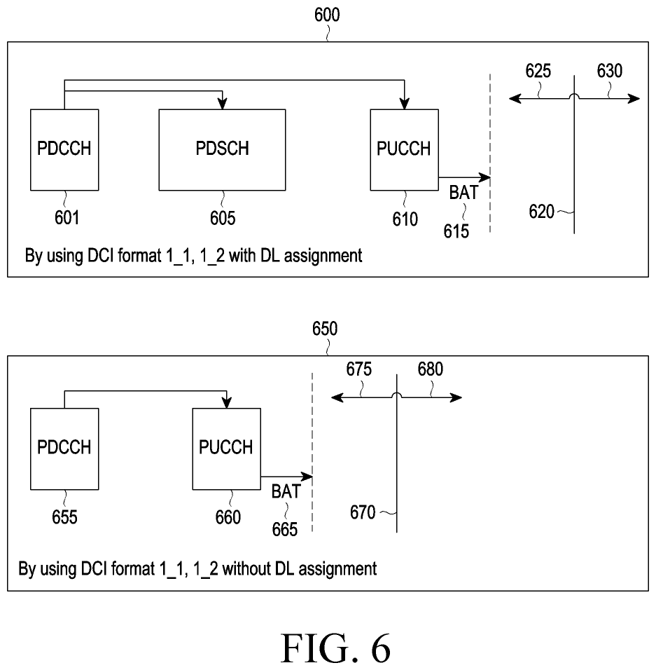

FIG. 6 illustrates a beam application time that is considerable when using a unified TCI scheme in a wireless communication system according to an embodiment. Referring to FIG. 6, the UE may receive DCI format 1_1 or 1_2 with or without downlink data channel scheduling information (DL assignment) from the base station and may apply one joint TCI state or separate TCI state set, indicated by the TCI state field of the corresponding DCI, to the uplink transmission and downlink reception beams.

DCI format 1_1 or 1_2 with DL assignment (600) refers to when the UE receives DCI format 1_1 or 1_2 including the downlink data channel (601) scheduling information from the base station to indicate one joint TCI state or separate TCI state set based on the unified TC scheme. The UE may receive a PDSCH (605) scheduled based on the received DCI and may transmit, to the base station, a PUCCH (610) including HARQ-ACK indicating reception success or failure of the DCI and the PDSCH. The HARQ-ACK may include success or failure of the DCI and the PDSCH, the UE may transmit NACK when at least one of the DCI and the PDSCH is not received, and the UE may transmit ACK when successfully receiving both the DCI and the PDSCH.

DCI format 1_1 or 1_2 without the DL assignment (650) refers to when the UE receives DCI format 1_1 or 1_2 not including the downlink data channel (655) scheduling information from the base station to indicate one joint TCI state or separate TCI state set based on the unified TCI scheme. The UE may assume the following for the corresponding DCI.

CRC scrambled using CS-RNTI is included.

Every bit allocated to fields used as redundancy version (RV) fields have a value of 1.

Every bit allocated to fields used as modulation and coding scheme (MCS) fields have a value of 1.

Every bit allocated to fields used as new data indication (NDI) fields have a value of 1.

Every bit allocated to an FDRA field has a value of 0 for FDRA type 0, every bit allocated to the FDRA field have a value of 1 for FDRA type 1, and every bit allocated to the FDRA field have a value of 0 for FDRA scheme dynamicSwitch.

The UE may transmit a PUCCH (660) including the HARQ-ACK indicating successful or unsuccessful reception of DCI format 1_1 or 1_2 in which the above details are assumed.

With respect to DCI format 1_1 or 1_2 with the DL assignment 600 and without the DL assignment 650, if a new TCI state indicated by the DCI 601 and the 655 is already indicated and identical to the TCI state applied to the uplink transmission and downlink reception beams, the UE may maintain the existing TCI state. If the new TCI state is different from the existing TCI state, the UE may determine an application time 630 or 680 of the joint TCI state or separate TCI state set indicated from the TCI state field of the DCI after an initial slot 620 or 670 after a time corresponding to a beam application time (BAT) 615 or 665 after the PUCCH transmission, and may use the previously indicated TCI-state until a previous section 625 or 675 of the corresponding slot 620 or 670.

With respect to both DCI format 1_1 or 1_2 with the DL assignment 600 and without the DL assignment 650, the BAT may be configured with higher layer signaling based on UE capability report information using a specific number of OFDM symbols. Numerology of the BAT and the first slot after the BAT 615, 665 may be determined based on the smallest numerology among all the cells to which the joint TCI state or separate TCI state set indicated by the DCI is applied.

The UE may apply one joint TCI state indicated by the MAC-CE or the DCI to receive CORESETs connected to every UE-specific search space, receive the PDSCH scheduled with the PDCCH transmitted from the corresponding CORESET and transmit the PUSCH, and transmit every PUCCH resource.

When one separate TCI state set indicated by the MAC-CE or the DCI includes one DL TCI state, the UE may apply the one separate TCI state set to receive CORESETs connected to every UE-specific search space, receive the PDSCH scheduled with the PDCCH transmitted from the corresponding CORESET, and apply to every PUSCH and PUCCH resource based on the existing UL TCI state indicated.

When one separate TCI state set indicated by the MAC-CE or the DCI includes one UL TCI state, the UE may apply the one separate TCI state set to every PUSCH and PUCCH resource, and based on the existing DL TCI state indicated, may receive CORESETs connected to every UE-specific search space, and receive the PDSCH scheduled with the PDCCH transmitted from the corresponding CORESET.

When one separate TCI state set indicated by the MAC-CE or the DCI includes one DL TCI state and one UL TCI state, the UE may apply the DL TCI state to receive CORESETs connected to every UE-specific search space, receive the PDSCH scheduled with the PDCCH transmitted from the corresponding CORESET, and apply the UL TCI state to every PUSCH and PUCCH resource.

### Unified TCI State MAC-CE

A UE receives, from a base station, scheduling of a PDSCH including the MAC-CE listed below, and from three slots after transmitting a HARQ-ACK for the corresponding PDSCH to the base station, the UE may interpret each codepoint in the TCI state field of DCI format 1_1 or 1_2 based on the information in the MAC-CE received from the base station. Thus, the UE may activate each entry of the MAC-CE received from the base station at each codepoint of the TCI state field in DCI format 1_1 or 1_2.

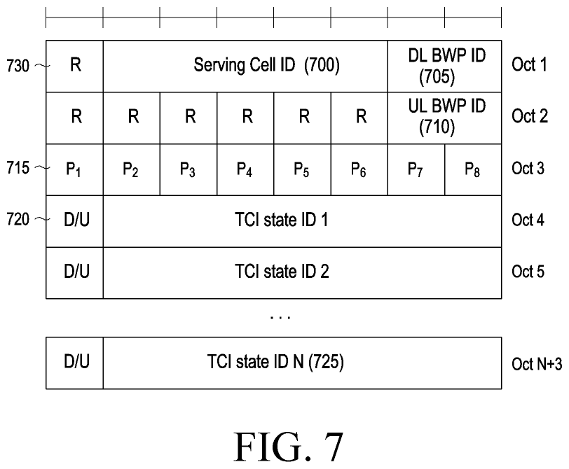

FIG. 7 illustrates another MAC-CE structure for activation and indication of a joint TCI state or separate DL or UL TCI states in a wireless communication system according to an embodiment. The meaning of each field within the corresponding MAC-CE structure is disclosed as follows.

The serving cell ID 700 indicates a serving cell to which the corresponding MAC-CE is to be applied. The length of this field may be 5 bits. If the serving cell indicated by this field is included in at least one of simultaneousTCI-UpdateList1, simultaneousTCI-UpdateList2, simultaneousTCI-UpdateList3, or simultaneousTCI-UpdateList4, the corresponding MAC-CE may be applied to all the serving cells included in at least one list among the simultaneousU-TCI-UpdateList1, simultaneousU-TCI-UpdateList2, simultaneousU-TCI-UpdateList3, simultaneousU-TCI-UpdateList4 in which serving cells indicated by this field are included.

The DL BWP ID 705 field indicates a DL BWP to which the corresponding MAC-CE is to be applied, and the meaning of each codepoint of the DL BWP ID may correspond to that of each codepoint of a BWP indicator in DCI. The length of the DL BWP ID field may be 2 bits.

The UL BWP ID 710 field indicates a UL BWP to which the corresponding MAC-CE is to be applied, and the meaning of each codepoint of the UL BWP ID may correspond to that of each codepoint of a BWP indicator in DCI. The length of the UL BWP ID field may be 2 bits.

The Pᵢ 715 field indicates whether each codepoint of a TCI state field in DCI format 1_1 or 12 codepoint has multiple TCI states or single TCI state. If Pᵢ has a value of 1, the corresponding i-th codepoint has multiple TCI states and this may indicate that the corresponding i-th codepoint may include a separate DL TCI state and a separate UL TCI state. If Pᵢ has a value of 0, the corresponding i-th codepoint has a single TCI state and this may indicate that the corresponding codepoint may include a joint TCI state or one of a separate DL TCI state and a separate UL TCI state.

The D/U 720 field indicates whether the TCI state ID in the same octet is for a joint TCI state or separate DL TCI state, or otherwise, for a separate UL TCI state. D refers to downlink and U refers to uplink. If this D/U field has a value of 1, the TCI state ID in the same octet may be for a joint TCI state or separate DL TCI state. If this field has a value of 0, the TCI state ID in the same octet is for a separate UL TCI state.

The TCI state ID 725 field indicates a TCI state identifiable by TCI-StateId which is higher layer signaling. If the D/U field is configured as 1, this TCI state ID field may be used for indicating the TCI-StateId, which may be indicated by 7 bits. If the D/U field is configured as 0, the most significant bit (MSB) of the TCI state ID field is considered as the reserved bit and remainder 6 bits may be used for indicating the UL-TCIState-Id which is higher layer signaling.

The maximum number of activated TCI states may be 8 in the case of joint TCI state and may be 16 in the case of separate DL or UL TCI state.

R 730 refers to a reserved bit and is configured as 0.

In connection with the MAC-CE structure of FIG. 7, the UE may include a third octet including the P₁, P₂, . . . , and P₈ fields of FIG. 7 in the corresponding MAC-CE structure, regardless of whether unifiedTCI-StateType-r17 in MIMOparam-r17 within ServingCellConfig, which is higher layer signaling, is configured as one type among the types of joint and separate. In this case, the UE may perform TCI state activation by using a fixed MAC-CE structure regardless of the higher layer signaling configured from the base station. Alternatively, in connection with the MAC-CE structure of FIG. 7 described above, the UE may omit the third octet that includes the P₁, P₂, . . . , and P₈ fields when unifiedTCI-StateType-r17 in MIMOparam-r17 within ServingCellConfig, which is higher layer signaling, is configured as joint. In this case, the UE may save up to 8 bits in the payload of the corresponding MAC-CE depending on the higher layer signaling configured from the base station. Further, the D/U fields located in the first bit from the fourth octet in FIG. 7 may all be considered as R fields, and the corresponding R fields may all be configured as 0 bits.

### PDCCH: Regarding DCI

Next, downlink control information (DCI) in a 5G communication system will be described in detail.

In a 5G system, scheduling information a PUSCH or PDSCH) is included in DCI and transferred from a base station to a UE through the DCI. The UE may monitor, with regard to the PUSCH or PDSCH, a fallback DCI format and a non-fallback DCI format. The fallback DCI format may include a fixed field predefined between the base station and the UE, and the non-fallback DCI format may include a configurable field.

The DCI may be subjected to channel coding and modulation processes and then transmitted through a PDCCH after a channel coding and modulation process. A cyclic redundancy check (CRC) may be attached to the DCI message payload, and the CRC may be scrambled by a radio network temporary identifier (RNTI) corresponding to the identity of the UE. Different RNTIs may be used according to the purpose of the DCI message, for example, UE-specific data transmission, power control command, or random access response. That is, the RNTI may not be explicitly transmitted, but may be transmitted while being included in a CRC calculation process. Upon receiving a DCI message transmitted through the PDCCH, the UE may identify the CRC by using the allocated RNTI. If the CRC identification result is correct, the UE may know that the corresponding message has been transmitted to the UE.

For example, DCI for scheduling a PDSCH regarding system information (SI) may be scrambled by an SI-RNTI. DCI for scheduling a PDSCH regarding a random access response (RAR) message may be scrambled by an RA-RNTI. DCI for scheduling a PDSCH regarding a paging message may be scrambled by a P-RNTI. DCI for notifying of a slot format indicator (SFI) may be scrambled by an SFI-RNTI. DCI for notifying of transmit power control (TPC) may be scrambled by a TPC-RNTI. DCI for scheduling a UE-specific PDSCH or PUSCH may be scrambled by a cell RNTI (C-RNTI).

DCI format 0_0 may be used as fallback DCI for scheduling a PUSCH, and in this case, the CRC may be scrambled by a C-RNTI. DCI format 0_0 in which the CRC is scrambled by a C-RNTI may include the following pieces of information given in Table 11 below.

TABLE 11
- Identifier for DCI formats - [1] bit
- Frequency domain resource
assignment --[ ┌log₂(N_{RB}^{UL,BWP}(N_{RB}^{UL,BWP} + 1)/2)┐ [symbol] ] bits
- Time domain resource assignment - X bits
- Frequency hopping flag - 1 bit.
- Modulation and coding scheme - 5 bits
- New data indicator - 1 bit
- Redundancy version - 2 bits
- HARQ process number - 4 bits
- Transmit power control (TPC) command for scheduled PUSCH- [2] bits
- Uplink/supplementary uplink indicator (UL/SUL indicator) - 0 or 1 bit

DCI format 0_1 may be used as non-fallback DCI for scheduling a PUSCH, and in this case, the CRC may be scrambled by a C-RNTI. DCI format 0_1 in which the CRC is scrambled by a C-RNTI may include the following pieces of information given in Table 12 below.

TABLE 12

| | - | Carrier indicator - 0 or 3 bits | |
|---|---|---|---|
| | - | UL/SUL indicator - 0 or 1 bit | |
| | - | Identifier for DCI formats - [1] bits | |
| | - | Bandwidth part indicator - 0, 1 or 2 bits | |
| | - | Frequency domain resource assignment | |
| | | • | For resource allocation type 0, ┌N_{RB}^{UL, BWP}/P┐ bits |
| | | • | For resource allocation type 1, ┌log₂ (N_{RB}^{UL, BWP} |
| | | | (N_{RB}^{UL, BWP} +1)/2)┐ bits |
| | - | Time domain resource assignment -1, 2, 3, or 4 bits | |
| | - | VRB-to-PRB mapping - 0 or 1 bit, only for resource allocation | |
| | | type 1. | |
| | | • | 0 bit if only resource allocation type 0 is configured; |
| | | • | 1 bit otherwise. |
| | - | Frequency hopping flag - 0 or 1 bit, only for resource allocation | |
| | | type 1. | |
| | | • | 0 bit if only resource allocation type 0 is configured; |
| | | • | 1 bit otherwise. |
| | - | Modulation and coding scheme - 5 bits | |
| | - | New data indicator - 1 bit | |
| | - | Redundancy version - 2 bits | |
| | - | HARQ process number - 4 bits | |
| | - | 1st downlink assignment index- 1 or 2 bits | |
| | | • | 1 bit for semi-static HARQ-ACK codebook; |
| | | • | 2 bits for dynamic HARQ-ACK codebook with single HARQ- |
| | | | ACK codebook. |
| | - | 2nd downlink assignment index - 0 or 2 bits | |
| | | • | 2 bits for dynamic HARQ-ACK codebook with two HARQ-ACK |
| | | | sub-codebooks; |
| | | • | 0 bit otherwise. |
| | - | TPC command for scheduled PUSCH - 2 bits | |
| | - | $SRS resource indicator - ⌈ {log}_{2} ( {\sum }_{k = 1}^{{L}_{max} \sum } ( \begin{matrix}{N}_{SRS} \\ k\end{matrix} ) ( ) ) ⌉ or ⌈ {log}_{2} ( {N}_{SRS} ) ⌉$ | |
| bits | | | |
| | | • | $⌈ {log}_{2} ( {\sum }_{k = 1}^{{L}_{max} \sum } ( \begin{matrix}{N}_{SRS} \\ k\end{matrix} ) ( ) ) ⌉ bits for non - codebook based$ |
| | | | PUSCH transmission; |
| | | • | ┌log₂(N_{SRS})┐ bits for non-codebook based PUSCH transmission. |

| | |
|---|---|
| - | Precoding information and number of layers-up to 6 bits |
| - | Antenna ports - up to 5 bits |
| - | SRS request - 2 bits |
| - | CSI request - 0, 1, 2, 3, 4, 5, or 6 bits |
| - | Code block group (CBG) transmission information - 0, 2, 4, 6, or 8 |

bits

| | |
|---|---|
| - | Phase tracking reference signal (PTRS)-demodulation reference |

signal (DMRS) association- 0 or 2 bits.

| | |
|---|---|
| - | beta_offset indicator- 0 or 2 bits |
| - | DMRS sequence initialization- 0 or 1 bit |

DCI format 1_0 may be used as fallback DCI for scheduling a PDSCH, and in this case, the CRC may be scrambled by a C-RNTI. DCI format 1_0 in which the CRC is scrambled by a C-RNTI may include the following pieces of information given in Table 13 below.

TABLE 13
- Identifier for DCI formats - [1] bit
- Frequency domain resource
assignment -[ ┌log₂(N_{RB}^{DL,BWP}(N_{RB}^{DL,BWP} + 1)/2)┐ [symbol] ] bits
- Time domain resource assignment - X bits
- VRB-to-PRB mapping - 1 bit.
- Modulation and coding scheme - 5 bits
- New data indicator - 1 bit
- Redundancy version - 2 bits
- HARQ process number - 4 bits
- Downlink assignment index - 2 bits
- TPC command for scheduled PUCCH - [2] bits
- Physical uplink control channel (PUCCH) resource indicator- 3 bits
- PDSCH-to-HARQ feedback timing indicator- [3] bits

DCI format 1_1 may be used as non-fallback DCI for scheduling a PDSCH, and in this case, the CRC may be scrambled by a C-RNTI. DCI format 1_1 in which the CRC is scrambled by a C-RNTI may include the following pieces of information given in Table 14 below.

```
TABLE 14
- Carrier indicator - 0 or 3 bits
- Identifier for DCI formats - [1] bits
- Bandwidth part indicator - 0, 1 or 2 bits
- Frequency domain resource assignment
    • For resource allocation type 0, ┌N_{RB}DL,DWP/P┐ [symbol]    bits
    • For resource allocation type 1,
    ┌log₂, (N_{RB}^{DL,BWP} (NRBDL,BWP + 1)/2┐ [symbol]    bits
- Time domain resource assignment -1, 2, 3, or 4 bits
- VRB-to-PRB mapping - 0 or 1 bit, only for resource allocation type 1.
    • 0 bit if only resource allocation type 0 is configured;
    • 1 bit otherwise.
- PRB bundling size indicator - 0 or 1 bit
- Rate matching indicator - 0, 1, or 2 bits
- ZP CSI-RS trigger - 0, 1, or 2 bits
For transport block 1:
  - Modulation and coding scheme - 5 bits
  - New data indicator - 1 bit
  - Redundancy version - 2 bits
For transport block 2:
  - Modulation and coding scheme - 5 bits
  - New data indicator - 1 bit
  - Redundancy version - 2 bits
- HARQ process number - 4 bits
- Downlink assignment index - 0 or 2 or 4 bits
- TPC command for scheduled PUCCH - 2 bits
- PUCCH resource indicator - 3 bits
- PDSCH-to-HARQ_feedback timing indicator - 3 bits
- Antenna ports - 4, 5 or 6 bits
- Transmission configuration indication- 0 or 3 bits
- SRS request - 2 bits
- CBG transmission information - 0, 2, 4, 6, or 8 bits
- CBG flushing out information - 0 or 1 bit
- DMRS sequence initialization - 1 bit
```

### PDSCH/PUSCH: Frequency Resource Allocation Related

Next, frequency domain resource assignment (FDRA) for a physical downlink shared channels (PDSCH) and a physical uplink shared channels (PUSCH) in NR will be described.

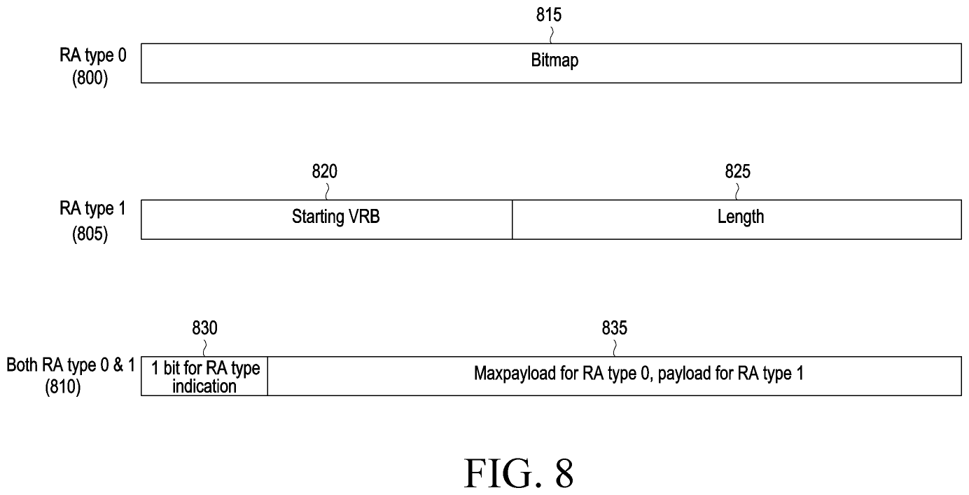

FIG. 8 illustrates a frequency domain resource allocation of a PDSCH or PUSCH in a wireless communication system according to an embodiment.

Referring to FIG. 8, three frequency domain resource allocation (FDRA) methods including FDRA type 0 800, FDRA type 1 805, and dynamic switch 810, are shown, and are configurable through a higher layer in an NR wireless communication system.

When a UE is configured to use only FDRA type 0 (800) through higher layer signaling, a part of DCI for scheduling a PDSCH or PUSCH for the UE includes a bitmap configured by N_{RBG} bits. In this case, N_{RBG} indicates the number of resource block groups (RBGs) determined, as shown in Table 15 below, according to the size of a BWP allocated by a BWP indicator and the higher layer parameter “rbg-Size,” and data is transmitted in the RBG represented as “1” using a bitmap.

TABLE 15

| Bandwidth Part Size | Configuration 1 | Configuration 2 |
|---|---|---|
| 1-36 | 2 | 4 |
| 37-72 | 4 | 8 |
| 73-144 | 8 | 16 |
| 145-275 | 16 | 16 |

The size of the frequency resource of a BWP may be defined as the number of RBs that the BWP includes. More specifically, if the UE is indicated to allocate FDRA type-0 resources, the length of the FDRA field of the DCI received by the UE is equal to the number of RBGs in the BWP (N_{RBG}), in which N_{RBG}=┌(N_{BWP}^{size}+(N_{BWP}^{start} mod P))/P┐. The first RBG in the BWP includes RBG₀^{size}=P−N_{BWP}^{size} mod P RBs, and if (N_{BWP}^{start}+N_{SWP}^{size})mod P>0, the last RBG in the BWP includes RBGₗₐₛₜ^{size}(N_{BWP}^{start}+N_{SWP}^{size})mod P RBs; otherwise, the last RBG includes RBGₗₐₛₜ^{size}=P RBs. The remaining RBGs in the BWP include P RBs. P is the number of nominal RBGs determined according to [Table 15] above.

If the UE is configured to use only FDRA type 1 (805) via higher layer signaling, the DCI assigning PDSCH or PUSCH to the UE includes FDRA information configured by ┌log₂(N_{RB}^{BWP}*(N_{RB}^{BWP}+1)/2┐ bits. N is the number of RBs included in the BWP. This enables the base station to configure a starting VRB 820 and a frequency-domain resource length 825 which is successively allocated therefrom.

If the UE is not configured with the higher layer signaling vrb-ToPRB-Interleaver, the UE may associate the resources allocated to the VRBs to the PRBs without interleaving. If the UE is configured with the higher layer signaling vrb-ToPRB-Interleaver, the higher layer signaling has a value of 2 or 4, which may be multiple units of RBs performing interleaving. That is, a bundle of RBs of 2 or 4 units may be used for interleaving.

If the UE is configured with an i-th BWP that starts at a location N_{BWP,i}^{start} and has a length of N_{BWP,i}^{size} RBs, and is configured with Lᵢ of vrb-ToPRB-Interleaver, the UE may split the i-th BWP into N_{bundle}=┌(N_{BWP,i}^{size}+(BWP,i^{start} mod Lᵢ))/Lᵢ┐ RB bundles, each of which may be configured by Lᵢ RBs.

In the i-th BWP, the first RB bundle may be configured by Lᵢ−(N_{BWP,i}^{size} mod Lᵢ) RBs.

In the i-th BWP, the last RB bundle may be configured by (N_{BWP,i}^{start}+N_{BWP,i}^{size}) mod Lᵢ RBs if a value of (N_{BWP,i}^{start}+_{BWP,i}^{size}) mod Lᵢ is greater than zero, otherwise the last RB bundle may be configured by Lᵢ RBs.

In the i-th BWP, the remaining RB bundle may be configured by Lᵢ RBs.

The VRBs may be connected to the PRBs according to the following method.

The last VRB bundle may be connected to the last PRB bundle.

The j-th (j=0, 1, N_{bundle}−2) VRB bundle may be connected to the f(j) PRB bundle, and f(j) may be expressed as Equation (1) below.

$$f ( j ) = rC + c \qquad ( 1 )$$

$$j = cR + r$$

$$r = 0 , 1 , … , R - 1$$

$$c = 0 , 1 , … , C - 1$$

$$R = 2$$

$$C = ⌊ {N}_{bundle} / R ⌋$$

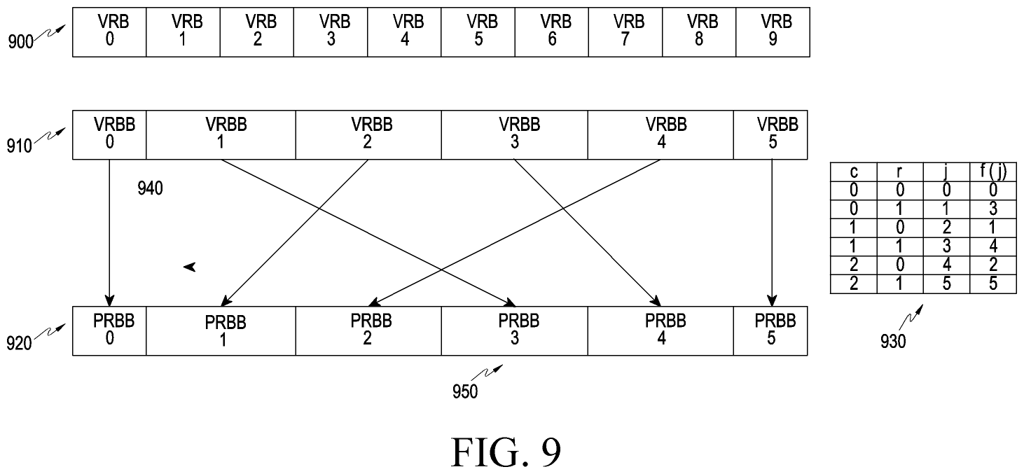

FIG. 9 illustrates a VRB-PRB interleaving scheme of a PDSCH during FDRA type-1 resource allocation according to an embodiment. Referring to FIG. 9, the case 910 in which the first and last VRB bundles are configured by 1 VRB in a BWP configured by 10 RBs (900) is shown. Therefore, N_{bundle}, which is the number of VRB bundles, may be 6, and may be calculated as C=└N_{bundle}/R┘=3 by Equation (1). Therefore, since the j-th VRB bundle may be connected to the f(j)th PRB bundle according to Equation (1), the connection from the VRB bundle to the PRB bundle via the result 930 calculated by the above Equation (1) may be performed as shown in reference numeral 920. For example, VRB bundle 1 940 may be connected to PRB bundle 3 950.

Referring back to FIG. 8, when a UE is configured to use both FDRA type-0 resource allocation and FDRA type-1 (810) resource allocation through layer signaling, some DCI for allocating the PDSCH/PUSCH to the corresponding UE may include frequency domain resource allocation information including bits of a larger value 835 among the payload 815 for configuring FDRA type-0 resource allocation and payloads 820 and 825 for configuring FDRA type-1 resource allocation. In this case, one bit may be added to the foremost part (MSB) of the frequency domain resource allocation information in the DCI, and the corresponding bit having a value of ‘0’ indicates that FDRA type-0 resource allocation is to be used, and a value of ‘1’ indicates that FDRA type-1 resource allocation is to be used.

If the UE is configured with the FDRA type-2 resource allocation method through higher layer signaling, the UE may receive instructions from the base station with respect to the FDRA type-2 resource allocation method according to the following method.

The UE may receive M interlace index sets of RB allocation information from the base station.

The interlace index mϵ{0, 1, . . . , M−1} may be configured by the common RB {m, M+m, 2M+m, 3M+, . . . }, in which M is defined as shown in Table 16 below.

TABLE 16

| μ | M |
|---|---|
| 0 | 10 |
| 1 | 5 |

The relationship of RB n_{IRB,m}^{μ}ϵ{0, 1, . . . } in interlace m and BWP i and the common RB n_{IRB}^{μ} may be defined in Equation (2) as follows.

$${n}_{CRB}^{μ} = {Mn}_{IRB , m}^{μ} + {N}_{BWB , i}^{start , μ} + ( ( m - {N}_{BWB , i}^{start , μ} ) mod M ) \qquad ( 2 )$$

In Equation (2), N_{BWP,1}^{start,μ} is the common RB in which BWP starts relative to common RB 0. u is subcarrier spacing index

When the subcarrier spacing is 15 kHz (u=0), the RB allocation information for the interlace set with (m0+1) indices may be notified of from the base station to the UE. Further, the resource allocation field may be configured by a resource indication value (RIV). When the resource indicator value is 0≤RIV<M(M+1)/2, l=0, 1, . . . L−1, the RIV may be configured by a starting interlace m0 and a number of consecutive interlaces L (L≥1), and the value of RIV is defined in the following algorithm:

if (L − 1) ≤ └M/2┘ then
RIV = M(L − 1) + m₀
else
RIV = M(M − L + 1) + (M − 1 − m₀)

When the resource indicator value is RIV≥M(M+1)/2, the resource indicator value is configured by the values of the starting interlace index m0 and 1 and may be configured as shown in Table 17 below.

TABLE 17

| RIV − M(M + 1)/2 | m0 | l |
|---|---|---|
| 0 | 0 | {0, 5} |
| 1 | 0 | {0, 1, 5, 6} |
| 2 | 1 | {0, 5} |
| 3 | 1 | {0, 1, 2, 3, 5, 6, 7, |
| | | 8} |
| 4 | 2 | {0, 5} |
| 5 | 2 | {0, 1, 2, 5, 6, 7} |
| 6 | 3 | {0, 5} |
| 7 | 4 | (0, 5} |

When the subcarrier spacing is 30 kHz (u=1), the RB allocation information may be notified of from the base station to the UE in the form of a bitmap indicating the interlaces assigned to the UE. The size of the bitmap is M, and each 1 bit of the bitmap corresponds to an interlace. The interlace bitmap order may be such that interlace indices 0 to M−1 are mapped from a most significant bit (MSB) to a least significant bit (LSB) of the bitmap.

For 15 kHz and 30 kHz, the LSB

$$Y = ⌈ log 2 \frac{{N}_{RB - set}^{BWP} ( {N}_{RB - set}^{BWP} + 1 )}{2} ⌉$$

of the FDRA field may represent a set of consecutive RBs of PUSCH scheduled in DCI format 0_1. Y bit may be configured by a resource indication value (RIVRBset). In 0≤RIV_{RBset}<N_{RB-set}^{BWP}(N_{RB-set}^{BWP}+1)/2, l=0, 1, . . . L_{RBset}−1, the RIVRBset value may be determined by the starting RB set (RBset_{START}) and the number of consecutive RB sets (L_{RBset}(L_{RBset}≥1)). The RIVRBset value may be defined in the following algorithm.

if (L_{RBset} − 1) ≤ └N_{RR-} [symbol] ^{BWP}/2┘ then
RIV_{RBset} = N_{RB-} [symbol] ^{BWP}(L_{RBset} − 1) + RBset_{START}
else
RIV_{RBset} = N_{RB-} [symbol] ^{BWP}(N_{RB-} [symbol] ^{BWP} − L_{RBset} + 1) + (N_{RB-} [symbol] ^{BWP} − 1 −
RBset_{START}) [symbol]
indicates data missing or illegible when filed

N_{RR-set}^{BWP} refers to the number of RB sets included in the BWP, which may be determined by the number of guard gaps (or bands) within a carrier configured (or preconfigured) via higher signaling.

### PDSCH/PUSCH: Regarding Time Resource Allocation

A base station may configure a table for time domain resource allocation information regarding a PDSCH and a PUSCH for a UE through upper layer signaling (for example, RRC signaling). A table including a maximum of maxNrofDL-Allocations=16 entries may be configured for the PDSCH, and a table including a maximum of maxNrofUJL-Allocations=16 entries may be configured for the PUSCH. The time domain resource allocation information may include PDCCH-to-PDSCH slot timing (for example, corresponding to a slot-unit time interval between a timepoint at which a PDCCH is received and a timepoint at which a PDSCH scheduled by the received PDCCH is transmitted; labeled K0), PDCCH-to-PUSCH slot timing (for example, corresponding to a slot-unit time interval between a timepoint at which a PDCCH is received and a timepoint at which a PUSCH scheduled by the received PDCCH is transmitted; hereinafter, labeled K2), information regarding the location and length of the start symbol by which a PDSCH or PUSCH is scheduled inside a slot, the mapping type of a PDSCH or PUSCH, and the like. For example, information such as in Table 18 or Table 19 below may be transmitted from the base station to the UE.

TABLE 18
PDSCH-TimeDomainResourceAllocationList information element

| | |
|---|---|
| PDSCH-TimeDomainResourceAllocationList ::= | SEQUENCE (SIZE(1..maxNrofDL- |

Allocations)) OF
PDSCH-TimeDomainResourceAllocation

| | |
|---|---|
| PDSCH-TimeDomainResourceAllocation ::= | SEQUENCE { |

```
          k0
INTEGER(0..32)
    OPTIONAL, -- Need S
        (PDCCH-to-PDSCH timing, slot unit)
```

| | |
|---|---|
| mappingType | ENUMERATED |

{typeA, typeB},
(PDSCH mapping type)

| | |
|---|---|
| startSymbol AndLength | INTEGER (0..127) |

```
    (start symbol and length of PDSCH)
  }
```

TABLE 19
PUSCH-TimeDomainResourceAllocationList information element

| | |
|---|---|
| PUSCH-TimeDomainResourceAllocationList := | SEQUENCE (SIZE(1..maxNrofUL- |

Allocations)) OF
PUSCH-TimeDomainResourceAllocation

| | |
|---|---|
| PUSCH-TimeDomainResourceAllocation ::= | SEQUENCE { |

k2

| | |
|---|---|
| INTEGER(0..32) OPTIONAL, | -- Need S |

(PDCCH-to-PUSCH timing, slot unit)

| | |
|---|---|
| mappingType | ENUMERATED |

{typeA, typeB},

| | |
|---|---|
| (PUSCH mapping type) | INTEGER (0..127) |

```
      startSymbolAndLength
          (start symbol and length of PUSCH)
  }
```

The base station may notify the UF of one of the entries of the table regarding time domain resource allocation information described above through L1 signaling, such as DCI. in a time domain resource allocation field. The UE may acquire time domain resource allocation information regarding a PDSCH or PUSCH, based on the DCI acquired from the base station.

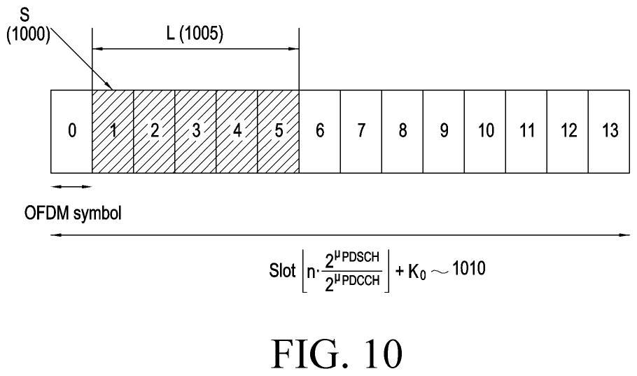

FIG. 10 illustrates a time domain resource allocation with regard to a PDSCH in a wireless communication system according to an embodiment.

Referring to FIG. 10, the base station may indicate the time domain location of a PDSCH resource according to the subcarrier spacing (SCS)(μ_{PDSCH}, μ_{PDCCH}) of a data channel and a control channel configured by using an upper layer, the scheduling offset (K0) value, and the OFDM symbol start location 1000 and length 1005 within one slot dynamically indicated through DCI.

### PUCCH: Transmission Related

In the NR system, the UE transmits control information (UCI) to the base station through PUCCH. The control information may include at least one of HARQ-ACK indicating success or failure of demodulation/decoding for a transport block (TB) received by the UE through the PDSCH, scheduling request (SR) for requesting, by the UE, resource allocation from the PUSCH base station for uplink data transmission, and channel state information (CSI), which is information for reporting the channel state of the UE.

The PUCCH resource may be largely divided into a long PUCCH and a short PUCCH according to the length of the allocated symbol. In the NR, the long PUCCH has a length of 4 symbols or more in a slot, and the short PUCCH has a length of 2 or fewer symbols in a slot.

The long PUCCH may be used for the purpose of improving uplink cell coverage, and thus may be transmitted in a DFT-S-OFDM scheme, which is a single carrier transmission rather than an OFDM transmission. The long PUCCH supports transmission formats such as PUCCH format 1, PUCCH format 3, and PUCCH format 4 depending on the number of supportable control information bits and whether UE multiplexing through Pre-DFT OCC support at the front end of the inverse fast Fourier transform (IFFT) is supported.

The PUCCH format 1 is a DFT-S-OFDM-based long PUCCH format capable of supporting up to 2 bits of control information, and uses as much frequency resources as 1RB. The control information may be configured by a combination of HARQ-ACK and SR or each. In PUCCH format 1, an OFDM symbol including a demodulation reference signal (DMRS) that is a demodulation reference signal (or a reference signal) and an OFDM symbol including UCI are repeatedly configured.

For example, when the number of transmission symbols of PUCCH format 1 is 8 symbols, the first start symbol of 8 symbols may be sequentially configured by DMRS symbol, UCI symbol, DMRS symbol, UCI symbol, DMRS symbol, UCI symbol, DMRS symbol, UCI symbol. The DMRS symbol is spread using an orthogonal code (or orthogonal sequence or spreading code, wᵢ(m)) on the time axis to a sequence corresponding to the length of 1RB on the frequency axis within one OFDM symbol, and may be transmitted after IFFT.

The UCI symbol may be generated such that the UE generates d(0) by BPSK modulating 1-bit control information and QPSK modulating 2-bit control information, multiplies the generated d(0) by a sequence corresponding to the length of 1 RB on the frequency axis to scramble, spreads the scrambled sequence using an orthogonal code (or an orthogonal sequence or spreading code, wᵢ(m)) on the time axis, and may transmit the same after performing the IFFT.

The UE generates the sequence, based on the group hopping or sequence hopping configuration and the configured ID configured by a higher signal from the base station, and generates a sequence corresponding to a length of 1 RB by cyclic shifting the generated sequence with an initial cyclic shift (CS) value configured by a higher signal.

The wᵢ(m) is determined as

$$w \text{?} ( m ) = e \text{?}$$

$$\text{?} \text{indicates text missing or illegible when filed}$$

when the length of the spreading code (NSF) is given, and specifically illustrated in Table 20 below. In the above, i refers to the index of the spreading code itself, and m refers to the index of the elements of the spreading code. The numbers within the brackets [ ] in Table 20 for PUCCH format 1 refer to ϕ(m), if the length of the spreading code is 2 and the index of the set spreading code is i=0, the spreading code becomes wᵢ(0)=e^{j2·/0N}^{ᵣ}=1, wᵢ(1)=e^{j2·/0N}^{ᵣ}=1, and thus wᵢ(m)=[1 1].

TABLE 20

| | φ(m) | | | | | | |
|---|---|---|---|---|---|---|---|
| N [symbol] | [symbol] = 0 | [symbol] = 1 | [symbol] = 2 | [symbol] = 3 | [symbol] = 4 | [symbol] = 5 | [symbol] = 6 |
| 1 | [0] | — | — | — | — | — | — |
| 2 | [0 0] | [0 1] | — | — | — | — | — |
| 3 | [0 0 0] | [0 1 2] | [0 2 1] | — | — | — | — |
| 4 | [0 0 0 0] | [0 2 0 2] | [0 0 2 2] | [0 2 2 0] | — | — | — |
| 5 | [0 0 0 0 0] | [0 1 2 3 4] | [0 2 4 1 3] | [0 3 1 4 2] | [0 4 3 2 1] | — | — |
| 6 | [0 0 0 0 0 0] | [0 1 2 3 4 5] | [0 2 4 0 2 4] | [0 3 0 3 0 3] | [0 4 2 0 4 2] | [0 5 4 3 2 1] | — |
| 7 | [0 0 0 0 0 0 0] | [0 1 2 3 4 5 6] | [0 2 4 6 1 3 5] | [0 3 6 2 5 1 4] | [0 4 1 5 2 6 3] | [0 5 3 1 6 4 2] | [0 6 5 4 3 2 1] |

[symbol]

indicates data missing or illegible when filed

The PUCCH format 3 is a DFT-S-OFDM-based long PUCCH format capable of supporting more than 2 bits of control information, and the number of RBs used may be configured through a higher layer. The control information may be configured by a combination of HARQ-ACK, SR, and CSI, or each. In the PUCCH format 3, the location of the DMRS symbol is presented according to whether frequency hopping in the slot and whether additional DMRS symbols are configured as shown in Table 21 below.

TABLE 21

| PUCCH | DMRS location in PUCCH format ¾ transmission | | | |
|---|---|---|---|---|
| format | Additional DMRS is not | | Additional DMRS | |
| ¾ | configured | | is configured | |
| trans- | Frequency | Frequency | Frequency | Frequency |
| mission | hopping is not | hopping is not | hopping is not | hopping is not |
| length | configured | configured | configured | configured |
| 4 | 1 | 0.2 | 1 | 0.2 |

| | | |
|---|---|---|
| 5 | 0, 3 | 0, 3 |
| 6 | 1, 4 | 1, 4 |
| 7 | 1, 4 | 1, 4 |
| 8 | 1, 5 | 1, 5 |
| 9 | 1, 6 | 1, 6 |
| 10 | 2, 7 | 1, 3, 6, 8 |
| 11 | 2, 7 | 1, 3, 6, 9 |
| 12 | 2, 8 | 1, 4, 7, 10 |
| 13 | 2, 9 | 1, 4, 7, 11 |
| 14 | 3, 10 | 1, 5, 8, 12 |

For example, when the number of transmission symbols of the PUCCH format 3 is 8 symbols, the first start symbol of the 8 symbols starts with 0, and the DMRS is transmitted in the first symbol and the fifth symbol. Table 21 is similarly applied to the DMRS symbol position of the PUCCH format 4.

The PUCCH format 4 is a DFT-S-OFDM-based long PUCCH format capable of supporting more than 2 bits of control information and uses as many frequency resources as 1RB. The control information may be configured by a combination of HARQ-ACK, SR, and CSI, or each of them. The difference between the PUCCH format 4 and the PUCCH format 3 is that, in case of the PUCCH format 4, the PUCCH format 4 of multiple UEs may be multiplexed within one RB. It is possible to multiplex PUCCH format 4 of a plurality of UEs through application of Pre-DFT orthogonal cover code (OCC) to control information in the front of the IFFT. However, the number of transmittable control information symbols of one UE decreases according to the number of multiplexed UEs. The number of multiplexable UEs, that is, the number of different OCCs that may be used, may be 2 or 4, and the number of OCCs and the OCC index to be applied may be configured through a higher layer.

The short PUCCH may be transmitted in both a downlink centric slot and an uplink centric slot. In general, the short PUCCH may be transmitted at the last symbol of the slot or an OFDM symbol at the end (e.g., the last OFDM symbol, the second OFDM symbol from the end, or the last 2 OFDM symbols). It is also possible to transmit the short PUCCH at any location in the slot. In addition, the short PUCCH may be transmitted using one OFDM symbol or two OFDM symbols. The short PUCCH may be used to shorten a delay time compared to the long PUCCH when uplink cell coverage is good and is transmitted in a CP-OFDM scheme.

The short PUCCH may support transmission formats such as PUCCH format 0 and PUCCH format 2 according to the number of supportable control information bits. First, the PUCCH format 0 is a short PUCCH format capable of supporting up to 2 bits of control information and uses frequency resources of 1 RB. The control information may be configured by a combination of HARQ-ACK and SR or each of them. The PUCCH format 0 does not transmit DMRS but transmits only sequences mapped to 12 subcarriers in the frequency axis within one OFDM symbol. The UE generates a sequence, based on the group hopping or sequence hopping configuration and configured ID, which are configured by a higher signal from the base station, cyclic shifts the generated sequence to the final cyclic shift (CS) value obtained by adding another CS value according to whether it is ACK or NACK to the indicated initial CS value, maps the same to 12 subcarriers, and transmits the same.

For example, when HARQ-ACK is 1 bit, as in Table 22 below, in the case of ACK, the UE may add 6 to the initial CS value to generate the final CS, and in the case of NACK, the UE may add 0 to the initial CS to generate the final CS. The CS value 0 for NACK and 6 for ACK are defined in the standard, and the UE may generate PUCCH format 0 according to the value to transmit 1-bit HARQ-ACK.

TABLE 22

| 1 bit HARQ-ACK | NACK | ACK |
|---|---|---|
| Final CS | (Initial CS + 0) mod | (Initial CS + 6) |
| | 12 = initial CS | mod 12 |

For example, when HARQ-ACK is 2 bits, the UE may add 0 to the initial CS value in the case of (NACK, NACK) as in Table 23 below, add 3 to the initial CS value in the case of (NACK, ACK), add 6 to the initial CS value in the case of (ACK, ACK), and add 9 to the initial CS value in the case of (ACK, NACK). The CS value 0 for (NACK, NACK), 3 for the CS value for (NACK, ACK), 6 for the CS value for (ACK, ACK), and 9 for the CS value for (ACK, NACK) are defined in the standard. The UE may transmit a 2-bit HARQ-ACK by generating PUCCH format 0 according to the value defined in the standard. When the final CS value exceeds 12 by the CS value added according to ACK or NACK to the initial CS value, since the sequence length is 12, modulo 12 may be applied to the final CS value.

TABLE 23

| 2 bits HARQ- | NACK, | NACK, | ACK, | ACK, |
|---|---|---|---|---|
| ACK | NACK | ACK | ACK | NACK |
| Final CS | (Initial CS + 0) | (Initial | (Initial | (Initial |
| | mod 12 = | CS + 3) | CS + 6) | CS + 9) |
| | Initial CS | mod 12 | mod 12 | mod 12 |

The PUCCH format 2 is a short PUCCH format that supports more than 2 bits of control information, and the number of RBs used may be configured through a higher layer. The control information may be configured by a combination of HARQ-ACK, SR, and CSI, or each of them. In the PUCCH format 2, the position of the subcarrier through which the DMRS is transmitted within one OFDM symbol may be fixed to the subcarrier having indexes of #1, #4, #7, and #10,when the index of the first subcarrier is #0. The control information may be mapped to the remaining subcarriers through a modulation process after channel coding except for the subcarrier in which the DMRS is located.

In summary, values that may be configured for each of the above-described PUCCH formats and their ranges may be arranged as shown in Table 24 below. When the value does not need to be configured in Table 24 below, it is indicated as N.A.

TABLE 24

| | | PUCCH | PUCCH | PUCCH | PUCCH | PUCCH |
|---|---|---|---|---|---|---|
| | | Format 0 | Format 1 | Format 2 | Format 3 | Format 4 |
| Starting symbol | Configurability | [symbol] | [symbol] | [symbol] | [symbol] | [symbol] |
| | Value range | 0-13 | 0-10 | 0-13 | 0-10 | 0-10 |
| Number of | Configurability | [symbol] | [symbol] | [symbol] | [symbol] | [symbol] |
| symbols in a slot | Value range | 1, 2 | 4-14 | 1, 2 | 4-14 | 4-14 |
| Index for | Configurability | [symbol] | [symbol] | [symbol] | [symbol] | [symbol] |
| identifying | Value range | 0-274 | 0-274 | 0-274 | 0-274 | 0-274 |
| starting PRB | | | | | | |
| Number of PRBs | Configurability | N.A. | N.A. | [symbol] | [symbol] | N.A. |
| | Value range | N.A. | N.A. | 1-16 | 1-6, 8-10, | N.A. |
| | | (Default is 1) | (Default is 1) | | 12, 15, 16 | (Default is 1) |
| Enabling | Configurability | [symbol] | [symbol] | [symbol] | [symbol] | [symbol] |
| frequency | Value range | On/Off | On/Off | On/Off | On/Off | On/Off |
| hopping | | (only for 2 symbol) | | (only for 2 symbol) | | |
| (intra-slot) | | | | | | |
| Freq [symbol] cy resource | Configurability | [symbol] | [symbol] | [symbol] | [symbol] | [symbol] |
| of 2^{nd} hop if | Value range | 0-274 | 0-274 | 0-274 | 0-274 | 0-274 |
| intra-slot | | | | | | |
| frequency | | | | | | |
| hopping is | | | | | | |
| enabled | | | | | | |
| Index of initial | Configurability | [symbol] | [symbol] | N.A. | N.A. | N.A. |
| cyclic shift | Value range | 0-11 | 0-11 | N.A. | N.A. | N.A. |
| Index of time- | Configurability | N.A. | [symbol] | N.A. | N.A. | N.A. |
| domain OCC | Value range | N.A. | 0-6 | N.A. | N.A. | N.A. |
| Length of | Configurability | N.A. | N.A. | N.A. | N.A. | [symbol] |
| Pre-DFT OCC | Value range | N.A. | N.A. | N.A. | N.A. | 2, 4 |
| Index of Pre-DFT | Configurability | N.A. | N.A. | N.A. | N.A. | [symbol] |
| OCC | Value range | N.A. | N.A. | N.A. | N.A. | 0, 1, 2, 3 |

[symbol]

indicates data missing or illegible when filed

Meanwhile, to improve uplink coverage, multi-slot repetition may be supported for PUCCH formats 1, 3, and 4, PUCCH repetition may be configured for each PUCCH format. The UE may repeatedly transmit the PUCCH including UCI as many as the number of slots configured through nrofSlots, which is higher layer signaling. For the PUCCH repeated transmission, the PUCCH transmission in each slot may be performed using the same number of consecutive symbols, and the corresponding consecutive symbols may be configured through a nrofSymbols in the PUCCH-format 1, the PUCCH-format 3, or the PUCCH-format 4, which is higher layer signaling. For the PUCCH repeated transmission, the PUCCH transmission in each slot may be performed using the same start symbol, and the corresponding start symbol may be configured through a startingSymbolIndex in the PUCCH-format 1, the PUCCH-format 3, or the PUCCH-format 4, which is higher layer signaling.

For the PUCCH repeated transmission, a single PUCCH-spatialRelationInfo may be configured for a single PUCCH resource. For the PUCCH repeated transmission, if the UE has been configured to perform frequency hopping in PUCCH transmission in different slots, the UE may perform frequency hopping in units of slots. In addition, if the UE has been configured to perform frequency hopping in the PUCCH transmission in different slots, the UE may start the PUCCH transmission from the first PRB index configured through startingPRB, which is higher layer signaling, in the even-numbered slot, and in the odd-numbered slot, the UE may start the PUCCH transmission from the second PRB index configured through secondHopPRB, which is higher layer signaling.

Additionally, if the UE is configured to perform frequency hopping in PUCCH transmission in different slots, the index of the slot in which the UE is instructed to transmit the first PUCCH is the number 0, and a value of the number of PUCCH repeated transmissions may be increased during the configured total number of PUCCH repeated transmissions, regardless of the PUCCH transmissions performed in each slot. If the UE is configured to perform frequency hopping in PUCCH transmission in different slots, the UE does not expect that frequency hopping in the slot is configured when transmitting PUCCH. If the UE is not configured to perform frequency hopping in PUCCH transmission in different slots but is configured for frequency hopping in a slot, the first and second PRB indexes are applied equally in the slot. If the number of uplink symbols capable of performing PUCCH transmission is less than nrofSymbols configured via higher layer signaling, the UE may not perform PUCCH transmission. If the UE fails to transmit a PUCCH for any reason in any slot during a PUCCH repeated transmission, the UE may increase the number of PUCCH repeated transmissions.

In NR Release 17, within PUCCH-ResourceExt, an extension of PUCCH-Resource which is higher layer signaling for PUCCH resources, the number of slots repeatedly transmitted for each PUCCH resource may be configured via higher layer signaling pucch-RepetitionNrofSlots-r17. When the corresponding higher layer signaling pucch-RepetitionNrofSlots-r17 is configured, the corresponding PUCCH resource is scheduled, and the higher layer signaling nrofSlots is also configured, the UE determines the number of slots, in which the corresponding PUCCH resource is repeatedly transmitted, through pucch-RepetitionNrofSlots-r17 and disregards the higher layer signaling nrofSlots.

### PUCCH: PUCCH Resource Configuration

The base station may configure, for a specific UE, PUCCH resources for each BWP through a higher layer. The PUCCH resource configuration may be shown in Table 25 below.

TABLE 25

| | |
|---|---|
| PUCCH-Config ::= | SEQUENCE { |
| resourceSetToAddModList | SEQUENCE (SIZE (1..maxNrofPUCCH-ResourceSets)) |

| | |
|---|---|
| OF PUCCH-ResourceSet | OPTIONAL, -- Need N |

| | |
|---|---|
| resourceSetToReleaseList | SEQUENCE (SIZE (1..maxNrofPUCCH-ResourceSets)) OF |

| | |
|---|---|
| PUCCH-ResourceSetId | OPTIONAL, -- Need N |

| | |
|---|---|
| resourceToAddModList | SEQUENCE (SIZE (1..maxNrofPUCCH-Resources)) OF |

| | |
|---|---|
| PUCCH-Resource | OPTIONAL, -- Need N |

| | |
|---|---|
| resourceToReleaseList | SEQUENCE (SIZE (1..maxNrofPUCCH-Resources)) OF P |

| | |
|---|---|
| UCCH-ResourceId | OPTIONAL, -- Need N |

| | | |
|---|---|---|
| format1 | SetupRelease { PUCCH-FormatConfig } | OPTIONA |

L, -- Need M

| | | |
|---|---|---|
| format2 | SetupRelease { PUCCH-FormatConfig } | OPTIONA |

L, -- Need M

| | | |
|---|---|---|
| format3 | SetupRelease { PUCCH-FormatConfig } | OPTIONA |

L, -- Need M

| | | |
|---|---|---|
| format4 | SetupRelease { PUCCH-FormatConfig } | OPTIONA |

L, -- Need M

| | |
|---|---|
| schedulingRequestResourceToAddModList | SEQUENCE (SIZE (1..maxNrofSR-Resources)) OF Sched |

| | |
|---|---|
| ulingRequestResourceConfig | OPTIONAL, -- Nee |

d N

| | |
|---|---|
| schedulingRequestResourceToReleaseList | SEQUENCE (SIZE (1..maxNrofSR-Resources)) OF Schedul |

| | |
|---|---|
| ingRequestResourceId | OPTIONAL, -- Need |

N

| | | |
|---|---|---|
| multi-CSI-PUCCH-ResourceList | SEQUENCE (SIZE (1..2)) OF PUCCH-ResourceId | OPTION |

AL, -- Need M

| | | |
|---|---|---|
| dl-DataToUL-ACK | SEQUENCE (SIZE (1..8)) OF INTEGER (0..15) | OPTI |

ONAL, -- Need M

| | |
|---|---|
| spatialRelationInfoToAddModList | SEQUENCE (SIZE (1..maxNrofSpatialRelationInfos)) OF PUC |

| | |
|---|---|
| CH-SpatialRelationInfo | OPTIONAL, -- |

Need N

| | |
|---|---|
| spatialRelationInfoToReleaseList | SEQUENCE (SIZE (1..maxNrofSpatialRelationInfos)) OF PUC |

| | |
|---|---|
| CH-SpatialRelationInfoId | OPTIONAL, -- |

Need N

| | | |
|---|---|---|
| pucch-PowerControl | PUCCH-PowerControl | OPTIONAL, |

```
-- Need M
  ...,
  [[
```

| | |
|---|---|
| resourceToAddModListExt-r16 | SEQUENCE (SIZE (1..maxNrofPUCCH-Resources)) OF |

| | |
|---|---|
| PUCCH-ResourceExt-r16 | OPTIONAL, -- Need N |

| | | |
|---|---|---|
| dl-DataToUL-ACK-r16 | SetupRelease { DL-DataToUL-ACK-r16 } | OPTIONA |

L, -- Need M

| | | |
|---|---|---|
| ul-AccessConfigListDCI-1-1-r16 | SetupRelease { UL-AccessConfigListDCI-1-1-r16 } | OPTIONAL, |

-- Need M

| | |
|---|---|
| subslotLengthForPUCCH-r16 | CHOICE { |

| | |
|---|---|
| normalCP-r16 | ENUMERATED {n2,n7}, |
| extendedCP-r16 | ENUMERATED {n2,n6} |

| | |
|---|---|
| } | OPTION |

AL, -- Need R

| | | |
|---|---|---|
| dl-DataToUL-ACK-DCI-1-2-r16 | SetupRelease { DL-DataToUL-ACK-DCI-1-2-r16} | OPTIONAL, |

-- Need M

| | | |
|---|---|---|
| numberOfBitsForPUCCH-ResourceIndicatorDCI-1-2-r16 | INTEGER (0..3) | OPTIONAL, |

-- Need R

| | | |
|---|---|---|
| dmrs-UplinkTransformPrecodingPUCCH-r16 | ENUMERATED {enabled} | OPTIONAL, -- Con |

d PI2-BPSK

| | |
|---|---|
| spatialRelationInfoToAddModListSizeExt-v1610 | SEQUENCE (SIZE (1..maxNrofSpatialRelationInfos |

Diff-r16)) OF PUCCH-SpatialRelationInfo
OPTIONAL, -- Need N

| | |
|---|---|
| spatialRelationInfoToReleaseListSizeExt-v1610 | SEQUENCE (SIZE (1..maxNrofSpatialRelationInfosDi |

ff-r16)) OF PUCCH-SpatialRelationInfoId
OPTIONAL, -- Need N

| | |
|---|---|
| spatialRelationInfoToAddModListExt-v1610 | SEQUENCE (SIZE (1..maxNrofSpatialRelationInfos-r16)) |

| | |
|---|---|
| OF PUCCH-SpatialRelationInfoExt-r16 | OPTION |

AL, -- Need N

| | |
|---|---|
| spatialRelationInfoToReleaseListExt-v1610 | SEQUENCE (SIZE (1..maxNrofSpatialRelationInfos-r16) |
| ) OF PUCCH-SpatialRelationInfoId-r16 | OPTIONAL, -- Need N |
| resourceGroupToAddModList-r16 | SEQUENCE (SIZE (1..maxNrofPUCCH-ResourceGroups- |

| | |
|---|---|
| r16)) OF PUCCH-ResourceGroup-r16 | OP |

TIONAL, -- Need N

| | |
|---|---|
| resourceGroupToReleaseList-r16 | SEQUENCE (SIZE (1..maxNrofPUCCH-ResourceGroups-r1 |

| | |
|---|---|
| 6)) OF PUCCH-ResourceGroupId-r16 | OPTI |

ONAL, -- Need N

| | | |
|---|---|---|
| sps-PUCCH-AN-List-r16 | SetupRelease { SPS-PUCCH-AN-List-r16 } | OPTIONAL, |

-- Need M

| | |
|---|---|
| schedulingRequestResourceToAddModListExt-v1610 | SEQUENCE (SIZE (1..maxNrofSR-Resources)) |

| | |
|---|---|
| OF SchedulingRequestResourceConfigExt-v1610 | OPTIONA |

L -- Need N
]]
}

In Table 25, one or a plurality of PUCCH resource sets in the PUCCH resource configuration for a specific BWP may be configured, and a maximum payload value for UCI transmission may be configured in some of the PUCCH resource sets. Each PUCCH resource set may belong to one or more PUCCH resources, and each of the PUCCH resources may belong to one of the above-described PUCCH formats.

For the PUCCH resource set, the maximum payload value of the first PUCCH resource set may be fixed to 2 bits. Accordingly, the corresponding value may not be separately configured through a higher layer. When the remaining PUCCH resource set is configured, the index of the corresponding PUCCH resource set may be configured in ascending order according to the maximum payload value, and the maximum payload value may not be configured in the last PUCCH resource set. The higher layer configuration for the PUCCH resource set may be as shown in Table 26 below.

TABLE 26

| | |
|---|---|
| PUCCH-ResourceSet ::= | SEQUENCE { |
| pucch-ResourceSetId | PUCCH-ResourceSetId, |
| resourceList | SEQUENCE (SIZE (1..maxNrofPUCCH-ResourcesPerSet)) |

OF PUCCH-ResourceId,

| | |
|---|---|
| maxPayloadSize | INTEGER (4..256) |

OPTIONAL - Need R
}

The resourceList parameter of Table 26 may include IDs of PUCCH resources belonging to the PUCCH resource set.

If at the time of initial access or when the PUCCH resource set is not configured, a PUCCH resource set as shown in Table 27 below, which is configured by a plurality of cell-specific PUCCH resources in the initial BWP, may be used. The PUCCH resource to be used for initial access in this PUCCH resource set may be indicated through SIB 1.

TABLE 27

| In- | PUCCH | First | Number of | PRB offset | Set of Initial |
|---|---|---|---|---|---|
| dex | format | symbol | symbols | RB_{BWP}^{offset} | CS indexes |
| 0 | 0 | 12 | 2 | 0 | {0, 3} |
| 1 | 0 | 12 | 2 | 0 | {0, 4, 8} |
| 2 | 0 | 12 | 2 | 3 | {0, 4, 8} |
| 3 | 1 | 10 | 4 | 0 | {0, 6} |
| 4 | 1 | 10 | 4 | 0 | {0, 3, 6, 9} |
| 5 | 1 | 10 | 4 | 2 | {0, 3, 6, 9} |
| 6 | 1 | 10 | 4 | 4 | {0, 3, 6, 9} |
| 7 | 1 | 4 | 10 | 0 | {0, 6} |
| 8 | 1 | 4 | 10 | 0 | {0, 3, 6, 9} |
| 9 | 1 | 4 | 10 | 2 | {0, 3, 6, 9} |
| 10 | 1 | 4 | 10 | 4 | {0, 3, 6, 9} |
| 11 | 1 | 0 | 14 | 0 | {0, 6} |
| 12 | 1 | 0 | 14 | 0 | {0, 3, 6, 9} |
| 13 | 1 | 0 | 14 | 2 | {0, 3, 6, 9} |
| 14 | 1 | 0 | 14 | 4 | {0, 3, 6, 9} |
| 15 | 1 | 0 | 14 | └N_{BWP}^{size}/4┘ | {0, 3, 6, 9} |

The maximum payload of each PUCCH resource included in the PUCCH resource set may be 2 bits in PUCCH format 0 or 1, and may be determined by symbol length, number of PRBs, and maximum code rate in the remaining formats. The symbol length and number of PRBs may be configured for each PUCCH resource, and the maximum code rate may be configured for each PUCCH format.

In SR transmission, a PUCCH resource for an SR corresponding to schedulingRequestID may be configured through a higher layer as shown in Table 28 below. The PUCCH resource may belong to PUCCH format 0 or PUCCH format 1.

TABLE 28

| SchedulingRequestResourceConfig ::= | SEQUENCE { | |
|---|---|---|
| schedulingRequestResourceId | SchedulingRequestResourceId, | |
| schedulingRequestID | SchedulingRequestId, | |
| periodicityAndOffset | CHOICE { | |
| sym2 | NULL, | |
| sym6or7 | NULL, | |
| sl1 | NULL, | -- Recurs in ever |

y slot

| | |
|---|---|
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19), |
| sl40 | INTEGER (0..39), |
| sl80 | INTEGER (0..79), |
| sl160 | INTEGER (0..159), |
| sl320 | INTEGER (0..319), |
| sl640 | INTEGER (0..639) |

| | |
|---|---|
| } | OPTIONAL, |

-- Need M

| | | |
|---|---|---|
| resource | PUCCH-ResourceId | OPTIONAL -- |

Need M
}

For the configured PUCCH resource, a transmission period and an offset may be configured through the periodicityAndOffset parameter of Table 28. When there is uplink data to be transmitted by the UE at a time corresponding to the configured period and offset, the corresponding PUCCH resource is transmitted; otherwise, the corresponding PUCCH resource may not be transmitted.

In the case of CSI transmission, a PUCCH resource for transmitting a periodic or semi-persistent CSI report through PUCCH may be configured in the pucch-CSI-ResourceList parameter as shown in Table 29 below. The pucch-CSI-ResourceList parameter may include a list of PUCCH resources for each BWP for the cell or CC to which the corresponding CSI report is to be transmitted. The PUCCH resource may be a resource belonging to PUCCH format 2 or PUCCH format 3 or PUCCH format 4. For the PUCCH resource, a transmission period and an offset may be configured through reportSlotConfig of Table 29.

TABLE 29

| | |
|---|---|
| CSI-ReportConfig ::= | SEQUENCE { |
| reportConfigId | CSI-ReportConfigId, |
| carrier | ServCellIndex OPTIONAL, -- Ne |

ed S
...

| | |
|---|---|
| reportConfigType | CHOICE { |
| periodic | SEQUENCE { |
| reportSlotConfig | CSI-ReportPeriodicityAndOffset, |
| pucch-CSI-ResourceList | SEQUENCE (SIZE (1..maxNrofBWPs)) OF PU |

CCH-CSI-Resource
},

| | |
|---|---|
| semiPersistentOnPUCCH | SEQUENCE { |
| reportSlotConfig | CSI-ReportPeriodicityAndOffset, |
| pucch-CSI-ResourceList | SEQUENCE (SIZE (1..maxNrofBWPs)) OF PU |

CCH-CSI-Resource
},

| | |
|---|---|
| semiPersistentOnPUSCH | SEQUENCE { |
| reportSlotConfig | ENUMERATED {sl5, sl10, sl20, sl40, sl80, sl1 |

60, sl320},

| | |
|---|---|
| reportSlotOffsetList | SEQUENCE (SIZE (1..maxNrofUL-Allocations)) OF |

INTEGER(0..32),

| | |
|---|---|
| p0alpha | P0-PUSCH-AlphaSetId |

},

| | |
|---|---|
| aperiodic | SEQUENCE { |
| reportSlotOffsetList | SEQUENCE (SIZE (1..maxNrofUL-Allocations)) OF I |

```
NTEGER(0..32)
    }
  },
  ...
}
```

In HARQ-ACK transmission, a resource set of PUCCH resources to be transmitted may be first selected according to the payload of the UCI including the corresponding HARQ-ACK. That is, a PUCCH resource set having a minimum payload not smaller than the UCI payload may be selected. The PUCCH resource in the PUCCH resource set can be selected through the PUCCH resource indicator (PRI) in the DCI scheduling the TB corresponding to the corresponding HARQ-ACK, and the PRI may be the PUCCH resource indicator specified above in Table 13 or Table 14. The relationship between the PRI and the PUCCH resource selected from the PUCCH resource set may be as shown in Table 30 below.

TABLE 30

| PUCCH | |
|---|---|
| resource | |
| indicator | PUCCH resource |
| ‘000’ | 1^{st} PUCCH resource provided by |
| | pucch-ResourceId obtained from the |
| | 1^{st} value of resourceList |
| ‘001’ | 2^{nd} PUCCH resource provided by |
| | pucch-ResourceId obtained from the |
| | 2^{nd} value of resourceList |
| ‘010’ | 3^{rd} PUCCH resource provided by |
| | pucch-ResourceId obtained from the |
| | 3^{rd} value of resourceList |
| ‘011’ | 4^{th} PUCCH resource provided by |
| | pucch-ResourceId obtained from the |
| | 4^{th} value of resourceList |
| ‘100’ | 5^{th} PUCCH resource provided by |
| | pucch-ResourceId obtained from the |
| | 5^{th} value of resourceList |
| ‘101’ | 6^{th} PUCCH resource provided by |
| | pucch-ResourceId obtained from the |
| | 6^{th} value of resourceList |
| ‘110’ | 7^{th} PUCCH resource provided by |
| | pucch-ResourceId obtained from the |
| | 7^{th} value of resourceList |
| ‘111’ | 8^{th} PUCCH resource provided by |
| | pucch-ResourceId obtained from the |
| | 8^{th} value of resourceList |

If the number of PUCCH resources in the selected PUCCH resource set is greater than 8, the PUCCH resource may be selected as defined in Equation (3) below.

$${r}_{PUCCH} = \{ \begin{matrix}\begin{matrix}⌊ \frac{{n}_{CCE , p} \cdot ⌈ {R}_{PUCCH} / 8 ⌉}{{N}_{CCE , p}} ⌋ + \\ {Δ}_{PRI} \cdot ⌈ \frac{{R}_{PUCCH}}{8} ⌉\end{matrix} & if {Δ}_{PRI} < {R}_{PUCCH} mod 8 \\ \begin{matrix}⌊ \frac{{n}_{CCE , p} \cdot ⌊ {R}_{PUCCH} / 8 ⌋}{{N}_{CCE , p}} ⌋ + {Δ}_{PRI} \cdot \\ ⌊ \frac{{R}_{PUCCH}}{8} ⌋ + {R}_{PUCCH} mod 8\end{matrix} & if {Δ}_{PRI} \geq {R}_{PUCCH} mod 8\end{matrix} \} \qquad ( 3 )$$

In Equation (3), r^{PUCCH} indicates the index of the selected PUCCH resource in the PUCCH resource set, R_{PUCCH} is the number of PUCCH resources belonging to the PUCCH resource set, Δ_{PRI} is the PRI value, N_{CCE.p} is the total number of CCEs of the CORESET p to which the receiving DCI belongs, and n_{CCE.p} is the first CCE index for the reception DCI.

The time point at which the corresponding PUCCH resource is transmitted is after the K₁ slot from the TB transmission corresponding to the corresponding HARQ-ACK. Candidates of the K₁ value are configured by a higher layer and, more specifically, may be configured in the dl-DataToUL-ACK parameter in the PUCCH-Config specified in Table 25. The K₁ value of one of these candidates may be selected by the PDSCH-to-HARQ feedback timing indicator in the DCI scheduling the TB, and this value may have a value specified above in Table 12 or Table 13. The unit of the K₁ value may be a slot unit or a sub slot unit. A sub slot is a unit of a length smaller than that of a slot, and one or a plurality of symbols may configure one sub slot.

The UE may transmit UCI through one or two PUCCH resources in one slot or sub slot, and when UCI is transmitted through two PUCCH resources in one slot/sub slot, i) each PUCCH resource does not overlap in units of symbols, and ii) at least one PUCCH resource may be a short PUCCH. The UE may not expect to transmit a plurality of PUCCH resources for HARQ-ACK transmission within one slot.

### PUCCH: Regarding Transmission Beam

If the UE does not have a UE-specific configuration for PUCCH resource configuration (dedicated PUCCH resource configuration), the PUCCH resource set is provided through pucch-ResourceCommon, which is higher layer signaling, and at this time, the beam configuration for PUCCH transmission follows the beam configuration used in PUSCH transmission scheduled through the random access response (RAR) UL grant. If the UE has a UE-specific configuration for PUCCH resource configuration (dedicated PUCCH resource configuration), the beam configuration for PUCCH transmission may be provided through pucch-spatialRelationInfoId, which is the higher level signaling included in Table 25. If the UE has been configured with one pucch-spatialRelationInfoId, beam configuration for PUCCH transmission of the UE may be provided through one pucch-spatialRelationInfoId. If the UE is configured with a plurality of pucch-spatialRelationInfoIDs, the UE is instructed to activate one of the plurality of pucch-spatialRelationInfoIDs through a MAC control element (CE).

The UE may receive up to eight pucch-spatialRelationInfoIDs through higher layer signaling, and may receive an indication that only one pucch-spatialRelationInfoID is activated among them. When the UE is instructed to activate any pucch-spatialRelationInfoID through the MAC CE, the UE may apply pucch-spatialRelationInfoID activation through MAC CE from a slot that first appears after 3Nₛₗₒₜ^{subframe,μ} slot from a slot in which HARQ-ACK transmission for a PDSCH that transmits MAC CE including activation information for pucch-spatialRelationInfoID. In the above, μ is a neurology applied to PUCCH transmission, and Nₛₗₒₜ^{subframe,μ} is the number of slots per subframe in a given neurology. The higher layer configuration for pucch-spatialRelationInfo may be as shown in Table 31 below.

TABLE 31

| | |
|---|---|
| PUCCH-SpatialRelationInfo ::= | SEQUENCE { |
| pucch-SpatialRelationInfoId | PUCCH-SpatialRelationInfoId, |
| servingCellId | ServCellIndex OPTIONAL, |

-- Need S

| | |
|---|---|
| reference Signal | CHOICE { |
| ssb-Index | SSB-Index, |
| csi-RS-Index | NZP-CSI-RS-ResourceId, |
| srs | PUCCH-SRS |

},

| | |
|---|---|
| pucch-PathlossReferenceRS-Id | PUCCH-PathlossReferenceRS-Id, |
| p0-PUCCH-Id | P0-PUCCH-Id, |
| closedLoopIndex | ENUMERATED { i0, i1 } |

}

| | |
|---|---|
| PUCCH-SpatialRelationInfoId ::= | INTEGER (1..maxNrofSpatialRelationInfos) |

In Table 31, one referenceSignal configuration may exist in a specific pucch-spatialRelationInfo configuration, and the referenceSignal may be ssb-Index indicating a specific SS/PBCH, may be csi-RS-Index indicating a specific CSI-RS, or may be srs indicating a specific SRS. If the referenceSignal is configured as ssb-Index, the UE configures the beam used when receiving the SS/PBCH corresponding to the ssb-Index among SS/PBCHs in the same serving cell as the beam for PUCCH transmission, or if servingCellId is provided, abeam used when receiving an SS/PBCH corresponding to an ssb-Index among SS/PBCHs in a cell indicated by servingCellId may be configured as a beam for pucch transmission. If the referenceSignal is configured as csi-RS-Index, the UE configures the beam used when receiving a CSI-RS corresponding to csi-RS-Index among CSI-RSs in the same serving cell as a beam for PUCCH transmission, or if servingCellId is provided, a beam used when receiving a CSI-RS corresponding to csi-RS-Index among CSI-RSs in a cell indicated by servingCellId may be configured as a beam for pucch transmission.

If the referenceSignal is configured to srs, the UE configures, as the beam for PUCCH transmission, the transmission beam used when transmitting the SRS corresponding to the resource index provided through a higher signaling resource in the same serving cell and/or in the activated uplink BWP, or if the servingCellID and/or uplinkBWP are/is provided, the UE configures, as the beam for PUCCH transmission, the transmission beam used when transmitting the SRS corresponding to the resource index provided through the higher signaling resource in the cell indicated by the servingCellID and/or uplinkBWP and/or in the uplink BWP. One pucch-PathlossReferenceRS-Id configuration may exist in a specific pucch-spatialRelationInfo configuration. PUCCH-PathlossReferenceRS as shown in Table 32 below may be mapped to pucch-PathlossReferenceRS-Id of Table 31, and a maximum of 4 may be configured through pathlossReferenceRSs in the higher signaling PUCCH-PowerControl of Table 32. If the PUCCH-PathlossReferenceRS is connected to the SS/PBCH through the higher signaling referenceSignal, ssb-Index is configured, and if PUCCH-PathlossReferenceRS is connected to CSI-RS, csi-RS-Index is configured.

TABLE 32

| PUCCH-PowerControl ::= | SEQUENCE { | |
|---|---|---|
| deltaF-PUCCH-f0 | INTEGER (−16..15) | OPTIONAL, -- Nee |

d R

| | | |
|---|---|---|
| deltaF-PUCCH-f1 | INTEGER (−16..15) | OPTIONAL, -- Nee |

d R

| | | |
|---|---|---|
| deltaF-PUCCH-f2 | INTEGER (−16..15) | OPTIONAL, -- Nee |

d R

| | | |
|---|---|---|
| deltaF-PUCCH-f3 | INTEGER (−16..15) | OPTIONAL, -- Nee |

d R

| | | |
|---|---|---|
| deltaF-PUCCH-f4 | INTEGER (−16..15) | OPTIONAL, -- Nee |

d R

| | |
|---|---|
| p0-Set | SEQUENCE (SIZE (1..maxNrofPUCCH-P0-PerSet)) OF P0- |

PUCCH OPTIONAL, -- Need M

| | |
|---|---|
| pathlossReferenceRSs | SEQUENCE (SIZE (1..maxNrofPUCCH-PathlossReferenceRSs) |

| | |
|---|---|
| ) OF PUCCH-PathlossReferenceRS | OPTIONAL, -- |

Need M

| | | |
|---|---|---|
| twoPUCCH-PC-AdjustmentStates | ENUMERATED {twoStates} | OPTIONAL, -- Need |

```
  S
  ...,
  [[
```

| | | |
|---|---|---|
| pathlossReferenceRSs-v1610 | SetupRelease { PathlossReferenceRSs-v1610 } | OPTIONAL |

-- Need M
]]
}

| | |
|---|---|
| P0-PUCCH ::= | SEQUENCE { |
| p0-PUCCH-Id | P0-PUCCH-Id, |
| p0-PUCCH-Value | INTEGER (−16..15) |

}

| | |
|---|---|
| P0-PUCCH-Id ::= | INTEGER (1..8) |
| PathlossReferenceRSs-v1610 ::= | SEQUENCE (SIZE (1..maxNrofPUCCH-PathlossReferenceRSsD |

iff-r16)) OF PUCCH-PathlossReferenceRS-r16

| | |
|---|---|
| PUCCH-PathlossReferenceRS ::= | SEQUENCE { |
| pucch-PathlossReferenceRS-Id | PUCCH-PathlossReferenceRS-Id, |
| referenceSignal | CHOICE { |
| ssb-Index | SSB-Index, |
| csi-RS-Index | NZP-CSI-RS-ResourceId |

}
}

| | |
|---|---|
| PUCCH-PathlossReferenceRS-r16 ::= | SEQUENCE { |
| pucch-PathlossReferenceRS-Id-r16 | PUCCH-PathlossReferenceRS-Id-v1610, |
| referenceSignal-r16 | CHOICE { |
| ssb-Index-r16 | SSB-Index, |
| csi-RS-Index-r16 | NZP-CSI-RS-ResourceId |

}
}

### PUCCH: Group-Based Spatial Relation Activation

In Rel-15, if a UE has multiple pucch-spatialRelationInfoIDs configured, the UE may determine a spatial relation of the corresponding PUCCH resource by receiving a MAC CE to activate the spatial relation for each PUCCH resource. However, this method is disadvantageous in that it requires excessive signaling overhead to activate the spatial relation of multiple PUCCH resources. Therefore, in Rel-16, PUCCH resource groups are added and a new MAC CE for activating spatial relations in units of PUCCH resource groups. A maximum of four PUCCH resource groups may be configured through resourceGroupToAddModList of Table 25 above, and each PUCCH resource group may be configured as a list of multiple PUCCH resource Ids within one PUCCH resource group as shown in Table 33 below.

TABLE 33

| | |
|---|---|
| PUCCH-ResourceGroup-r16 ::= | SEQUENCE { |
| pucch-ResourceGroupId-r16 | PUCCH-ResourceGroupId-r16, |
| resourcePerGroupList-r16 | SEQUENCE (SIZE (1..maxNrofPUCCH-ResourcesPerG |

roup-r16)) OF PUCCH-ResourceId
}

| | |
|---|---|
| PUCCH-ResourceGroupId-r16 ::= | INTEGER (0..maxNrofPUCCH-ResourceGroups-1-r16) |

In Rel-16, the base station may configure each PUCCH resource group in a UE via the resourceGroupToAddModList of Table 25 and the higher layer configuration of Table 33, and may configure a MAC CE for simultaneous activation of the spatial relation of all PUCCH resources within one PUCCH resource group.

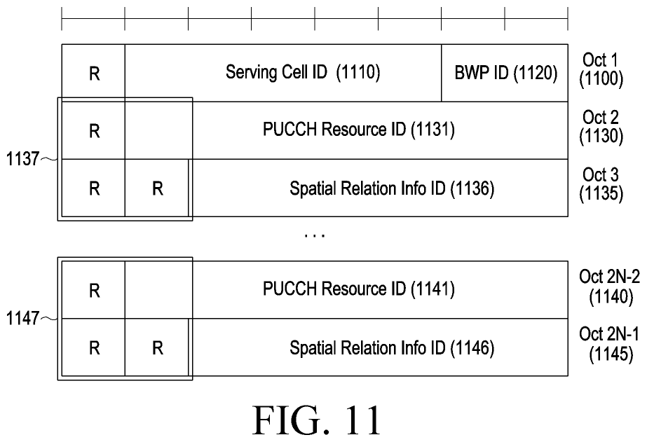

FIG. 11 illustrates a MAC CE for PUCCH resource group-based spatial relation activation in a wireless communication system according to an embodiment.

Referring to FIG. 11, a serving cell ID 1110 and a BWP ID 1120, in which PUCCH resources for application of the corresponding MAC CE are configured, are indicated as October 1 1100. PUCCH Resource IDs 1131 and 1141 indicate the ID of the PUCCH resource, and if the indicated PUCCH resource is included in a PUCCH resource group according to resourceGroupToAddModList, other PUCCH resource IDs in the same PUCCH resource group are not indicated to the same MAC CE, and all PUCCH resources in the same PUCCH resource group are activated by the same spatial relation info IDs 1136 and 1146. In this case, the spatial relation info IDs 1136 and 1146 include a value corresponding to PUCCH-SpatialRelationInfoId−1 to be applied to the PUCCH resource group of Table 31.

### PUSCH Transmission Scheme

PUSCH transmission may be dynamically scheduled by a UL grant inside DCI, or operated by means of configured grant Type 1 or Type 2. Dynamic scheduling indication regarding PUSCH transmission may be made by DCI format 0_0 or 0_1.

Configured grant Type 1 PUSCH transmission may be configured semi-statically by receiving configuredGrantConfig including rrc-ConfiguredUplinkGrant in Table 34 below through upper signaling, without receiving a UL grant inside DCI. Configured grant Type 2 PUSCH transmission may be scheduled semi-persistently by a UL grant inside DCI after receiving configuredGrantConfig not including rrc-ConfiguredUplinkGrant in Table 34 through upper signaling, If PUSCH transmission is operated by a configured grant, parameters applied to the PUSCH transmission are applied through configuredGrantConfig (upper signaling) in Table 34 except for dataScramblingIdentityPUSCH, txConfig, codebookSubset, maxRank, and scaling of UCI-OnPUSCH, which are provided by pusch-Config (upper signaling) in Table 35 below, If provided with transformPrecoder inside configuredGrantConfig (upper signaling) in Table 34, the UE applies tp-pi2BPSK inside pusch-Config in Table 35 to PUSCH transmission operated by a configured grant.

TABLE 34

| | |
|---|---|
| ConfiguredGrantConfig ::= | SEQUENCE { |

| | |
|---|---|
| frequencyHopping | ENUMERATED {intraSlot, interSlot} |

OPTIONAL, -- Need S,

| cg-DMRS-Configuration | DMRS-UplinkConfig, | |
|---|---|---|
| mcs-Table | ENUMERATED {qam256, | |
| qam64LowSE} | OPTIONAL, | -- Need S |

| | |
|---|---|
| mcs-TableTransformPrecoder | ENUMERATED {qam256, qam64LowSE} |

OPTIONAL, -- Need S

| uci-OnPUSCH | SetupRelease { CG-UCI- | |
|---|---|---|
| OnPUSCH } | OPTIONAL, | -- Need M |

| | |
|---|---|
| resourceAllocation | ENUMERATED { resourceAllocationType0, |

resourceAllocationType1, dynamicSwitch },

| | |
|---|---|
| rbg-Size | ENUMERATED |

| | |
|---|---|
| {config2} | OPTIONAL, |

-- Need S

| powerControlLoopToUse | ENUMERATED {n0, n1}, | |
|---|---|---|
| p0-PUSCH-Alpha | P0-PUSCH-AlphaSetId, | |
| transformPrecoder | ENUMERATED { enabled, | |
| disabled} | OPTIONAL, | -- Need S |

| | |
|---|---|
| nrofHARQ-Processes | INTEGER(1..16), |
| repK | ENUMERATED |

{n1, n2, n4, n8},

| repK-RV | ENUMERATED {s1- | |
|---|---|---|
| 0231, s2-0303, s3-0000} | OPTIONAL, | -- Need R |

| | |
|---|---|
| periodicity | ENUMERATED { |

sym2, sym7,

sym1x14, sym2x14, sym4x14, sym5x14, sym8x14, sym10x14, sym16x14, sym20x14,

sym32x14,

sym40x14, sym64x14, sym80x14, sym128x14, sym160x14, sym256x14, sym320x14,
sym512x14,

sym640x14,

sym1024x14, sym1280x14, sym2560x14, sym5120x14,

sym6, sym1x12,

sym2x12, sym4x12, sym5x12, sym8x12, sym10x12, sym16x12, sym20x12, sym32x12,

sym40x12,

sym64x12, sym80x12, sym128x12, sym160x12, sym256x12, sym320x12, sym512x12,
sym640x12,

sym1280x12,

sym2560x12
},

| | |
|---|---|
| configuredGrantTimer | INTEGER (1..64) |

OPTIONAL, -- Need R

| | |
|---|---|
| rrc-ConfiguredUplinkGrant | SEQUENCE { |
| timeDomainOffset | INTEGER (0..5119), |
| timeDomainAllocation | INTEGER (0..15), |
| frequencyDomainAllocation | BIT STRING (SIZE(18)), |

| | |
|---|---|
| antennaPort | INTEGER |

(0..31),

| | |
|---|---|
| dmrs-SeqInitialization | INTEGER (0..1) |

OPTIONAL, -- Need R

| | |
|---|---|
| precodingAndNumberOfLayers | INTEGER (0..63), |
| srs-ResourceIndicator | INTEGER (0..15) |

OPTIONAL, -- Need R
mcsAndTBS
INTEGER (0..31),

| frequencyHoppingOffset | | INTEGER (1.. |
|---|---|---|
| maxNrofPhysicalResourceBlocks-1) | OPTIONAL, | -- Need R |

| | |
|---|---|
| pathlossReferenceIndex | INTEGER |

```
(0..maxNrofPUSCH-PathlossReferenceRSs-1),
    ...
  }
OPTIONAL, -- Need R
  ...
}
```

The DMRS antenna port for PUSCH transmission is identical to an antenna port for SRS transmission. PUSCH transmission may follow a codebook-based transmission method and a non-codebook-based transmission method according to whether the value of txConfig inside pusch-Config in Table 35, which is upper signaling, is “codebook” or “nonCodebok”.

As described above, PUSCH transmission may be dynamically scheduled through DCI format 0_0 or 0_1 and may be operated semi-statically configured by a configured grant. Upon receiving indication of scheduling regarding PUSCH transmission through DCI format 0_0, the UE performs beam configuration for PUSCH transmission by using pucch-spatialRelationInfoID corresponding to a UE-specific PUCCH resource corresponding to the minimum ID inside an activated uplink BWP inside a serving cell, and the PUSCH transmission is based on a single antenna port. The UE does not expect scheduling regarding PUSCH transmission through DCI format 0_0 inside a BWP having no configured PUCCH resource including pucch-spatialRelationInfo. If the UE has no configured txConfig inside pusch-Config in Table 35, the UE does not expect scheduling through DCI format 0_1.

TABLE 35

| | |
|---|---|
| PUSCH-Config ::= | SEQUENCE { |
| dataScramblingIdentityPUSCH | INTEGER (0..1023) |

OPTIONAL, -- Need S
txConfig
ENUMERATED {codebook, nonCodebook}
OPTIONAL, -- Need S

| dmrs-UplinkForPUSCH-MappingTypeA | SetupRelease { DMRS- | |
|---|---|---|
| UplinkConfig } | OPTIONAL, | -- Need M |
| dmrs-UplinkForPUSCH-MappingTypeB | SetupRelease { DMRS- | |
| UplinkConfig } | OPTIONAL, | -- Need M |

| | |
|---|---|
| pusch-PowerControl | PUSCH-PowerControl |

OPTIONAL, -- Need M

| | |
|---|---|
| frequencyHopping | ENUMERATED |
| {intraSlot, interSlot} | OPTIONAL, -- Need |

S

| | |
|---|---|
| frequencyHoppingOffsetLists | SEQUENCE (SIZE (1..4)) OF |

INTEGER (1.. maxNrofPhysicalResourceBlocks-1)
OPTIONAL, -- Need M

| | |
|---|---|
| resourceAllocation | ENUMERATED |

{ resourceAllocationType0, resourceAllocationType1, dynamicSwitch},

| pusch-TimeDomainAllocationList | SetupRelease { PUSCH- | |
|---|---|---|
| TimeDomainResourceAllocationList } | OPTIONAL, | -- Need M |

| | |
|---|---|
| pusch-AggregationFactor | ENUMERATED { n2, n4, n8 } |

OPTIONAL, -- Need S

| | |
|---|---|
| mcs-Table | ENUMERATED |
| {qam256, qam64LowSE} | OPTIONAL, - |

- Need S

| mcs-TableTransformPrecoder | ENUMERATED {qam256, | |
|---|---|---|
| qam64LowSE} | OPTIONAL, | -- Need S |

| | |
|---|---|
| transformPrecoder | ENUMERATED |
| {enabled, disabled} | OPTIONAL, -- |

Need S

| | |
|---|---|
| codebookSubset | ENUMERATED |

{fullyAndPartialAndNonCoherent, partialAndNonCoherent,nonCoherent}
OPTIONAL, -- Cond codebookBased

| | |
|---|---|
| maxRank | INTEGER |

(1..4)
OPTIONAL, -- Cond codebookBased
rbg-Size
ENUMERATED { config2}
OPTIONAL, -- Need S

| | |
|---|---|
| uci-OnPUSCH | SetupRelease { UCI- |
| OnPUSCH} | OPTIONAL, -- Need M |
| tp-pi2BPSK | ENUMERATED |
| {enabled} | OPTIONAL, -- Need |

S
...
}

The codebook-based PUSCH transmission may be dynamically scheduled through DCI format 0_0 or 0_1, and may be operated semi-statically by a configured grant. If a codebook-based PUSCH is dynamically scheduled through DCI format 0_1 or configured semi-statically by a configured grant, the UE determines a precoder for PUSCH transmission, based on an SRS resource indicator (SRI), a transmission precoding matrix indicator (TPMI), and a transmission rank (the number of PUSCH transmission layers).

The SRI may be given through the SRS resource indicator (a field inside DCI) or configured through srs-ResourceIndicator (upper signaling). During codebook-based PUSCH transmission, the UE has at least one SRS resource configured for the PUSCH transmission, and may have a maximum of two SRS resources configured for the PUSCH transmission. If the UE is provided with the SRI through DCI, the SRS resource indicated by the corresponding SRI refers to the SRS resource corresponding to the SRI, among SRS resources transmitted prior to the PDCCH including the corresponding SRI. In addition, the TPMI and the transmission rank may be given through “precoding information and number of layers” (a field inside DCI) or configured through precodingAndNumberOfLayers (upper signaling). The TPMI is used to indicate a precoder to be applied to PUSCH transmission. If one SRS resource is configured for the UE, the TPMI may be used to indicate a precoder to be applied in the configured one SRS resource. If multiple SRS resources are configured for the UE, the TPMI is used to indicate a precoder to be applied in an SRS resource indicated through the SRI.

The precoder to be used for PUSCH transmission is selected from an uplink codebook having the same number of antenna ports as the value of nrofSRS-Ports inside SRS-Config (upper signaling). In connection with codebook-based PUSCH transmission, the UE determines a codebook subset, based on codebookSubset inside pusch-Config (upper signaling) and TPMI. The codebookSubset inside pusch-Config (upper signaling) may be configured to be one of “fullyAndPartialAndNonCoherent”, “partialAndNonCoherent”, or “noncoherent”, based on UE capability reported by the UE to the base station. If the UE reported “partialAndNonCoherent” as UE capability, the UE does not expect that the value of codebookSubset (upper signaling) will be configured as “fullyAndPartialAndNonCoherent”. If the UE reported “nonCoherent” as UE capability, UE does not expect that the value of codebookSubset (upper signaling) will be configured as “fullyAndPartialAndNonCoherent” or “partialAndNonCoherent”. If nrofSRS-Ports inside SRS-ResourceSet (upper signaling) indicates two SRS antenna ports, the UE does not expect that the value of codebookSubset (upper signaling) will be configured as “partialAndNonCoherent”.

There may be one SRS resource set configured for the UE, wherein the value of usage inside SRS-ResourceSet (upper signaling) is “codebook”, and one SRS resource may be indicated through an SRI inside the corresponding SRS resource set. If multiple SRS resources are configured inside the SRS resource set wherein the value of usage inside SRS-ResourceSet (upper signaling) is “codebook”, the UE expects that the value of nrofSRS-Ports inside SRS-Resource (upper signaling) is identical for all SRS resources.

The UE transmits, to the base station, one or multiple SRS resources included in the SRS resource set wherein the value of usage is configured as “codebook” according to upper signaling, and the base station selects one from the SRS resources transmitted by the UE and indicates the UE to be able to transmit a PUSCH by using transmission beam information of the corresponding SRS resource. In connection with the codebook-based PUSCH transmission, the SRI is used as information for selecting the index of one SRS resource and is included in DCI. Additionally, the base station adds information indicating the rank and TPMI to be used by the UE for PUSCH transmission to the DCI. Using the SRS resource indicated by the SRI, the UE applies, in performing PUSCH transmission, the precoder indicated by the rank and TPMI indicated based on the transmission beam of the corresponding SRS resource, thereby performing PUSCH transmission.

The non-codebook-based PUSCH transmission may be dynamically scheduled through DCI format 0_0 or 0_1, and may be operated semi-statically by a configured grant. If at least one SRS resource is configured inside an SRS resource set wherein the value of usage inside SRS-ResourceSet (upper signaling) is “nonCodebook”, non-codebook-based PUSCH transmission may be scheduled for the UE through DCI format 0_1.

With regard to the SRS resource set wherein the value of usage inside SRS-ResourceSet (upper signaling) is “nonCodebook”, one connected NZP CSI-RS resource (non-zero power CSI-RS) may be configured for the UE. The UE may calculate a precoder for SRS transmission by measuring the NZP CSI-RS resource connected to the SRS resource set. If the difference between the last received symbol of an aperiodic NZP CSI-RS resource connected to the SRS resource set and the first symbol of aperiodic SRS transmission in the UE is less than 42 symbols, the UE does not expect that information regarding the precoder for SRS transmission will be updated.

If the configured value of resourceType inside SRS-ResourceSet (upper signaling) is “aperiodic”, the connected NZP CSI-RS is indicated by an SRS request which is a field inside DCI format 0_1 or 1_1. If the connected NZP CSI-RS resource is an aperiodic NZP CSI-RS resource, the existence of the connected NZP CSI-RS is indicated when the value of SRS request (a field inside DCI format 0_1 or 1_1) is not “00”. The corresponding DCI should not indicate cross carrier or cross BWP scheduling. In addition, if the value of SRS request indicates the existence of a NZP CSI-RS, the NZP CSI-RS is positioned in the slot used to transmit the PDCCH including the SRS request field. In this case, TCI states configured for the scheduled subcarrier are not configured as QCL-TypeD.

If there is a periodic or semi-persistent SRS resource set configured, the connected NZP CSI-RS may be indicated through associatedCSI-RS inside SRS-ResourceSet (upper signaling). With non-codebook-based transmission, the UE does not expect that spatialRelationInfo which is upper signaling regarding the SRS resource and associatedCSI-RS inside SRS-ResourceSet (upper signaling) will be configured together.

If multiple SRS resources are configured for the UE, the UE may determine a precoder to be applied to PUSCH transmission and the transmission rank, based on an SRI indicated by the base station. The SRI may be indicated through the SRS resource indicator (a field inside DCI) or configured through srs-ResourceIndicator (upper signaling). Similarly to the above-described codebook-based PUSCH transmission, if the UE is provided with the SRI through DCI, the SRS resource indicated by the corresponding SRI refers to the SRS resource corresponding to the SRI, among SRS resources transmitted prior to the PDCCH including the corresponding SRI. The UE may use one or multiple SRS resources for SRS transmission, and the maximum number of SRS resources that can be transmitted simultaneously in the same symbol inside one SRS resource set and the maximum number of SRS resources are determined by UE capability reported to the base station by the UE. SRS resources simultaneously transmitted by the UE occupy the same RB. The UE configures one SRS port for each SRS resource. There may be only one configured SRS resource set wherein the value of usage inside SRS-ResourceSet (upper signaling) is “nonCodebook”, and a maximum of four SRS resources may be configured for non-codebook-based PUSCH transmission.

The base station transmits one NZP-CSI-RS connected to the SRS resource set to the UE, and the UE calculates the precoder to be used when transmitting one or multiple SRS resources inside the corresponding SRS resource set, based on the result of measurement when the corresponding NZP-CSI-RS is received. The UE applies the calculated precoder when transmitting, to the base station, one or multiple SRS resources inside the SRS resource set wherein the configured usage is “nonCodebook”, and the base station selects one or multiple SRS resources from the received one or multiple SRS resources. In connection with the non-codebook-based PUSCH transmission, the SRI indicates an index that may express one SRS resource or a combination of multiple SRS resources, and the SRI is included in DCI. The number of SRS resources indicated by the SRI transmitted by the base station may be the number of transmission layers of the PUSCH, and the UE transmits the PUSCH by applying the precoder applied to SRS resource transmission to each layer.

### PUSCH: Preparation Procedure Time

If a base station schedules a UE so as to transmit a PUSCH by using DCI format 0_0, 0_1, or 0_2, the UE may require a PUSCH preparation procedure time such that a PUSCH is transmitted by applying a transmission method (SRS resource transmission precoding method, the number of transmission layers, spatial domain transmission filter) indicated through DCI. The PUSCH preparation procedure time is defined in an NR system in consideration thereof. The PUSCH preparation procedure time of the UE is defined in Equation (4) below.

$${T}_{proc , 2} = max ( ( {N}_{2} + {d}_{2 , 1} + {d}_{2} ) ( 2048 + 144 ) \dot{e} {2}^{- μ} {T}_{c} + {T}_{ext} + {T}_{switch} , {d}_{2 , 2} ) \qquad ( 4 )$$

Each parameter in T_{proc,2} described above in Equation (4) may have the following description.

N₂ refers to the number of symbols determined according to UE processing capability 1 or 2, based on the UE's capability, and numerology μ. N₂ may have a value in Table 36 below if UE processing capability 1 is reported according to the UE's capability report and may have a value in Table 37 below if UE processing capability 2 is reported, and if availability of UE processing capability 2 is configured through upper layer signaling.

TABLE 36

| μ | PUSCH preparation time N₂ [symbols] |
|---|---|
| 0 | 10 |
| 1 | 12 |
| 2 | 23 |
| 3 | 36 |

TABLE 37

| μ | PUSCH preparation time N₂ [symbols] |
|---|---|
| 0 | 5 |
| 1 | 5.5 |
| 2 | 11 for frequency range 1 |

d_{2,1} refers to the number of symbols determined to be 0 if all resource elements of the first OFDM symbol of PUSCH transmission include DM-RSs, and to be 1 otherwise.

é is 64

μ follows a value, among μ_{DL} and μ_{UL}, which makes T_{proc,2} larger. μ_{DL} refers to the numerology of a downlink used to transmit a PDCCH including DCI that schedules a PUSCH, and μ_{UL} refers to the numerology of an uplink used to transmit a PUSCH.

T_{c} has 1/(Δfₘₐₓ·N_{f}), Δfₘₐₓ=480-10³ Hz, N_{f}=4096.

d_{2,2} follows a BWP switching time if DCI that schedules a PUSCH indicates BWP switching, and has 0 otherwise.

d₂ refers to, if OFDM symbols overlap temporally between a PUSCH having a high priority index and a PUCCH having a low priority index, the d₂ value of the PUSCH having a high priority index is used. Otherwise, d₂ is 0.

Tₑₓₜ refers to, if the UE uses a shared spectrum channel access scheme, the UE may calculate Tₑₓₜ and apply the same to a PUSCH preparation procedure time. Otherwise, Tₑₓₜ is assumed to be 0.

T_{switch} refers to, if an uplink switching spacing has been triggered, T_{switch} is assumed to be the switching spacing time. Otherwise, T_{switch} is assumed to be 0.

The base station and the UE may determine that the PUSCH preparation procedure time is insufficient if the first symbol of a PUSCH starts earlier than the first uplink symbol in which a CP starts after T_{proc,2} from the last symbol of a PDCCH including DCI that schedules the PUSCH, in view of the influence of timing advance between the uplink and the downlink and time domain resource mapping information of the PUSCH scheduled through the DCI. Otherwise, the base station and the UE determines that the PUSCH preparation procedure time is sufficient. The UE may transmit the PUSCH only if the PUSCH preparation procedure time is sufficient, and may disregard the DCI that schedules the PUSCH if the PUSCH preparation procedure time is insufficient.

### PUSCH Repeated Transmission

A 5G system supports two types of methods for repeatedly transmitting an uplink data channel, PUSCH repeated transmission type A and PUSCH repeated transmission type B. One of PUSCH repeated transmission type A and type B may be configured for a UE through upper layer signaling.

### 1. PUSCH Repeated Transmission Type a (PUSCH Repetition Type A)

As described above, the symbol length of an uplink data channel and the location of the start symbol may be determined by a time domain resource allocation method in one slot, and a base station may notify a UE of the number of repeated transmissions through upper layer signaling (for example, RRC signaling) or L1 signaling (for example, DCI).

Based on the number of repeated transmissions received from the base station, the UE may repeatedly transmit an uplink data channel having the same length and start symbol as the configured uplink data channel, in a continuous slot. If the base station configured a slot as a downlink for the UE, or if at least one of symbols of the uplink data channel configured for the UE is configured as a downlink, the UE omits uplink data channel transmission, but counts the number of repeated transmissions of the uplink data channel. That is, although included in the number of repeated transmissions of the uplink data channel, the uplink data channel may not be transmitted. In contrast, the UE supporting Rel-17 uplink data repeated transmission may determine a slot capable of uplink data repeated transmission as an available slot, and may count the number of transmissions during uplink data channel repeated transmission in the slot determined as an available slot. If uplink data channel repeated transmission is omitted in a slot determined as “available slot”, the repeated transmission may be postponed and thereafter performed through a slot available for transmission.

To determine an available slot as described above, if at least one symbol configured for a PUSCH by time domain resource allocation (TDRA) in a slot for PUSCH transmission overlaps a symbol for purposes other than uplink transmission (for example, downlink transmission), the corresponding slot is determined as an unavailable slot (for example, a slot other than an available slot, which is determined as being unavailable for PUSCH transmission). In addition, an available slot may be considered a resource for PUSCH transmission and an uplink resource for determining a TB size (TBS) in PUSCH repeated transmission and multi-slot PUSCH transmission including one TB on multiple slots (TB (TBoMS).

### 2. PUSCH Repeated Transmission Type B (PUSCH Repetition Type B)

As described above, the symbol length of an uplink data channel and the location of the start symbol may be determined by a time domain resource allocation method in one slot, and a base station may notify a UE of the number of repeated transmissions (numberofrepetitions) through upper layer signaling (for example, RRC signaling) or L1 signaling (for example, DCI).

The nominal repetition of the uplink data channel is determined as follows, based on the previously configured start symbol and length of the uplink data channel. The slot in which the n^{th} nominal repetition starts is given by

$${K}_{S} + ⌊ \frac{S + n \cdot L}{{N}_{symb}^{slot}} ⌋ ,$$

and the symbol starting in that slot is given by mod(S+n·L, N_{symb}^{slot}). The slot in which the n^{th} nominal repetition ends is given by

$${K}_{S} + ⌊ \frac{S + ( n + 1 ) \cdot L - 1}{{N}_{symb}^{slot}} ⌋ ,$$

and the symbol ending in that slot is given by mod(S+(n+1)·L−1, N_{symb}^{slot}). In this regard, n=0, . . . , numberofrepetitions−1, S refers to the start symbol of the configured uplink data channel, and L refers to the symbol length of the configured uplink data channel. Kₛ refers to the slot in which PUSCH transmission starts, and N_{symb}^{slot} refers to the number of symbols per slot.

For PUSCH repeated transmission type B, the UE may determine a specific OFDM symbol as an invalid symbol in the following cases.

A symbol configured as a downlink by tdd-UL-DL-ConfigurationCommon or tdd-UL-DL-ConfigurationDedicated may be determined as the invalid symbol for PUSCH repeated transmission type B.

Symbols indicated by ssb-PositionsInBurst within SIB1 or ssb-PositionsInBurst within ServingCellConfigCommon (upper signaling) for the sake of SSB reception in the unpaired spectrum (TDD spectrum) may be determined as the invalid symbol for PUSCH repeated transmission type B.

Symbols indicated through pdcch-ConfigSIB1 within the MIB for the sake of reception of a CORESET associated with Type0-PDCCH CSS set in the unpaired spectrum (TDD spectrum) may be determined as the invalid symbol for PUSCH repeated transmission type B.

If numberOfInvalidSymbolsForDL-UL-Switching (upper signaling) is configured in the unpaired spectrum (TDD spectrum), as many symbols as numberOfInvalidSymbolsForDL-UL-Switching from the symbol configured as a downlink by tdd-UL-DL-ConfigurationCommon or tdd-UL-DL-ConfigurationDedicated may be determined as the invalid symbol.

Additionally, the invalid symbol may be configured in an upper layer parameter (for example, InvalidSymbolPattern), which may provide a symbol level bitmap across one or two slots, thereby configuring the invalid symbol. In the bitmap, 1 represents the invalid symbol. Additionally, the cycle and pattern of the bitmap may be configured through the upper layer parameter (for example, InvalidSymbolPattern). If an upper layer parameter (for example, InvalidSymbolPattern) is configured, and if parameter InvalidSymbolPatternIndicator-ForDCIFormat0_1 or InvalidSymbolPatternIndicator-ForDCIFormat0_2 indicates 1, the UE applies an invalid symbol pattern, and if the above parameter indicates 0, the UE does not apply the invalid symbol pattern. If an upper layer parameter (for example, InvalidSymbolPattern) is configured, and if parameter InvalidSymbolPatternIndicator-ForDCIFormat0_1 or InvalidSymbolPatternIndicator-ForDCIFormat0_2 is not configured, the UE applies the invalid symbol pattern.

After an invalid symbol is determined, the UE may consider, with regard to each nominal repetition, that symbols other than the invalid symbol are valid symbols. If one or more valid symbols are included in each nominal repetition, the nominal repetition may include one or more actual repetitions. Each actual repetition includes a set of consecutive valid symbols available for PUSCH repeated transmission type B in one slot. In the case where the OFDM symbol length of the nominal repetition is not 1, if the length of the actual repetition is 1, the UE may disregard transmission for the actual repetition.

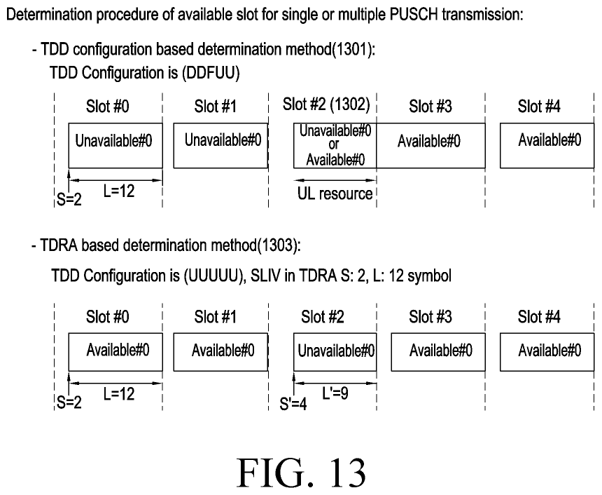

FIG. 13 illustrates a method for determining an available slot during PUSCH repetition type A transmission by a UE in a 5G system according to an embodiment.

When the base station configures an uplink resource via higher layer signaling (e.g., tdd-UL-DL-ConfigurationCommon or tdd-UL-DL-ConfigurationDedicated) or L1 signaling (e.g., dynamic slot format indicator), the base station and the UE may determine an available slot for the configured uplink resource according to the following two methods.

Available slot determination method based on TDD configuration

Available slot determination method in consideration of TDD configuration and time domain resource allocation (TDRA), and configured grant (CG) configuration or activation DCI

As an available slot determination method based on the TDD configuration, in FIG. 13, when the TDD configuration is configured as ‘DDFUU’ through higher layer signaling, the base station and the UE may determine that slot #3 and slot #4, which are configured as uplink ‘U’ based on the TDD configuration, are available slots 1301. Slot #2 1302, which is configured as a flexible slot ‘F’ based on the TDD configuration, may be determined as an unavailable slot or an available slot, and may be predefined, for example, through base station configurations.

As an available slot determination method considering the TDD configuration and time domain resource allocation (TDRA), and CG configuration or activation DCI, when in FIG. 13 the TDD configuration is configured as ‘UUUUU’ via higher layer signaling, and the start and length indicator value (SLIV) of the PUSCH transmission is configured as {S: 2, L: 12 symbol} via L1 signaling, the base station and the UE may determine, as available slots, slot #0, slot #1, slot #3, and slot #4 satisfying the SLIV of PUSCH for the configured uplink slot ‘U’. At this time, the base station and the UE may determine slot #2 (‘L=9’≤SLIV ‘L=12’) that does not satisfy the SLIV, which is a TDRA condition for PUSCH transmission, as an unavailable slot 1303. This is for illustrative purposes only and is not limited to PUSCH transmissions and may also be applied to PUCCH transmissions, PUSCH/PUCCH repeated transmissions, nominal repetition of PUSCH repetition type B, and TBoMS.

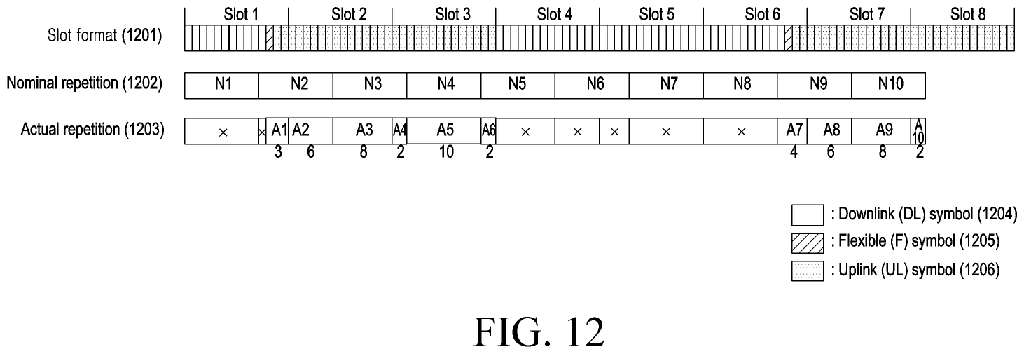

FIG. 12 illustrates a PUSCH repeated transmission type B in a wireless communication system according to an embodiment.

The UE may receive the following configurations: the start symbol S of an uplink data channel is 0, the length L of the uplink data channel is 14, and the number of repeated transmissions is 16. In this case, nominal repetitions may appear in 16 consecutive slots (1201). Thereafter, the UE may determine that the symbol configured as a downlink symbol in each nominal repetition 1201 is an invalid symbol. The UE determines that symbols configured as 1 in the invalid symbol pattern 1202 are invalid symbols. If valid symbols other than invalid symbols in respective nominal repetitions constitute one or more consecutive symbols in one slot, they are configured and transmitted as actual repetitions (1203).

In addition, with regard to PUSCH repeated transmission, additional methods may be defined in NR Release 16 with regard to UL grant-based PUSCH transmission and configured grant-based PUSCH transmission, across slot boundaries, as follows:

In method 1 (mini-slot level repetition), through one UL grant, two or more PUSCH repeated transmissions are scheduled inside one slot or across the boundary of consecutive slots. Time domain resource allocation information inside DCI indicates resources of the first repeated transmission. In addition, time domain resource information of remaining repeated transmissions may be determined according to time domain resource information of the first repeated transmission, and the uplink or downlink direction determined with regard to each symbol of each slot. Each repeated transmission occupies consecutive symbols.

In method 2 (multi-segment transmission), through one UL grant, two or more PUSCH repeated transmissions are scheduled in consecutive slots. Transmission no. 1 is designated for each slot, and the start point or repetition length may differ between respective transmissions. Time domain resource allocation information inside DCI indicates the start point and repetition length of all repeated transmissions. In the case of performing repeated transmissions inside a single slot through method 2, if there are multiple bundles of consecutive uplink symbols in the corresponding slot, respective repeated transmissions may be performed with regard to respective uplink symbol bundles. If there is a single bundle of consecutive uplink symbols in the corresponding slot, PUSCH repeated transmission is performed once according to the method of NR Release 15.

In method 3, two or more PUSCH repeated transmissions are scheduled in consecutive slots through two or more UL grants. Transmission no. 1 is designated for each slot, and the nth UL grant may be received before PUSCH transmission scheduled by the (n−1)th UL grant is completed.

In method 4, through one UL grant or one configured grant, one or multiple PUSCH repeated transmissions inside a single slot, or two or more PUSCH repeated transmissions across the boundary of consecutive slots may be supported. The number of repetitions indicated to the UE by the base station is only a nominal value, and the UE may perform more PUSCH repeated transmissions than the nominal number of repetitions. Time domain resource allocation information inside DCI or configured grant refers to resources of the first repeated transmission indicated by the base station. Time domain resource information of remaining repeated transmissions may be determined with reference to resource information of the first repeated transmission and the uplink or downlink direction of symbols. If time domain resource information of a repeated transmission indicated by the base station spans a slot boundary or includes an uplink/downlink switching point, the corresponding repeated transmission may be divided into multiple repeated transmissions. One repeated transmission may be included in one slot with regard to each uplink period.

### PUSCH: DMRS Bundling

A UE may be configured with a time window for simultaneous channel estimation from a base station and, for example, the configured time window for simultaneous channel estimation is referred to as a C-TDW. As a higher layer parameter associated with the C-TDW, the UE may be configured with at least a length in the time domain of the C-TDW (e.g., a specific number of consecutive slots) from the base station. In this case, the length in the time domain of the C-TDW may be configured for each BWP, for each cell, or for each numerology.

Based on the length in the time domain of the C-TDW configured from the base station, the UE may determine the time, at which the one or more C-TDWs are applied for simultaneous channel estimation for the PUSCH repeated transmissions scheduled by the base station, based on the following criteria.

The start time of the first C-TDW is determined.

The UE may determine, as the start time of the first C-TDW, the start time of a slot that performs the first PUSCH repeated transmission among the scheduled PUSCH repeated transmissions.

Alternatively, the UE may determine, as the start time of the first C-TDW, the start time of the first available slot determined to perform the scheduled PUSCH repeated transmissions. Even if a specific slot is determined to be an available slot, a PUSCH repeated transmission may not be performed in the corresponding slot.

From the above start time, the UE may expect a first C-TDW to be defined with a length in the time domain of the C-TDW configured by higher layer signaling.

A start time for at least one C-TDW that may appear after the first C-TDW is determined.

The start time for at least one C-TDW that may appear after the first C-TDW may be implicitly predetermined before the first PUSCH repeated transmission.

For example, in a paired spectrum (FDD) or supplementaryUplink (SUL), one or more C-TDWs may be defined consecutively after the first C-TDW, and the start time of each C-TDW may be the same as the end time of the C-TDW defined immediately before.

Alternatively, in unpaired spectrum (TDD), after the first C-TDW, the UE may determine the start time of the next C-TDW by considering DL/UL configuration information configured via higher layer. For example, if the duplex direction of a slot appearing immediately after the end of the first C-TDW has been configured as DL via higher layer signaling and the next appearing slot is configured as UL, the UE may skip a DL slot and determine the start time of the next appearing UL slot as the start time of the second C-TDW. In other words, the UE may determine, as the start time of the second C-TDW, the start time of the slot that is configured as the first UL slot after the end of the first C-TDW.

The end time of the last C-TDW is determined.

The end time of the last C-TDW may be determined as the end point of a slot in which the last PUSCH repeated transmission has been performed.

Alternatively, the UE may determine, as the start time of the last C-TDW, the end point of the available slot determined to perform the last scheduled PUSCH repeated transmission. As described above, even if a specific slot is determined to be an available slot, a PUSCH repeated transmission in the corresponding slot may not be performed.

Accordingly, after determining the start point and the interval of the at least one C-TDW for a specific PUSCH repeated transmission, the UE may determine at least one A-TDW within each C-TDW. The UE may expect the base station to perform simultaneous channel estimation for PUSCH repeated transmissions in units of A-TDWs. In other words, the UE may expect the base station to simultaneously estimate channels by bundling DMRS included in one or more PUSCH repeated transmissions within the A-TDW. The following criteria for A-TDW determination may be considered.

The start time of the first A-TDW is determined.

The UE may determine, as the start time of the first A-TDW, the start time of a slot that performs the first PUSCH repeated transmission among PUSCH repeated transmissions within a specific C-TDW.

Alternatively, the UE may determine, as the start time of the first A-TDW, the start time of the first available slot determined to perform the PUSCH repeated transmission within a specific C-TDW. As described above, even if a specific slot is determined to be an available slot, a PUSCH repeated transmission may not be performed in the corresponding slot.

After the first A-TDW is initiated, the UE may expect that power consistency and phase continuity of the transmission power are maintained until at least one of the following conditions is satisfied and may understand that the A-TDW is terminated when at least one of the following conditions is satisfied.

The A-TDW reaches a slot in which the last PUSCH repeated transmission within the C-TDW is performed.

Alternatively, the A-TDW reaches the last available slot within the C-TDW.

When a situation occurs in which power consistency and phase continuity of the transmission power are not maintained (specific examples of the corresponding situation may consider a situation in which DL slots exist based on the DL/UL slot format configuration in unpaired spectrum, a situation in which the maximum length of the A-TDW is reached, a high priority transmission or a frequency hopping is performed).

After the first A-TDW is initiated within a specific C-TDW as described above, the A-TDW may be terminated due to a situation in which power consistency and phase continuity of the transmission power are not maintained, and whether the UE is able to generate a new A-TDW after the termination of the first A-TDW may be determined through the UE capability report.

If the UE is able to generate the new A-TDW, the start point of the new A-TDW may be based on the first available slot after the time when the situation in which power consistency and phase continuity of the transmission power are not maintained occurs, or based on a slot in which the first PUSCH repeated transmission is performed.

If the UE is unable to generate the new A-TDW, the UE may expect that no new A-TDW exists until the end of the corresponding C-TDW. In connection with the decoding of each PUSCH repeated transmission occurs until the end of the corresponding C-TDW, the UE may expect that the base station does not perform simultaneous channel estimation.

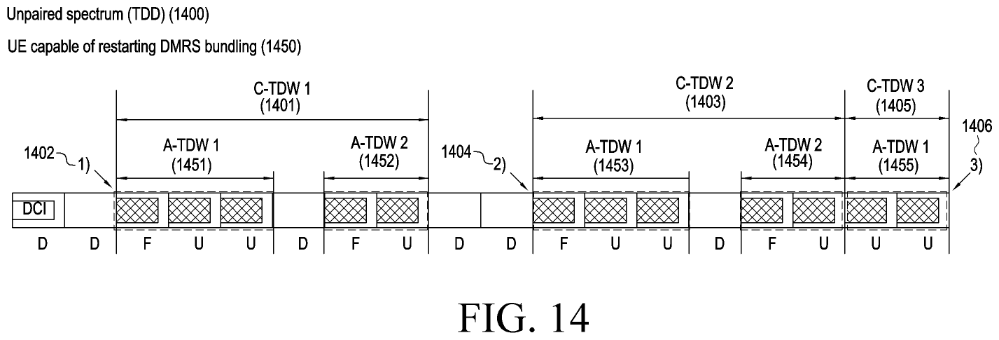

FIG. 14 illustrates a method for determining a C-TDW and an A-TDW for performing simultaneous channel estimation during PUSCH transmissions in a wireless communication system according to an embodiment. Referring to FIG. 14, a UE may be assumed to be configured with 6 slots of the length of the C-TDW from a base station.

In the case of an unpaired spectrum (TDD) 1400, the start point of the first C-TDW may be determined as the position of 1) (1402) in which the PUSCH repeated transmission scheduled with DCI as described above is first transmitted, and the time of the 6 slots from the position 1402 may be considered as the first C-TDW 1401.

After the point in which the first C-TDW ends, DL slots are skipped as above, and the position of 2), which is the PUSCH repeated transmission position that first appears after the first C-TDW, may be determined as a start point 1404 of the second C-TDW and the time of 6 slots from the position 1404 may be considered as the second C-TDW 1403. in a similar manner, and when a number of PUSCH repeated transmissions is indicated as 12, the third C-TDW may end at a position 1406, which is the point at which the last PUSCH repeated transmission ends. Accordingly, the length of the third C-TDW may be determined to be 2 slots rather than the configured value of 6 slots (1405).

Within each C-TDW determined as described above, one or more A-TDWs may be defined according to the criteria described above. In FIG. 14, the UE may be assumed to have reported to the base station the UE capability capable of generating the new A-TDW (indicated by reference numeral 1450). Within the first C-TDW 1401, the UE may maintain the A-TDW until, by considering the first transmitted PUSCH repeated transmission as the start point, a situation occurs in which power consistency and phase continuity of the transmission power are not maintained. Since the fourth slot within the first C-TDW is configured as DL, the UE may define the first three consecutive slots within the first C-TDW as the first A-TDW (1451). Since the UE has reported the UE capability to generate the new A-TDW after skipping the subsequent DL slots that appear, the UE may define a second A-TDW (1452). Similarly, the UE may also define two A-TDWs 1453 and 1454 and one A-TDW 1455 within the second and third C-TDWs, respectively. If the UE has not reported the UE capability to generate the new A-TDW, the UE is unable to define the second A-TDWs 1452 and 1454 within the first and second C-TDWs.

Within an A-TDW defined as described above, the UE may expect the base station to perform simultaneous channel estimation for one or more PUSCH repeated transmissions within the A-TDW.

For the operation and parameter configurations related to simultaneous channel estimation during the PUSCH transmissions, the UE may transfer to the base station whether the corresponding function is supported, through UE capability reporting. The reportable UE capability information may include at least one of the following pieces of information.

Whether simultaneous channel estimation during PUSCH repeated transmissions is supported

Whether definition of at least one C-TDW for simultaneous channel estimation during PUSCH repeated transmissions is possible

At least one of methods of defining a start point of the first C-TDW

At least one of methods of determining the end time of the last C-TDW

Whether definition of at least one A-TDW for simultaneous channel estimation during PUSCH repeated transmission is possible

Whether definition of A-TDW restart or multiple A-TDWs is possible within a specific C-TDW for simultaneous channel estimation during PUSCH repeated transmissions

Conditions for maintaining power consistency of and phase continuity of transmission power

Minimum symbol spacing between two PUSCH repeated transmissions

Whether a DL symbol/slot is able to be maintained, if existing between two PUSCH repeated transmissions

Whether DL is able be maintained when receiving between two PUSCH repeated transmissions

The UE capabilities described above may be optional with capability signaling, and signaling differentiated according to FR1/FR2 may be supported. Some or all of the above-described UE capabilities may be included in one feature group, and each UE capability may support individual feature group signaling. UE-specific band combination-specific, band-specific, or CC-specific signaling with regard to the UE capabilities described above may be supported.

### PUSCH: Frequency Hopping Process

5G supports two types of PUSCH frequency hopping methods with regard to each PUSCH repeated transmission type. In PUSCH repeated transmission type A, intra-slot frequency hopping and inter-slot frequency hopping are supported, and in PUSCH repeated transmission type B, inter-repetition frequency hopping and inter-slot frequency hopping are supported.

The intra-slot frequency hopping method supported in PUSCH repeated transmission type A is a method in which a UE transmits allocated resources in the frequency domain, after changing the same by a configured frequency offset, by two hops in one slot. The start RB of each hop in connection with intra-slot frequency hopping may be expressed in Equation (5) below.

$${RB}_{start} = \{ \begin{matrix}{RB}_{start} & i = 0 \\ ( {RB}_{start} + {RB}_{offset} ) {mod N}_{BWP}^{size} & i = 1\end{matrix} \qquad ( 5 )$$

In Equation (5), i=0 and i=1 may denote the first and second hops, respectively, and RBₛₜₐᵣₜ may denote the start RB in a UL BWP and may be calculated from a frequency resource allocation method. RB_{offset} denotes a frequency offset between two hops through an upper layer parameter. The number of symbols of the first hop may be represented by └N_{symb}^{PUSCH,s}/2┘, and number of symbols of the second hop may be represented by N_{symb}^{PUSCH,s}−└N_{symb}^{PUSCH,s}/2┘. N_{symb}^{PUSCH,s} is the length of PUSCH transmission in one slot and is expressed by the number of OFDM symbols.

Next, The inter-slot frequency hopping method supported in PUSCH repeated transmission types A and B is a method in which the UE transmits allocated resources in the frequency domain, after changing the same by a configured frequency offset, in each slot. The start RB during a slot in connection with inter-slot frequency hopping may be expressed in Equation (6) below.

$${RB}_{start} ( {n}_{s}^{μ} ) = \{ \begin{matrix}{RB}_{start} & {n}_{s}^{μ} mod 2 = 0 \\ ( {RB}_{start} + {RB}_{offset} ) {mod N}_{BWP}^{size} & {n}_{s}^{μ} mod 2 = 1\end{matrix} \qquad ( 6 )$$

In Equation (6), nₛ^{μ} denotes the current slot number during multi-slot PUSCH transmission, and RBₛₜₐᵣₜ denotes the start RB inside a UL BWP and may be calculated from a frequency resource allocation method. RB_{offset} may denote a frequency offset between two hops through an upper layer parameter.

The inter-repetition frequency hopping method supported in PUSCH repeated transmission type B is a method in which resources allocated in the frequency domain regarding one or multiple actual repetitions in each nominal repetition are moved by a configured frequency offset and then transmitted. The index RBstart(n) of the start RB in the frequency domain regarding one or multiple actual repetitions in the nth nominal repetition may be expressed in Equation (7) below:

$${RB}_{start} ( n ) = \{ \begin{matrix}{RB}_{start} & n mod 2 = 0 \\ ( {RB}_{start} + {RB}_{offset} ) {mod N}_{BWP}^{size} & n mod 2 = 1\end{matrix} \qquad ( 7 )$$

In Equation (7), n denotes the index of nominal repetition, and RB_{offset} denotes an RB offset between two hops through an upper layer parameter.

### PUSCH: Regarding Transmission Power

In the 5G system, the transmission power of the uplink data channel may be determined in Equation (8) below.

$${P}_{PUSCH , b , f , c} ( i , j , {q}_{d} , l ) = min \{ \begin{matrix}{P}_{CMAXf , c} ( i ) , \\ \begin{matrix}\begin{matrix}\begin{matrix}\begin{matrix}\begin{matrix}{P}_{O\_PUSCH , b , f , c} ( j ) + \\ 10 {log}_{10} ( {2}^{μ} \cdot {M}_{RB , b , f , c}^{PUSCH} ( i ) ) +\end{matrix} \\ {α}_{b , f , c} ( j ) \cdot \end{matrix} \\ {PL}_{b , f , c} ( {q}_{d} ) +\end{matrix} \\ {Δ}_{TE , b , f , c} ( i ) +\end{matrix} \\ {f}_{b , f , c} ( i , l )\end{matrix}\end{matrix} \} [ dBm ] \qquad ( 8 )$$

In Equation (8), j may denote a grant type of PUSCH. Specifically, j=0 may denote a PUSCH grant for a random access response, and j=1 may denote a configured grant. jϵ2, 3, . . . J−1) may denote dynamic grant. P_{CMAX,f,c}(i) may denote the maximum output power configured in the UE with respect to carrier f of a serving cell c for the PUSCH transmission occasion i. P_{O_PUSCH,b,f,c}(j) may be configured by the sum of P_{O_NOMINAL_PUSCH,f,c}(j), which is configured via a higher layer parameter, and P_{O_UE_PUSCH,b,f,c}(j), which may be determined via a higher layer configuration and SRI (in a case of dynamic grant PUSCH). M_{RB,b,f,c}^{PUSCH}(i) may denote a bandwidth for resource allocation expressed by the number of RBs for PUSCH transmission occasion i. Δ_{TF,b,f,c}(i) may denote a value determined according to the type of information transmitted through a PUSCH and a modulation coding scheme (MCS) (e.g., whether UL-SCH or CSI is included, etc.). α_{b,j,c}(j) denotes a value for compensating for pathloss and may denote a value that may be determined via the higher layer configuration and SRS resource indicator (SRI) (in a case of dynamic grant PUSCH). PL_{b,f,c}(q_{d}) may denote a downlink pathloss estimation value, which is estimated by a UE through a reference signal having the reference signal index q_{d}. The reference signal index q_{d} may be determined by the UE through higher layer configuration and SRI (in a case of dynamic grant PUSCH or ConfiguredGrantConfig-based configured grant PUSCH (type 2 configured grant PUSCH) that does not include higher layer configuration rrc-ConfiguredUplinkGrant) or through higher layer configuration. f_{b,f,c}(i,l) is a closed loop power adjustment value and may be supported by the accumulation method and absolute method. When the higher layer parameter tpc-Accumulation is not configured in the UE, the closed-loop power adjustment value may be determined by the accumulation method. d_{b,f,c(i,l) may be determined by}

$${f}_{b , f , c} ( i - {i}_{0} , l ) + {\sum }_{m = 0}^{0 ( {D}_{i} ) - 1} {δ}_{PUSCH , b , f , c} ( m , l ) ,$$

obtained by adding the closed-loop power adjustment value for the previous PUSCH transmission occasion (i−i₀) and the TPC command values for closed-loop index 1 received through the DCI between the time before the K_{PUSCH}(i−i₀)−1 symbol from the start of transmission of PUSCH transmission occasion (i−i₀) and the time before the K_{PUSCH}(i) symbol from the start of transmission of PUSCH transmission occasion i. When the higher layer parameter tpc-Accumulation is configured in the UE, f_{b,f,c}(i,l) may be determined as the TPC command value δ_{PUSCH,b,f,c}(i,l) for the closed loop index 1 received through the DCI. The closed loop index 1 may be configured to be a value of 0 or 1 when the higher layer parameter twoPUSCH-PC-AdjustementStates is configured in the UE, and the value may be determined through the higher layer configuration and SRI (in a case of dynamic grant PUSCH). The mapping relationship between the TPC command field and the TPC value δ_{PUSCH,b,f,c} in the DCI according to the accumulation method and the absolute method may be defined as shown in Table 38 below.

TABLE 38

| TPC | Accumulated | Absolute |
|---|---|---|
| command field | δ_{PUSCH,}_{_{b,f,c}}[dB] | δ_{PUSCH,}_{_{b,f,c}}[dB] |
| 0 | −1 | −4 |
| 1 | 0 | −1 |
| 2 | 1 | 1 |
| 3 | 3 | 4 |

### Transmit Precoding Matrix Indicator (TPMI)

When the UE is scheduled with one-layer transmission using a single PUSCH antenna port through DCI or higher layer signaling configured from the base station, the TPMI may be defined by W=1. Otherwise, when the UE is scheduled with one-layer PUSCH scheduling or more using a plurality of PUSCH antenna ports through DCI or higher layer signaling configured from the base station, W, which is TPMI, may be defined in Table 39 to Table 45 below.

TABLE 39

| TPMI | W | | | | | | | |
|---|---|---|---|---|---|---|---|---|
| index | (ordered from left to right in increasing order of TPMI index) | | | | | | | |
| 0-5 | $\frac{1}{\sqrt{2}} [ \begin{matrix}1 \\ 0\end{matrix} ]$ | $\frac{1}{\sqrt{2}} [ \begin{matrix}0 \\ 1\end{matrix} ]$ | $\frac{1}{\sqrt{2}} [ \begin{matrix}1 \\ 1\end{matrix} ]$ | $\frac{1}{\sqrt{2}} [ \begin{matrix}1 \\ - 1\end{matrix} ]$ | $\frac{1}{\sqrt{2}} [ \begin{matrix}1 \\ j\end{matrix} ]$ | $\frac{1}{\sqrt{2}} [ \begin{matrix}1 \\ - j\end{matrix} ]$ | — | — |

Table 39 above shows a one-layer TPMI when the UE has two PUSCH antenna ports. In Table 39 above, when the UE has a non-coherent antenna structure and has reported a UE capability corresponding thereto to the base station, the base station may provide an indication to the UE by selecting one of TPMI indexes 0 and 1. When the UE has a full-coherent antenna structure and has reported a UE capability corresponding thereto to the base station, the base station may provide an indication to the UE by selecting one of TPMI indexes 0 to 5.

Table 40 below shows one-layer TPMI when the UE has four PUSCH antenna ports with transform precoding enabled (i.e., in the case of using DFTS-OFDM waveform).

TABLE 40

| | W | | | | | | | |
|---|---|---|---|---|---|---|---|---|
| TPMI index | (ordered from left to right in increasing order of TPMI index) | | | | | | | |
| 0-7 | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| 8-15 | $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ - 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ 1\end{matrix} ]$ | $\frac{1}{2} [ \begin{matrix}1 \\ 1 \\ - j \\ - j\end{matrix} ]$ |
| 16-23 | $\frac{1}{2} [ \begin{matrix}1 \\ j \\ 1 \\ j\end{matrix} ]$ | $\frac{1}{2} [ \begin{matrix}1 \\ j \\ j \\ 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ - 1\end{matrix} ]$ | $\frac{1}{2} [ \begin{matrix}1 \\ - 1 \\ 1 \\ 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ - 1\end{matrix} ]$ | $\frac{1}{2} [ \begin{matrix}1 \\ - 1 \\ - j \\ j\end{matrix} ]$ |
| 24-27 | $\frac{1}{2} [ \begin{matrix}1 \\ - j \\ 1 \\ - j\end{matrix} ]$ | $\frac{1}{2} [ \begin{matrix}1 \\ - j \\ j \\ - 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ 1\end{matrix} ]$ | — | — | — | — |

In Table 40, when the UE has a non-coherent antenna structure and has reported a UE capability corresponding thereto to the base station, the base station may provide an indication to the UE by selecting one of TPMI indexes 0 to 3, and when the UE has a partial-coherent antenna structure and has reported a UE capability corresponding thereto to the base station, the base station may provide an indication to the UE by selecting one of TPMI indexes 0 to 11. When the UE has a full-coherent antenna structure and has reported a UE capability corresponding thereto to the base station, the base station may provide an indication to the UE by selecting one of TPMI indexes 0 to 27.

Table 41 above shows one-layer TPMI when the UE has four PUSCH antenna ports with transform precoding disabled (i.e., in the case of using CP-OFDM waveform).

TABLE 41

| | W | | | | | | | |
|---|---|---|---|---|---|---|---|---|
| TPMI index | (ordered from left to right in increasing order of TPMI index) | | | | | | | |
| 0-7 | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| 8-15 | $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ - 1\end{matrix} ]$ | $\frac{1}{2} [ \begin{matrix}1 \\ 1 \\ - j \\ - j\end{matrix} ]$ |
| 16-23 | $\frac{1}{2} [ \begin{matrix}1 \\ j \\ 1 \\ j\end{matrix} ]$ | $\frac{1}{2} [ \begin{matrix}1 \\ j \\ j \\ - 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ 1\end{matrix} ]$ | $\frac{1}{2} [ \begin{matrix}1 \\ - 1 \\ 1 \\ - 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ 1\end{matrix} ]$ | $\frac{1}{2} [ \begin{matrix}1 \\ - 1 \\ - j \\ j\end{matrix} ]$ |
| 24-27 | $\frac{1}{2} [ \begin{matrix}1 \\ - j \\ 1 \\ - j\end{matrix} ]$ | $\frac{1}{2} [ \begin{matrix}1 \\ - j \\ j \\ 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ - 1\end{matrix} ]$ | — | — | — | — |

In Table 41, when the UE has a non-coherent antenna structure and has reported a UE capability corresponding thereto to the base station, the base station may provide an indication to the UE by selecting one of TPMI indexes 0 to 3. When the UE has a partial-coherent antenna structure and has reported a UE capability corresponding thereto to the base station, the base station may provide an indication to the UE by selecting one of TPMI indexes 0 to 11. When the UE has a full-coherent antenna structure and has reported a UE capability corresponding thereto to the base station, the base station may provide an indication to the UE by selecting one of TPMI indexes 0 to 27.

Table 42 below shows a two-layer TPMI when the UE has two PUSCH antenna ports with transform precoding disabled (i.e., in the case of using CP-OFDM waveform).

TABLE 42

| TPMI | W | | |
|---|---|---|---|
| index | (ordered from left to right in increasing order of TPMI index) | | |
| 0-2 | $\frac{1}{\sqrt{2}} [ \begin{matrix}1 & 0 \\ 0 & 1\end{matrix} ]$ | $\frac{1}{\sqrt{2}} [ \begin{matrix}1 & 1 \\ 1 & - 1\end{matrix} ]$ | $\frac{1}{\sqrt{2}} [ \begin{matrix}1 & 1 \\ j & - j\end{matrix} ]$ |

In Table 42, when the UE has a non-coherent antenna structure and has reported a UE capability corresponding thereto to the base station, the base station may provide an indication to the UE by selecting TPMI index 0, and when the UE has a full-coherent antenna structure and has reported a UE capability corresponding thereto to the base station, the base station may provide an indication to the UE by selecting one of TPMI indexes 0 to 2.

Table 43 below shows a 2-layer TPMI when the UE has four PUSCH antenna ports with transform precoding disabled (i.e., in the case of using CP-OFDM waveform).

TABLE 43

| TPMI | W | | | |
|---|---|---|---|---|
| index | (ordered from left to right in increasing order of TPMI index) | | | |
| 0-3 | $\frac{1}{2} [ \begin{matrix}1 & 0 \\ 0 & 1 \\ 0 & 0 \\ 0 & 0\end{matrix} ]$ | $\frac{1}{2} [ \begin{matrix}1 & 0 \\ 0 & 0 \\ 0 & 1 \\ 0 & 0\end{matrix} ]$ | $\frac{1}{2} [ \begin{matrix}1 & 0 \\ 0 & 0 \\ 0 & 0 \\ 0 & 1\end{matrix} ]$ | $\frac{1}{2} [ \begin{matrix}0 & 0 \\ 1 & 0 \\ 0 & 1 \\ 0 & 0\end{matrix} ]$ |
| 4-7 | $\frac{1}{2} [ \begin{matrix}0 & 0 \\ 1 & 0 \\ 0 & 0 \\ 0 & 1\end{matrix} ]$ | $\frac{1}{2} [ \begin{matrix}0 & 0 \\ 0 & 0 \\ 1 & 0 \\ 0 & 1\end{matrix} ]$ | $\frac{1}{2} [ \begin{matrix}1 & 0 \\ 0 & 1 \\ 1 & 0 \\ 0 & - j\end{matrix} ]$ | $\frac{1}{2} [ \begin{matrix}1 & 0 \\ 0 & 1 \\ 1 & 0 \\ 0 & j\end{matrix} ]$ |
| 8-11 | $\frac{1}{2} [ \begin{matrix}1 & 0 \\ 0 & 1 \\ - j & 0 \\ 0 & 1\end{matrix} ]$ | $\frac{1}{2} [ \begin{matrix}1 & 0 \\ 0 & 1 \\ - j & 0 \\ 0 & - 1\end{matrix} ]$ | $\frac{1}{2} [ \begin{matrix}1 & 0 \\ 0 & 1 \\ - 1 & 0 \\ 0 & - j\end{matrix} ]$ | $\frac{1}{2} [ \begin{matrix}1 & 0 \\ 0 & 1 \\ - 1 & 0 \\ 0 & j\end{matrix} ]$ |
| 12-15 | $\frac{1}{2} [ \begin{matrix}1 & 0 \\ 0 & 1 \\ j & 0 \\ 0 & 1\end{matrix} ]$ | $\frac{1}{2} [ \begin{matrix}1 & 0 \\ 0 & 1 \\ j & 0 \\ 0 & - 1\end{matrix} ]$ | $\frac{1}{2 \sqrt{2}} [ \begin{matrix}1 & 1 \\ 1 & 1 \\ 1 & - 1 \\ 1 & - 1\end{matrix} ]$ | $\frac{1}{2 \sqrt{2}} [ \begin{matrix}1 & 1 \\ 1 & 1 \\ j & - j \\ j & - j\end{matrix} ]$ |
| 16-19 | $\frac{1}{2 \sqrt{2}} [ \begin{matrix}1 & 1 \\ j & j \\ 1 & - 1 \\ j & - j\end{matrix} ]$ | $\frac{1}{2 \sqrt{2}} [ \begin{matrix}1 & 1 \\ j & j \\ j & - j \\ - 1 & 1\end{matrix} ]$ | $\frac{1}{2 \sqrt{2}} [ \begin{matrix}1 & 1 \\ - 1 & - 1 \\ 1 & - 1 \\ - 1 & 1\end{matrix} ]$ | $\frac{1}{2 \sqrt{2}} [ \begin{matrix}1 & 1 \\ - 1 & - 1 \\ j & - j \\ - j & j\end{matrix} ]$ |
| 20-21 | $\frac{1}{2 \sqrt{2}} [ \begin{matrix}1 & 1 \\ - j & - j \\ 1 & - 1 \\ - j & j\end{matrix} ]$ | $\frac{1}{2 \sqrt{2}} [ \begin{matrix}1 & 1 \\ - j & - j \\ j & - j \\ 1 & - 1\end{matrix} ]$ | — | — |

In Table 43 when the UE has a non-coherent antenna structure and has reported a UE capability corresponding thereto to the base station, the base station may provide an indication to the UE by selecting one of TPMI indexes 0 to 5. When the UE has a partial-coherent antenna structure and has reported a UE capability corresponding thereto to the base station, the base station may provide an indication to the UE by selecting one of TPMI indexes 0 to 13. When the UE has a full-coherent antenna structure and has reported a UE capability corresponding thereto to the base station, the base station may provide an indication to the UE by selecting one of TPMI indexes 0 to 21.

Table 44 below shows a three-layer TPMI when the UE has four PUSCH antenna ports with transform precoding disabled (i.e., in the case of using CP-OFDM waveform).

TABLE 44

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 \\ 0 & 1 & 0 \\ 0 & 0 & 1 \\ 0 & 0 & 0\end{matrix} ]$ | $\frac{1}{2} [ \begin{matrix}1 & 0 & 0 \\ 0 & 1 & 0 \\ 1 & 0 & 0 \\ 0 & 0 & 1\end{matrix} ]$ | $\frac{1}{2} [ \begin{matrix}1 & 0 & 0 \\ 0 & 1 & 0 \\ - 1 & 0 & 0 \\ 0 & 0 & 1\end{matrix} ]$ | $\frac{1}{2 \sqrt{3}} [ \begin{matrix}1 & 1 & 1 \\ 1 & - 1 & 1 \\ 1 & 1 & - 1 \\ 1 & - 1 & - 1\end{matrix} ]$ |
| 4-6 | $\frac{1}{2 \sqrt{3}} [ \begin{matrix}1 & 1 & 1 \\ 1 & - 1 & 1 \\ j & j & - j \\ j & - j & - j\end{matrix} ]$ | $\frac{1}{2 \sqrt{3}} [ \begin{matrix}1 & 1 & 1 \\ - 1 & 1 & - 1 \\ 1 & 1 & - 1 \\ - 1 & 1 & 1\end{matrix} ]$ | $\frac{1}{2 \sqrt{3}} [ \begin{matrix}1 & 1 & 1 \\ - 1 & 1 & - 1 \\ j & j & - j \\ - j & j & j\end{matrix} ]$ | — |

In Table 44, when the UE has a non-coherent antenna structure and has reported a UE capability corresponding thereto to the base station, the base station may provide an indication to the UE by selecting TPMI index 0, and when the UE has a partial-coherent antenna structure and has reported a UE capability corresponding thereto to the base station, the base station may provide an indication to the UE by selecting one of TPMI index 0 to 2. When the UE has a full-coherent antenna structure and has reported a UE capability corresponding thereto to the base station, the base station may provide an indication to the UE by selecting one of TPMI indexes 0 to 6.

Table 45 below shows a four-layer TPMI when the UE has four PUSCH antenna ports with transform precoding disabled (i.e., in the case of using CP-OFDM waveform).

TABLE 45

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 & 0 \\ 0 & 1 & 0 & 0 \\ 0 & 0 & 1 & 0 \\ 0 & 0 & 0 & 1\end{matrix} ]$ | $\frac{1}{2 \sqrt{2}} [ \begin{matrix}1 & 1 & 0 & 0 \\ 0 & 0 & 1 & 1 \\ 1 & - 1 & 0 & 0 \\ 0 & 0 & 1 & - 1\end{matrix} ]$ | $\frac{1}{2 \sqrt{2}} [ \begin{matrix}1 & 1 & 0 & 0 \\ 0 & 0 & 1 & 1 \\ j & - j & 0 & 0 \\ 0 & 0 & j & - j\end{matrix} ]$ | $\frac{1}{4} [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$ |

| | | | | |
|---|---|---|---|---|
| 4 | $\frac{1}{4} [ \begin{matrix}1 & 1 & 1 & 1 \\ 1 & - 1 & 1 & - 1 \\ j & j & - j & - j \\ j & - j & - j & j\end{matrix} ]$ | — | — | — |

In Table 45, when the UE has a non-coherent antenna structure and has reported a UE capability corresponding thereto to the base station, the base station may provide an indication to the UE by selecting TPMI index 0, and when the UE has a partial-coherent antenna structure and has reported a UE capability corresponding thereto to the base station, the base station may provide an indication to the UE by selecting one of TPMI index 0 to 2. When the UE has a full-coherent antenna structure and has reported a corresponding UE capability to the base station, the base station may provide an indication to the UE by selecting one of TPMI indexes 0 to 4.

### PHR

The PHR is generated when a UE measures the difference (i.e., represents the available transmission power of the UE) between the nominal UE maximum transmission power and the estimated power for uplink transmission and transmits the same to the base station. The PHR may be used to support power aware packet scheduling. The estimated power for the uplink transmission may include the estimated power for UL-SCH (PUSCH) transmission for each activated serving cell, the estimated power for UL-SCH and PUCCH transmission in SpCell of other MAC entities (e.g., E-UTRA MAC entity in EN-DC, NE-DC, and NGEN-DC cases in the related Standard), the estimated power for SRS transmission for each activated serving cell, and the like. The UE may trigger a PHR when any of the following trigger events are satisfied:

Trigger event 1: When the higher layer parameter phr-ProhibitTimer expires and the MAC entity has uplink resources for new transmission, the pathloss for at least one activated serving cell has changed more than the higher layer parameter phr-Tx-PowerFactorChange dB since the most recent PHR transmission. The active downlink BWP for the at least one activated serving cell is not a dormant BWP. In this case, the pathloss change for one cell is determined as the difference between the pathloss currently measured on the current pathloss reference and the pathloss measured at the transmission time of the most recent PHR transmission on the pathloss reference in use at the corresponding time.

Trigger Event 2: Higher layer parameter phr-PeriodicTimer expires.

Trigger Event 3: Configuration or reconfiguration of the power headroom reporting function by a higher layer has performed, rather than configuration or reconfiguration not to support power headroom reporting.

Trigger Event 4: Activation of an SCell of any MAC entity having an uplink of which firstActiveDownlinkBWP-Id is not configured as a dormant BWP. The firstActiveDownlinkBWP-Id refers to the identifier of a DL BWP to be activated when performing RRC (re)configuration (when configured for SpCell) or the identifier of a DL BWP to be used when activating the SCell (when configured for SCell).

Trigger Event 5: addition of PSCell (i.e., PSCell is new added or changed) Trigger Event 6: When the higher layer parameter phr-ProhibitTimer has expired and the MAC entity has uplink resources for new transmission, there are uplink resources allocated for transmission or PUCCH is transmitted to the corresponding cell, and when the MAC entity has uplink resources for transmission or transmits PUCCH to the corresponding cell, the required power backoff due to power management for the corresponding cell is greater than the higher layer parameter phr-Tx-PowerFactorChange dB after the most recent PHR transmission.

Trigger Event 7: The activated BWP of the SCell for a MAC entity having a configured uplink is changed from a dormant BWP to a non-dormant downlink BWP.

Trigger event 8: If, in FR2, higher layer parameter mpe-Reporting indicating whether to report maximum allowed UE output power reduction (MPE P-MPR) to meet maximum permissible exposure (MPE) is configured in a UE and mpe-ProhibitTimer is not running, the measured P-MPR, which is applied to meet the FR2 MPE requirement with respect to at least one activated FR2-serving cell since the most recent PHR when the PHR is referred to as an MPE P-MPR report, is greater than or equal to the higher layer parameter mpe-Threshold.

Power headroom reporting may be triggered according to the above trigger events, and the UE may determine power headroom reporting according to the following additional conditions.

### Additional Conditions Based on Temporary Required Power Backoff:

The MAC entity should avoid triggering a PHR when the required power backoff is temporarily (i.e. Up to a few tens of milliseconds) decreases due to power management. When the required power backoff is temporarily decreased and the PHR is triggered by other trigger events, this should avoid reflecting such temporary decrease in the value of P_{CMAX,f,c}/PH, which represents a ratio between maximum power and remaining (available) power. That is, the PHR triggering due to temporary power backoff should be avoided. For example, when the PHR is triggered by another PHR trigger event (such as expiration of a periodictimer), a condition is added so that PHs reflecting temporary power decrease due to the required power backoff are not reported and PHs excluding the impact of required power backoff are reported.

### Conditions for Power Headroom Reporting Based on UE Implementation:

If one HARQ process is configured based on cg-RetransmissionTimer and a PHR has already been included in the MAC PDU for the transmission by the corresponding HARQ process, but the transmission through the lower layers has not yet occurred, the UE implementation determines a method of processing details of the power headroom report.

If power headroom reporting is triggered by the occurrence of one or more of the above trigger events and the uplink transmission resource allocated via DCI is able to accommodate the MAC entity for power headroom reporting and subheaders for the same, the UE performs power headroom reporting through the corresponding uplink resource. In this case, the corresponding uplink resource refers to the resource for the uplink transmission scheduled by the first DCI format or the first uplink grant that schedules the initial transmission of the TB after the power headroom triggering. In other words, following the occurrence of power headroom triggering, the UE may perform power headroom reporting via an uplink transmission scheduled by the first DCI format or the first uplink grant of the uplink resources that can accommodate the MAC entity for power headroom and subheaders for the same. Alternatively, after a power headroom trigger occurs, the UE may perform power headroom reporting via a configured grant PUSCH transmission that can accommodate the MAC entity for power headroom and subheaders for the same.

When performing power headroom reporting for a specific cell, the UE may select and calculate one of two types of power headroom information and report the same. The first type of power headroom information is actual PHR, which is power headroom information calculated based on the actual transmitted uplink signal (e.g., PUSCH) transmission power. The second type of power headroom information is virtual PHR (or reference format), which is the power headroom information calculated based on the transmission power parameters configured by a higher layer without the actual transmitted PUSCH. After the PHR is triggered, the UE may calculate the actual PHR based on the DCI received up to a time point including a PDCCH monitoring interval in which the first DCI format that schedules a PUSCH to transmit a MAC CE including a PHR is received, as described above, and based on the higher layer information for periodic/semi-persistent SRS transmission and configured grant transmission.

If the UE receives the DCI or determines to transmit periodic/semi-persistent SRS or configured grant, after the PDCCH monitoring interval in which the first DCI format is received, the UE may calculate the virtual PHR for the corresponding cell. Alternatively, after the power headroom reporting is triggered, the UE may calculate the actual PHR based on the DCI received up to a time point before T_{proc,2}=T_{proc,2}, which corresponds to the PUSCH preparation process time described above, based on the first uplink symbol of the configured grant PUSCH that can transmit the corresponding power headroom information, and based on the higher layer information for periodic/semi-persistent SRS transmissions and configured grant transmissions. If the UE receives DCI or determines to perform periodic/semi-persistent SRS transmission or configured grant transmission after the time point before T_{proc,2} based on the first uplink symbol of the configured grant PUSCH, the UE may calculate the virtual PHR for the corresponding cell.

When the UE calculates the actual PHR based on actual PUSCH transmission, the power headroom reporting information for serving cell c, carrier f, BWP b, and PUSCH transmission time point i may be expressed by Equation (9) below.

$${PH}_{type 1 b , f , c} ( i , j , {q}_{d} , l ) = {P}_{CMAX , f , c} ( i ) - \{ \begin{matrix}\begin{matrix}\begin{matrix}\begin{matrix}\begin{matrix}{P}_{O\_PUSCH . b , f , c} ( j ) + \\ 10 {log}_{10} ( {2}^{p} \cdot {M}_{RB , b , f , c}^{PUSCH} ( i ) ) +\end{matrix} \\ {α}_{b , f , c} ( j ) \cdot \end{matrix} \\ {PL}_{b , f , c} ( {q}_{d} ) +\end{matrix} \\ {Δ}_{TF , b , f , c} ( i ) +\end{matrix} \\ {f}_{b , f , c} ( i , l )\end{matrix} \} [ dB ] \qquad ( 9 )$$

Alternatively, when the UE calculates the virtual PHR based on the transmission power parameters configured in the higher layer, the power headroom reporting information for serving cell c, carrier f, BWP b, and PUSCH transmission time point i may be expressed by Equation (10) below.

$${PH}_{type 1 b , f , c} ( i , j , {q}_{d} , l ) = {\tilde{P}}_{CMAXf , c} ( i ) - \{ \begin{matrix}\begin{matrix}\begin{matrix}{P}_{O\_PUSCH b , f , c} ( j ) + \\ {α}_{b , f , c} ( j ) \cdot \end{matrix} \\ {PL}_{b , f , c} ( {q}_{d} ) +\end{matrix} \\ {f}_{b , f , c} ( i , l )\end{matrix} \} [ dB ] \qquad ( 10 )$$

In Equation (9) above, power headroom information may be calculated using the difference between the maximum output power and the transmission power for PUSCH transmission occasion i. In Equation (10), he power headroom information may be calculated using the parameters related to maximum power reduction (MPR) (e.g., MPR, additional MPR (A-MPR), power management MPR (P-MPR), etc.) and the difference between \tilde{P}_{CMAX,f,c}(i), which is the maximum output power when ^{Δ}T_{c} is assumed to be zero, and the reference PUSCH transmission power using the default transmission power parameter (e.g., P_{O_NOMINAL_PUSCH,f,c}(0), p0 and alpha of P0-PUSCH-AlpahSet with p0-PUSCH-AlphaSetId=0, PL_{b,f,c}(q,t) corresponding to pusch-PathlossReferenceRS-Id=0, and closed loop power adjustment value with closed loop index l=0). For the description of each variable in Equations (9) and (10), reference may be made to the variable description in Equation (8).

The A-MPR is the MPR that satisfies the additional emission requirement (e.g., the combination of additionalSpectrumEmission and NR freq. band indicated by the RRC determines the network signaling label and the resulting A-MPR value is defined in the relevant Standard), indicated by the base station by higher layer signaling. The above P-MPR provides the maximum allowed UE output power reduction for serving cell c, is capable of satisfying the applicable electromagnetic energy absorption requirements, and is defined in the relevant Standard. Herein, type 1 PHR information is for PUSCH transmission power, type 2 PHR information is for PUCCH transmission power, and type 3 PHR information is for SRS transmission power. However, the disclosure is not limited thereto.

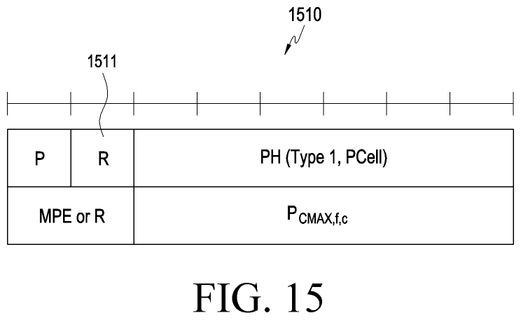

FIG. 15 illustrates a MAC CE structure including a single piece of PHR information according to an embodiment.

Referring to FIG. 15, when MR-DC or UL-CA is not supported, the base station configures the higher layer parameter ‘multiplePHR’ to ‘false’ for the corresponding UE, signifying that the UE supports PHR reporting for the PCell with a MAC CE having a single entry, as shown in reference numeral 1510. Each field in FIG. 15, including R (1511), may be defined as shown in Table 46 below.

TABLE 46

P: P consisting of 1 bit is configured as 0 when
mpe-Reporting-FR2 is configured and the P-MPR
applied according to TS38.133 is less than P-
MPR_00 when the serving cell operates in
FR2, Otherwise, P is configured as
1. When mpe-Reporting-FR2 is not configured
or the serving cell operates in
FR1, P indicates whether power back
off is applied for transmit power
adjustment or not. When the corresponding
Pcmax, c field has a different value
because power backoff is not applied
due to power management, the
corresponding P area is configured as 1;
Pcmax, f, c: This field indicates the maximum
transmission power value used
to calculate power headroom when
performing power headroom reporting.
This field includes 6 bits of information
and allows selection of one of 64
levels of nominal UE transmit power level;
MPE: When mpe-Reporting-FR2 is
configured, the serving cell operates in
FR2, and the P field is set to 1, the MPE
area indicates a power back-off value
applied to meet the maximum permissible
exposure (MPE) requirements. This
field is a field configured by two bits and
indicates a value of one of the four
measured P-MPR value stages. When
mpe-Reporting-FR2 is not configured,
when the serving cell is operating in FR1,
or when the P field is set to zero, a
reserved bit, such as R, may exist;
R: Reserved bit and is set to have a value of 0;
PH: This field indicates the power
headroom level. This field may be
configured by 6 bits, and allow selection
of a value of one from a total of 64
power headroom levels.

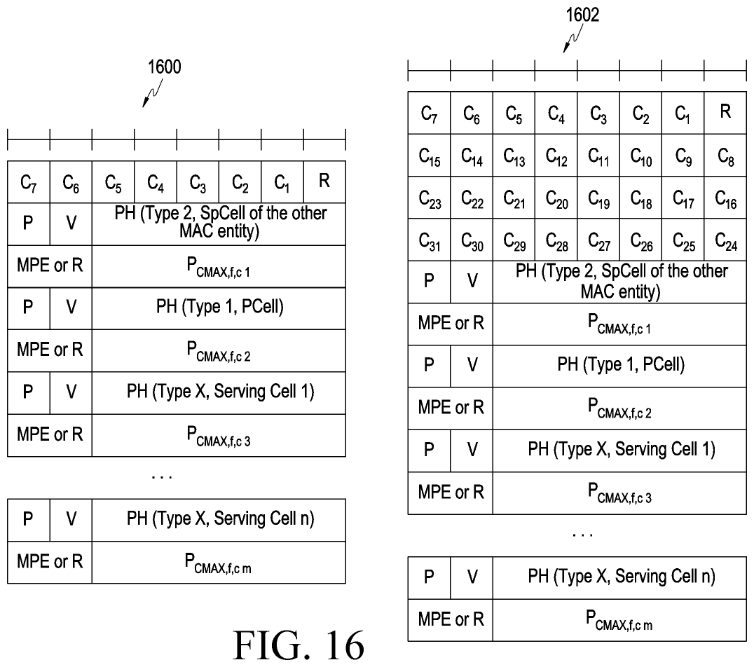

FIG. 16 illustrates a MAC CE structure including multiple pieces of PHR information according to an embodiment. Referring to FIG. 16, when the UE supports multi-RAT dual connectivity (MR-DC) or uplink carrier aggregation (UL-CA), the base station configures the higher layer parameter ‘multiplePHR’ to ‘true’ for the corresponding UE to perform PHR reporting for each supported cell. This signifies that the UE supports PHR reporting for multiple serving cells, by using a MAC CE having multiple entries, such as a first format 1600 or a second format 1602. The first format 1600 is a PHR MAC CE format that may be used when a plurality of serving cells are configured and the largest index among the serving cells is less than 8. The second format 1602 is a PHR MAC CE format that may be used when a plurality of serving cells are configured and the largest index among the serving cells is greater than or equal to 8.

Unlike the PHR MAC CE format shown in FIG. 15, the first format 1600 or the second format 1602 shown in FIG. 16 may have a variable size depending on a set on which serving cells are configured or number of serving cells. The information may include a second type of PH information for a special cell (SpCell) of another MAC entity (e.g., LTE), and may include a first type of PH information for a PCell. When the largest index value in the corresponding serving cells is less than 8, a field indicating serving cell information may be configured by one octet. When the largest index value in the corresponding serving cells is greater than or equal to 8, a field indicating serving cell information may be configured by four octets. Within the PHR MAC CE, PHR information may be included according to the serving cell index order. When a PHR is triggered, the MAC entity may transmit a PHR MAC CE including PHR information through a transmittable PUSCH. Whether the PHR information is calculated based on actual transmission (i.e., actual PHR) or based on transmission power parameters configured in the higher layer (i.e., virtual PHR) may be determined based on the uplink signaling and DCI received up to a specific time point, as described above, of (a time point including the PDCCH monitoring interval in which the first DCI format has been detected, or a time point before T_{proc,2} from the first symbol of the first PUSCH). The fields of the PHR MAC CE format shown in FIG. 16 may have the same meaning (definition) as most of the fields of the PHR MAC CE format shown in FIG. 15, where Cᵢ and V may have the same meaning as that described in Table 47 below.

TABLE 47

Cᵢ: This region indicates whether a power
headroom area for the serving cell with
ServeCellIndex I exists. If power headroom
reporting for serving cell i is
performed, the corresponding Cᵢ region
is set to have a value of 1. If power
headroom reporting for serving cell i is
not performed, the corresponding Cᵢ
region is set to have a value of 0;
V: This region indicates whether a power
headroom value is calculated based on
actual transmission or reference format.
For the first type of power headroom
information, V is set to have a value of
0 if the PUSCH has actually been
transmitted, and V is set to have a value
of 1 if the reference format for the
PUSCH has been used. For the second
type of power headroom information, V
is set to have a value of 0 if PUCCH has
actually been transmitted, and V is set
to have a value of 1 if the reference format
for PUCCH has been used. For the
third type of power headroom information,
V is set to have a value of 0 if SRS
has been actually transmitted, and V is set
to have a value of 1 if the reference
format for SRS has been used. In addition,
for the first type, the second type,
and the third type of power headroom
information, if V has a value of 0, the
P_{cma,f,c} and MPE fields exist, and if V has
a value of 1, the P_{cma,f,c} and MPE fields
may be omitted.

### SRS

The base station may configure at least one SRS configuration with regard to each uplink BWP to transfer configuration information for SRS transmission to the UE and may also configure as least one SRS resource set with regard to each SRS configuration. As an example, the base station and the UE may exchange upper signaling information as follows, to transfer information regarding the SRS resource set.

srs-ResourceSetId indicates an SRS resource set index

srs-ResourceIdList indicates a set of SRS resource indices referred to by SRS resource sets

resourceType indicates time domain transmission configuration of SRS resources referred to by SRS resource sets and may be configured as one of “periodic”, “semi-persistent”, and “aperiodic”. If configured as “periodic” or “semi-persistent”, associated CSI-RS information may be provided according to the place of use of SRS resource sets. If configured as “aperiodic”, an aperiodic SRS resource trigger list/slot offset information may be provided, and associated CSI-RS information may be provided according to the place of use of SRS resource sets.

usage indicates a configuration regarding the place of use of SRS resources referred to by SRS resource sets, and may be configured as one of “beamManagement”, “codebook”, “nonCodebook”,and “antennaSwitching”.

alpha, p0, pathlossReferenceRS, srs-PowerControlAdjustmentStates provides a parameter configuration for adjusting the transmission power of SRS resources referred to by SRS resource sets.

The UE may understand that an SRS resource included in a set of SRS resource indices referred to by an SRS resource set follows the information configured for the SRS resource set.

The base station and the UE may transmit/receive upper layer signaling information to transfer individual configuration information regarding SRS resources. For example, the individual configuration information regarding SRS resources may include time-frequency domain mapping information inside slots of the SRS resources, and this may include information regarding intra-slot or inter-slot frequency hopping of the SRS resources. The individual configuration information regarding SRS resources may include time domain transmission configuration of SRS resources, and may be configured as one of “periodic”, “semi-persistent”, and “aperiodic”. The time domain transmission configuration of SRS resources may be limited to have the same time domain transmission configuration as the SRS resource set including the SRS resources. If the time domain transmission configuration of SRS resources is configured as “periodic” or “semi-persistent”, the time domain transmission configuration may further include an SRS resource transmission cycle and a slot offset (for example, periodicityAndOffset).

The base station may activate or deactivate SRS transmission for the UE through upper layer signaling including RRC signaling or MAC CE signaling, or L1 signaling (for example, DCI). For example, the base station may activate or deactivate periodic SRS transmission for the UE through upper layer signaling. The base station may indicate activation of an SRS resource set having resourceType configured as “periodic” through upper layer signaling, and the UE may transmit the SRS resource referred to by the activated SRS resource set. Intra-slot time-frequency domain resource mapping of the transmitted SRS resource follows resource mapping information configured for the SRS resource, and slot mapping, including the transmission cycle and slot offset, follows periodicityAndOffset configured for the SRS resource. The spatial domain transmission filter applied to the transmitted SRS resource may refer to spatial relation info configured for the SRS resource or may refer to associated CSI-RS information configured for the SRS resource set including the SRS resource. The UE may transmit the SRS resource inside the uplink BWP activated with regard to the periodic SRS resource activated through upper layer signaling.

For example, the base station may activate or deactivate semi-persistent SRS transmission for the UE through upper layer signaling. The base station may indicate activation of an SRS resource set through MAC CE signaling, and the UE may transmit the SRS resource referred to by the activated SRS resource set. The SRS resource set activated through MAC CE signaling may be limited to an SRS resource set having resourceType configured as “semi-persistent”. Intra-slot time-frequency domain resource mapping of the transmitted SRS resource follows resource mapping information configured for the SRS resource, and slot mapping, including the transmission cycle and slot offset, follows periodicityAndOffset configured for the SRS resource. The spatial domain transmission filter applied to the transmitted SRS resource may refer to spatial relation info configured for the SRS resource or may refer to associated CSI-RS information configured for the SRS resource set including the SRS resource. If spatial relation info is configured for the SRS, the spatial domain transmission filter may be determined, without following the same, by referring to configuration information regarding spatial relation info transferred through MAC CE signaling that activates semi-persistent SRS transmission. The UE may transmit the SRS resource inside the uplink BWP activated with regard to the semi-persistent SRS resource activated through upper layer signaling.

The base station may trigger aperiodic SRS transmission by the UE through DCI. The base station may indicate one of aperiodic SRS triggers (aperiodicSRS-ResourceTrigger) through the SRS request field of DCI. The UE may understand that the SRS resource set including the aperiodic SRS resource trigger indicated through DCI in the aperiodic SRS resource trigger list, among configuration information of the SRS resource set, has been triggered. The UE may transmit the SRS resource referred to by the triggered SRS resource set. Intra-slot time-frequency domain resource mapping of the transmitted SRS resource follows resource mapping information configured for the SRS resource. Slot mapping of the transmitted SRS resource may be determined by the slot offset between the SRS resource and a PDCCH including DCI, and this may refer to value(s) included in the slot offset set configured for the SRS resource set. Specifically, as the slot offset between the SRS resource and the PDCCH including DCI, a value indicated in the time domain resource assignment field of DCI, among offset value(s) included in the slot offset set configured for the SRS resource set, may be applied. The spatial domain transmission filter applied to the transmitted SRS resource may refer to spatial relation info configured for the SRS resource or to associated CSI-RS information configured for the SRS resource set including the SRS resource. The UE may transmit the SRS resource inside the uplink BWP activated with regard to the aperiodic SRS resource triggered through DCI.

If the base station triggers aperiodic SRS transmission for the UE through DCI, a minimum time interval may be necessary between the transmitted SRS and the PDCCH including the DCI that triggers aperiodic SRS transmission, in order for the UE to transmit the SRS by applying configuration information regarding the SRS resource. The time interval for SRS transmission by the UE may be defined as the number of symbols between the last symbol of the PDCCH including the DCI that triggers aperiodic SRS transmission and the first symbol mapped to the first transmitted SRS resource among transmitted SRS resource(s).

The minimum time interval may be determined with reference to the PUSCH preparation procedure time needed by the UE to prepare PUSCH transmission and may have a different value depending on the place of use of the SRS resource set including the transmitted SRS resource. For example, the minimum time interval may be determined as N2 symbols defined in view of UE processing capability that follows the UE's capability with reference to the UE's PUSCH preparation procedure time. If the place of use of the SRS resource set is configured as “codebook” or “antennaSwitching” in consideration of the place of use of the SRS resource set including the transmitted SRS resource, the minimum time interval may be determined as N2 symbols, and if the place of use of the SRS resource set is configured as “nonCodebook” or “beamManagement”, the minimum time interval may be determined as N2+14 symbols. The UE may transmit an aperiodic SRS if the time interval for aperiodic SRS transmission is larger than or equal to the minimum time interval and may disregard the DCI that triggers the aperiodic SRS if the time interval for a periodic SRS transmission is smaller than the minimum time interval.

Table 48 below provides Configuration information spatialRelationInfo.

TABLE 48

| | |
|---|---|
| SRS-Resource ::= | SEQUENCE { |
| srs-ResourceId | SRS-ResourceId, |
| nrofSRS-Ports | ENUMERATED {port1, ports2, |

ports4},

| | |
|---|---|
| ptrs-PortIndex | ENUMERATED {n0, n1 } |

OPTIONAL, -- Need R

| | |
|---|---|
| transmissionComb | CHOICE { |
| n2 | SEQUENCE { |
| combOffset-n2 | INTEGER (0..1), |
| cyclicShift-n2 | INTEGER (0..7) |

},

| | |
|---|---|
| n4 | SEQUENCE { |
| combOffset-n4 | INTEGER (0..3), |
| cyclicShift-n4 | INTEGER (0..11) |

```
      }
  },
```

| | |
|---|---|
| resourceMapping | SEQUENCE { |
| startPosition | INTEGER (0..5), |
| nrofSymbols | ENUMERATED {n1, n2, n4}, |
| repetitionFactor | ENUMERATED {n1, n2, n4} |

},

| | |
|---|---|
| freqDomainPosition | INTEGER (0..67), |
| freqDomainShift | INTEGER (0..268), |
| freqHopping | SEQUENCE { |
| c-SRS | INTEGER (0..63), |
| b-SRS | INTEGER (0..3), |
| b-hop | INTEGER (0..3) |

},

| | |
|---|---|
| groupOrSequenceHopping | ENUMERATED { neither, |

groupHopping, quenceHopping },

| | |
|---|---|
| resourceType | CHOICE { |
| aperiodic | SEQUENCE { |

```
        ...
      },
```

| | |
|---|---|
| semi-persistent | SEQUENCE { |
| periodicityAndOffset-sp | SRS- |

```
PeriodicityAndOffset,
        ...
      },
```

| | |
|---|---|
| periodic | SEQUENCE { |
| periodicityAndOffset-p | SRS- |

```
PeriodicityAndOffset,
        ...
      }
  },
```

| | |
|---|---|
| sequenceId | INTEGER (0..1023), |
| spatialRelationInfo | SRS-SpatialRelationInfo |

OPTIONAL, -- Need R
...
}

In Table 48, configuration information spatialRelationInfo above may be applied, with reference to one reference signal, to a beam used for SRS transmission corresponding to beam information of the corresponding reference signal. For example, configuration of spatialRelationInfo may include information as in Table 49 below.

TABLE 49

| SRS-SpatialRelationInfo ::= | SEQUENCE { |
|---|---|
| servingCellId | ServCellIndex |
| OPTIONAL, -- Need S | |
| referenceSignal | CHOICE { |
| ssb-Index | |
| SSB-Index, | |
| csi-RS-Index | NZP- |

```
CSI-RS-ResourceId,
      srs
SEQUENCE {
          resourceId
SRS-ResourceId,
        uplinkBWP
BWP-Id
    }
  }
}
```

Referring to the above-described spatialRelationInfo configuration, an SS/PBCH block index, CSI-RS index, or SRS index may be configured as the index of a reference signal to be referred to use beam information of a specific reference signal. Upper signaling referenceSignal corresponds to configuration information indicating which reference signal's beam information is to be referred to for corresponding SRS transmission, ssb-Index refers to the index of an SS/PBCH block, csi-RS-Index refers to the index of a CSI-RS, and srs refers to the index of an SRS. If upper signaling referenceSignal has a configured value of “ssb-Index”, the UE may apply the reception beam which was used to receive the SS/PBCH block corresponding to ssb-Index as the transmission beam for the corresponding SRS transmission. If upper signaling referenceSignal has a configured value of “csi-RS-Index”, the UE may apply the reception beam which was used to receive the CSI-RS corresponding to csi-RS-Index as the transmission beam for the corresponding SRS transmission. If upper signaling referenceSignal has a configured value of “srs”, the UE may apply the reception beam which was used to transmit the SRS corresponding to srs as the transmission beam for the corresponding SRS transmission.

### UL Phase Tracking Reference Signal (PTRS)

A UE may configure phaseTrackingRS, which is a higher layer parameter for a PTRS, on a higher layer parameter DMRS-UplinkConfig. When a PUSCH is transmitted to a base station, the UE may transmit the PTRS for tracking a phase regarding an uplink channel. A procedure by which the UE transmits a UL PTRS may be determined based on whether transform precoding is performed during PUSCH transmission. When the transform precoding is performed and a transformPrecoderEnabled field is configured in a higher layer parameter PTRS-UplinkConfig, sampleDensity in the transformPrecoderEnabled field may indicate a sample density threshold indicated by N_{RB0} to N_{RB4} of Table 50 below. When transform precoding is performed and a transformPrecoderEnabled field is configured in a higher layer parameter PTRS-UplinkConfig, the UE may determine a PT-RS group pattern for a resource N_{RB} scheduled in Table 50 below. In addition, when a transform precoder is applied to the PUSCH transmission, the number of bits in a PTRS-DMRS association field for indicating an association between PTRS and DMRS is 0 in DC format 0_1 or 0_2.

TABLE 50

| Scheduled | Number of | Number of samples |
|---|---|---|
| bandwidth | PT-RS groups | per PT-RS group |
| N_{RB0} ≤ N_{RB} < N_{RB1} | 2 | 2 |
| N_{RB1} ≤ N_{RB} < N_{RB2} | 2 | 4 |
| N_{RB2} ≤ N_{RB} < N_{RB3} | 4 | 2 |
| N_{RB3} ≤ N_{RB} < N_{RB4} | 4 | 4 |
| N_{RB4} ≤ N_{RB} | 8 | 4 |

When the transform precoding is not applied to the PUSCH transmission and phaseTrackingRS that is a higher layer parameter is configured, the UE may indicate N_{RB0} to N_{RB1} as frequencyDensity in a transformPrecoderDisabled field in the higher layer parameter PTRS-UplinkConfig and may indicate ptrs-MCS₁ to ptrs-MCS₃ as timeDensity. The UE may determine PT-RS density (L_{PT-RS}) of a time domain and PT-RS density (K_{PT-RS}) of a frequency domain, as described below in Tables 51 and 52, respectively, according to MCS (I_{MCS}) and RB (N_{RB}) of the scheduled PUSCH. In Table 51, although ptrs-MCS₄ is not explicitly stated as a higher layer parameter, the base station and the UE may be aware that ptrs-MCS₄ is 29 or 28 according to a configured MCS table.

TABLE 51

| Scheduled MCS | Time Density (L_{PT-RS}) |
|---|---|
| I_{MCS} < ptrs-MCS₁ | PT-RS is not present |
| ptrs-MCS₁ ≤ I_{MCS} < ptrs-MCS₂ | 4 |
| ptrs-MCS₂ ≤ I_{MCS} < ptrs-MCS₃ | 2 |
| ptrs-MCS₃ ≤ I_{MCS} < ptrs-MCS₄ | 1 |

TABLE 52

| Scheduled bandwidth | Frequency density (K_{PT-RS}) |
|---|---|
| N_{RB} < N_{RB0} | PT-RS is not present |
| N_{RB0} ≤ N_{RB} < N_{RB1} | 2 |
| N_{RB1} ≤ N_{RB} | 4 |

When the transform precoder is not applied to the PUSCH transmission and PTRS-UplinkConfig is configured, the base station may provide, to the UE, an indication of the ‘PTRS-DMRS association’ field of 2 bits so as to indicate the association between the PTRS and DMRS in the DCI format 0_1 or 0_2. The indicated PTRS-DMRS association field of 2 bits may be applied to Table 53 or 54 below according to the maximum number of ports of PTRS configured by maxNrofPorts in the higher layer parameter PTRS-UplinkConfig. When the maximum number of PTRS ports is 1, the UE may determine the association between the PTRS and DMRS as shown in Table 53 and the 2 bits indicated as the PTRS-DMRS association field, and may transmit the PTRS according to the determined association. When the maximum number of PTRS ports is 2, the UE may determine the association between the PTRS and DMRS as shown in Table 54 and the 2 bits indicated as the PTRS-DMRS association field and may transmit the PTRS according to the determined association.

TABLE 53

| Value | DMRS port |
|---|---|
| 0 | 1^{st} scheduled DMRS port |
| 1 | 2^{nd} scheduled DMRS port |
| 2 | 3^{rd} scheduled DMRS port |
| 3 | 4^{th} scheduled DMRS port |

TABLE 54

| Value of | | Value | |
|---|---|---|---|
| MSB | DMRS port | of LSB | DMRS port |
| 0 | 1^{st} DMRS port | 0 | 1^{st} DMRS port |
| | which shares PTRS | | which shares |
| | port 0 | | PTRS port 1 |
| 1 | 2^{nd} DMRS port | 1 | 2^{nd} DMRS port |
| | which shares | | which shares |
| | PTRS port 0 | | PTRS port 1 |

DMRS ports of Tables 53 and 54 may be determined by a table determined by higher layer parameter configuration and ‘Antenna ports’ field indicated by the same DCI as the DCI indicating PTRS-DMRS association. When the transform precoder is not configured via higher configuration of the PUSCH, dmrs-Type is configured to 1 and maxLength is configured to 2 for the DMRS, and a rank of PUSCH is configured to 2, the UE may determine the DMRS port via a bit indicated by the antenna port fields and a table regarding ‘Antenna port(s)’ as Table 55. When a non-codebook-based PUSCH is supported, the UE may determine a value of rank by referring to the SRI field indicated by the same DCI as the DCI including the ‘Antenna ports’ field (i.e., when the SRI field does not exist, the UE may consider rank to be 1). When a codebook-based PUSCH is supported, the UE may determine a value of rank by referring to the TPMI field indicated by the same DCI as the DCI including the ‘Antenna ports’ field.

Table 55 below is the antenna port table being referred to during the PUSCH configuration described above. However, the disclosure is not limited thereto. When the PUSCH has been configured by another parameter, the DMRS port may be determined according to a bit of the ‘Antenna ports’ field indicated by the DCI and the ‘Antenna port’ table according to the configuration.

TABLE 55

| | Number of DMRS | | Number of |
|---|---|---|---|
| | CDM group(s) without | DMRS | front-load |
| Value | data | port(s) | symbols |
| 0 | 1 | 0, 1 | 1 |
| 1 | 2 | 0, 1 | 1 |
| 2 | 2 | 2, 3 | 1 |
| 3 | 2 | 0, 2 | 1 |
| 4 | 2 | 0, 1 | 2 |
| 5 | 2 | 2, 3 | 2 |
| 6 | 2 | 4, 5 | 2 |
| 7 | 2 | 6, 7 | 2 |
| 8 | 2 | 0, 4 | 2 |
| 9 | 2 | 2, 6 | 2 |
| 10-15 | Reserved | Reserved | Reserved |

The 1^{st} scheduled DMRS to 4^{th} scheduled DMRS of Table 53 may be defined as values sequentially mapping DMRS ports indicated by the ‘antenna port’ table according to the higher layer configuration and the bit of the ‘Antenna ports’ field of DCI. For example, when the bits of the ‘Antenna ports’ field of DCI is 0001 and the DMRS ports are determined by referring to Table 55, the scheduled DMRS ports may have a value of 0 and 1, wherein the DMRS port 0 may be defined as 1^{st} scheduled DMRS and the DMRS port 1 may be defined as 2^{nd} scheduled DMRS. This may be similarly applied to a DMRS port determined by a bit of another ‘Antenna ports’ field and an ‘antenna port’ table according to another higher layer configuration. Among the DMRS ports defined as above, the UE may determine one DMRS port to be associated with a PTRS port by referring to a bit indicated by the PTRS-DMRS association in the DCI, and transmits the PTRS according to the determined DMRS port.

In Table 54, a DMRS port sharing a PTRS port 0 and a DMRS port sharing a PTRS port 1 may be defined according to the codebook-based PUSCH transmission or non-codebook-based PUSCH transmission. When the UE transmits the PUSCH based on a partial-coherent or non-coherent codebook, an uplink layer transmitted through PUSCH antenna ports may be associated with the PTRS port 0, and an uplink layer transmitted by PUSCH antenna ports may be associated with the PTRS port 1. More specifically, when layer 3: TPMI=2 is selected for the codebook-based PUSCH transmission, a first layer may be associated with the PTRS port 0 because the first layer is transmitted through the PUSCH antenna ports, and a second layer and a third layer may be associated with the PTRS port 1 because the second layer may be transmitted through the PUSCH antenna port and the third layer may be transmitted through the PUSCH antenna port. The three layers each denote a DMRS port. The DMRS port regarding the first layer may correspond to ‘1^{st} DMRS port which shares PTRS port 0’ in Table 54, the DMRS port regarding the second layer may correspond to ‘1^{st} DMRS port which shares PTRS port 1’ in Table 54, and the DMRS port regarding the third layer may correspond to ‘2^{nd} DMRS port which shares PTRS port 1’ in Table 54. Similarly, the DMRS port associated with the PTRS port 0 and the DMRS port associated with the PTRS port 1 may be determined according to TPMI and the different numbers of layers. When the UE transmits the PUSCH based on a non-codebook, the DMRS port associated with the PTRS port 0 and the DMRS port associated with the PTRS port 1 may be distinguished according to antenna ports and SRI indicated by the DCI.

More specifically, the SRS resource included in the SRS resource set in which the usage is ‘nonCodebook’ may be configured whether the SRS is associated with the PTRS port 0 or the PTRS port 1 by a higher layer parameter ptrs-PortIndex. The base station may indicate the SRS resource for non-codebook-based PUSCH transmission by the SRI. Ports of indicated SRS resources may be mapped to PUSCH DMRS ports in a one-to-one manner. An association between a PUSCH DMRS port and a PTRS port may be determined according to the higher layer parameter ptrs-PortIndex of the SRS resource mapped to the DMRS port. More specifically, when ptrs-PortIndex is configured to be n0, n0, n1, and n1, respectively, for SRS resources 1 to 4 included in the SRS resource set for which the usage is nonCodebook, that the PUSCH is indicated to be transmitted through SRS resources 1, 2, and 4 by SRI, and that DMRS ports 0, 1, and 2 are indicated as antenna port fields. Ports of the SRS resources 1, 2, and 4 are mapped to the DMRS ports 0, 1, and 2, respectively. In addition, the DMRS ports 0 and 1 are associated with the PTRS port 0 and the DMRS port 2 are associated with the PTRS port 1 according to ptrs-PortIndex in the SRS resource.

Accordingly, in Table 54, the DMRS port 0 corresponds to ‘1^{st} DMRS port which shares PTRS port 0’, the DMRS port 1 corresponds to ‘2^{nd} DMRS port which shares PTRS port 0’, and the DMRS port 2 corresponds to ‘1^{st} DMRS port which shares PTRS port 1’. Similarly, the DMRS port associated with the PTRS port 0 and the DMRS port associated with the PTRS port 1 may be determined according to different SRI values and a ptrs-PortIndex configuration method in the SRS resources of different patterns. The UE determines the association between the DMRS port and the PTRS port as described above for two PTRS ports. Thereafter, the UE determines a DMRS port to be associated with the PTRS port 0 by referring to MSB of PTRS-DMRS association, among multiple DMRS ports associated with each PTRS port. The UE determines a DMRS port to be associated with the PTRS port 1 by referring to the LSB and transmits the PTRS.

### PUSCH DMRS

For indications of antenna port fields included within DCI format 0_1 and DCI format 0_2, the antenna port fields within DCI formats 0_1 and 0_2 may be represented by 3, 4, or 5 bits, and may be indicated as shown in Table 56 to Table 71 below.

Table 56 below relates to Antenna port(s), transform precoder is disabled, dmrs-Type=1, maxLength=1, rank=1

TABLE 56

| | Number of DMRS CDM | |
|---|---|---|
| Value | group(s) without data | DMRS port(s) |
| 0 | 1 | 0 |
| 1 | 1 | 1 |
| 2 | 2 | 0 |
| 3 | 2 | 1 |
| 4 | 2 | 2 |
| 5 | 2 | 3 |
| 6-7 | Reserved | Reserved |

Table 57 relates to Antenna port(s), transform precoder is disabled, dmrs-Type=1, maxLength=1, rank=2

TABLE 57

| | Number of DMRS CDM | |
|---|---|---|
| Value | group(s) without data | DMRS port(s) |
| 0 | 1 | 0, 1 |
| 1 | 2 | 0, 1 |
| 2 | 2 | 2, 3 |
| 3 | 2 | 0, 2 |
| 4-7 | Reserved | Reserved |

Table 58 relates to Antenna port(s), transform precoder is disabled, dmrs-Type=1, maxLength=1, rank=3

TABLE 58

| Value | Number of DMRS CDM group(s) without data | DMRS port(s) |
|---|---|---|
| 0 | 2 | 0-2 |
| 1-7 | Reserved | Reserved |

Table 59 relates to Antenna port(s), transform precoder is disabled, dmrs-Type=1, maxLength=1, rank=4

TABLE 59

| Value | Number of DMRS CDM group(s) without data | DMRS port(s) |
|---|---|---|
| 0 | 2 | 0-3 |
| 1-7 | Reserved | Reserved |

Table 60 relates to Antenna port(s), transform precoder is disabled, dmrs-Type=1, maxLength=2, rank=1

TABLE 60

| | Number of DMRS CDM | DMRS | Number of |
|---|---|---|---|
| Value | group(s) without data | port(s) | front-load symbols |
| 0 | 1 | 0 | 1 |
| 1 | 1 | 1 | 1 |
| 2 | 2 | 0 | 1 |
| 3 | 2 | 1 | 1 |
| 4 | 2 | 2 | 1 |
| 5 | 2 | 3 | 1 |
| 6 | 2 | 0 | 2 |
| 7 | 2 | 1 | 2 |
| 8 | 2 | 2 | 2 |
| 9 | 2 | 3 | 2 |
| 10 | 2 | 4 | 2 |
| 11 | 2 | 5 | 2 |
| 12 | 2 | 6 | 2 |
| 13 | 2 | 7 | 2 |
| 14-15 | Reserved | Reserved | Reserved |

Table 61 relates to Antenna port(s), transform precoder is disabled, dmrs-Type=1, maxLength=2, rank=2

TABLE 61

| | Number of DMRS CDM | DMRS | Number of |
|---|---|---|---|
| Value | group(s) without data | port(s) | front-load symbols |
| 0 | 1 | 0, 1 | 1 |
| 1 | 2 | 0, 1 | 1 |
| 2 | 2 | 2, 3 | 1 |
| 3 | 2 | 0, 2 | 1 |
| 4 | 2 | 0, 1 | 2 |
| 5 | 2 | 2, 3 | 2 |
| 6 | 2 | 4, 5 | 2 |
| 7 | 2 | 6, 7 | 2 |
| 8 | 2 | 0, 4 | 2 |
| 9 | 2 | 2, 6 | 2 |
| 10-15 | Reserved | Reserved | Reserved |

Table 62 relates to Antenna port(s), transform precoder is disabled, dmrs-Type=1, maxLength=2, rank=3

TABLE 62

| | Number of DMRS CDM | DMRS | Number of |
|---|---|---|---|
| Value | group(s) without data | port(s) | front-load symbols |
| 0 | 2 | 0-2 | 1 |
| 1 | 2 | 0, 1, 4 | 2 |
| 2 | 2 | 2, 3, 6 | 2 |
| 3-15 | Reserved | Reserved | Reserved |

Table 63 relates to Antenna port(s), transform precoder is disabled, dmrs-Type=1, maxLength=2, rank=4

TABLE 63

| | Number of DMRS CDM | DMRS | Number of |
|---|---|---|---|
| Value | group(s) without data | port(s) | front-load symbols |
| 0 | 2 | 0-3 | 1 |
| 1 | 2 | 0, 1, 4, 5 | 2 |
| 2 | 2 | 2, 3, 6, 7 | 2 |
| 3 | 2 | 0, 2, 4, 6 | 2 |
| 4-15 | Reserved | Reserved | Reserved |

Table 64 relates to Antenna port(s), transform precoder is disabled, dmrs-Type=2, maxLength=1, rank=1

TABLE 64

| Value | Number of DMRS CDM group(s) without data | DMRS port(s) |
|---|---|---|
| 0 | 1 | 0 |
| 1 | 1 | 1 |
| 2 | 2 | 0 |
| 3 | 2 | 1 |
| 4 | 2 | 2 |
| 5 | 2 | 3 |
| 6 | 3 | 0 |
| 7 | 3 | 1 |
| 8 | 3 | 2 |
| 9 | 3 | 3 |
| 10 | 3 | 4 |
| 11 | 3 | 5 |
| 12-15 | Reserved | Reserved |

Table 65 relates to Antenna port(s), transform precoder is disabled, dmrs-Type=2, maxLength=1, rank=2

TABLE 65

| Value | Number of DMRS CDM group(s) without data | DMRS port(s) |
|---|---|---|
| 0 | 1 | 0, 1 |
| 1 | 2 | 0, 1 |
| 2 | 2 | 2, 3 |
| 3 | 3 | 0, 1 |
| 4 | 3 | 2, 3 |
| 5 | 3 | 4, 5 |
| 6 | 2 | 0, 2 |
| 7-15 | Reserved | Reserved |

Table 66 relates to Antenna port(s), transform precoder is disabled, dmrs-Type=2, maxLength=1, rank=3

TABLE 66

| Value | Number of DMRS CDM group(s) without data | DMRS port(s) |
|---|---|---|
| 0 | 2 | 0-2 |
| 1 | 3 | 0-2 |
| 2 | 3 | 3-5 |
| 3-15 | Reserved | Reserved |

Table 67 relates to Antenna port(s), transform precoder is disabled, dmrs-Type=2, maxLength=1, rank=4

TABLE 67

| Value | Number of DMRS CDM group(s) without data | DMRS port(s) |
|---|---|---|
| 0 | 2 | 0-3 |
| 1 | 3 | 0-3 |
| 2-15 | Reserved | Reserved |

Table 68 relates to Antenna port(s), transform precoder is disabled, dmrs-Type=2, maxLength=2, rank=1

TABLE 68

| | Number of DMRS | | Number of |
|---|---|---|---|
| | CDM group(s) | DMRS | front-load |
| Value | without data | port(s) | symbols |
| 0 | 1 | 0 | 1 |
| 1 | 1 | 1 | 1 |
| 2 | 2 | 0 | 1 |
| 3 | 2 | 1 | 1 |
| 4 | 2 | 2 | 1 |
| 5 | 2 | 3 | 1 |
| 6 | 3 | 0 | 1 |
| 7 | 3 | 1 | 1 |
| 8 | 3 | 2 | 1 |
| 9 | 3 | 3 | 1 |
| 10 | 3 | 4 | 1 |
| 11 | 3 | 5 | 1 |
| 12 | 3 | 0 | 2 |
| 13 | 3 | 1 | 2 |
| 14 | 3 | 2 | 2 |
| 15 | 3 | 3 | 2 |
| 16 | 3 | 4 | 2 |
| 17 | 3 | 5 | 2 |
| 18 | 3 | 6 | 2 |
| 19 | 3 | 7 | 2 |
| 20 | 3 | 8 | 2 |
| 21 | 3 | 9 | 2 |
| 22 | 3 | 10 | 2 |
| 23 | 3 | 11 | 2 |
| 24 | 1 | 0 | 2 |
| 25 | 1 | 1 | 2 |
| 26 | 1 | 6 | 2 |
| 27 | 1 | 7 | 2 |
| 28-31 | Reserved | Reserved | Reserved |

Table 69 relates Antenna port(s), transform precoder is disabled, dmrs-Type=2, maxLength=2, rank=2

TABLE 69

| | Number of DMRS CDM | DMRS | Number of |
|---|---|---|---|
| Value | group(s) without data | port(s) | front-load symbols |
| 0 | 1 | 0, 1 | 1 |
| 1 | 2 | 0, 1 | 1 |
| 2 | 2 | 2, 3 | 1 |
| 3 | 3 | 0, 1 | 1 |
| 4 | 3 | 2, 3 | 1 |
| 5 | 3 | 4, 5 | 1 |
| 6 | 2 | 0, 2 | 1 |
| 7 | 3 | 0, 1 | 2 |
| 8 | 3 | 2, 3 | 2 |
| 9 | 3 | 4, 5 | 2 |
| 10 | 3 | 6, 7 | 2 |
| 11 | 3 | 8, 9 | 2 |
| 12 | 3 | 10, 11 | 2 |
| 13 | 1 | 0, 1 | 2 |
| 14 | 1 | 6, 7 | 2 |
| 15 | 2 | 0, 1 | 2 |
| 16 | 2 | 2, 3 | 2 |
| 17 | 2 | 6, 7 | 2 |
| 18 | 2 | 8, 9 | 2 |
| 19-31 | Reserved | Reserved | Reserved |

Table 70 relates to Antenna port(s), transform precoder is disabled, dmrs-Type=2, maxLength=2, rank=3

TABLE 70

| | Number of DMRS | | Number |
|---|---|---|---|
| | CDM group(s) | DMRS | of front-load |
| Value | without data | port(s) | symbols |
| 0 | 2 | 0-2 | 1 |
| 1 | 3 | 0-2 | 1 |
| 2 | 3 | 3-5 | 1 |
| 3 | 3 | 0, 1, 6 | 2 |
| 4 | 3 | 2, 3, 8 | 2 |
| 5 | 3 | 4, 5, 10 | 2 |
| 6-31 | Reserved | Reserved | Reserved |

Table 71 relates to Antenna port(s), transform precoder is disabled, dmrs-Type=2, maxLength=2, rank=4

TABLE 71

| | Number of DMRS | | Number |
|---|---|---|---|
| | CDM group(s) | DMRS | of front-load |
| Value | without data | port(s) | symbols |
| 0 | 2 | 0-3 | 1 |
| 1 | 3 | 0-3 | 1 |
| 2 | 3 | 0, 1, 6, 7 | 2 |
| 3 | 3 | 2, 3, 8, 9 | 2 |
| 4 | 3 | 4, 5, 10, 11 | 2 |
| 5-31 | Reserved | Reserved | Reserved |

Table 56 to Table 59 are used when dmrs-type is specified as 1 and maxLength is specified as 1.

Table 60 to Table 63 are used when dmrs-Type=1 and maxLength=2.

Table 64 to Table 67 are used when dmrs-type=2 and maxLength=1.

Table 68 to Table 71 are used when drms-type is 2 and maxLength is 2.

For DCI format 0_1, if the UE has been configured with both the higher layer signaling dmrs-UplinkForPUSCH-MappingTypeA and dmrs-UplinkForPUSCH-MappingTypeB, the bit length of the antenna port field in DCI format 0_1 may be determined as max(x−_{A}, x_{B}), where x_{A} and x_{B} may signify the bit lengths of the antenna port field determined by dmrs-UplinkForPUSCH-MappingTypeA and dnrs-UplinkForPUSCH-MappingTypeB, respectively. If a PUSCH mapping type corresponding to the smaller one of x_{A} and x_{B} is scheduled, as many MSB bits as |x_{A}−x_{B}| may be allocated as 0 bits and transmitted.

For DCI format 0_2, if the UE has not been configured with the higher layer signaling antennaPortsFieldPresenceDCI-0-2, the corresponding DCI format 0_2 may not have an antenna port field. In other words, the length of the antenna port field may be 0 bits in this case, and the UE may determine a DMRS port assuming the 0th entry of Table 56 to Table 71. If the UE has been configured with the higher layer signaling antennaPortsFieldPresenceDCI-0-2, the bit length of the antenna port field in DCI format 0_2 may be determined similarly to DCI format 0_1 described above. If the UE has been configured with both the higher layer signaling dmrs-UplinkForPUSCH-MappingTypeA-DCI-0-2 and dmrs-UplinkForPUSCH-MappingTypeB-DCI-0-2, the bit length of the antenna port field in DCI format 02 may be determined as max(x-A, x_{B}), where x_{A} and x_{B} may denote the bit lengths of the antenna port field determined by dmrs-UplinkForPUSCH-MappingTypeA-DCI-0-2 and dmrs-UplinkForPUSCH-MappingTypeB-DCI-0-2, respectively. When a PDSCH mapping type corresponding to the smaller one of x_{A} and x_{B} is scheduled, as many MSB bits as |x_{A}−x_{B}| may be allocated as 0 bits and transmitted.

In Table 56 to Table 71, the numbers 1, 2, and 3 indicated by the number of DMRS CDM group(s) without data refer to CDMR groups {0}, {0, 1}, and {0, 1, 2}, respectively. In the “DMRS port(s)” column, indexes of ports being used are arranged according to the sequence of the indexes, and the antenna port is indicated by (DMRS port+1000). The DMRS CDM group is associated with a method of generating the DMRS sequence and the antenna port, as shown in Table 72 and Table 73 below.

TABLE 72

| | | |
|---|---|---|
| CDM | w_{f} (k′) | wₜ (l′) |

| \tilde{p} | group λ | Δ | k′ = 0 | k′ = 1 | l′ = 0 | l′ = 1 |
|---|---|---|---|---|---|---|
| 0 | 0 | 0 | +1 | +1 | +1 | +1 |
| 1 | 0 | 0 | +1 | −1 | +1 | +1 |
| d2 | 1 | 1 | +1 | +1 | +1 | +1 |
| 3 | 1 | 1 | +1 | −1 | +1 | +1 |
| 4 | 0 | 0 | +1 | +1 | +1 | −1 |
| 5 | 0 | 0 | +1 | −1 | +1 | −1 |
| 6 | 1 | 1 | +1 | +1 | +1 | −1 |
| 7 | 1 | 1 | +1 | −1 | +1 | −1 |

TABLE 73

| | | |
|---|---|---|
| CDM | w_{f} (k′) | wₜ (l′) |

| \tilde{p} | group λ | Δ | k′ = 0 | k′ = 1 | l′ = 0 | l′ = 1 |
|---|---|---|---|---|---|---|
| 0 | 0 | 0 | +1 | +1 | +1 | +1 |
| 1 | 0 | 0 | +1 | −1 | +1 | +1 |
| 2 | 1 | 2 | +1 | +1 | +1 | +1 |
| 3 | 1 | 2 | +1 | −1 | +1 | +1 |
| 4 | 2 | 4 | +1 | +1 | +1 | +1 |
| 5 | 2 | 4 | +1 | −1 | +1 | +1 |
| 6 | 0 | 0 | +1 | +1 | +1 | −1 |
| 7 | 0 | 0 | +1 | −1 | +1 | −1 |
| 8 | 1 | 2 | +1 | +1 | +1 | −1 |
| 9 | 1 | 2 | +1 | −1 | +1 | −1 |
| 10 | 2 | 4 | +1 | +1 | +1 | −1 |
| 11 | 2 | 4 | +1 | −1 | +1 | −1 |

Table 72 shows parameters in the case of using dmrs-type=l and Table 73 shows parameters in the case of using dmrs-type=2.

The sequence of DMRS according to each parameter is determined by Equation (11) below, in which \tilde{p} denotes a DMRS port, k denotes a subcarrier index, l denotes an OFDM symbol index, p denotes a subcarrier spacing, and w_{f}(k′) and wₜ(l′) denote a frequency domain orthogonal cover code (FD-OCC) coefficient and a time domain orthogonal cover code (TD-OCC) coefficient according to the values of k′ and l′, respectively, Δ is a value representing a spacing between CDM groups in terms of the number of subcarriers, and β_{PUSCH}^{DMRS} is a scaling factor, which refers to a ratio between the energy per RE (EPRE) of PUSCH and the EPRE of DMRS, and may be calculated as

$${β}_{PUSCH}^{DMRS} = {10}^{- \frac{{β}_{DMRS}}{20}} ,$$

where β_{DMRS} may have a value of 0 dB, −3 dB, and −4.77 dB depending on the number 1, 2, and 3 of CDM groups.

$${\tilde{a}}_{k , l}^{( {p}_{j} , μ )} = {w}_{f} ( {k}^{′} ) {w}_{t} ( {l}^{′} ) r ( 2 n + {k}^{′} ) \qquad ( 11 )$$

$$k = \{ \begin{matrix}4 n + 2 {k}^{′} + Δ & Configuration type 1 \\ 6 n + {k}^{′} + Δ & Configuration type 2\end{matrix}$$

$${k}^{′} = 0 , 1$$

$$l = \overline{l} + {l}^{′}$$

$$n = 0 , 1 , …$$

$$j = 0 , 1 , … , v - 1$$

$$[ \begin{matrix}{a}_{k , l}^{( {p}_{o , μ} )} \\ ⋮ \\ {a}_{k , l}^{( {p}_{p - 1} , μ )}\end{matrix} ] = {β}_{PUSCH}^{DMRS} W [ \begin{matrix}{\tilde{a}}_{k , i}^{( {p}_{o} , μ )} \\ ⋮ \\ {\tilde{a}}_{k , l}^{( {p}_{v - 1} , μ )}\end{matrix} ]$$

If frequency hopping is not used, the UE should assume that the higher layer signaling, dmrs-AdditionalPosition, is configured as ‘pos2’ and a maximum of two additional DMRS symbols may be used for PUSCH transmission. If frequency hopping is used, the UE should assume that the higher layer signaling, dmrs-AdditionalPosition, is configured as ‘pos1’, and a maximum of one additional DMRS symbol may be used for PUSCH transmission.

In the PUSCH scheduled in DCI formats 0_1 and 0_2, the UE may assume that the CDM groups indicated by the column “Number of DMRS CDM group(s) without data” in Table 56 to Table 71 may include DMRS ports assigned to other UEs that may be co-scheduled via a multi-user MIMO scheme and may not be used for data transmission by the corresponding UE. In Table 56 to Table 71, the values of 1, 2, and 3 indicated by the column “Number of DMRS CDM group(s) without data” may be understood as meaning that the indexes of the CDM groups corresponding to the values correspond to CDM groups 0, {0,1}, and {0,1,2}, respectively.

### UE Capability Report

In LTE and NR, a UE may perform a procedure in which, while being connected to a serving base station, the UE reports capability supported by the UE to the corresponding base station, in a UE capability report.

The base station may transfer a UE capability enquiry message to the UE in a connected state so as to request a capability report. The message may include a UE capability request with regard to each radio access technology (RAT) type of the base station. The RAT type-specific request may include supported frequency band combination information and the like. In the UE capability enquiry message, UE capability with regard to multiple RAT types may be requested through one RRC message container transmitted by the base station, or the base station may transfer a UE capability enquiry message including multiple UE capability requests with regard to respective RAT types. That is, a capability enquiry may be repeated multiple times in one message, and the UE may configure a UE capability information message corresponding thereto and report the same multiple times. In next-generation mobile communication systems, a UE capability request may be made regarding multi-RAT dual connectivity (MR-DC), such as NR, LTE, E-UTRA—NR dual connectivity (EN-DC). The UE capability enquiry message may be transmitted initially after the UE is connected to the base station, but may be requested in any condition if needed by the base station.

Upon receiving the UE capability report request from the base station in the above step, the UE configures UE capability according to band information and RAT type requested by the base station. The method in which the UE configures UE capability in an NR system is summarized below.

1. If the UE receives a list regarding LTE and/or NR bands from the base station at a UE capability request, the UE constructs band combinations (BCs) regarding EN-DC and NR standalone (SA). That is, the UE configures a candidate list of BCs regarding EN-DC and NR SA, based on bands received from the base station at a request through FreqBandList. Bands have priority in the order described in FreqBandList.

2. If the base station sets “eutra-nr-only” flag or “eutra” flag and requests a UE capability report, the UE removes everything related to NR SA BCs from the configured BC candidate list. Such an operation may occur only if an LTE base station (eNB) requests “eutra” capability.

3. The UE then removes fallback BCs from the BC candidate list configured in the above step. As used herein, a fallback BC refers to a BC that can be obtained by removing a band corresponding to at least one SCell from a specific BC, and since a BC before removal of the band corresponding to at least one SCell can already cover a fallback BC, the same may be omitted. This step is applied in MR-DC as well as LTE bands. BCs remaining after the above step constitute the final “candidate BC list”.

4. The UE selects BCs appropriate for the requested RAT type from the final “candidate BC list” and configures BCs to report. In this step, the UE configures supportedBandCombinationList in a determined order. That is, the UE configures BCs and UE capability to report according to a preconfigured rat-Type order. (nr->eutra-nr->eutra).→(nr->eutra-nr->eutra). In addition, the UE configures featureSetCombination regarding the configured supportedBandCombinationList and configures a list of “candidate feature set combinations” from a candidate BC list from which a list regarding fallback BCs (including capability of the same or lower step) is removed. The “candidate feature set combinations” may include all feature set combinations regarding NR and EUTRA-NR BCs and may be acquired from feature set combinations of containers of UE-NR-Capabilities and UE-MRDC-Capabilities.

5. If the requested RAT type is eutra-nr and has an influence, featureSetCombinations is included on both containers of UE-MRDC-Capabilities and UE-NR-Capabilities. However, the feature set of NR is included only in UE-NR-Capabilities.

After the UE capability is configured, the UE transfers a UE capability information message including the UE capability to the base station. The base station performs scheduling and transmission/reception management appropriate for the UE, based on the UE capability received from the UE.

mTRP

### Related to NC-JT

FIG. 17 illustrates a configuration of antenna ports and a resource allocation for transmitting a PDSCH using cooperative communication in a wireless communication system according to an embodiment.

Referring to FIG. 17, the example for PDSCH transmission is described for each JT scheme and examples for allocating radio resources for each TRP are described.

An example 1710 of coherent joint transmission (C-JT) supporting coherent precoding between respective cells, TRPs, and/or beams is also illustrated.

In the case of C-JT, a TRP A 1705 and a TRP B 1710 transmit single PDSCH data to a UE 1715, and the plurality of TRPs may perform joint precoding. This may signify that the TRP A 1705 and a TRP B 1710 transmit DMRSs through the same DMRS ports to transmit the same PDSCH. For example, the TRP A 1705 and a TRP B 1710 may transmit DMRSs to the UE through a DMRS port A 1725 and a DMRS port B 1730, respectively. In this case, the UE may receive one piece of DCI information for receiving one PDSCH demodulated based on the DMRSs transmitted through the DMRS port A 1725 and the DMRS port B 1730.

FIG. 17 shows an example 1720 of NC-JT that supports non-coherent precoding between each cell, TRP or/and beam for PDSCH transmission.

In the NC-JT, the PDSCH is transmitted to a UE 1735 per cell, per TPR, and/or per beam, and individual precoding may be applied to each PDSCH. Respective cells, TRPs, and/or beams may transmit different PDSCHs or different PDSCH layers to the UE, thereby improving throughput compared to single cell, TRP, and/or beam transmission. Respective cells, TRPs, and/or beams may repeatedly transmit the same PDSCH to the UE, thereby improving reliability compared to single cell, TRP, and/or beam transmission. For convenience of description, the cell, TRP, and/or beam are commonly called a TRP.

In this case, various wireless resource allocations such as the case 1740 in which frequency and time resources used by a plurality of TRPs for PDSCH transmission are all the same, the case 1745 in which frequency and time resources used by a plurality of TRPs do not overlap at all, and the case 1750 in which some of the frequency and time resources used by a plurality of TRPs overlap each other may be considered.

To support NC-JT, DCIs in various forms, structures, and relations may be considered to simultaneously allocate a plurality of PDSCHs to one UE.

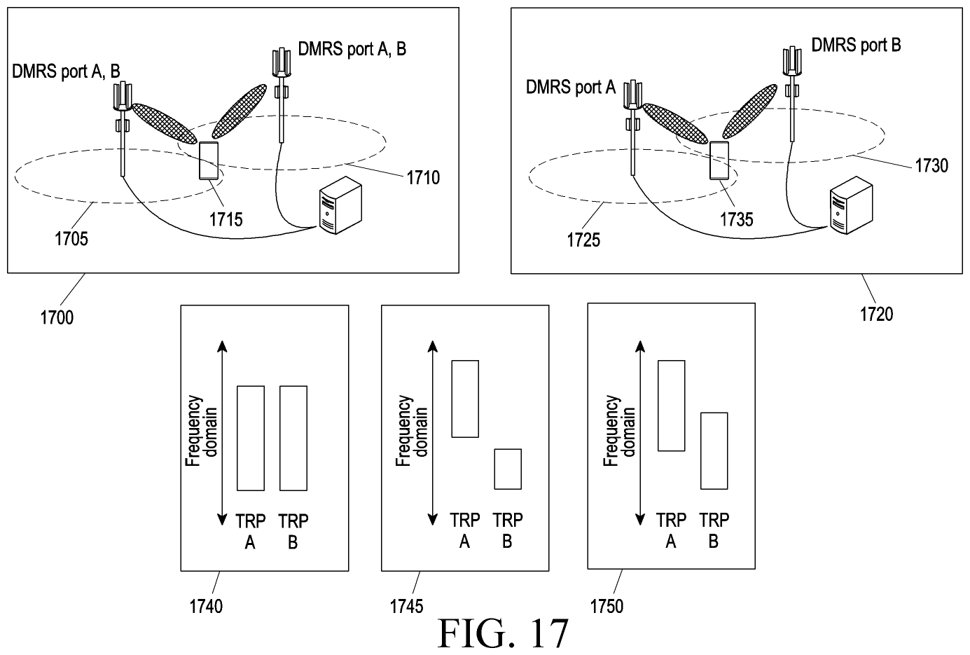

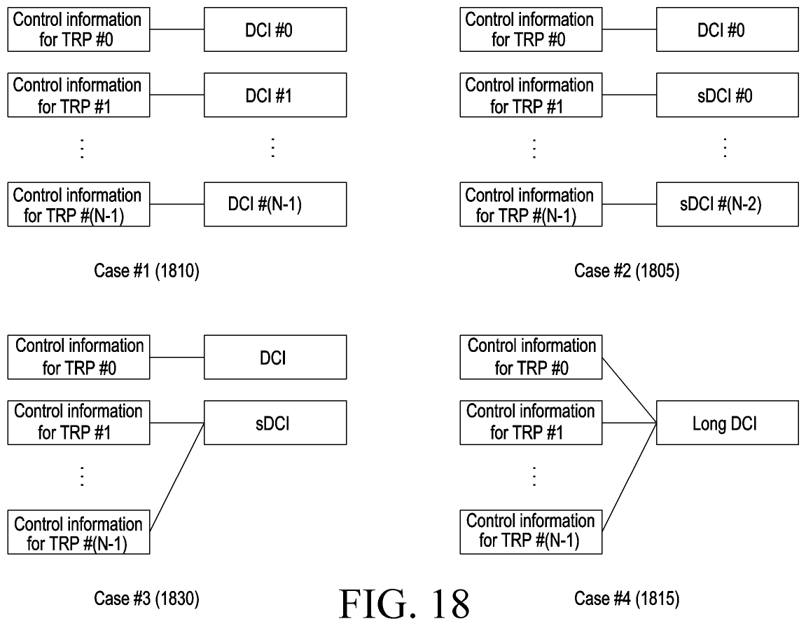

FIG. 18 illustrates an example for a configuration of DCI for NC-JT in which respective TRPs transmit different PDSCHs or different PDSCH layers to the UE in a wireless communication system according to an embodiment.

Referring to FIG. 18, case #1 1810 is an example in which control information for PDSCHs transmitted from (N−1) additional TRPs is transmitted independently from control information for a PDSCH transmitted from a serving TRP when (N−1) different PDSCHs are transmitted from the (N−1) additional TRPs (TRP #1 to TRP #(N−1)) other than the serving TRP (TRP #0) used for single PDSCH transmission. That is, the UE may acquire control information for PDSCHs transmitted from different TRPs (TRP #0 to TRP #(N−1)) through independent DCIs (DC1 #0 to DCI #(N−1)). Formats between the independent DCIs may be the same as or different from each other, and payload between the DCIs may also be the same as or different from each other. In case #1, a degree of freedom of PDSCH control or allocation may be completely guaranteed, but when respective pieces of the DCI are transmitted by different TRPs, a difference between DCI coverages may be generated and reception performance may deteriorate.

Case #2 1805 is an example in which pieces of control information for PDSCHs of (N−1) additional TRPs are transmitted and each piece of the DCI is dependent on control information for the PDSCH transmitted from the serving TRP when (N−1) different PDSCHs are transmitted from (N−1) additional TRPs (TRP #1 to TRP #(N−1)) other than the serving TRP (TRP #0) used for single PDSCH transmission.

For example, DCI #0 that is control information for a PDSCH transmitted from the serving TRP (TRP #0) may include all information elements of DCI format 1_0, DCI format 1_1, and DCI format 1_2, but shortened DCIs (hereinafter, sDCIs) (sDCI #0 to sDCI #(N−2)) that are control information for PDSCHs transmitted from the cooperative TRPs (TRP #1 to TRP #(N−1)) may include only some of the information elements of DCI format 10, DCI format 1_1, and DCI format 1_2. Accordingly, the sDCI for transmitting control information of PDSCHs transmitted from cooperative TPRs has smaller payload compared to the normal DCI (nDCI) for transmitting control information related to the PDSCH transmitted from the serving TRP, and thus can include reserved bits compared to the nDCI.

In case #2 1805, a degree of freedom of each PDSCH control or allocation may be limited according to content of information elements included in the sDCI, but reception capability of the sDCI is better than the nDCI, and thus a probability of the generation of difference between DCI coverages may become lower.

Case #3 1830 is an example in which one piece of control information for PDSCHs of (N−1) additional TRPs is transmitted and the DCI is dependent on control information for the PDSCH transmitted from the serving TRP when (N−1) different PDSCHs are transmitted from (N−1) additional TRPs (TRP #1 to TRP #(N−1)) other than the serving TRP (TRP #0) used for single PDSCH transmission.

For example, in the case of DCI #0 that is control information for the PDSCH transmitted from the serving TRP (TRP #0), all information elements of DCI format 1_0, DCI format 1_1, and DCI format 1_2 may be included, and in the case of control information for PDSCHs transmitted from cooperative TRPs (TRP #1 to TRP #(N−1)), only some of the information elements of DCI format 1_0, DCI format 1_1, and DCI format 12 may be gathered in one “secondary” DCI (sDCI) and transmitted. For example, the sDCI may include at least one piece of HARQ-related information such as frequency domain resource assignment and time domain resource assignment of the cooperative TRPs and the MCS. Information that is not included in the sDCI such as a BWP indicator and a carrier indicator may follow the DCI (DCI #0, normal DCI, or nDCI) of the serving TRP.

In case #3 1830, a degree of freedom of PDSCH control or allocation may be limited according to content of the information elements included in the sDCI but reception performance of the sDCI can be controlled, and case #3 1830 may have less complexity of DCI blind decoding of the UE compared to case #1 1810 or case #2 1805.

Case #4 1815 is an example in which control information for PDSCHs transmitted from (N−1) additional TRPs is transmitted in the long DCI that is the same as that of control information for the PDSCH transmitted from the serving TRP when different (N−1) PDSCHs are transmitted from the (N−1) additional TRPs (TRP #1 to TRP #(N−1)) other than the serving TRP (TRP #0) used for single PDSCH transmission. That is, the UE may acquire control information for PDSCHs transmitted from different TRPs (TRP #0 to TRP #(N−1)) through single DCI. In case #4 1815, complexity of DCI blind decoding of the UE may not be increased, but a degree of freedom of PDSCH control or allocation may be low since the number of cooperative TRPs is limited according to long DCI payload restriction.

Herein, sDCI may refer to various pieces of supplementary DCI such as shortened DCI, secondary DCI, or normal DCI (DCI formats 1_0 and 1_1) including PDSCH control information transmitted in the cooperative TRP, and unless specific restriction is mentioned, the corresponding description may be similarly applied to the various pieces of supplementary DCI.

In FIG. 18, Case #1 1810, case #2 1805, and case #3 1830 in which one or more pieces of DCI (or PDCCHs) are used to support NC-JT may be classified as multiple PDCCH-based NC-JT, and case #4 1815 in which single DCI (or PDCCH) is used to support NC-JT may be classified as single PDCCH-based NC-JT.

In multiple PDCCH-based PDSCH transmission, a CORESET for scheduling the DCI of the serving TRP (TRP #0) is separated from CORESETs for scheduling the DCI of cooperative TRPs (TRP #1 to TRP #(N−1)). A method of distinguishing the CORESETs may include a distinguishing method through a higher-layer indicator for each CORESET and a distinguishing method through a beam configuration for each CORESET. In single PDCCH-based NC-JT, single DCI schedules a single PDSCH having a plurality of layers instead of scheduling a plurality of PDSCHs, and the plurality of layers may be transmitted from a plurality of TRPs. In this case, association between a layer and a TRP transmitting the corresponding layer may be indicated through a transmission configuration indicator (TCI) indication for the layer.

Herein, the expression cooperative TRP may be replaced by a cooperative panel or a cooperative beam when actually applied.

In addition, when NC-JT is applied may be variously interpreted as when the UE simultaneously receives one or more PDSCHs in one BWP, when the UE simultaneously receives PDSCHs based on two or more transmission configuration indicator (TCI) indications in one BWP, and when the PDSCHs received by the UE are associated with one or more DMRS port groups according to circumstances, but one expression may be used for convenience of description.

A wireless protocol structure for NC-JT may be variously used herein according to a TRP development scenario. For example, when there is no backhaul delay between cooperative TRPs or there is a small backhaul delay, a method (a CA-like method) using a structure based on MAC layer multiplexing can be used similarly to reference numeral S10 of FIG. 4. However, when the backhaul delay between cooperative TRPs is too large to be disregarded (for example, when a time of 2 ms or longer is needed to exchange information such as CSI, scheduling, and HARQ-ACK between cooperative TRPs), a DC-like method of securing a characteristic robust to a delay can be used through an independent structure for each TRP from an RLC layer similarly to reference numeral S20 of FIG. 4.

The UE supporting C-JT/NC-JT may receive a C-JT/NC-JT-related parameter or a setting value from a higher-layer configuration and set an RRC parameter of the UE based on the same. For the higher-layer configuration, the UE may use a UE capability parameter, for example, tci-StatePDSCH. The UE capability parameter, for example, tci-StatePDSCH may define TCI states for PDSCH transmission, the number of TCI states may be configured as 4, 8, 16, 32, 64, and 128 in FR1 and as 64 and 128 in FR2, and a maximum of 8 states which can be indicated by 3 bits of a TCI field of the DCI may be configured through a MAC CE message among the configured numbers. A maximum value 128 refers to a value indicated by maxNumberConfiguredTCIstatesPerCC within the parameter tci-StatePDSCH which is included in capability signaling of the UE. As described above, a series of configuration processes from the higher-layer configuration to the MAC CE configuration may be applied to a beamforming indication or a beamforming change command for at least one PDSCH in one TRP.

### Multi-DCI Based Multi-TRP

According to multi-DCI based multi-TRP transmission method, a downlink control channel for NC-JT may be configured based on multi-PDCCHs.

In NC-JT based on multiple PDCCHs, there may be a CORESET or a search space separated for each TRP when the DCI for scheduling the PDSCH of each TRP is transmitted. The CORESET or the search space for each TRP can be configured according to at least one of the following configuration cases.

CORESET configuration information configured by a higher layer may include an index value, and a TRP for transmitting a PDCCH in the corresponding CORESET may be distinguished by the configured index value for each CORESET. That is, in a set of CORESETs having the same higher-layer index value, it may be considered that the same TRP transmits the PDCCH or that the PDCCH for scheduling the PDSCH of the same TRP is transmitted. The index for each CORESET may be referred to as CORESETPoolIndex, and it may be considered that the PDCCH is transmitted from the same TRP in CORESETs in which the same CORESETPoolIndex value is configured. In the CORESET in which the same CORESETPoolIndex value is not configured, it may be considered that a default value of CORESETPool Index is configured, and the default value may be 0.

When the number of types of CORESETPoolIndex of each of a plurality of CORESETs included in higher-layer signaling PDCCH-Config is larger than 1, that is, when respective CORESETs have different CORESETPoolIndex, the UE may consider that the base station can use a multi-DCI-based multi-TRP transmission method.

In contrast, when the number of types of CORESETPoolIndex of each of a plurality of CORESETs included in higher-layer signaling PDCCH-Config is 1, that is, when all CORESETs have the same CORESETPoolIndex of 0 or 1, the UE may consider that the base station performs transmission using a single-TRP instead of using the multi-DCI-based multi-TRP transmission method.

A plurality of PDCCH-Config is configured in one BWP, and each PDCCH-Config may include a PDCCH configuration for each TRP. That is, a list of CORESETs for each TRP and/or a list of search spaces for each TRP may be included in one PDCCH-Config, and it may be considered that one or more CORESETs and one or more search spaces included in one PDCCH-Config correspond to a specific TRP.

A TRP that corresponds to the corresponding CORESET may be distinguished through a beam or a beam group configured for each CORESET. For example, when the same TCI state is configured in a plurality of CORESETs, it may be considered that the corresponding CORESETs are transmitted through the same TRP or that a PDCCH for scheduling a PDSCH of the same TRP are transmitted in the corresponding CORESET.

A beam or a beam group is configured for each search space, and a TRP for each search space may be distinguished therethrough. For example, when the same beam/beam group or TCI state is configured in a plurality of search spaces, the same TRP may transmit the PDCCH in the corresponding search space or a PDCCH for scheduling a PDSCH of the same TRP may be transmitted in the corresponding search space.

As described above, by separating the CORESETs or search spaces for each TRP, it is possible to divide PDSCHs and HARQ-ACK for each TRP and accordingly to generate an independent HARQ-ACK codebook for each TRP and use an independent PUCCH resource.

The configuration may be independent for each cell or BWP. For example, while two different CORESETPool Index values may be configured in the primary cell (PCell), no CORESETPoolIndex value may be configured in a specific SCell. In this case, NC-JT may be configured in the PCell, but NC-JT may not be configured in the SCell in which no CORESETPoolIndex value is configured.

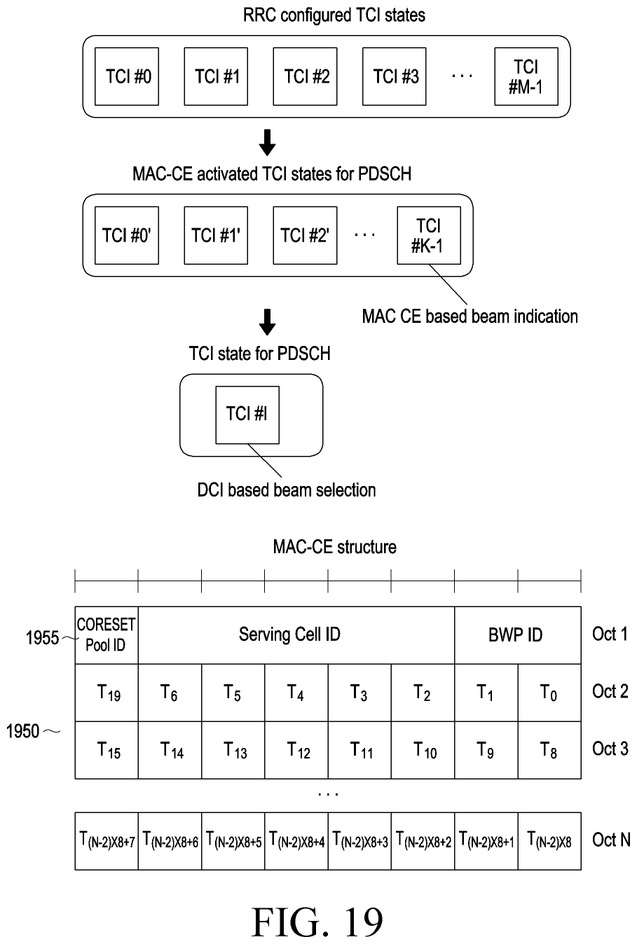

FIG. 19 illustrates a process for beam configuration and activation with regard to a PDSCH according to an embodiment.

Referring to FIG. 19, a PDSCH TCI state activation/deactivation MAC-CE which can be applied to the multi-DCI-based multi-TRP transmission method is provided. When the UE does not receive a configuration of CORESETPoolIndex for each of all CORESETs within higher-layer signaling PDCCH-Config, the UE may disregard a CORESET Pool ID field 1955 within a corresponding MAC-CE 1950. When the UE can support the multi-DCI-based multi-TRP transmission method, that is, when respective CORESETs within higher-layer signaling PDCCH-Config have different CORESETPoolIndex, the UE may activate a TCI state within the DCI included in PDCCHs transmitted in CORESETs having CORESETPoolIndex which is the same as a value of a CORESET Pool ID field 1955 within the corresponding MAC-CE 1950. For example, when the CORESET Pool ID field 1955 within the corresponding MAC-CE 1950 has a value of 0, a TCI state within the DCI included in PDCCHs transmitted by the CORESETs having CORSETPoolIndexof 0 may follow activation information of the corresponding MAC-CE.

When the UE receives a configuration indicating that the multi-DCI-based multi-TRP transmission method can be used from the base station, that is, the number of types of CORESETPoolIndex of a plurality of CORESETs included in higher-layer signaling PDCCH-Config is larger than 1 or respective CORESETs have different CORESETPoolIndex, the UE is able to know that the following restrictions on PDSCHs scheduled by PDCCHs within respective CORESETs having different two CORESETPoolIndex are in place.

1) When PDSCH indicated by PDCCHs within respective CORESETs having different two CORESETPoolIndex completely or partially overlap, the UE may apply TCI states indicated by the respective PDCCHs to different CDM groups. That is, two or more TCI states may not be applied to one CDM group

2) When PDSCH indicated by PDCCHs within respective CORESETs having different two CORESETPoolIndex completely or partially overlap, the UE may expect that the numbers of actual front loaded DMRS symbols of respective PDSCHs, the numbers of actual additional DMRS symbols, locations of actual DMRS symbols, and DMRS types are not different.

3) The UE may expect that BWPs indicated by PDCCHs within respective CORESETs having different two CORESETPool Index are identical and subcarrier spacings are also identical.

4) The UE may expect that information on PDSCH scheduled by PDCCHs within respective CORESETs having different two CORESETPoolIndex are completely included in respective PDCCHs.

### Single-DCI Based Multi-TRP

The single-DCI-based multi-TRP transmission method may configure a downlink control channel for NC-JT based on a single PDCCH.

In a single-DCI-based multi-TRP transmission method, a PDSCH transmitted from a plurality of TRPs may be scheduled by one piece of the DCI. As a method of indicating the number of TRPs transmitting the corresponding PDSCHs, the number of TCI states may be used. That is, when the number of TCI states indicated by the DCI for scheduling the PDSCHs is 2, single PDCCH-based NC-JT transmission may be considered, and single-TRP transmission may be considered when the number of TCI states is 1. The TCI states indicated by the DCI may correspond to one or two TCI states among TCI states activated by the MAC CE. When the TCI states of the DCI correspond to two TCI states activated by the MAC CE, a TCI codepoint indicated by the DCI is associated with the TCI states activated by the MAC CE, which corresponds to when the number of TCI states activated by the MAC CE, corresponding to the TCI codepoint, is 2.

Alternatively, when at least one of all codepoints of the TCI state field within the DCI indicate two TCI states, the UE may consider that the base station can perform transmission based on the single-DCI-based multi-TRP method. In this case, at least one codepoint indicating two TCI states within the TCI state field may be activated through an enhanced PDSCH TCI state activation/deactivation MAC-CE.

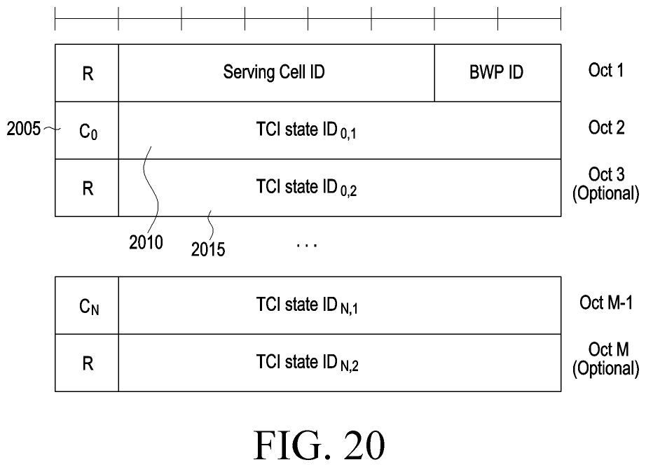

FIG. 20 illustrates an enhanced PDSCH TCI state activation/deactivation MAC-CE structure according to an embodiment. Each field within the MAC CE and a value configurable in each field are as described in Table 74 below.

TABLE 74

```
  - Serving Cell ID: This field indicates the
identity of the Serving Cell for which the
MAC CE applies. The length of the field is 5
bits. If the indicated Serving Cell is configured
as part of a simultaneousTCI-UpdateList1 or
simultaneousTCI-UpdateList2 as specified in
TS 38.331 [5], this MAC CE applies to all
the Serving Cells configured in the set
simultaneousTCI-UpdateList1 or
simultaneousTCI-UpdateList2, respectively;
  - BWP ID: This field indicates a DL BWP
for which the MAC CE applies as the
codepoint of the DCI bandwidth part indicator
field as specified in TS 38.212 [9]. The length
of the BWP ID field is 2 bits;
  - Cᵢ: This field indicates whether the octet
containing TCI state ID_{i,2} is present. If this
field is set to “1”, the octet containing TCI state
ID_{i,2} is present. If this field is set to “0”, the
octet containing TCI state ID_{i,2} is not present;
  - TCI state ID_{i,j}: This field indicates the
TCI state identified by TCI-StateId as
specified in TS 38.331 [5], where i is the index
of the codepoint of the DCI Transmission
configuration indication field as specified in
TS 38.212 [9] and TCI state ID_{i,j} denotes the j-
th TCI state indicated for the i-th codepoint
in the DCI Transmission Configuration
Indication field. The TCI codepoint to which
the TCI States are mapped is determined by its
ordinal position among all the TCI codepoints
with sets of TCI state ID_{i,j} fields, i.e. the first
TCI codepoint with TCI state ID_{0,1} and TCI
state ID_{0,2} shall be mapped to the codepoint
value 0, the second TCI codepoint with TCI
state ID_{1,1} and TCI state ID_{1,2} shall be mapped
to the codepoint value 1 and so on. The TCI state
ID_{i,2} is optional based on the indication of
the Ci field. The maximum number of activated
TCI codepoint is 8 and the maximum number
of TCI states mapped to a TCI codepoint is 2.
  - R: Reserved bit, set to “0”.
```

Referring to FIG. 20, when a C₀ field 2005 has a value of 1, the corresponding MAC-CE may include a TCI state ID_{0,2} field 2015 in addition to a TCI state ID_{0,1} field 2010. This signifies that a TCI state ID_{0, 1} 2010 and a TCI state ID_{0,2} 2015 are activated for a zeroth codepoint of the TCI state field included within the DCI, and when the base station indicates the corresponding codepoint to the UE, the UE may receive an indication of two TCI states. When the C₀ field 2005 has a value of 0, the corresponding MAC-CE is unable to include the TCI state ID_{0,2} field 2015, which signifies that one TCI state corresponding to the TCI state ID_{0, 1} is activated for the zeroth codepoint of the TCI state field included in the DCI.

The configuration may be independent for each cell or BWP. For example, while a maximum number of activated TCI states corresponding to one TCI codepoint is 2 in the PCell, a maximum number of activated TCI states corresponding to one TCI codepoint may be 1 in a specific SCell. In this case, it may be considered that NC-JT may be configured in the PCell but may not be configured in the SCell.

### Distinguishing Single-DCI-Based Multi-TRP PDSCH Repeated Transmission Schemes (TDM/FDM/SDM)

The UE may receive an indication of different single-DCI-based multi-TRP PDSCH repeated transmission schemes from the base station according to a value indicated by a DCI field and a higher-layer signaling configuration. Table 75 below shows a method of distinguishing single or multi-TRP-based schemes according to a specific DCI field value and a higher-layer signaling configuration.

TABLE 75

| | Num- | Num- | repetition | | |
|---|---|---|---|---|---|
| | ber | ber | Number | Related to | Transmission |
| | of | of | configuration | repetition | scheme |
| Combi- | TCI | CDM | and indication | Scheme | indicated |
| nation | states | groups | condition | configuration | to UE |
| 1 | 1 | ≥1 | condition 2 | Not | Single-TRP |
| | | | | configured | |
| 2 | 1 | ≥1 | condition 2 | Configured | Single-TRP |
| 3 | 1 | ≥1 | condition 3 | Configured | Single-TRP |
| 4 | 1 | 1 | condition 1 | Configured | Single-TRP |
| | | | | or not | TDM scheme |
| | | | | configured | B |
| 5 | 2 | 2 | condition 2 | Not | Multi-TRP |
| | | | | configured | SDM |
| 6 | 2 | 2 | condition 3 | Not | Multi-TRP |
| | | | | configured | SDM |
| 7 | 2 | 2 | condition 3 | Configured | Multi-TRP |
| | | | | | SDM |
| 8 | 2 | 1 | condition 3 | Configured | Multi-TRP |
| | | | | | FDM scheme |
| | | | | | A/FDM |
| | | | | | scheme |
| | | | | | B/TDM |
| | | | | | scheme A |
| 9 | 2 | 1 | condition 1 | Not | Multi-TRP |
| | | | | configured | TDM scheme |

Each column in Table 75 above may be described as follows.

Number of TCI states (second column) refers to the number of TCI states indicated by a TCI state field within the DCI, and may be 1 or 2.

Number of CDM groups (third column) refers to the number of different CDM groups of DRMS ports indicated by an antenna port field within the DCI. The number of CDM groups may be 1, 2, or 3.

RepetitionNumber configuration and indication condition (fourth column) has three conditions according to whether repetitionNumber for all TDRA entries which can be indicated by a time domain resource allocation field within the DCI is configured and whether an actually indicated TDRA entry has a repetitionNumber configuration.

Condition 1 refers to when at least one of all TDRA entries which can be indicated by the time domain resource allocation field includes the configuration for repetitionNumber and the TDRA entry indicated by the time domain resource allocation field within the DCI includes the configuration of repetitionNumber larger than 1.

Condition 2 refers to when at least one of all TDRA entries which can be indicated by the time domain resource allocation field includes the configuration for repetitionNumber and the TDRA entry indicated by the time domain resource allocation field within the DCI does not include the configuration for repetitionNumber.

Condition 3 refers to when all TDRA entries which can be indicated by the time domain resource allocation field do not include the configuration for repetitionNumber.

Related to a repetitionScheme configuration (fifth column) refers to whether repetitionScheme which is higher-layer signaling is configured. RepetitionScheme which is higher-layer signaling may receive a configuration of one of ‘tdmSchemeA’, and ‘fdmSchemeA’, ‘fdmSchemeB’.

Transmission scheme indicated to UE (sixth column) refers to single or multiple-TRP schemes indicated according to each combination (first column) expressed by Table 75 above.

A single-TRP refers to single-TRP-based PDSCH transmission. When the UE receives a configuration of pdsch-AggegationFactor within higher-layer signaling PDSCH-config, the UE may receive scheduling of single TRP-based PDSCH repeated transmission a number of times received through the configuration. Otherwise, the UE may receive scheduling of single TRP-based PDSCH single transmission.

A single-TRP TDM scheme B refers to time resource division-based PDSCH repeated transmission between single TRP-based slots. The UE repeatedly transmits a PDSCH on a time dimension a number of times corresponding to the number of slots of repetitionNumber larger than 1 configured in the TDRA entry indicated by the time domain resource allocation field according to condition 1 related to repetitionNumber. In this case, a start symbol and a symbol length of the PDSCH indicated by the TDRA entry is equally applied to every slot corresponding to repetitionNumber and the same TCI state is applied to each PDSCH repeated transmission. The corresponding scheme is similar to a slot aggregation scheme in that the PDSCH repeated transmission between slots is performed in time resources but is different therefrom in that a repeated transmission indication is dynamically determined based on the time domain resource allocation field within the DCI.

A multi-TRP SDM refers to a multi-TRP-based space resource division PDSCH transmission scheme. This is a method of dividing a layer and performing reception from each TRP and may increase reliability of PDSCH transmission in that transmission can be performed at a lowered coding rate through an increase in the number of layers even though it is not the repeated transmission scheme. The UE may receive a PDSCH by applying each of two TCI states indicated through the TCI state field within the DCI to two CDM groups indicated by the base station.

A multi-TRP FDM scheme A refers to a multi-TRP-based frequency resource division PDSCH transmission scheme and is a scheme having one PDSCH transmission occasion and capable of performing transmission with higher reliability by increasing frequency resources and lowering a coding rate even though is not the repeated transmission such as multi-TRP SDM. The Multi-TRP FDM scheme A may apply two TCI states indicated through the TCI state field within the DCI to frequency resources which do not overlap each other. When the PRB bundling size is determined as a wideband and the number of RBs indicated by the frequency domain resource allocation field is N, the UE may receive first ceil (N/2) RBs by applying a first TC state and receive the remaining floor(N/2) RBs by applying a second TCI state. Ceil(.) and floor(.) are operators indicating rounding up and rounding down at the first decimal place. When the PRB bundling size is determined as 2 or 4, even-numbered PRGs are received by applying a first TCI state and odd-numbered PRGs are received by applying a second TCI state.

The multi-TRP FDM scheme B refers to a multi-TRPP-based frequency resource division PDSCH repeated transmission scheme and has two PDSCH transmission occasions to repeatedly transmit a PDSCH on each occasion. As with the multi-TRP FDM scheme A, multi-TRP FDM scheme B may also apply two TCI states indicated through the TCI state field within the DCI to frequency resources which do not overlap each other. When the PRB bundling size is determined as a wideband and the number of RBs indicated by the frequency domain resource allocation field is N, the UE may receive first ceil (N/2) RBs by applying a first TC state and receive the remaining floor(N/2) RBs by applying a second TCI state. Ceil(.) and floor(.) are operators indicating rounding up and rounding down at the first decimal place. When the PRB bundling size is determined as 2 or 4, even-numbered PRGs are received by applying a first TCI state and odd-numbered PRGs are received by applying a second TCI state.

The multi-TRP TDM scheme A refers to a PDSCH repeated transmission scheme within a multi-TRP-based time resource division slot. The UE has two PDSCH transmission occasion within one slot, and a first reception occasion may be determined based on a start symbol and a symbol length of the PDSCH indicated through the time domain resource allocation field within the DCI. A start symbol of a second reception occasion of the PDSCH may be an occasion to which a symbol offset by higher-layer signaling StartingSymbolOffsetK from the last symbol of the first transmission occasion, and the transmission occasion corresponding to the symbol length indicated therefrom may be determined. When higher-layer signaling StartingSymbolOffsetK is not configured, the symbol offset may be considered as 0.

The multi-TRP TDM scheme B refers to a PDSCH repeated transmission scheme between multi-TRP-based time resource division slots. The UE has one PDSCH transmission occasion within one slot and may receive repeated transmission based on a start symbol and a symbol length of the same PDSCH during slots corresponding to repetitionNumber indicated by the time domain resource allocation field within the DCI. When repetitionNumber is 2, the UE may receive PDSCH repeated transmission of first and second slots by applying first and second TCI states, respectively. When repetitionNumber is greater than 2, the UE may use different TCI state schemes according to configured higher-layer signaling tciMapping. When tciMapping is configured as cyclicMapping, first and second TCI states may be applied to first and second PDSCH transmission occasions, respectively, and the same TCI state application method is equally applied to the remaining PDSCH transmission occasions. When tciMapping is configured as sequenticalMapping, a first TCI state may be applied to first and second PDSCH transmission occasions, a second TCI state may be applied to third and fourth PDSCH transmission occasions, and the same TCI state application method may be equally applied to the remaining PDSCH transmission occasions.

### Additional Multi-TCI State Indication and Activation Method Based on Unified TCI State Scheme

A UE may receive, from a base station, scheduling of a PDSCH including a MAC-CE that is configurable by at least one combination of the various MAC-CE structures below, and from 3 slots after transmission of HARQ-ACK for the corresponding PDSCH to the base station, may interpret each codepoint of a TCI state field in DCI format 1_1 or 1_2, based on information in the MAC-CE received from the base station. In other words, the UE may activate each entry of the MAC-CE received from the base station at each codepoint in the TCI state field in DCI format 1_1 or 1_2.

When the UE has received configuration of two different CORESETPoolIndexes via higher layer signaling, and receives configuration of DLorJointTCIState or UL-TCIState that is higher layer signaling, the base station and UE may expect that, in FIG. 7, which is one of the MAC-CE structures indicating the activation of the unified TCI state, an R field 7-30 existing in the first octet is interpreted as a field representing the CORESET Pool ID. If the corresponding CORESET Pool ID is configured to have a value of 0, the UE may consider that the corresponding MAC-CE is applicable to each codepoint of a TCI state field in the PDCCH transmitted in a CORESET corresponding to CORESETPoolIndex 0. If the corresponding CORESET Pool ID is configured to have a value of 1, the UE may consider that the corresponding MAC-CE is applicable to each codepoint of a TCI state field in the PDCCH transmitted in a CORESET corresponding to CORESETPoolIndex 1.

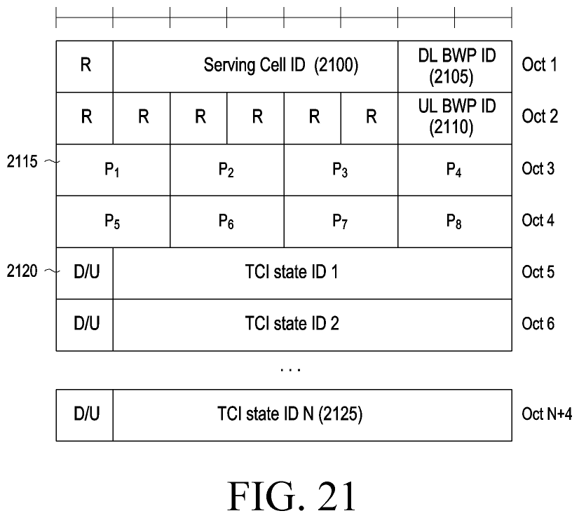

FIG. 21 illustrates another MAC-CE structure for activating and indicating multiple joint TCI states or a separate DL or UL TCI state in a wireless communication system according to an embodiment. Each field in the corresponding MAC-CE structure will now be described.

A serving cell ID field 2100 may indicate a serving cell to which the corresponding MAC-CE is to be applied. This field may have a length of 5 bits. If a serving cell indicated by this field is included in one or more of simultaneousU-TCI-UpdateList1, simultaneousU-TCI-UpdateList2, simultaneousU-TCI-UpdateList3, or simultaneousU-TCI-UpdateList4, which are higher layer signaling, the corresponding MAC-CE may be applied to all of serving cell included in one or more of the following lists of simultaneousU-TCI-UpdateList1, simultaneousU-TCI-UpdateList2, simultaneousU-TCI-UpdateList3, simultaneousU-TCI-UpdateList4 that includes the serving cell indicated by this field.

A DL BWP ID field 2105 may indicate a DL BWP to which the corresponding MAC-CE is to be applied, and the meaning of each codepoint in this field may correspond to each codepoint of a BWP indicator in DCI. This field may have a length of 2 bits.

A UL BWP ID field 2110 may indicate an UL BWP to which the corresponding MAC-CE is to be applied, and the meaning of each codepoint in this field may correspond to each codepoint of the BWP indicator in the DCI. This field may have a length of 2 bits.

A Pᵢ field 2115 may indicate whether each codepoint of the TCI state field in DCI format 1_1 or 1_2 has multiple TCI states or one TCI state.

When the UE is able to configure one type among the types of joint and separate for the unifiedTCI-StateType-r17 in MIMOparam-r17 in ServingCellConfig, which is higher layer signaling, this field may be interpreted as follows, regardless of the configured type among the two types of configuration information.

If Pᵢ has a value of ‘00’, the corresponding i-th codepoint has a single TCI state, and this may signify that the corresponding codepoint may include one of a joint TCI state, a separate DL TCI state, or a separate UL TCI state.

If Pᵢ has a value of ‘01’, the corresponding i-th codepoint has two TCI states, and this may signify that the corresponding codepoint may include one of the following: two joint TCI states, one separate DL TCI state and one separate UL TCI state, two separate DL TCI states, or two separate UL TCI states.

If Pᵢ has a value of ‘10’, the corresponding i-th codepoint has three TCI states, and this may signify that the corresponding codepoint may include one of the following: separate DL TCI state and two separate UL TCI states, or two separate DL TCI states and one separate UL TCI state.

If Pᵢ has a value of ‘11’, the corresponding i-th codepoint has four TCI states, and this may signify that the corresponding codepoint may include two separate DL TCI states and two separate UL TCI states.

When the UE is able to configure one mode among the joint, separate, and mixed modes for the unifiedTCI-StateType-r17 in MIMOparam-r17 in ServingCellConfig, which is higher layer signaling, this field may be interpreted as follows, regardless of the configured value among the possible configuration values. The mixed mode may be expressed by a single configuration value which indicates that a general mixed mode of joint TCI state and separate DL or UL TCI state is possible, or may be expressed by multiple configuration values, such as ‘1joint+1DL’, ‘1joint+1UL’, to be configured to represent a specific combination of a specific number of joint TCI states and a specific number of separate DL or UL TCI states.

If Pᵢ has a value of ‘00’, the corresponding i-th codepoint has a single TCI state, and this may signify that the corresponding codepoint may include one of a joint TCI state, a separate DL TCI state, or a separate UL TCI state.

If Pᵢ has a value of ‘01’, the corresponding i-th codepoint has two TCI states, which signifies that the corresponding codepoint may include one of the following: two joint TCI states, one joint TCI state and one separate DL TCI state, one joint TCI state and one separate UL TCI state, one separate DL TCI state and one separate UL TCI state, two separate DL TCI states, or two separate UL TCI states. If the UE allows the unifiedTCI-StateType-r17 in MIMOparam-r17 in ServingCellConfig, which is higher layer signaling, to receive a configuration of a value having a meaning that a mixed mode, such as a general mixed mode of joint TCI state and separate DL or UL TCI state, is possible, one joint TCI state and one separate DL TCI state as well as one joint TCI state and one separate UL TCI state are possible. If the UE allows the unifiedTCI-StateType-r17 in MIMOparam-r17 in ServingCellConfig, which is higher layer signaling, to receive a configuration of one of ‘1joint+1DL’ and ‘1joint+1UL’, only those that correspond to the unifiedTCI-StateType-r17 configuration value, among the above-described one joint TCI state and one separate DL TCI state as well as one joint TCI state and one separate UL TCI state, are possible.

If Pᵢ has a value of ‘10’, the corresponding i-th codepoint has three TCI states, which signifies that the corresponding codepoint may include one separate DL TCI state and two separate UL TCI states, or two separate DL TCI states and one separate UL TCI state.

If Pᵢ has a value of ‘11’, the corresponding i-th codepoint has four TCI states, which signifies that the corresponding codepoint may include two separate DL TCI states and two separate UL TCI states.

This Pᵢ field may be 2 bits.

A D/U 2120 field may indicate whether the TCI state ID field within the same octet is a joint TCI state or a separate DL TCI state, or a separate UL TCI state. If this field has a value of 1, the TCI state ID field within the same octet may be a joint TCI state or a separate DL TCI state. If this field has a value of 0, the TCI state ID field within the same octet may be a separate UL TCI state.

A TCI state ID N 2125 field may indicate a TCI state that is identifiable by TCI-StateId which is higher layer signaling. When the D/U field is configured as 1, this field may be used to express the TCI-StateId, which is expressible by 7 bits. When the D/U field is configured as 0, the MSB of this field may be considered as a reserved bit, and the remaining 6 bits may be used to express UL-TCIState-Id which is higher layer signaling. The maximum number of TCI states that can be activated is 8 for joint TCI states and 16 for separate DL or UL TCI states.

An R field denotes a reserved bit, which may be configured as 0.

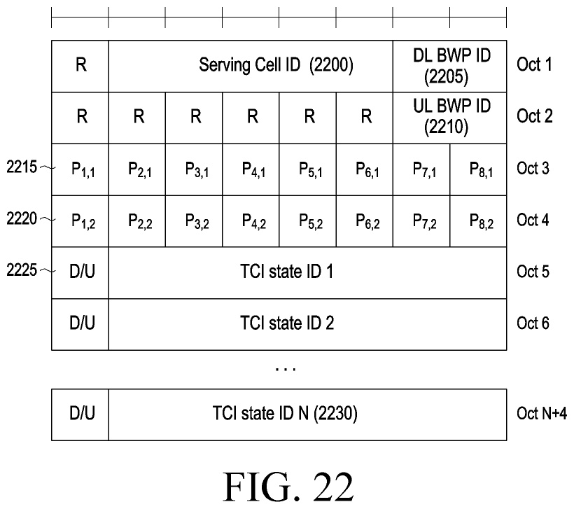

FIG. 22 illustrates a MAC-CE structure for activating and indicating multiple joint TCI states or a separate DL or UL TCI state in a wireless communication system according to an embodiment. Each field in the corresponding MAC-CE structure is described as follows.

The serving cell ID field 2200 may indicate a serving cell to which the corresponding MAC-CE is to be applied. This field may have a length of 5 bits. If a serving cell indicated by this field is included in one or more of simultaneousU-TCI-UpdateList1, simultaneousU-TCI-UpdateList2, simultaneousU-TCI-UpdateList3, or simultaneousU-TCI-UpdateList4, which are higher layer signaling, the corresponding MAC-CE may be applied to all of serving cells included in one or more of the following lists of simultaneousU-TCI-UpdateList1, simultaneousU-TCI-UpdateList2, simultaneousU-TCI-UpdateList3, simultaneousU-TCI-UpdateList4 that includes the serving cell indicated by this field.

The DL BWP ID field 2205 may indicate a DL BWP to which the corresponding MAC-CE is to be applied, and the meaning of each codepoint in this field may correspond to each codepoint of a BWP indicator in DCI. This field may have a length of 2 bits.

The UL BWP ID field 2210 may indicate an UL BWP to which the corresponding MAC-CE is to be applied, and the meaning of each codepoint in this field may correspond to each codepoint of the BWP indicator in the DCI. This field may have a length of 2 bits.

The P_{i,1} field 2215 and P_{i,2} field 2220 may indicate whether each codepoint of the TCI state field in DCI format 1_1 or 1_2 has multiple TCI states or one TCI state.

In connection with when the UE is able to configure one type among the types of joint and separate for the unifiedTCI-StateType-r17 in MIMOparam-r17 in ServingCellConfig, which is higher layer signaling, or is able to configure one mode among joint, separate, and mixed modes therefor, when the unifiedTCI-StateType-r17 that is higher layer signaling is configured as joint, the UE may omit the fourth octet including the fields P_{1,2}, P_{2,2}, . . . , and P_{8,2} fields in FIG. 22 and may interpret P_{i,1} only as follows. The mixed mode may be expressed as a single configuration value which indicates that a general mixed mode of joint TCI state and separate DL or UL TCI state is possible, or may be expressed as a plurality of configuration values, such as ‘1joint+1DL’ and ‘1joint+1UL’, to indicate a specific combination of a specific number of joint TCI states and a specific number of separate DL or UL TCI states.

If Pᵢ has a value of ‘0’, the corresponding i-th codepoint has one TCI state, and this may indicate that the corresponding codepoint includes one joint TCI state.

If Pᵢ has a value of ‘1’, the corresponding i-th codepoint has two TCI states, and this may indicate that the codepoint includes two joint TCI states.

In connection with when the UE is able to configure one type among the types of joint and separate or configure one mode among joint, separate, and mixed modes for the unifiedTCI-StateType-r17 in MIMOparam-r17 in ServingCellConfig, which is higher layer signaling, when the unifiedTCI-StateType-r17 that is higher layer signaling is configured as separate, the UE may consider P_{i,1} in the 3rd octet and P_{i,2} in the 4th octet as a single field of 2 bits and interpret the same as follows. The mixed mode may be expressed as a single configuration value having a meaning that a general mixed mode of joint TCI state and separate DL or UL TCI state is possible, or may be expressed as a plurality of configuration values, such as ‘1joint+1DL’ and ‘1joint+1UL’, to be configured to indicate a specific combination of a specific number of joint TCI states and a specific number of separate DL or UL TCI states.

If P_{i,1} and P_{i,2} have a value of ‘0’ and ‘0’, respectively, the corresponding i-th codepoint has a single TCI state, which indicates that the corresponding codepoint may include either a separate DL TCI state or a separate UL TCI state.

If P_{i,1} and P_{i,2} have a value of ‘0’ and ‘1’, respectively, the corresponding i-th codepoint has two TCI states, which indicates that the corresponding codepoint may include one of: one separate DL TCI state and one separate UL TCI state, two separate DL TCI states, or two separate UL TCI states.

If P_{i,1} and P_{i,2} have a value of ‘1’ and ‘0’, respectively, the corresponding i-th codepoint has three TCI states, which indicates that the corresponding codepoint may include one separate DL TCI state and two separate UL TCI states, or two separate DL TCI states and one separate UL TCI state.

If P_{i,1} and P_{i,2} have a value of ‘1’ and ‘1’, respectively, the corresponding i-th codepoint has four TCI states, which indicates that the corresponding codepoint may include two separate DL TCI states and two separate UL TCI states.

When the UE is able to configure one mode among joint, separate, and mixed modes for the unifiedTCI-StateType-r17 in MIMOparam-r17 in ServingCellConfig, which is higher layer signaling, when the unifiedTCI-StateType-r17 that is higher layer signaling is configured as the mixed mode, the UE may interpret P_{i,1} in the 3rd octet as follows, and may not transmit the 4th octet. The mixed mode may be expressed by one configuration value, which indicates that the general mixed mode of joint TCI state and separate DL or UL TCI state is possible.

If P_{i,1} has a value of ‘0’, this may be understood as that the corresponding i-th codepoint includes one joint TCI state and one separate DL TCI state.

If P_{i,1} has a value of ‘1’, this may be understood as that the corresponding i-th codepoint includes one joint TCI state and one separate UL TCI state.

When the UE is able to configure one mode among joint, separate, and mixed modes for the unifiedTCI-StateType-r17 in MIMOparam-r17 in ServingCellConfig, which is higher layer signaling, when the unifiedTCI-StateType-r17 that is higher layer signaling is configured as a mixed mode, the UE may interpret P_{i,1} in the 3rd octet and P_{i,2} in the 4th octet as follows. The mixed mode may be expressed by one configuration value, which indicates that the general mixed mode of joint TCI state and separate DL or UL TCI state is possible.

If P_{i,1} has a value of ‘0’, this may be understood as that the corresponding i-th codepoint includes only one joint TCI state. In other words, no mixed mode is used, and the value of P_{i,2} may be disregarded.

If P_{i,1} has a value of ‘1’, this may be understood as that the corresponding i-th codepoint includes one of one separate UL TCI state and one separate DL TCI state in addition to one joint TCI state. In other words, the mixed mode may be used for the corresponding codepoint, if P_{i,2} has a value of ‘0’, one separate UL TCI state may be used additionally, and if P_{i,2} has a value of ‘1’, one separate UL TCI state may be used additionally.

The D/U field 2225 may indicate whether the TCI state ID field within the same octet is a joint TCI state or a separate DL TCI state, or a separate UL TCI state. If this field has a value of 1, the TCI state ID field within the same octet may be a joint TCI state or a separate DL TCI state. If this field has a value of 0, the TCI state ID field within the same octet may be a separate UL TCI state.

The TCI state ID field 2230 may indicate a TCI state that is identifiable by TCI-StateId which is higher layer signaling. When the D/U field is configured as 1, this field may be used to represent the TCI-StateId, which is expressible by 7 bits. When the D/U field is configured as 1, the most significant bit (MSB) of this field may be considered as a reserved bit, and the remaining 6 bits may be used to express UL-TCIState-Id which is higher layer signaling. The maximum number of TCI states that may be activated is 8 for joint TCI states and 16 for separate DL or UL TCI states.

The R field denotes a reserved bit, which may be configured as 0.

The unifiedTCI-StateType-r17 in MIMOparam-r17 in ServingCellConfig, which is higher layer signaling described above, may be defined as a new parameter, such as unifiedTCI-StateType-r18 in MIMOparam-r18 that is higher layer signaling in ServingCellConfig, or an existing parameter may be reused.

### Group-Based Beam Reporting

If a UE is capable of simultaneously receiving multiple (e.g., two) simultaneously receivable reference signals (e.g., CSI-RS or SSB resources, etc.), the UE may report channel state information (CSI) for the simultaneously receivable reference signals to the base station via group-based beam reporting. A group-based beam reporting by a first method allows the UE to report, to a base station, an index (e.g., CRI or SSBRI) for two different reference signals that may be simultaneously received at a single CSI reporting instance. In a second method of group-based beam reporting, the UE may report one or more group(s) to the base station at a single CSI reporting instance. The following description is for the second method of group-based beam reporting.

When performing the group-based beam reporting of the second method, a group may be configured by indexes of two reference signals (e.g., CRI or SSBRI) that the UE is capable of simultaneously receiving. As to the number of groups that the UE is capable of reporting, the base station may configure a higher layer parameter, such as ‘nrofReportedGroups’, in the UE by referring to the UE capability report reported by the UE. The higher layer parameter ‘nrofReportedGroups’ may be configured, by the base station, as a value of one of between 1 and 4 in the UE. The two reference signals, which may be simultaneously received by the UE and may be identified via the reference signal indexes included in one group, may be selected as one CSI-RS or SSB each from the two CSI resource sets for CSI reporting settings (which may be defined as two CSI resource sets as specified in the relevant Standard, or may be defined as a channel measurement resource set as specified in the relevant Standard). For example, the index for the first reference signal in the first group that the UE reports to the base station may be determined by selecting one reference signal (e.g., the reference signal with the largest measured RSRP among the reference signals in the CSI resource set) from one of the two CSI resource sets (e.g., the CSI resource set that includes the reference signal with the largest measured RSRP value among two CSI resource sets may be selected, and the indicator for the corresponding resource set may be reported to the base station as ‘Resource set indicator’ for CSI reporting by the UE).

The index of the first reference signal in the first group may be the reference signal with the largest RSRP value among all reference signals in the two resource sets, and based on this, the UE may select the CSI resource set in which the index of the first reference signal in the group is selected among the two CSI resource sets, and the resource set indicator thereof may be reported by the UE to the base station as CSI information. After selecting the index of the first reference signal in the first group, the UE may select the index of the second reference signal in the first group. The UE may select the index of the second reference signal in the first group as the index of one of the reference signals in the other one of the two resource sets instead of the resource set from which the first reference signal in the first group is selected (e.g., the reference signal with the largest RSRP among the plurality of reference signals that may be received simultaneously with the first reference signal in the first group).

The UE may report the RSRP of the reference signal indicated by the index of the first reference signal in the first group. For reference signals indicated by the index of other reference signals (e.g., the index of the second reference signal in the first group, etc.), the UE may report a differential RSRP, which refers to a differential value between the measured RSRP of the reference signal indicated by the index of the first reference signal in the first group and the measured RSRP of the reference signal indicated by the index of the second reference signal in the first group. For example, if the measured RSRP of the reference signal indicated by the index of the first reference signal in the first group is defined as RSRP1 and the measured RSRP of the reference signal indicated by the index of the second reference signal in the first group is defined as RSRP2, the differential RSRP reported with the index of the second reference signal in the first group may be determined by the UE as a value of (RSRP1−RSRP2) expressed in 2 dB intervals.

To perform the second method of group-based beam reporting, two CSI resource sets should be defined as previously described. With respect to two CSI resource sets, if the resourceType in the higher layer parameter ‘CSI-ResourceConfig’ is configured as ‘periodic’ or ‘semiPersistent’ and ‘groupBasedBeamReporting-v1710’ is configured, the base station may configure two NZP CSI-RS resource sets (e.g., two NZP-CSI-RS-ResourceSetIds may be configured in nzp-CSI-RS-ResourceSetList), two CSI SSB resource sets (e.g., two CSI-SSB-ResourceSetIds may be configured in csi-SSB-ResourceSetList), or one NZP CSI-RS resource set and one CSI SSB resource set (e.g., one NZP-CSI-RS-ResourceSetId may be configured in nzp-CSI-RS-ResourceSetList and one CSI-SSB-ResourceSetId may be configured in csi-SSB-ResourceSetList).

If one NZP CSI-RS resource set and one CSI SSB resource set are configured and the UE performs the second method of group-based beam reporting to the base station, the UE may configure the resource set indicator as ‘1’ and report to the base station that the one CSI SSB resource set includes a reference signal indicated by the index of the first reference signal in the first group. If one NZP CSI-RS resource set and one CSI SSB resource set are configured and the UE performs the second method of group-based beam reporting to the base station, the UE may configure the resource set indicator as ‘0’ and report to the base station that one NZP CSI resource set includes the reference signal indicated by the index of the first reference signal in the first group.

If two NZP CSI-RS resource sets are configured and the UE performs the second method of group-based beam reporting to the base station, the UE may configure the resource set indicator as ‘0’ and report to the base station that the first NZP CSI resource set includes the reference signal indicated by the index of the first reference signal in the first group, or the UE may configure the resource set indicator as ‘1’ and report to the base station that the second NZP CSI resource set includes the reference signal indicated by the index of the first reference signal in the first group.

If two CSI SSB resource sets are configured and the UE performs the second method of group-based beam reporting to the base station, the UE may configure the resource set indicator as ‘0’ and report to the base station that the first CSI SSB resource set includes the reference signal indicated by the index of the first reference signal in the first group, or the UE may configure the resource set indicator as ‘1’ and report to the base station that the second CSI SSB resource set includes the reference signal indicated by the index of the first reference signal in the first group.

If the higher layer parameter groupBasedBeamResporting-v1710 (or groupBasedBeamReporting-r17) is configured in the UE, the UE does not need to update the measurement for more than 64 CSI-RS and/or SSB resources. The UE may report to the base station a group(s) of nrofReportedGroups (if configured) at a single reporting instance, where the UE selects one CSI-RS or SSB from each CSI resource set among the two CSI resource sets according to the reporting settings as described above, and the UE selects the two CRIs or SSBRIs as one group. In this case, the CSI-RS and/or SSB resources in each group are selected as resources that may be received simultaneously by the UE.

Table 76 below explains a method of configuring a CSI field for the nth CSI report when the UE performs the group-based beam reporting of the second method to the base station. As described above, the UE may configure, as CSI fields, a resource set indicator to select and indicate one of the two CSI resource sets (or channel measurement resource sets), two reference signal resource indexes to be included in up to four resource groups, and RSRP or differential RSRP for the same, and may report the CSI fields to the base station.

TABLE 76

| CSI report number | CSI fields |
|---|---|
| CSI report #n | Resource set indicator |
| | CRI or SSBRI #1 of 1st resource group |
| | CRI or SSBRI #2 of 1st resource group |
| | CRI or SSBRI #1 of 2nd resource group |
| | CRI or SSBRI #2 of 2nd resource group |
| | CRI or SSBRI #1 of 3rd resource group |
| | CRI or SSBRI #2 of 3rd resource group |
| | CRI or SSBRI #1 of 4th resource group |
| | CRI or SSBRI #2 of 4th resource group |
| | RSRP of CRI or SSBRI #1 of 1st resource group |
| | Differential RSRP of CRI or SSBRI |
| | #2 of 1st resource group |
| | Differential RSRP of CRI or SSBRI |
| | #1 of 2nd resource group |
| | Differential RSRP of CRI or SSBRI |
| | #2 of 2nd resource group |
| | Differential RSRP of CRI or SSBRI |
| | #1 of 3rd resource group |
| | Differential RSRP of CRI or SSBRI |
| | #2 of 3rd resource group |
| | Differential RSRP of CRI or SSBRI |
| | #1 of 4th resource group |
| | Differential RSRP of CRI or SSBRI |
| | #2 of 4th resource group |

Respective elements included in the CSI field may be determined as shown in Table 77 below. Kₛ^{CSI-RS} denotes the number of CSI-RS resources configured in the corresponding CSI resource set, and Kₛ^{SSB} denotes the number of SS/PBCH blocks configured in the corresponding CSI resource set.

TABLE 77

| Field | Bitwidth |
|---|---|
| CRI | ┌log₂ (Kₛ^{CSI-RS})┐ |
| SSBRI | ┌log₂ (Kₛ^{SSB})┐ |
| RSRP | 7 |
| Differential RSRP | 4 |
| Capability Index | 2 |

### First Embodiment: UE Beam Reporting Method for Supporting Simultaneous Multi-Panel Transmissions and Base Station Uplink Beam Indication Method

The first embodiment describes a method in which a UE reports a combination of simultaneously transmittable beams to a base station to support a simultaneous multi-panel transmission technique.

The UE may receive, by using a multi-panel, multiple (e.g., two) reference signals (e.g., SSBSs or CSI-RSs) transmitted by the base station simultaneously (“simultaneously” refers to performing downlink signal reception or uplink transmission using the same resources for at least one symbol in a time domain). In this case, the UE may simultaneously receive only a combination of some reference signals among full reference signals configured in the UE through a multi-panel. Since the base station does not know a combination of reference signals that the UE may simultaneously receive through the multi-panel, the base station may request CSI reporting (i.e., group-based beam reporting) from the UE to know the combination of reference signals. As such, the UE may perform group-based beam reporting to the base station by grouping the indexes of reference signal resources that may be received simultaneously by the UE through multiple panels into a single group (or may be expressed as a resource group, a beam pair, a beam combination, a beam group, and the like), and the UE may select one or more resource groups (a value configured by the higher layer parameter ‘nrofReportedGroups’) according to a UE capability and a higher layer parameter configured by the base station based on the UE capability and report the selected resource groups to the base station. In this case, a resource set indicator for indicating a CSI resource set (when configuring a higher layer parameter ‘groupBasedBeamReporting-v1710’, refers to a resource set including a corresponding reference signal among two SSB or CSI-RS resource sets configured in the higher layer parameter ‘CSI-ResourceConfig’ (two CSI-SSB-ResourceSets, two NZP-CSI-RS-ResourceSets, or a combination of one CSI-SSB-ResourceSet and one NZP-CSI-RS-ResourceSet)) including a reference signal received with the largest RSRP among the RSRP values measured through reference signals included in full resource groups in addition to multiple resource groups, and a value expressed in bits by quantizing RSRP values of reference signals received with the largest RSRP and a differential RSRP (a differential value between the largest RSRP and an RSRP in which the reference signal is received) of other reference signals included in a group beam report may be reported together. Alternatively, depending on a higher layer parameter configuration, some differential RSRPs or resource groups may not be reported and only some values may be reported. This is a method of reporting to the base station that the UE may simultaneously receive downlink signals through multiple panels.

Additionally, a UE capability, in which the UE may simultaneously transmit multiple uplink signals (e.g., PUCCH, PUSCH, or SRS) to the base station by using multiple panels, may be supported. Similarly, since the base station is unable to know a combination of reference signals that the UE refers to in determining an uplink beam on which the UE may transmit uplink signals through multiple panels simultaneously, the base station may request group-based beam reporting from the UE to know the combination of reference signals.

In other words, if the base station is able to know a combination of reference signals that the UE refers to in determining an uplink beam on which the UE may transmit uplink signals through multiple panels simultaneously, the base station may activate and indicate, to the UE, a TCI state in which the reference signal in the combination of the corresponding reference signals is indicated as the reference signal of QCL info. In other words, if the referenceSignal of the QCL info (e.g., the type of the QCL info is type D) of the two joint TCI states or two UL TCI states indicated by the base station is configured as the index of the reference signal resource included in a predetermined one resource group reported by the UE to the base station, the UE may determine an uplink beam by referring to the indicated TCI state and simultaneously transmit the uplink signal based on the simultaneous multi-panel transmission technique. In this case, the UE may perform group-based beam reporting for simultaneous uplink transmission to the base station according to at least one of the following methods.

### Method 5: Use the Same Group-Based Beam Report for Simultaneous Downlink Reception and Simultaneous Uplink Transmission

If the UE is capable of simultaneously receiving and transmitting downlink and uplink channels using multiple panels, the UE may report the corresponding UE capability (capable of performing simultaneous uplink and downlink transmissions) to the base station. In addition, the UE may use one group-based beam report to the base station, as described in Method 1, to report a group of resources that are capable of simultaneous uplink and downlink transmission and reception. The UE may perform multi-panel-based simultaneous uplink transmission and simultaneous downlink reception based on reference signals included in the resource group(s) reported to the base station through the group-based beam report. In other words, the UE may simultaneously notify the base station of resource group(s) capable of simultaneous uplink transmission and resource group(s) capable of simultaneous downlink reception through one group-based beam report rather than separate group-based beam reports. Method 1 may be used in combination with a TCI state indication method based on a joint TCI state.

Alternatively, Method 5 may also be combined with a TCI state indication method based on separate TCI states (DL TCI state and UL TCI state are indicated separately). For example, the base station may activate codepoints for a single- or multi-TCI state indication via the MAC CE by referring to group-based beam reports reported by the UE through Method 5. If the base station has configured the higher layer parameter unifiedTCI-StateType-r17 as ‘joint’ in the UE, each codepoint for indication of a TCI state activated by the MAC CE may include one or multiple (e.g., two) TCI states. For the base station to schedule a simultaneous multi-panel-based uplink transmission to the UE, the base station should instruct the UE a codepoint including two TCI states, and the base station may instruct the two TCI states based on the group-based beam report reported by the UE. For example, the reference signal for QCL type D of the two TCI states instructed by the base station to the UE may be configured as the two reference signals included within a group of one of the group-based beam reporting information reported by the UE. More specifically, the first TCI state among the two TCI states instructed to the UE by the base station may be one of the TCI states in which the reference signal for QCL type D is configured as the first reference signal in the nth group (where n is a value from 1 to 4) of the group-based beam information reported by the UE to the base station. The second TCI state among the two TCI states instructed by the base station to the UE may be one of the TCI states in which the reference signal for QCL type D is configured as the second reference signal in the nth group of group-based beam information reported by the UE to the base station. As such, if the UE reports a beam combination that is capable of simultaneous multi-panel-based uplink transmission to the base station through group-based beam reporting to the base station, and the base station indicates a TCI state to the UE based on the beam combination, the base station may schedule the uplink data channel for simultaneous multi-panel transmission to the UE. If the two TCI states indicated by the base station do not match values selected based on the group-based beam reporting reported by the UE, the uplink signals transmitted simultaneously by the UE through the multiple panels may not be received at the SNR expected by the base station. Alternatively, depending on the implementation of the UE, simultaneous multi-panel-based uplink transmission may not be performed. This signifies that the UE may only transmit uplink signals through one panel and may not transmit the uplink signals through another panel.

### Method 6: Use Separate Group-Based Beam Reporting for Simultaneous Downlink Reception and Simultaneous Uplink Transmission

If the UE is capable of simultaneously receiving/transmitting downlink/uplink channels using multiple panels, the UE may report the corresponding UE capability (capable of performing simultaneous uplink and downlink transmission and reception) to the base station. Unlike Method 5, in Method 6, group-based beam reporting for simultaneous downlink reception and group-based beam reporting for simultaneous uplink transmission are performed respectively. This is because the downlink reception beam for simultaneous downlink reception and the uplink transmission beam for simultaneous uplink transmission may not match. Therefore, the UE may perform group-based beam reporting for uplink and downlink separately to report the respective transmission beam group and reception beam group to the base station. The same type of group-based beam reporting method as described in Method 5 may be used, but the UE should report separate UE capability and receive separate higher layer parameters configured from the base station to configure simultaneous uplink transmission group-based beam reporting. In addition, the UE performs separate simultaneous uplink transmission group-based group beam reporting through separate CSI reporting. In this case, the field of the CSI information used to perform the group-based beam reporting for the separate simultaneous uplink transmission may be configured to be the same as the field of the CSI information used to perform the group-based beam reporting for the simultaneous downlink reception. That is, the field may be configured by a field for reporting a beam group and a resource set indicator to indicate a resource set including a reference signal received with the largest value of RSRP, a field for reporting the largest value of RSRP, and a field for reporting a differential RSRP for reference signals other than a reference signal received with the largest value of RSRP.

### Method 7: New Beam Reporting Method for Simultaneous Multi-Panel Transmissions

According to Method 7, group-based beam reporting for simultaneous downlink reception and group-based beam reporting for simultaneous uplink transmission are performed, respectively. A UE may report to the base station, in addition to UE capabilities for simultaneous multi-panel transmissions, UE capabilities to indicate that a new beam reporting method for reporting beam groups capable of simultaneous multi-panel transmissions is supportable. When the UE performs CSI reporting to the base station using a possible new beam reporting method, additional information about the reported beam may be reported together. When a UE performs CSI reporting of information about a beam, the UE may report the beam information being reported along with an indicator that indicates that the beam is transmittable to multiple panels simultaneously.

For example, if a UE is capable of simultaneously transmitting an uplink channel to multiple panels using an uplink beam referring to K different CSI-RSs (or SSBs) (where K is one of the values greater than 1, for example 2), the UE may include one new indicator in the CSI information for each CSI-RS, in addition to pieces of CSI information for the corresponding K different CSI-RSs. The UE may report, to the base station, the new indicators included in the pieces of CSI information for the K CSI-RSs that may be referred to perform the simultaneous uplink transmission, by configuring the new indicators to be the same value. If a UE may perform simultaneous multi-panel uplink transmission by referring to a CSI-RS with a CSI-RS resource indicator (CRI) of 1 and a CSI-RS with a CRI of 2, the UE may report the CSI information to the base station by configuring a new indicator to have a value of ‘1’ within the CSI information for a CSI-RS with a CRI of 1 and also by configuring a new indicator to have a value of ‘1’ within the CSI information for a CSI-RS with a CRI of 2. Furthermore, if a simultaneous multi-panel uplink transmission may be performed by referring to other CSI-RS combinations, the UE may additionally take this into account when reporting CSI to the base station. For example, if a UE may perform a simultaneous multi-panel uplink transmission by referring to a CSI-RS with a CRI of 5 and a CSI-RS with a CRI of 7, the UE may report the CSI information to the base station by configuring a new indicator to have a value of ‘2’ (or any one value except the new indicator value (e.g., ‘1’) previously used for beam combinations capable of different simultaneous transmissions and any new indicator value (e.g., ‘0’) to indicate beams not capable of simultaneous multi-panel transmissions) within the CSI information for a CSI-RS with a CRI of 5 and also by configuring a new indicator to have a value of ‘2’ within the CSI information for a CSI-RS with a CRI of 7.

Other beam combinations capable of simultaneous multi-panel transmissions may also be reported to the base station by configuring the new indicator in the CSI information for each beam to have the same value. Although description for the CSI-RS has been made, the same may be applied to the SSB, and the UE may distinguish and report to the base station which beam combinations are capable of simultaneous transmission based on SSBRI rather than CRI. If the uplink beam, determined based on a particular reference signal, is not capable of supporting simultaneous multi-panel-based transmission, the UE may report to the base station by configuring a new indicator included in the CSI report for the corresponding reference signal to a predetermined specific value. ‘0’ may be configured as the value of the new indicator included in the CSI report for the reference signal for which simultaneous multi-panel transmissions are not supported. Alternatively, if the base station configures the number of beam combinations corresponding to the maximum number of beam combinations that the UE may report+1 to be ‘X’ in the UE via a higher layer parameter, ‘X’ may be defined, by the base station and the UE, as the value of a new indicator to be included in CSI reporting for reference signals where simultaneous multi-panel transmissions are not supported.

As further information reported along with the beam information, the UE may consider an operation of adding a predetermined indicator to the CSI information and reporting the same to the base station. If the UE is capable of simultaneously transmitting uplink channels to multiple panels by using uplink beams referring to K different CSI-RSs (or SSBs) (where K is one of values greater than 1, for example 2), the UE may include a new indicator configured as a predetermined value X (for example, 0) in the CSI reporting for some reference signals among the total reference signals, and may include a new indicator configured as a predetermined value Y, such as 1, in the CSI reporting for some reference signals among the total reference signals. If the UE reports CSI information to the base station with the new indicator configured as X for predetermined reference signal 1, and the UE reports CSI information to the base station with the new indicator configured as Y for predetermined reference signal 2, this indicates that the UE is capable of performing simultaneous multi-panel-based transmission with reference to reference signal 1 and reference signal 2. The base station may refer to the CSI information to which the new indicator is added and which is reported by the UE, to instruct the UE to perform simultaneous multi-panel-based transmission, and may configure the two TCI states based on the CSI information.

In other words, one or more of the above CSI reporting methods that the UE may perform may allow the base station to identify a reference signal that the UE may refer to in determining the combination of uplink beams that may be simultaneously transmitted to the multiple panels.

Using the identified combination of reference signals, the base station may activate codepoints for indicating a TCI state (e.g., a maximum of eight codepoints for a MAC CE-based TCI state or any value greater than eight (e.g., 16) may be activated. Each codepoint may indicate one or two TCI states in the case of a joint TCI state, one or two TCI-states and/or one or two TCI-UL-states in the case of a separate TCI state) and may indicate one codepoint of the multiple codepoints through DCI (when two or more codepoints are activated via the MAC CE). In this case, two TCI states (assuming a joint TCI state) may be indicated to the codepoint indicated by the base station to the UE through DCI, and a combination of reference signals of QCL type D of the two TCI states may correspond to a combination of reference signals, provided through CSI reporting by the UE to the base station through the methods described above (one or a combination of methods). Since such a combination of reference signals represents reference signals that the UE may refer to in determining the uplink beam for simultaneous transmission of uplink signals to multiple panels, the UE may perform simultaneous multi-panel transmissions by using the TCI state indicated by the corresponding codepoint.

### Second Embodiment: Method for Supporting Enhanced Simultaneous Multi-Panel Transmissions

The second embodiment specifically describes a method in which a UE performs more flexible panel selection and enhanced simultaneous uplink transmissions using K panels (where K is a positive integer greater than 2, e.g., K=4).

If a fixed wireless access (FWA), a customer premises equipment (CPE), or a vehicle is used to support uplink transmission and reception, more multi-panel operations may be supported based on a wider form factor compared to a hand held device. For example, FWA or CPE devices may have a cylindrical or box-like shape, be larger than a typical smartphone, and may be disposed in a fixed location. These devices may use multiple reception panels for receiving downlink signals transmitted from various directions and multiple transmission panels for transmitting uplink signals so that they may be received at multiple points. If two transmission and reception panels are used, each panel should transmit and receive uplink signals over a range of approximately 180 degrees. This has a disadvantage in that the signal transmission and reception performance decreases from the center of the panel to both ends in terms of effective aperture. If more than two transmission and reception panels are used, for example, four panels, each panel may support transmitting and receiving uplink signals over a range of about 90 degrees, and the performance decrease from the center of the panel to both ends may be less than that of a device operating based on two panels (this refers to that the transmission and reception performance at both ends is decreased compared to the center, but the performance decrease is less than that of a device using two panels).

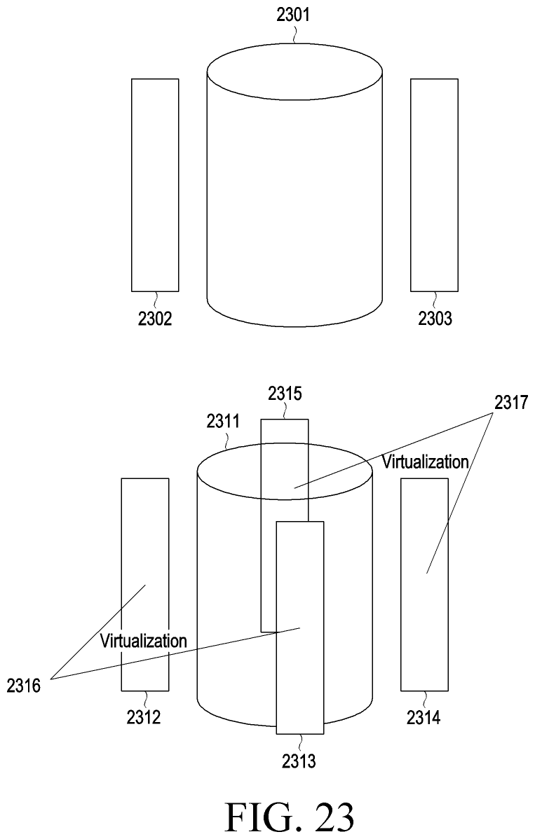

FIG. 23 illustrates a UE structure using multiple panels according to an embodiment. Referring to FIG. 23, a UE device 2301 is configured by two panels 2302 and 2303 and a UE device 2310 is configured by four panels 2312, 2313, 2314, and 2315. The respective panels 2302 and 2303 of the UE device 2301, which is configured by two panels, receive downlink signals and transmit uplink signals in different directions of about 180 degrees. The respective panels 2312, 2313, 2314, and 2315 of the UE device 2311, which is configured by four panels, receive downlink signals and transmit uplink signals in different directions of about 90 degrees. Alternatively, the UE device 2311 configured by four panels may virtualize two panels and use the virtualized two panels similarly as one panel 2316 or 2317. For example, the first panel 2312 and the second panel 2313 may be virtualized to configure one large panel 2316, and the third panel 2314 and fourth panel 2315 may be virtualized to configure one large panel 2317. The UE may use two large panels 2316 and 2317 configured by virtualization to receive downlink signals and transmit uplink signals in different directions of 180 degrees.

If a UE configured by four panels may flexibly virtualize the four panels according to the current channel status, the beamforming gain that may be obtained from spatial diversity and array gain may be maximized.

However, even if the UE uses a panel flexibly, if the base station does not schedule the corresponding uplink and downlink signals, a gain that may be obtained by using the flexible panel may be limited. For example, when supporting the uplink, if configuration of only two SRS resource sets is possible (SRS resource sets described in the second embodiment of the disclosure all refer to SRS resource sets, the usage of which is configured as codebook or nonCodebook), it may be difficult to configure the SRS resource sets to correspond to each panel. If codebook-based PUSCH is supported and the number of SRS ports of the SRS resources configured in multiple SRS resource sets is the same, precoding considering the number of antenna ports of the virtualized panel may be difficult even if the panel is operated flexibly through virtualization. This is because, when the UE uses the panel flexibly depending on channel conditions, the base station has difficulty identify in real time the number of antenna ports the UE uses to transmit a PUSCH.

### Third Embodiment

A method for enhancing group-based beam reporting is specifically described so that a UE may report to a base station the number of antenna ports supportable when transmitting and receiving uplink and downlink channels based on multiple panels.

In the third embodiment, there is described a method of augmenting a group-based beam reporting method to allow a UE to report, to a base station, an operable beam and an antenna port that the UE can support for the corresponding beam, if the UE is capable of performing transmission to and reception from more than two panels and a flexible panel operation is possible.

In addition, described is a method in which a base station schedules transmission and reception channels for a UE, by considering flexible panel operations based on enhanced group-based beam reporting.

### Fourth Embodiment

The fourth embodiment, described later herein in more detail, describes a method in which, to effectively support more than two panels, the UE selects two or more beams as one group and reports the same to the base station, and the base station may support the UE based on the selection.

As described above, a UE capable of performing transmission and reception through two or more panels may flexibly select a panel to transmit and receive uplink and downlink channels depending on channel situations. For example, a UE capable of operating four panels may select two of the four panels to receive downlink signals. Alternatively, the UE may virtualize two of the four panels and select two virtualized panels (selecting all four panels in total) to transmit an uplink signal.

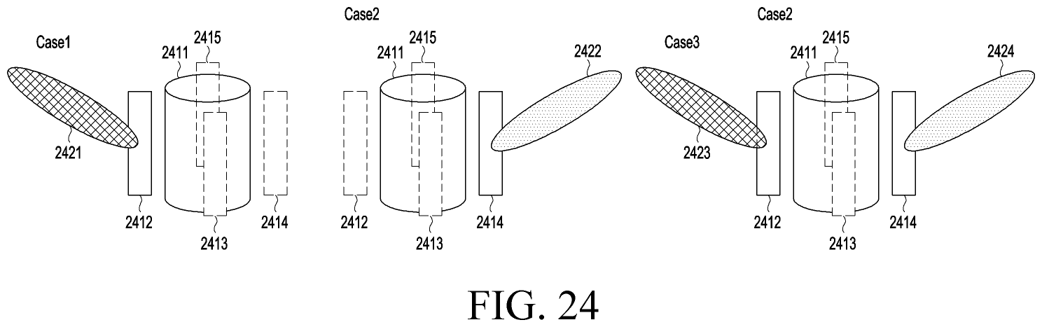

FIG. 24 illustrates the first example of a panel operation method by a UE configured by four panels according to an embodiment.

Referring to FIG. 24, assuming that each panel of the UE shown in FIG. 24 is configured by two antenna ports, and the UE may perform 2Tx uplink transmission and 2Rx downlink reception by using one panel. In Case 1, the UE may perform uplink channel transmission to one TRP (TRP1) by using a first panel 2412. The UE may perform uplink channel transmission by using the first panel 2412 configured by two antennas and an uplink beam 2421 determined by referring to a TCI state indicated by a base station (e.g., the first TCI state among multiple TCI states, etc.). In Case 2, the UE may perform uplink channel transmission to the other TRP (TRP2) by using a third panel 2414. The UE may perform uplink channel transmission by using the third panel 2414 configured by two antennas and an uplink beam 2422 determined by referring to a TCI state indicated by a base station (e.g., the second TCI state among multiple TCI states, etc.). In Case 3, the UE may simultaneously perform uplink channel transmission to two TRPs (TRP1 and TRP2) by using the first panel 2412 and the third panel 2414. The UE may perform uplink channel transmission to TRP 1 by using the first panel 2412 configured by two antennas and an uplink beam 2423 determined by referring to a TCI state indicated by a base station (e.g., the first TCI state among multiple TCI states, etc.), and may simultaneously perform uplink channel transmission to TRP 2 by using the third panel 2414 configured by two antennas and an uplink beam 2424 determined by referring to a TCI state indicated by a base station (e.g., the second TCI state among multiple TCI states, etc.).

Case 1 and Case 2 show a method in which the UE transmits an uplink signal to a single TRP by using a single panel, and Case 3 shows a method in which the UE simultaneously transmits an uplink signal to multiple TRPs by using multiple panels (two panels). As such, the UE may select, among K panels (K is a positive integer equal to or greater than 2, e.g., 4), k panels (k is a positive integer equal to or less than K, e.g., 1 or 2) so as to use either a single TRP panel selection-based uplink channel transmission or a multi-TRP multi-panel selection-based simultaneous uplink transmission technique. Although FIG. 24 is explained based on a method for uplink channel transmission, the UE may receive a downlink channel by using a reception beam determined based on k panels selected among K panels and the indicated TCI state. The UE in FIG. 24 may select a panel to perform single TRP transmission and reception or multiple TRP simultaneous transmission and reception.

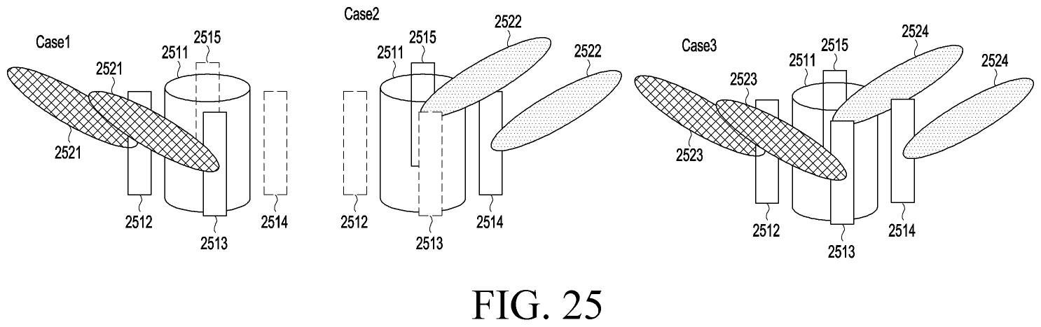

FIG. 25 illustrates a second example of a panel operation method by a UE configured by four panels according to an embodiment.

Referring to FIG. 25, assuming that each panel of the UE shown in FIG. 25 is configured by two antenna ports, and the UE may perform 2Tx uplink transmission and 2Rx downlink reception by using one panel. If the two panels are virtualized and operate like a single panel, the UE may use the corresponding virtualized panel to perform 4Tx uplink transmission and 4Rx downlink reception. In Case 1, the UE may perform uplink channel transmission to one TRP (TRP1) by using a first panel 2512 and a second panel 2513. The first panel 2512 and the second panel 2513 are virtualized and may be used like a single panel. The UE may perform uplink channel transmission by using a panel obtained by virtualizing the first panel 2512 and the second panel 2513 each configured by two antennas and an uplink beam 2521 determined by referring to a TCI state indicated by a base station (e.g., the first TCI state among multiple TCI states, etc.).

The UE is capable of performing 4Tx uplink transmission because both panels 2412 and 2413 transmit uplink signals to TRP1 through the virtualized panel. In Case 2, the UE may perform uplink channel transmission to the other TRP (TRP2) by using a third panel 2514 and a fourth panel 2515. The third panel 2514 and the fourth panel 2515 each configured by two antennas are virtualized and may be used like a single panel. The UE may perform uplink channel transmission by using a panel obtained by virtualizing the third panel 2514 and the fourth panel 2515 each configured by two antennas and an uplink beam 2522 determined by referring to a TCI state indicated by a base station (e.g., the second TCI state among multiple TCI states, etc.). The UE is capable of performing 4Tx uplink transmission because both panels 2514 and 2515 transmit uplink signals to TRP2 through the virtualized panel. In Case 3, the UE may simultaneously perform uplink channel transmission to two TRPs (TRP1 and TRP2) by using all of the first panel to the fourth panel 2512, 2513, 2514, and 2515. The UE may use two virtualized panels, in which the first panel 2512 and the second panel 2513 are virtualized, and the third panel 2514 and the fourth panel 2515 are virtualized. The UE may perform uplink channel transmission to TRP1 by using a panel obtained by virtualizing the first panel 2512 and the second panel 2513 each configured by two antennas and an uplink beam 2523 determined by referring to a TCI state indicated by a base station (e.g., the first TCI state among multiple TCI states, etc.), and may simultaneously perform uplink channel transmission to TRP2 by using a panel obtained by virtualizing the third panel 2514 and the fourth panel 2515 each configured by two antennas and an uplink beam 2524 determined by referring to a TCI state indicated by the base station (e.g., the second TCI state among multiple TCI states, etc.). Case 1 and Case 2 show a method in which the UE transmits an uplink signal to a single TRP by using a panel obtained by virtualizing multiple panels, and Case 3 shows a method in which the UE simultaneously transmits an uplink signal to multiple TRPs by using multiple virtualized panels obtained by virtualizing multiple panels. As such, the UE may virtualize k′ panels (k′ is a positive integer greater than 1, e.g., 2) among K panels (K is a positive integer equal to or greater than 2, e.g., 4), and may select some or all of k virtualized panels to use the same in a single TRP virtualized panel selection-based uplink channel transmission or a multi-TRP virtualized panel selection-based simultaneous uplink transmission technique. Although FIG. 25 is explained based on a method for uplink channel transmission, the UE may receive a downlink channel by using a reception beam determined based on k virtualized panels, in which k′ panels among the K panels are virtualized, and the indicated TCI state. FIG. 25 is just a transmitting and receiving uplink and downlink signals by selecting some of multiple panels, and the UE may select a panel to perform virtualization thereof and may perform single TRP transmission and reception or multiple TRP simultaneous transmission and reception by using some or all of the virtualized panels. In addition, while FIGS. 24 and 25 assume that all panels of the UE are configured with the same number of antenna ports, the number of antenna ports configured on each panel may differ, and the number of panels constituting a virtualized panel may also differ.

When performing multi-panel multi-TRP simultaneous transmission and reception, the number of panels transmitting and receiving uplink and downlink channels for each TRP may be different.

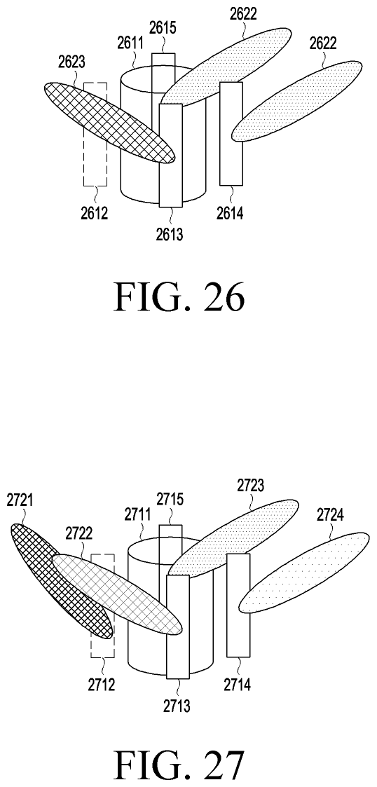

FIG. 26 illustrates an operation in which a UE configured by two or more panels simultaneously transmits and receives an uplink/downlink channel according to an embodiment.

Referring to FIG. 26, the UE transmits the uplink channel to one TRP by using a second panel 2613. The UE may perform uplink channel transmission by using the second panel 2613 configured by two antennas and an uplink beam 2621 determined by referring to a TCI state indicated by a base station (e.g., the first TCI state among multiple TCI states, etc.). The UE performs uplink channel transmission to another TRP using the third panel 2614 and the fourth panel 2615. The third panel 2614 and the fourth panel 2615 of the UE are virtualized and may be used as one panel. The UE may perform uplink channel transmission by using a panel obtained by virtualizing the third panel 2614 and the fourth panel 2615 and an uplink beam 2622 determined by referring to a TCI state indicated by a base station (e.g., the second TCI state among multiple TCI states, etc.). Unlike the examples previously described in FIG. 24 or FIG. 25, the example described in FIG. 26 shows when the number of antennas of panels or virtualized panels for transmitting the uplink channel to each TRP is different. In other words, more various panel operations may be supported depending on the channel status between the TRP and the UE.

A more enhanced beam reporting method may be needed in order for the base station to schedule the UE to select a panel according to a channel situation and perform simultaneous transmission and reception based on the selected panel, similar to those described in FIG. 24, 25, or 26. If the UE reports, to the base station, only the RSRP (or differential RSRP) measured when receiving a resource group (beam group) and a reference signal included in the resource group through group-based beam reporting, the problem may occur such that the base station is unable to identify information about the number of antennas of a panel that the UE uses to transmit and receive simultaneously based on the reference signals included in the reported resource group. In other words, the base station may implicitly know information about a beam groups on which the UE can perform simultaneous transmission and reception through group-based beam reporting and a channel state (channel quality) estimated when using the beam group. The base station schedules the uplink and downlink channels only by referring to the maximum number of antenna ports reported by the UE as being capable of being supported. For example, it is assumed that a UE may use four panels and may use a large-virtualized panel obtained by virtualizing multiple panels. Additionally, it is assumed that the four panels each are configured by two antenna ports, and that a virtualized panel configured by two panels is configured by four antenna ports, which is the sum of the antenna ports of the two panels. The UE may report to the base station that a maximum of four antenna ports may be used. However, if the UE selects and supports a panel other than a virtualized panel in a specific channel situation, a problem occurs in that the base station is unable to identify a panel operation method that the UE has changed, as follows.

Referring to FIGS. 24 and 25, if the UE may support the various operations shown in FIGS. 24 and 25, the UE may report, to the base station, UE capabilities indicating that uplink/downlink transmission to and reception from the base station are enabled using a maximum of four antenna ports. The UE may also report, to the base station, UE capabilities indicating that simultaneous multi-panel-based transmission and reception techniques are supportable. Based on the capabilities reported by the UE, the base station may configure, in the UE, higher layer parameters capable of supporting four antenna ports and higher layer parameters capable of supporting multi-panel transmission and reception techniques. Thereafter, the UE may be scheduled by the base station to perform group-based beam reporting, and the UE may determine a group of resources (beam groups) that can simultaneously perform transmission and reception in consideration of the channel conditions and report the same to the base station. In this case, some of the various resource groups selected by the UE may refer to combinations of beams that are simultaneously transmitted to and received from a panel other than a virtualized panel, as illustrated in FIG. 24. Some of the remaining of the various resource groups selected by the UE may refer to combinations of beams that are simultaneously transmitted to and received from at least one virtualized panel, as illustrated in FIG. 25.

While the UE knows information about the panel configuration at the time of selecting the corresponding resource group, the base station is unable to identify specific information about the panel configuration. Thereafter, when the base station selects one of the resource groups reported by the UE and indicates a TCI state based on the selected resource group to schedule a simultaneous multi-panel transmission and reception method, the base station may perform indication of the number of transmission/reception layers, precoding, or precoding matrix, etc. Based on the number of maximum antenna ports, etc. without specific UE panel configuration information. For example, even if the base station schedules the UE to simultaneously transmit uplink signals to multiple panels through two antenna ports for each panel, in Case 3 in FIG. 24, the base station should provide, to the UE, an indication of the SRI and TPMI (in case of supporting codebook-based PUSCH transmission) for each panel based on the maximum number of antenna ports reported by the UE, which is 4. This is because the base station is unable to know that the UE uses only two antenna ports for each panel when performing simultaneous multi-panel transmissions based on the corresponding resource group.

To solve the above problem, the following group-based beam reporting method may be enhanced to support the base station in identifying antenna port information used by the UE according to a resource group.

### Group Based Beam Reporting Enhancement Method

When a UE performs group-based beam reporting capable of supporting simultaneous transmission and reception, a Capability index for each reference signal resource reported in each resource group may be additionally reported to a base station. For example, the UE may perform simultaneous transmission by using an uplink beam determined based on a reference signal indicated by CRI #1 and a reference signal indicated by CRI #2 in a first resource group. The UE may additionally report the maximum number of SRS ports that may be supported when transmitting an uplink channel using an uplink beam determined by the reference signal indicated by CRI #1. Additionally, the maximum number of supported SRS ports that may be supported when the UE transmits an uplink channel using an uplink beam determined by the reference signal indicated by CRI #2 may be additionally reported. If the UE reports multiple resource groups, the maximum number of SRS ports that may be supported for all reference signal resources in all reporting resource groups may be reported.

The number of SRS ports may refer to the number of antennas that the UE may support when transmitting an uplink channel. Alternatively, the number of SRS ports may refer to the maximum number of reception antenna ports instead of the maximum number of supported SRS ports. Alternatively, assuming that the maximum number of supported SRS ports that the UE may support and the maximum number of reception antenna ports are the same, the maximum number of supported SRS ports or the maximum number of reception antenna ports may be used interchangeably. The operation of the base station and the UE is described in detail based on the maximum number of supported SRS ports, but in a different sense, a newly introduced CSI field area is used to indicate the maximum number of antenna ports that the UE may operate. In Table 78 below, the UE may report to the base station by adding the capability index to the CSI field to report the maximum number of supported SRS ports for each beam of resource groups to be reported.

TABLE 78

| CSI report number | CSI fields |
|---|---|
| CSI report #n | Resource set indicator |
| | CRI or SSBRI #1 of 1st resource group, if reported |
| | CRI or SSBRI #2 of 1st resource group, if reported |
| | CRI or SSBRI #1 of 2nd resource group, if reported |
| | CRI or SSBRI #2 of 2nd resource group, if reported |
| | CRI or SSBRI #1 of 3rd resource group, if reported |
| | CRI or SSBRI #2 of 3rd resource group, if reported |
| | CRI or SSBRI #1 of 4th resource group, if reported |
| | CRI or SSBRI #2 of 4th resource group, if reported |
| | RSRP of CRI or SSBRI #1 of 1st resource group |
| | Differential RSRP of CRI or SSBRI |
| | #2 of 1st resource group |
| | Differential RSRP of CRI or SSBRI |
| | #1 of 2nd resource group, if reported |
| | Differential RSRP of CRI or SSBRI |
| | #2 of 2nd resource group, if reported |
| | Differential RSRP of CRI or SSBRI |
| | #1 of 3rd resource group, if reported |
| | Differential RSRP of CRI or SSBRI |
| | #2 of 3rd resource group, if reported |
| | Differential RSRP of CRI or SSBRI |
| | #1 of 4th resource group, if reported |
| | Differential RSRP of CRI or SSBRI |
| | #2 of 4th resource group, if reported |
| | Capability Index of CRI or SSBRI |
| | #1 of 1st resource group |
| | Capability Index of CRI or SSBRI |
| | #2 of 1st resource group |
| | Capability Index of CRI or SSBRI |
| | #1 of 2nd resource group, if reported |
| | Capability Index of CRI or SSBRI |
| | #2 of 2nd resource group, if reported |
| | Capability Index of CRI or SSBRI |
| | #1 of 3rd resource group, if reported |
| | Capability Index of CRI or SSBRI |
| | #2 of 3rd resource group, if reported |
| | Capability Index of CRI or SSBRI |
| | #1 of 4th resource group, if reported |
| | Capability Index of CRI or SSBRI |
| | #2 of 4th resource group, if reported |

In Table 78, the CapabilityIndex for each reported reference signal resource indicates the maximum number of supported SRS ports (maximum number of reception antenna ports) required to transmit (receive) using the corresponding beam, that is, a UE capability value. The number of bits in the CSI field to indicate the UE capability value may be determined as ┌log₂ C┐ according to the number C of codepoints that may be indicated through CapabilityIndex. For example, if the total number of codepoints that may be indicated through CapabilityIndex is 4, the number of bits in the CSI field to indicate CapabilityIndex is log₂ 4=2. The UE capability value that the UE may report to the base station through CapabilityIndex may be determined through the following method.

### UE Capability Value Codepoint Determination Method

The value indicated by capability index may be determined based on the UE capability report. When the UE reports the UE capability to the base station, the value of the UE capability value that the UE may support and a codepoint to indicate this value through CapabilityIndex may be reported to the base station through the UE capability. For example, the UE may configure the parameter value for UE capability reporting and report the same to the base station as shown in Table 79 below.

TABLE 79
-- ASN1START
-- TAG-MIMO-PARAMETERSPERBAND-START

| | |
|---|---|
| MIMO-ParametersPerBand ::= | SEQUENCE { |

... omit...
-- R1 23-1-4 UE capability value reporting

| | |
|---|---|
| srs-PortReport-rxx | SEQUENCE { |
| capVal1-rxx | ENUMERATED {n1, n2, n4, n8} |

OPTIONAL,

| | |
|---|---|
| capVal2-rxx | ENUMERATED {n1, n2, n4, n8} |

OPTIONAL,

| | |
|---|---|
| capVal3-rxx | ENUMERATED {n1, n2, n4, n8} |

OPTIONAL,

| | |
|---|---|
| capVal4-rxx | ENUMERATED {n1, n2, n4, n8} |

OPTIONAL,
}
OPTIONAL,
...omit ...
}

In Table 79, the value configured for each capVal1 to capVal4 may be n1, n2, n4, n8, or any other value indicating the maximum number of SRS ports that the UE may support. The UE determines the values configured for each capVal1 to capVal4 to be configured as different values. Alternatively, the UE may support not only capVal1 to capVal4 but also a larger number of capValCs (where C is a positive integer greater than 4).

### Alternative UE Capability Value Codepoint Determination Method

The base station and the UE pre-define a codepoint so that the value indicated by CapabilityIndex may be determined. Unlike the previous UE capability value codepoint determination method, since the UE reports the UE capability value to the base station based on the codepoint, pre-defined by the UE and the base station, there is no need for separate UE capability reporting to determine the codepoint as described above in the previous UE capability value codepoint determination method. However, although it is standardly defined to have more than four codepoints, if only some codepoints are available due to the structure of the UE, etc., there is a disadvantage in that unnecessary bits may increase when configuring the CSI field.

Table 80 below shows a codepoints for reporting the UE capability value that is predefined by the base station and UE and that may be defined in the standard according to UE capability value codepoint determination method 2.

TABLE 80

| CapabilityIndex | UE capability value |
|---|---|
| 0 | n1 |
| 1 | n2 |
| 2 | n4 |
| . . . | |
| C-1 | n_x |

In Table 80, C refers to the number of codepoints to indicate the maximum number of SRS ports that is supportable by pre-defined C different UEs, and the CSI field bitwidth of CapabilityIndex may be defined as a ┌log₂ C┐ bit to indicate a total of C codepoints. n_x refers to the maximum number of SRS ports that is supportable by the UE and may be defined as the maximum number of SRS ports that may be defined in any NR Release or 6G system. For example, n_x may be defined as ‘8’.

### Alternative Group-Based Beam Reporting Enhancement Method

When a UE performs group-based beam reporting capable of supporting simultaneous transmission and reception, a Capability index for each resource group may be additionally reported to the base station. For example, the UE may perform simultaneous transmission with an uplink beam determined based on a reference signal indicated by CRI #1 and a reference signal indicated by CRI #2 in the first resource group. The UE may determine the maximum number of SRS ports supportable by the UE so that the maximum number of SRS ports supportable when transmitting an uplink channel using the uplink beam determined by the reference signal indicated by CRI #1 is the same as the maximum number of SRS ports supportable when transmitting an uplink channel using the uplink beam determined by the reference signal indicated by CRI #2, and may report the determined maximum number of SRS ports to a base station. If the UE reports multiple resource groups, the maximum number of SRS ports that can be supported by one of all reporting resource groups may be reported. The number of SRS ports may refer to the number of antennas that the UE may support when transmitting an uplink channel. Alternatively, the number of SRS ports may refer to the maximum number of reception antenna ports instead of the maximum number of supported SRS ports. Alternatively, assuming that the maximum number of supported SRS ports that the UE may support and the maximum number of reception antenna ports are the same, the maximum number of supported SRS ports or the maximum number of reception antenna ports may be used interchangeably. The operation of the base station and the UE is described in detail below based on the maximum number of supported SRS ports, but in a different sense, a newly introduced CSI field area is used to indicate the maximum number of antenna ports that the UE may operate. The UE may report to the base station by adding the capability index to the CSI field to report the maximum number of supported SRS ports for the reporting resource group, as shown in Table 81 below.

TABLE 81

| CSI report number | CSI fields |
|---|---|
| CSI report #n | Resource set indicator |
| | CRI or SSBRI #1 of 1st resource group, if reported |
| | CRI or SSBRI #2 of 1st resource group, if reported |
| | CRI or SSBRI #1 of 2nd resource group, if reported |
| | CRI or SSBRI #2 of 2nd resource group, if reported |
| | CRI or SSBRI #1 of 3rd resource group, if reported |
| | CRI or SSBRI #2 of 3rd resource group, if reported |
| | CRI or SSBRI #1 of 4th resource group, if reported |
| | CRI or SSBRI #2 of 4th resource group, if reported |
| | RSRP of CRI or SSBRI #1 of 1st resource group |
| | Differential RSRP of CRI or SSBRI |
| | #2 of 1st resource group |
| | Differential RSRP of CRI or SSBRI |
| | #1 of 2nd resource group, if reported |
| | Differential RSRP of CRI or SSBRI |
| | #2 of 2nd resource group, if reported |
| | Differential RSRP of CRI or SSBRI |
| | #1 of 3rd resource group, if reported |
| | Differential RSRP of CRI or SSBRI |
| | #2 of 3rd resource group, if reported |
| | Differential RSRP of CRI or SSBRI |
| | #1 of 4th resource group, if reported |
| | Differential RSRP of CRI or SSBRI |
| | #2 of 4th resource group, if reported |
| | Capability Index of 1st resource group |
| | Capability Index of 2nd resource group, if reported |
| | Capability Index of 3rd resource group, if reported |
| | Capability Index of 4th resource group, if reported |

In Table 81, the CapabilityIndex for each reported reference signal resource indicates the maximum number of supported SRS ports (maximum number of reception antenna ports) required to transmit (receive) using the corresponding beam, that is, a UE capability value. The number of bits of the CSI field to indicate the UE capability value may be determined as ┌log₂ C┐ according to the number C of codepoints that may be indicated through CapabilityIndex. In addition, the UE capability value indicated through CapabilityIndex may be defined in the same manner as the UE capability value codepoint determination method 1 or UE capability value codepoint determination method 2 described above.

To support the above enhanced group-based beam reporting method, additional UE capability reporting is required to inform the base station that the UE may also support enhanced group-based beam reporting (e.g., ‘enhancedGroupgBeamReporting’, etc.) as well as the UE capabilities related to simultaneous transmission and reception of multiple panels. If the UE reports, to the base station, UE capabilities indicating that enhanced group-based beam reporting is supportable, the base station may separately configure, in the UE, higher layer parameters to support enhanced group-based beam reporting. The base station may configure these higher layer parameters in the UE at a level such as per UE, per serving cell, or per BWP.

Through enhanced group-based beam reporting, the base station may identify the beam group that the UE may transmit and receive simultaneously, the RSRP for the beams within the beam group, and the maximum number of antenna ports (or maximum SRS ports) that the UE may support when supporting the corresponding beam.

The base station may configure multiple SRS resource sets for uplink transmission with respect to a UE that may support a simultaneous multi-panel-based transmission and reception method. If the UE may support the above-mentioned enhanced group-based beam reporting and may additionally report CapabilityIndex to the base station as well as information about the beam group, the base station may configure the SRS resource set in the UE, to schedule a flexible uplink channel by considering the supporting and reporting of the UE, in the following method.

### Multi-SRS Resource Set Configuration Method

If codebook-based PUSCH is supported, the base station may configure SRS resource(s) to support different numbers of SRS ports in the SRS resource set. Even if the UE does not support full power mode2 transmission, SRS resources with the higher layer parameter ‘nrofSRS-Ports’ configured as different values may be configured in one SRS resource set. For example, the base station may configure two SRS resource sets in the UE. In addition, each SRS resource set may include one SRS resource with ‘nrofSRS-Ports’ configured as ‘ports2’ and one SRS resource with ‘nrofSRS-Ports’ configured as ‘ports4’. That is, a total of two SRS resources are configured in each SRS resource set, one SRS resource may support two SRS ports, and the other SRS resource may support four SRS ports. If the UE supports enhanced group-based beam reporting and may report the CapabilityIndex for the reference signal resource within each resource group (beam group) according to [Group-based beam reporting enhancement method 1], the UE may report, to the base station, the maximum number of SRS ports, which are supportable via CapabilityIndex, with respect to the reference signal resources of the first resource group and the second resource group. The UE may report that the UE may support a maximum of two SRS ports with respect to the first reference signal resource and the second reference signal resource of the first resource group, and a maximum of four SRS ports with respect to the first reference signal resource and the second reference signal resource of the second resource group.

The base station may, by referring to the enhanced group-based beam reporting of the UE, activate and indicate, to the UE, two TCI states (each different reference signal is configured as referenceSignal) associated with the two reference signal resources of the first resource group (the referenceSignal configured in the QCL-Info of typeD being configured with the corresponding reference signal resource). Based on this, the UE may use two SRS ports each when performing uplink transmission associated with each TCI state. To schedule the PUSCH, the base station may indicate, as SRI, SRS resources for supporting two SRS ports and indicate a TPMI (precoder to support 2Tx) corresponding thereto to the UE. Similarly, the base station may, by referring to the enhanced group-based beam reporting of the UE, activate and indicate, to the UE, two TCI states associated with the two reference signal resources of the second resource group. Based on this, the UE may use four SRS ports each when performing uplink transmission associated with each TCI state. To schedule PUSCH, the base station may indicate, as SRI, SRS resources for supporting four SRS ports and indicate a TPMI (precoder to support 4Tx) corresponding thereto to the UE. Since the bitwidth of TPMI to support 2Tx and the bitwidth of TPMI to support 4Tx may be different, the base station and the UE may predetermine the bitwidth of the TPMI assuming that it has the maximum bitwidth and may use the leftmost bits in order and consider the remaining bits as reserved. Alternatively, the rightmost bits may be used in order and the remaining bits may be considered reserved.

### Alternative Multi-SRS Resource Set Configuration Method

As another SRS resource set configuration method, a base station may configure an SRS resource based on the maximum number of SRS ports that the UE may support. If codebook-based PUSCH is supported and the maximum number of supportable SRS ports reported by the UE to the base station is four, the base station may configure, in the UE, an SRS resource with ‘nrofSRS-Ports’ configured as ‘ports4’ in multiple SRS resource sets. If the UE supports enhanced group-based beam reporting, it may be assumed that enhanced group-based beam reporting has been performed as described above in the previous Multi-SRS resource set configuration method. The base station may, by referring to the enhanced group-based beam reporting of the UE, activate and indicate, to the UE, TCI states associated with the two reference signal resources of the first resource group. Based on this, the UE may use two SRS ports each when performing uplink transmission associated with each TCI state.

The base station may schedule to transmit SRS resource sets for PUSCH transmission to the UE before scheduling the PUSCH. Since the TCI states indicated by the base station to the UE indicate uplink and downlink beams transmitted and received using two SRS ports, the UE may transmit SRS resources configured to use four SRS ports in the SRS resource to the base station, by using only two SRS ports. Specifically, if the UE supports a codebook-based PUSCH, the UE may transmit SRS resources for transmitting four SRS ports in the SRS resource set by using only two SRS ports. Depending on the implementation of UE, the SRS resource may be transmitted using only the first two SRS ports among the four SRS ports, the SRS resource may be transmitted using only the last two SRS ports, or the SRS resource may be transmitted by selecting two SRS ports from among four SRS ports. The UE may not transmit the remaining two SRS ports to the base station. If the UE supports a non-codebook-based PUSCH, the UE may transmit only two SRS resources among four SRS resources in the SRS resource set. Depending on the implementation of UE, the first two SRS resources of the four SRS resources may be transmitted, the last two SRS resources may be transmitted, or two SRS resources of any four SRS resources may be selected and transmitted. The UE may not transmit the remaining two SRS resources to the UE. The base station may, by referring to the enhanced group-based beam reporting, activate and indicate the TCI state associated with the two reference signal resources of the second resource group to the UE. Based on this, the UE may use four SRS ports each when performing uplink transmission associated with each TCI state. Unlike the case of using two SRS ports each when performing uplink transmission associated with each TCI state described above, all four SRS ports configured in the SRS resource are used (if codebook-based PUSCH is supported) or all four SRS resources may be used (if non-codebook-based PUSCH is supported).

The reason for configuring an SRS resource set based on the maximum number of SRS ports that the UE may support is that an uplink and downlink beam group to be transmitted and received by the UE may be changed according to a TCI state indicated by the base station, and the maximum number of SRS ports that the UE may support may be updated according to a beam group indicated through a TCI state. Therefore, higher layer parameters are configured by considering the maximum number of SRS ports and rules may be defined to transmit uplink channels by considering only the actual number of ports that the UE may operate according to the indicated TCI state among the configured number of SRS ports. If the UE supports a non-codebook-based PUSCH, a bitwidth of an SRI field in DCI that schedules the PUSCH transmitted by the base station to the UE may be determined according to the number of SRS resources configured in the SRS resource set, and even when only some of the SRS resources are actually transmitted by the UE according to the indicated TCI state, the SRI field may be indicated the same as when all SRS resources are used. This is because when the UE does not receive any SRS resource, the base station will not schedule the UE to transmit the PUSCH using the SRS resource that the UE does not transmit. In addition, the number of available SRS resources may be updated depending on the TCI state, and to schedule the uplink channel without a separate higher layer parameter reconfiguration, the bitwidth of the fields in the DCI should be determined based on the maximum number of bits so that the number of bits in the DCI fields does not change.

For convenience of explanation, the operations of the base station and the UE have been described in detail based on the operation of the UE transmitting the uplink channel, especially the PUSCH. However, similarly in the case of transmitting the downlink channel, the described method is applied to allow the UE to perform simultaneous reception.

Fourth embodiment: The fourth embodiment describes a method in which a UE selects some or all of multiple panels according to channel conditions and transmits and receives uplink and downlink simultaneously based on multiple panels. Specifically, when supporting more than two panels, different transmission and reception beams may be formed using two or more panels. This embodiment proposes an enhanced group-based beam reporting method to support enabling simultaneous operation of transmission and reception beams optimized for a channel between each panel and a base station, and specifically describes the operations of the base station and UE using the same.

As shown in FIG. 24 of the third embodiment, the UE may select some of the multiple panels to transmit and receive uplink and downlink channels to a specific TRP, or may select panels including a virtualized panel, among the multiple panels as shown in FIGS. 25 and 26, and transmit and receive uplink and downlink channels to a specific TRP. According to the simultaneous multi-panel transmission method described in the third embodiment, a maximum of two transmission and reception beams are reported as one resource group and two TCI states may be indicated based thereon to transmit and receive the uplink channel. However, if the UE may support more than two panels, the UE may use the same number of different transmission and reception beams as the maximum number of panels that the UE may support. Accordingly, different transmission and reception beams may be determined by UE implementation based on the same TCI state, but the UE may also determine different transmission and reception beams based on different TCI states. The base station may support more than two TRPs, and may instruct the UE to transmit and receive uplink and downlink channels based on different reference signals for each TRP.

FIG. 27 illustrates a UE that performs simultaneous transmission with four different transmission beams by using four panels according to an embodiment.

Referring to FIG. 27, a UE is shown that performs simultaneous transmission with four different transmission beams 2721 to 2724 by using four panels 2712 to 2715.

To support a simultaneous multi-panel transmission and reception technique based on more than two transmission and reception beams, enhanced group-based beam reporting needs to be supported first. The following methods may be considered to perform beam reporting to support a simultaneous multi-panel transmission and reception technique based on more transmission and reception beams.

### Higher Layer Parameter Configuration Method for Enhanced Beam Reporting

The base station may increase, to a number greater than two, the number of reference signal resource sets (e.g., SSB resource sets or CSI resource sets) configured to support enhanced group-based beam reporting to the UE. With respect to reference signals for indicating the transmission and reception beams capable of simultaneously transmitting and receiving uplink and downlink signals, using multiple panels, to and from more than two reference signal resource sets, the UE may report one reference signal from each of reference signal resource sets and select the reported reference signals as a group. The UE may report UE capabilities to the base station. The UE may report, to the base station, UE capabilities to report that simultaneous uplink and downlink transmission and reception using two or more transmission and reception beams are possible.

As to the UE capability reported by the UE to the base station, a parameter such as ‘NrofSimultaneousRx-Tx-STxMP’ may be used to report that the UE may support more than two simultaneous transmission and reception beams, and the UE may report to the base station by configuring the corresponding parameters to have a value of ‘n3’, ‘n4’, etc. Thereafter, the base station may configure higher layer parameters in the UE based on the UE capabilities reported by the UE. The base station may include parameters to support simultaneous multi-panel transmission and reception in the higher layer parameters to be configured for the UE. For example, the base station may configure, in the UE, parameters for simultaneous multi-panel-based transmission techniques that the UE can support and that the base station is to support (e.g., STxMPScheme may be configured as a value of one of spatial domain multiplexing (‘SDM’), single frequency network (‘SFN’), and etc., or a combination of multiple values). Additionally, higher layer parameters (e.g., ‘enhancedGroupBasedBeamReporting’ or ‘multipleTCIState’) may be configured to report more than two simultaneous transmission and reception beams and support simultaneous transmission and reception techniques based on the same. For example, if the base station has configured ‘enhancedGroupBasedBeamReporting’, the base station may configure, in the UE, the parameter ‘nrofReportedGroups-rxx’ to indicate the number of beam groups to be reported by the UE within the corresponding higher layer parameters as one or a combination of n1, n2, n3, n4, or a ng indicating a positive integer greater than 4. Additionally, the base station may determine the number of beams included in one beam group through additional parameters in ‘enhancedGroupBasedBeamReporting’ and configure the same in the UE. For example, the base station may configure ‘nrofReportedBeams-rxx’ in the UE as one or a combination of n2, n3, n4, or nk indicating a positive integer k greater than 4. As such, if the base station has configured, in the UE, ‘enhancedGroupBasedBeamReporting’ and ‘nrofReportedGroups-rxx’ and ‘nrofReportedBeams-rxx’ in the corresponding higher layer parameters, the parameters for configuring CSI resources to perform enhanced group-based beam reporting may be indicated to the UE.

The higher layer parameter ‘enhancedGroupBasedBeamReporting’ described above may be configured in one or multiple CSI-ReportConfigs. In other words, the UE may identify that the CSI report reported based on CSI-ReportConfig with the higher layer parameter ‘enhancedGroupBasedBeamReporting’ configured is an enhanced group-based beam report. The CSI-ResourceConfig associated with the CSI-ReportConfig in which the higher layer parameter ‘enhancedGroupBasedBeamReporting’ is configured may be indicated by CSI-ResourceConfigId. Multiple reference signal resource sets may be configured in the CSI-ResourceConfig associated with the CSI-ResportConfig in which ‘enhancedGroupBasedBeamReporting’ is configured. For example, if the CSI RS resource set is used for group-based beam reporting, the base station may configure multiple NZP-CSI-RS-ResourceSetIds in CSI-ResourceConfig as the value of nzp-CSI-RS-ResourceSetList and provide an indication of the configuration to the UE. For example, if ‘nrofReportedBeams-rxx’ in ‘enhancedGroupBasedBeamReporting’ is configured as n4, four NZP-CSI-RS-ResourceSetIds may be configured in nzp-CSI-RS-ResourceSetList. Alternatively, if the SSB resource set is used for group-based beam reporting, the base station may add and configure csi-SSB-ResourceSetListExt-rxx in CSI-ResourceConfig and configure multiple CSI-SSB-ResourceSetIds with the corresponding value. Assuming that ‘nrofReportedBeams-rxx’ in ‘enhancedGroupBasedBeamReporting’ is configured as n4, the base station may configure csi-SSB-ResourceSetListExt-rxx such that the number of the CSI-SSB-ResourceSetIds configured in csi-SSB-ResourceSetList and csi-SSB-ResourceSetListExt-r17 and the number of CSI-SSB-ResourceSetIds configured in csi-SSB-ResourceSetListExt-rxx are four in total and provide an indication thereof to the UE.

Alternatively, the base station may configure the csi-SSB-ResourceSetListExt-rxx such that the number of the CSI-SSB-ResourceSetIds configured in the csi-SSB-ResourceSetList and the csi-SSB-ResourceSetListExt-rxx are four in total and provide an indication thereof to the UE. If the csi-SSB-ResourceSetListExt-rxx has been configured, the UE may disregard the csi-SSB-ResourceSetListExt-r17. Alternatively, the base station may configure the csi-SSB-ResourceSetListExt-rxx such that the number of the CSI-SSB-ResourceSetIds configured in the csi-SSB-ResourceSetListExt-rxx are four in total and provide an indication thereof to the UE. Further, if the csi-SSB-ResourceSetListExt-rxx has been configured, the UE may disregard the csi-SSB-ResourceSetList and csi-SSB-ResourceSetListExt-r17. If CSI reporting with ‘enhancedGroupBasedBeamReporting’ configured is performed aperiodically, CSI-AssociatedReportConfigInfo may be configured according to the configured ‘enhancedGroupBasedBeamReporting’ as shown in Table 82 below.

TABLE 82

| | |
|---|---|
| CSI-AssociatedReportConfigInfo ::= | SEQUENCE { |

| reportConfigId | | CSI-ReportConfigId, |
|---|---|---|
| resourcesForChannel | | CHOICE { |
| nzp-CSI-RS | | SEQUENCE { |
| | resourceSet | INTEGER (1..maxNrofNZP-CSI-RS- |

ResourceSetsPerConfig),

| | |
|---|---|
| qcl-info | SEQUENCE (SIZE(1..maxNrofAP-CSI-RS- |

ResourcesPerSet)) OF TCI-StateId

| | |
|---|---|
| OPTIONAL | -- Cond Aperiodic |

},

| | |
|---|---|
| csi-SSB-ResourceSet | INTEGER (1..maxNrofCSI-SSB-ResourceSetsPerConfig) |

},

| | |
|---|---|
| csi-IM-ResourcesForInterference | INTEGER(1..maxNrofCSI-IM-ResourceSetsPerConfig) |

OPTIONAL, -- Cond CSI-IM-ForInterference

| | |
|---|---|
| nzp-CSI-RS-ResourcesForInterference | INTEGER (1..maxNrofNZP-CSI-RS-ResourceSetsPerConfig) |

```
OPTIONAL, -- Cond NZP-CSI-RS-ForInterference
  ...,
  [[
```

| | |
|---|---|
| resourcesForChannel2-r17 | CHOICE { |

| nzp-CSI-RS2-r17 | | SEQUENCE { |
|---|---|---|
| | resourceSet2-r17 | INTEGER (1..maxNrofNZP-CSI-RS- |

ResourceSetsPerConfig),

| | |
|---|---|
| qcl-info2-r17 | SEQUENCE (SIZE(1..maxNrofAP-CSI-RS- |

ResourcesPerSet)) OF TCI-StateId

| | |
|---|---|
| OPTIONAL | -- Cond Aperiodic |

},

| | |
|---|---|
| csi-SSB-ResourceSet2-r17 | INTEGER (1..maxNrofCSI-SSB-ResourceSetsPerConfigExt) |

},

| | |
|---|---|
| OPTIONAL, | -- Cond NoUnifiedTCI |

| | |
|---|---|
| csi-SSB-ResourceSetExt | INTEGER (1..maxNrofCSI-SSB-ResourceSetsPerConfigExt) |

| | |
|---|---|
| OPTIONAL | -- Need R |

```
  ]]
  [[
```

| | |
|---|---|
| resourcesForChannel3-rxx | CHOICE { |

| nzp-CSI-RS3-rxx | | SEQUENCE { |
|---|---|---|
| | resourceSet3-rxx | INTEGER (1..maxNrofNZP-CSI-RS- |

ResourceSetsPerConfig),

| | |
|---|---|
| qcl-info3-rxx | SEQUENCE (SIZE(1..maxNrofAP-CSI-RS- |

ResourcesPerSet)) OF TCI-StateId

| | |
|---|---|
| OPTIONAL | -- Cond Aperiodic |

},

| | |
|---|---|
| csi-SSB-ResourceSet3-rxx | INTEGER (1..maxNrofCSI-SSB-ResourceSetsPerConfigExt) |

}

| | |
|---|---|
| OPTIONAL, | -- Cond NoUnifiedTCI |

...

| | |
|---|---|
| resourcesForChannelk-rxx | CHOICE { |

| nzp-CSI-RSk-rxx | | SEQUENCE { |
|---|---|---|
| | resourceSetk-rxx | INTEGER (1..maxNrofNZP-CSI-RS- |

ResourceSetsPerConfig),

| | |
|---|---|
| qcl-infok-rxx | SEQUENCE (SIZE(1..maxNrofAP-CSI-RS- |

ResourcesPerSet)) OF TCI-StateId

| | |
|---|---|
| OPTIONAL | -- Cond Aperiodic |

},

| | |
|---|---|
| csi-SSB-ResourceSetk-rxx | INTEGER (1..maxNrofCSI-SSB-ResourceSetsPerConfigExt) |

}

| | |
|---|---|
| OPTIONAL, | -- Cond NoUnifiedTCI |

| | |
|---|---|
| csi-SSB-ResourceSetExt2 | INTEGER (1..maxNrofCSI-SSB-ResourceSetsPerConfigExt2) |

| | |
|---|---|
| OPTIONAL | -- Need R |

]]

}

In Table 82, if the base station and UE do not operate based on the unified TCI framework, configuration may be made as resourcesForChannel3-rxx to resourcesForChanelk-rxx and csi-SSB-ResourceSet3-rxx to csi-SSB-ResourceSetk-rxx of Table 82. That is, the base station may provide, to the UE, an indication of higher layer parameters for indicating QCL information for each reference signal resource set. If operating based on the unified TCI framework, resourcesForChannel3-rxx to resourcesForChanelk-rxx and csi-SSB-ResourceSet3-rxx to csi-SSB-ResourceSetk-rxx of Table 82 may not be configured.

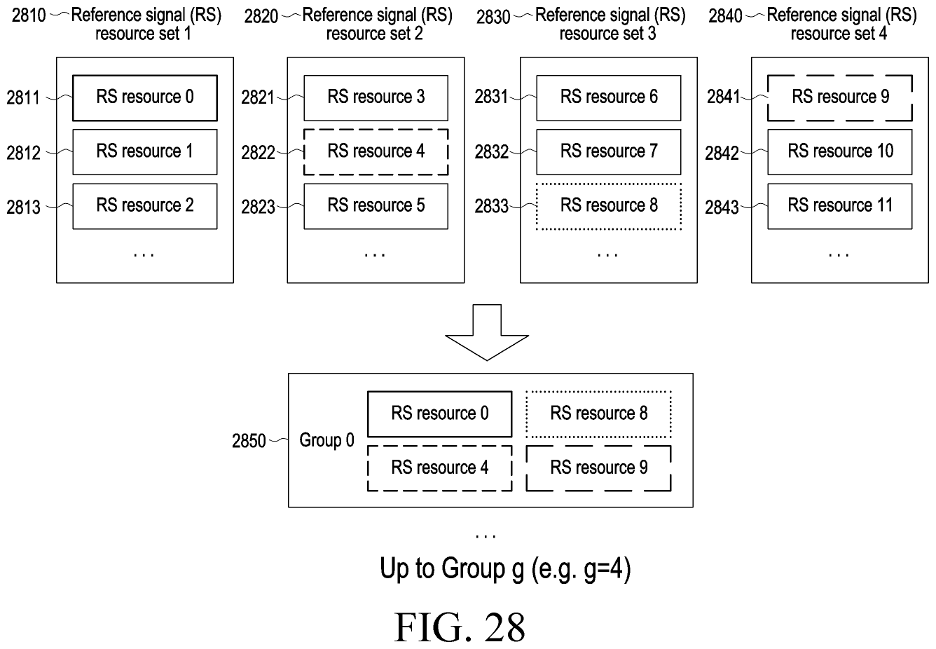

FIG. 28 illustrates a method by which a UE determines a reference signal resource group by using four different reference signal resource sets according to an embodiment. Referring to FIG. 28, the UE may receive, from a base station, CSI-ResourceConfig and CSI-ReportConfig with which four R) resource sets 2810, 2820, 2830, and 2840 are associated to perform enhanced group-based beam reporting. Resource indexes for multiple reference signal resources 2811, 2812, and 2813 may be configured in first reference signal resource set 1. For example, if the corresponding reference signal resource set is a CSI resource set, any NZP-CSI-RS-ResourceSet may be configured as the first resource set, and an NZP-CSI-RS-ResourceSetId of the NZP-CSI-RS-ResourceSet corresponding to the CSI-ResourceConfig may be configured. The first reference signal resource set 1 in the example may be interpreted as an NZP-CSI-RS-ResourceSet having a corresponding NZP-CSI-RS-ResourceSetId. Similarly, FIG. 28 may be interpreted in the same manner as for the second reference signal resource set 2 to the fourth reference signal resource set 4. NZP-CSI-RS-Resource may be configured as reference signals 2811, 2812, and 2813 included in the reference signal resource set. The NZP-CSI-RS-ResourceId, as an index for the corresponding reference signal resource, may be configured in the NZP-CSI-RS-ResourceSet. In other words, NZP-CSI-RS-Resources corresponding to the reference signals 2811, 2812, and 2813 may be configured for the NZP-CSI-RS-ResourceSet corresponding to the first reference signal set 1.

Reference signals 2821, 2822, and 2823 within the second reference signal resource set 2 2820, reference signals 2831, 2832, and 2833 within the third reference signal resource set 3 2830, and reference signals 2841, 2842, and 2843 within the fourth reference signal resource set 4 2840 may be configured. When performing CSI reporting according to the corresponding CSI-ReportConfig, the UE may receive reference signals from associated reference signal resource sets, and based on the received reference signals, the UE may select a combination of reference signals that may be simultaneously transmitted and received by the UE and determine the selected combination of reference signals as one group. For example, the UE may simultaneously receive, through multiple panels, first reference signal resource RS resource 0 2811 of the first reference signal resource set 1 2810, second reference signal resource RS resource 4 2822 of the second reference signal resource set 2 2820, third reference signal resource RS resource 8 2833 of the third reference signal resource set 3 2830, and first reference signal resource RS resource 9 2841 of the fourth reference signal resource set 4 2840. The UE may organize the corresponding reference signals into a single resource group 2850 if the UE may simultaneously transmit a transmission beam (or a transmit spatial filter, etc.) determined by referring to the corresponding reference signals through multiple panels. The total number of resource groups to be determined by the UE may be determined through the higher layer parameter ‘nrofReportedGroups-rxx’, and g groups each may be configured by four reference signals as described above. Alternatively, if more than four reference signal resource sets (e.g., 6) are configured, the number of reference signals included in one resource group may be the same as the number of configured reference signal resource sets (e.g., 6).

This is assumed to be a CSI resource set for ease of explanation but may be configured to an SSB resource set as described above. Further, if an SSB resource set is configured, the reference signal resource sets of FIG. 28 may be interpreted as CSI-SSB-ResourceSets, and the reference signal resources may be interpreted as SSB resources indicated by the SSB-Index configured in the CSI-SSB-ResourceSet. The specific examples have assumed that the higher layer parameters are configured to have a specific value (e.g., ‘nrofReportedGroups-rxx’ is n4, ‘nrofReportedBeams-rxx’ is n4). However, this is just one example and is configured as different values based on the same rules, and based on this configuration, the UE may perform enhanced group-based beam reporting.

### Alternative Higher Layer Parameter Configuration Method for Enhanced Beam Reporting

A base station may configure two reference signal resource sets (e.g., SSB resource sets or CSI resource sets) to support enhanced group-based beam reporting to a UE. Unlike the previous higher layer parameter configuration method for enhanced beam reporting, which configures more than two reference signal resource sets, the base station configures two reference signal resource sets in the UE according to the alternative higher layer parameter configuration method for enhanced beam reporting]. The UE may select one or more reference signal resources capable of simultaneous multi-panel-based transmission and reception within each reference signal resource set and determine the selected reference signal resources as a resource group. The base station and the UE may define a total number of reference signal resources to be determined by the UE from the two reference signal resource sets. This may be determined using the higher layer parameter ‘nrofReportedBeams-rxx’, etc., as described above. For convenience of explanation, in the example described later, assuming when ‘nrofReportedBeams-rxx’ is configured as n4, the UE may determine four reference signal resources capable of simultaneous transmission and reception as one group. The base station and the UE may predefine the number of reference signal resources selected for each reference signal resource set or configure the same through higher layer parameters. For example, the base station and the UE may select

$$⌈ \frac{k}{2} ⌉$$

reference signal resources (e.g., two reference signal resources if k=4) from the first reference signal resource set, and may select

$$k - ⌈ \frac{k}{2} ⌉$$

reference signal resources (e.g., two reference signal resources if k=4) from the second reference signal resource without separate higher layer parameter configuration.

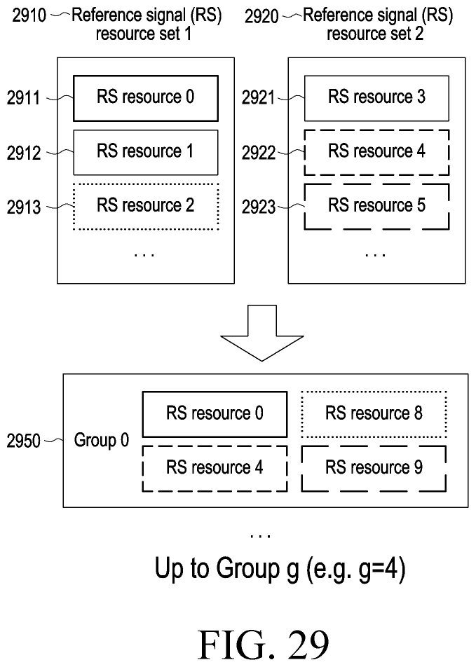

FIG. 29 illustrates a method in which a UE determines four reference signal resources as one group by using two different reference signal resource sets according to an embodiment.

Referring to FIG. 29, the UE may receive, from a base station, CSI-ResourceConfig and CSI-ReportConfig with which two RS resource sets 2910 and 2920 are associated to perform enhanced group-based beam reporting. Resource indexes for multiple reference signal resources 2911, 2912, and 2913 may be configured in first reference signal resource set 1. For example, if the corresponding reference signal resource set is a CSI resource set, any NZP-CSI-RS-ResourceSet may be configured as the first resource set, and an NZP-CSI-RS-ResourceSetId of the NZP-CSI-RS-ResourceSet corresponding to the CSI-ResourceConfig may be configured. The first reference signal resource set 1 in the example may be interpreted as an NZP-CSI-RS-ResourceSet having a corresponding NZP-CSI-RS-ResourceSetId. Similarly, FIG. 29 may be interpreted in the same manner as for the second reference signal resource set 2. NZP-CSI-RS-Resource may be configured as reference signals 2911, 2912, and 2913 included in the reference signal resource set. The NZP-CSI-RS-ResourceId, as an index for the corresponding reference signal resource, may be configured in the NZP-CSI-RS-ResourceSet. In other words, NZP-CSI-RS-Resources corresponding to the reference signals 2911, 2912, and 2913 may be configured for the NZP-CSI-RS-ResourceSet corresponding to the first reference signal set 1. Reference signals 2921, 2922, and 2923 within the second reference signal resource set 2 2920 may be configured. When performing CSI reporting according to the corresponding CSI-ReportConfig, the UE may receive reference signals from associated reference signal resource sets, and based on the received reference signals, the UE may select a combination of reference signals that may be simultaneously transmitted and received by the UE and determine the selected combination of reference signals as one group. For example, the UE may simultaneously receive, through multiple panels, first reference signal resource RS resource 0 2911 and third reference signal resource RS resource 2 2913 of the first reference signal resource set 1 2910, and second reference signal resource RS resource 4 2922 and third reference signal resource RS resource 2923 of the second reference signal resource set 2 2920.

The UE may organize the corresponding reference signals into a single resource group 2950 if the UE may simultaneously transmit a transmission beam (or a transmit spatial filter, etc.) determined by referring to the corresponding reference signals through multiple panels. The total number of resource groups to be determined by the UE may be determined through the higher layer parameter ‘nrofReportedGroups-rxx’, and g groups each may be configured by four reference signals as described above. This is just one example, and the number of reference signal resources selected by the UE may be different for each reference signal resource set. For example, the UE may select only one reference signal resource from the first reference signal resource set and selects the remaining (k−1) (for example, 3 if k=4) reference signal resources from the second reference signal resource set and may determine the selected reference signal resources as one resource group. In addition, a number of different combinations may be selected from each reference signal resource set. Alternatively, the base station may configure the number of reference signals to be selected from the first reference signal resource along with ‘nrofReportedBeams-rxx’ in the UE via higher layer parameters. For example, the base station may configure ‘nrofBeamsforFirstSet’ (or this may be some higher layer parameter with another name that performs the same function) along with ‘nrofReportedBeams-rxx’ in the UE, and candidate values of ‘nrofBeamsforFirstSet’ may have a value less than or equal to nk configured in the ‘nrofReportedBeams-rxx’. If the ‘nrofBeamsforFirstSet’ is configured to have a value of nk, the UE may select all reference signal resources within one resource group from the first reference signal resource set. Conversely, if the ‘nrofBeamsforFirstSet’ is configured to have a value of n0, the UE may select all reference signal resources within one resource group from the second reference signal resource set. This is just one example, and according to the rules defined by the base station and the UE, the UE may select multiple reference signal resources that may be transmitted and received simultaneously to multiple panels from two sets of reference signal resources and determine the selected multiple reference signal resources as one resource group.

It is assumed to be a CSI resource set, but it may also be configured as an SSB resource configured as described above. Further, if an SSB resource set is configured, the reference signal resource sets of FIG. 29 may be interpreted as CSI-SSB-ResourceSets, and the reference signal resources may be interpreted as SSB resources indicated by the SSB-Index configured in the CSI-SSB-ResourceSet. The specific examples have assumed that the higher layer parameters are configured to have a specific value (e.g., ‘nrofReportedGroups-rxx’ is n4, ‘nrofReportedBeams-rxx’ is n4). However, this is just one example and is configured as different values based on the same rules, and based on this configuration, the UE may perform enhanced group-based beam reporting.

The foregoing higher layer parameter configuration methods for enhanced beam reporting may be used in combination with each other. For example, the base station may configure four reference signal resource sets in the UE, and may also configure higher layer parameters in the UE to report six reference signal resources of the four reference signal resource sets as one resource group. In this case, the UE may also select one or more reference signal resources from one reference signal resource set.

As such, the two higher layer parameter configuration methods for enhanced beam reporting have described a specific method in which a base station configures higher layer parameters in a UE in order for the UE to perform enhanced group-based beam reporting, and a method in which a UE determines a resource group configured by multiple reference signal resources based on the specific method. Various methods in which a UE determines a resource group based thereon are further described, and a CSI field configuration method for reporting the determined resource group to a base station and the meaning of each field are specifically described.

In addition to the methods for determining resource groups previously described, a UE may additionally consider one of the following methods to determine the reference signal resources included in the resource group(s).

### Reference Signal Resource Determination Method

As described above, all k reference signal resources may be selected according to the nk configured as the higher layer parameter ‘nrofReportedBeams-rxx’ and determined as one resource group. Table 83 below shows the CSI field format in which a UE report the resource groups included in the four reference signal resources when the ‘nrofReportedGroups-rxx’ has a maximum value of n4 and ‘nrofReportedBeams-rxx’ has a maximum value of n4.

TABLE 83

| CSI report number | CSI fields |
|---|---|
| CSI report #n | Resource set indicator |
| | CRI or SSBRI #1 of 1st resource group, if reported |
| | CRI or SSBRI #2 of 1st resource group, if reported |
| | CRI or SSBRI #3 of 1st resource group, if reported |
| | CRI or SSBRI #4 of 1st resource group, if reported |
| | CRI or SSBRI #1 of 2nd resource group, if reported |
| | CRI or SSBRI #2 of 2nd resource group, if reported |
| | CRI or SSBRI #3 of 2nd resource group, if reported |
| | CRI or SSBRI #4 of 2nd resource group, if reported |
| | CRI or SSBRI #1 of 3rd resource group, if reported |
| | CRI or SSBRI #2 of 3rd resource group, if reported |
| | CRI or SSBRI #3 of 3rd resource group, if reported |
| | CRI or SSBRI #4 of 3rd resource group, if reported |
| | CRI or SSBRI #1 of 4th resource group, if reported |
| | CRI or SSBRI #2 of 4th resource group, if reported |
| | CRI or SSBRI #3 of 4th resource group, if reported |
| | CRI or SSBRI #4 of 4th resource group, if reported |
| | RSRP of CRI or SSBRI #1 of 1st resource group |
| | Differential RSRP of CRI or SSBRI |
| | #2 of 1st resource group |
| | Differential RSRP of CRI or SSBRI |
| | #3 of 1st resource group |
| | Differential RSRP of CRI or SSBRI |
| | #4 of 1st resource group |
| | Differential RSRP of CRI or SSBRI |
| | #1 of 2nd resource group, if reported |
| | Differential RSRP of CRI or SSBRI |
| | #2 of 2nd resource group, if reported |
| | Differential RSRP of CRI or SSBRI |
| | #3 of 2nd resource group, if reported |
| | Differential RSRP of CRI or SSBRI |
| | #4 of 2nd resource group, if reported |
| | Differential RSRP of CRI or SSBRI |
| | #1 of 3rd resource group, if reported |
| | Differential RSRP of CRI or SSBRI |
| | #2 of 3rd resource group, if reported |
| | Differential RSRP of CRI or SSBRI |
| | #3 of 3rd resource group, if reported |
| | Differential RSRP of CRI or SSBRI |
| | #4 of 3rd resource group, if reported |
| | Differential RSRP of CRI or SSBRI |
| | #1 of 4th resource group, if reported |
| | Differential RSRP of CRI or SSBRI |
| | #2 of 4th resource group, if reported |
| | Differential RSRP of CRI or SSBRI |
| | #3 of 4th resource group, if reported |
| | Differential RSRP of CRI or SSBRI |
| | #4 of 4th resource group, if reported |

As shown in Table 83, the CSI field for CSI reporting may include indexes to indicate four reference signal resources within each reference signal resource group (1^{st} resource group to 4^{th} resource group) and may include a differential RSRP to report a differential RSRP value between the received RSRP for each reference signal indicated by the index and the largest RSRP value of all reference signals being reported. In Table 83, the resource set indicator field may be a resource set indicator augmented to indicate a reference signal resource set including reference signals received with the largest RSRP value among more than two reference signal resource sets, as described later, or may be a resource set indicator augmented using another method.

### Alternative Reference Signal Resource Determination Method

The UE may select k′ reference signal resources, which are part of the k reference signal resources, according to nk configured via the higher layer parameter ‘nrofReportedBeams-rxx’ and determine the same as one resource group. The UE may select a different number of reference signal resources for each of the multiple resource groups according to ‘nrofReportedGroups-rxx’, or may select the same k′ number of reference signal resources for all resource groups.

Table 84 below shows a CSI field in which the ‘nrofReportedGroups-rxx’ has a maximum value of n4 and the UE selects a different number of reference signal resources for each resource group to report CSI information to the base station.

TABLE 84

| CSI report number | CSI fields |
|---|---|
| CSI report #n | Resource set indicator |
| | The number k′₁ of resource of 1st |
| | resource group, if reported |
| | CRI or SSBRI #1 of 1st resource group, if reported |
| | . . . |
| | CRI or SSBRI #k′₁ of 1st resource group, if reported |
| | The number k′₂ of resource of |
| | 2nd resource group, if reported |
| | CRI or SSBRI #1 of 2nd resource group, if reported |
| | . . . |
| | CRI or SSBRI # k′₂ of 2nd resource group, if reported |
| | The number k′₃ of resource of |
| | 3rd resource group, if reported |
| | CRI or SSBRI #1 of 3rd resource group, if reported |
| | . . . |
| | CRI or SSBRI # k′₃ of 3rd resource group, if reported |
| | The number k′₄ of resource of |
| | 4th resource group, if reported |
| | CRI or SSBRI #1 of 4th resource group, if reported |
| | . . . |
| | CRI or SSBRI # k′₄ of 4th resource group, if reported |
| | RSRP of CRI or SSBRI #1 of 1st resource group |
| | Differential RSRP of CRI or |
| | SSBRI #2 of 1st resource group |
| | . . . |
| | Differential RSRP of CRI or SSBRI |
| | # k′₁ of 1st resource group |
| | Differential RSRP of CRI or SSBRI #1 |
| | of 2nd resource group, if reported |
| | . . . |
| | Differential RSRP of CRI or SSBRI # k′₂ |
| | of 2nd resource group, if reported |
| | Differential RSRP of CRI or SSBRI #1 |
| | of 3rd resource group, if reported |
| | . . . |
| | Differential RSRP of CRI or SSBRI # k′₃ |
| | of 3rd resource group, if reported |
| | Differential RSRP of CRI or SSBRI #1 |
| | of 4th resource group, if reported |
| | . . . |
| | Differential RSRP of CRI or SSBRI # k′₄ |
| | of 4th resource group, if reported |
| | reserved |

In Table 84, k′₁ to k′₄, which refers to the number of reference signals included in each resource group, may be any number greater than (or greater than or equal to) 0 and less than or equal to k. The number of bits in the field for indicating k′₁ to k′₄ may be equal to ┌log₂ k┐. The number of bits in the full CSI field for performing enhanced group-based beam reporting may be determined considering when the full resource group includes up to k reference signal resources, and if at least one of k′₁ to k′₄ has a value less than k, there may be a ‘reserved’ field of 1 bit or more.

Alternatively, the UE may select k′ greater than 0 and less than k as shown in Table 85 below and select reference signal resources within all reference signal resource groups based on this selection.

TABLE 85

| CSI report number | CSI fields |
|---|---|
| CSI report #n | Resource set indicator |
| | The number k′ of resource of |
| | 1st resource group, if reported |
| | CRI or SSBRI #1 of 1st resource group, if reported |
| | . . . |
| | CRI or SSBRI #k′ of 1st resource group, if reported |
| | CRI or SSBRI #1 of 2nd resource group, if reported |
| | . . . |
| | CRI or SSBRI # k′ of 2nd resource group, if reported |
| | CRI or SSBRI #1 of 3rd resource group, if reported |
| | . . . |
| | CRI or SSBRI # k′ of 3rd resource group, if reported |
| | CRI or SSBRI #1 of 4th resource group, if reported |
| | . . . |
| | CRI or SSBRI # k′ of 4th resource group, if reported |
| | RSRP of CRI or SSBRI #1 of 1st resource group |
| | Differential RSRP of CRI or SSBRI |
| | #2 of 1st resource group |
| | . . . |
| | Differential RSRP of CRI or SSBRI |
| | # k′ of 1st resource group |
| | Differential RSRP of CRI or SSBRI #1 |
| | of 2nd resource group, if reported |
| | . . . |
| | Differential RSRP of CRI or SSBRI # k′ of |
| | 2nd resource group, if reported |
| | Differential RSRP of CRI or SSBRI #1 of |
| | 3rd resource group, if reported |
| | . . . |
| | Differential RSRP of CRI or SSBRI # k′ of |
| | 3rd resource group, if reported |
| | Differential RSRP of CRI or SSBRI #1 of |
| | 4th resource group, if reported |
| | . . . |
| | Differential RSRP of CRI or SSBRI # k′ |
| | of 4th resource group, if reported |
| | reserved |

Different than in Table 84, in Table 85 the UE may select one k′ and select k′ reference signal resources capable of simultaneous transmission and reception within each resource group. The number of bits in the field to indicate the number k′ of reference signals included in the full resource group may be equal to ┌log₂ k┐. Similarly, if k′ has a value smaller thank, a ‘reserved’ field of 1 bit or more may exist.

### Additional Reference Signal Resource Determination Method

The base station may configure the number of reference signals included in each resource group in the UE via higher layer parameters. Previously, in the prior reference signal resource determination method, the UE determines the number of reference signals included in each resource group or all resource groups and reports them together to the base station. In contrast to the UE determining k′₁ to k′₄ described above and reporting them to the base station, the base station may also configure k′₁ to k′₄ in the UE. That is, instead of configuring ‘nrofReportedBeams-rxx’ as one value of k, such as nk, the base station may configure the number of reference signals that the UE should select for each number of resource groups, such as k′1 to k′4.

Table 86 below shows the CSI field format for reporting resource groups by the UE to the base station when the ‘nrofCeportedGroups-rxx’ has a maximum value of n4 and the base station configures the number k′₁ to k′₄ of reference signals included in each reference signal group via higher layer parameters.

TABLE 86

| CSI report number | CSI fields |
|---|---|
| CSI report #n | Resource set indicator |
| | CRI or SSBRI #1 of 1st resource group, if reported |
| | . . . |
| | CRI or SSBRI #k′₁ of 1st resource group, if reported |
| | CRI or SSBRI #1 of 2nd resource group, if reported |
| | . . . |
| | CRI or SSBRI # k′₂ of 2nd resource group, if reported |
| | CRI or SSBRI #1 of 3rd resource group, if reported |
| | . . . |
| | CRI or SSBRI # k′₃ of 3rd resource group, if reported |
| | CRI or SSBRI #1 of 4th resource group, if reported |
| | . . . |
| | CRI or SSBRI # k′₄ of 4th resource group, if reported |
| | RSRP of CRI or SSBRI #1 of 1st resource group |
| | Differential RSRP of CRI or SSBRI |
| | #2 of 1st resource group |
| | . . . |
| | Differential RSRP of CRI or SSBRI |
| | # k′₁ of 1st resource group |
| | Differential RSRP of CRI or SSBRI #1 |
| | of 2nd resource group, if reported |
| | . . . |
| | Differential RSRP of CRI or SSBRI # k′₂ |
| | of 2nd resource group, if reported |
| | Differential RSRP of CRI or SSBRI #1 |
| | of 3rd resource group, if reported |
| | . . . |
| | Differential RSRP of CRI or SSBRI # k′₃ |
| | of 3rd resource group, if reported |
| | Differential RSRP of CRI or SSBRI #1 |
| | of 4th resource group, if reported |
| | . . . |
| | Differential RSRP of CRI or SSBRI # k′₄ |
| | of 4th resource group, if reported |

Since the number of resource groups and the number of reference signal resources included in each resource group are configured and fixed via higher layer parameters, the reserved field described in Tables 84 and 85 may not be needed.

If the enhanced group-based beam reporting method is supported based on two reference signal resource sets, a resource set indicator configured by 1 bit may be used. However, when more than two reference signal resource sets are configured as described in [Higher layer parameter configuration method 1 for enhanced beam reporting], a 1-bit resource set indicator is unable to indicate a reference signal resource set including reference signals received with the largest RSRP. To solve this problem, if more than two reference signal resource sets are configured in the UE as described in [Higher layer parameter configuration method 1 for enhanced beam reporting], the resource set indicator may be supplemented to indicate the following information.

### Enhanced Resource Set Indicator 1

If a base station has configured g reference signal resource sets in a UE, the UE may perform enhanced group-based beam reporting to the base station by configuring a resource set indicator of ┌log₂ g┐ bits to indicate one reference signal resource set that includes reference signals received with the largest RSRP. For example, when the base station has configured four reference signal resource sets in the UE and the third reference signal resource set includes reference signal resources received with the largest RSRP, the UE may configure the resource set indicator as ┌log₂ g┐=┌log₂ 4┐=2 bits and determine two bits of the resource set indicator to be ‘10’ and report the same to the base station. Therefore, the first reference signal resource of each resource group may be selected from the third reference signal resource set, and the remaining reference signal resources may be selected in order from the remaining reference signal resource sets excluding the reference signal resource set including the first reference signal resource. For example, the first reference signal resource of the first resource group may be selected from the third reference signal resource set, the second reference signal resource of the first resource group may be selected from the first reference signal resource set, the third reference signal resource of the first resource group may be selected from the second reference signal resource set, and the fourth reference signal resource of the first resource group may be selected from the fourth reference signal resource set. Similarly, the UE may select reference signal resources for the second to fourth resource groups and report them to the base station.

### Enhanced Resource Set Indicator 2

If a base station has configured g reference signal resource sets in a UE, the UE may report the order of the g reference signal resource sets by using the resource set indicator. The number of bits of the resource set indicator may be defined as ┌log₂ g!┐ (where ! denotes factorial function and g! denotes a value (1·2·3· . . . ·g) multiplied by all positive integers from 1 to g. If g is 4, g! is 24). The codepoint indicated by ┌log₂ g!┐ may refer to one of any values to indicate the order of g reference signal resource sets (for example, if g=4 and the resource set indicator is configured by 5 bits, ‘00000’ may indicate that the first to fourth reference signals of each resource group are selected from the first resource set, second resource set, third resource set, and fourth resource set, and ‘00001’ may indicate that the first to fourth reference signals of each resource group are selected from the first resource set, second resource set, fourth resource set, and third resource set).

### Enhanced Resource Set Indicator 3

Alternatively, one resource set indicator may be configured by a total of g fields, and each field may be configured by ┌log₂ g┐ bits to select one reference signal resource set. The first field indicates a reference signal resource set including the first reference signal resource of each resource group, and the g-th field may indicate a reference signal resource set including the g-th reference signal resource of each resource group. One or more reference signals may be selected from one reference signal resource set and included in a resource group, and there may also be a reference signal resource set from which no reference signal is selected. Alternatively, the resource set indicator may be configured with a field of the maximum number k of reference signal resources included in the resource group, rather than the number g of reference signal resource sets.

### Enhanced Resource Set Indicator 4

When performing enhanced group-based beam reporting, the UE may select reference signal resources within each resource group in the order in which reference signal resource sets are configured, instead of reporting the resource set indicator. The UE may report RSRPs, instead of differential RSRP, to all reference signal resources. The UE may select reference signal resources in the order of reference signal resource sets configured by the higher layer parameters to be selected as a resource group, rather than selecting reference signal resource sets that include reference signal resources received with the largest RSRP. The UE may also report the RSRP measured when receiving each reference signal resource, instead of calculating the differential RSRP.

The group-based beam reporting method described in the above Enhanced Resource set indicators 1-4 have been described assuming that the number of reference signal resources included in the resource group and the number of reference signal resource sets configured in the UE are the same. However, the UE may select a reference signal capable of simultaneous transmission and reception from only some of the reference signal resource sets configured via higher layer parameters and determine the same as a resource group. If a reference signal capable of simultaneous transmission and reception is selected from only some of the full reference signal resource sets, the UE may use a method such as Enhanced Resource set indicator 3 or 4 to indicate the selected some reference signal resource sets, and the number of bits in the resource set indicator field may be increased to indicate the selected some reference signal resource sets.

When configuring multiple reference signal resource sets in the UE, the base station may allow the same reference signal resource to be included in different reference signal resource sets. Alternatively, different reference signal sets may be limited to include only different reference signal resources. If the same reference signal resource is able to be included in multiple reference signal resource sets, the UE may select the same reference signal resource more than once and determine the same as one resource group. For example, when an NZP-CSI-RS resource with NZP-CSI-RS-ResourceId of 1 is included in the first NZP-CSI-RS-ResourceSet and the second NZP-CSI-RS-ResourceSet, the UE may select an NZP-CSI-RS resource with an NZP-CSI-RS-ResourceId of 1 as the first reference signal resource of any one resource group, select an NZP-CSI-RS resource with an NZP-CSI-RS-ResourceId of 1 as the second reference signal resource, select any NZP-CSI-RS resource with an NZP-CSI-RS-ResourceId of not 1, included in the third NZP-CSI-RS-ResourceSet, as the third reference signal resource, and select any NZP-CSI-RS resource with an NZP-CSI-RS-ResourceId of not 1, included in the fourth NZP-CSI-RS-ResourceSet, as the fourth reference signal resource. If the UE is assumed to perform simultaneous transmission and reception using four panels, the UE may determine transmission and reception beams for any two panels (e.g., the first panel and the second panel) based on a reception filter used when receiving the NZP-CSI-RS resource with an NZP-CSI-RS-ResourceId of 1, and may determine transmission and reception beams for the remaining two panels (e.g., the third panel and the fourth panel) based on a reception filter used when receiving the remaining third and fourth reference signals, respectively.

### Fifth Embodiment: TCI State Indication Method for Supporting Enhanced Multi-Panel Selection-Based Simultaneous Transmission and Reception Technique

The fifth embodiment describes a method in which, when a UE supports an enhanced multi-panel selection-based simultaneous transmission and reception technique and performs enhanced group-based beam reporting, the base station indicates a TCI state to the UE by considering group-based beam reporting and performs simultaneous multi-panel transmission and reception.

The base station may receive an enhanced group-based beam report from the UE as described above in the third or fourth embodiment. The base station may activate and indicate the TCI state to support simultaneous multi-panel transmission and reception to the UE based on the reported resource group. For example, the UE has reported four resource groups each including four reference signal resources to the base station according to [Higher layer parameter configuration method 1 for enhanced beam reporting], and the base station may activate the TCI state based on the first resource group among the received four received resource groups. In other words, the base station may configure four TCI states in one codepoint, the first TCI state may indicate the first reference signal resource in the first resource group as the reference signal of QCL info (qcl-type1 and/or qcl-type2), the second TCI state may indicate the second reference signal resource in the first resource group as the reference signal of QCL info (qcl-type1 and/or qcl-type2), the third TCI state may indicate the third reference signal resource in the first resource group as a reference signal of QCL info (qcl-type1 and/or qcl-type2), and the fourth TCI state may indicate the fourth reference signal resource in the first resource group as a reference signal of QCL info (qcl-type1 and/or qcl-type2).

If the UE selects the same reference signal resource more than once and selects the same as one resource group, the base station may configure and activate/indicate, to the UE, different TCI states indicating the same reference signal resource as the reference signal of the QCL info, or may indicate the same TCI state more than once. For example, it is assumed that an NZP-CSI-RS resource with NZP-CSI-RS-ResourceId of 1 is included twice in the first resource group in the group-based beam information reported by the UE, and the base station has configured the NZP-CSI-RS resource with NZP-CSI-RS-ResourceId of 1 as the reference signal of QCL info (qcl-type1 and/or qcl-type2) in the TCI state with TCI-StateId of 1. The base station may activate and indicate the TCI state based on the first resource group by referring to the group-based beam reporting of the UE. In this case, the base station may indicate a TCI state with TCI-StateId of 1 as the first TCI state and the second TCI state.

Alternatively, the base station may indicate one TCI state instead of indicating all overlapping TCI states as above. For example, if a total of four TCI states may be indicated and the first TCI state and the second TCI state have the same reference signal configured as the reference signal of QCL info as above, the base station may indicate three TCI states to the UE instead of four TCI states, and may indicate only once the TCI state having the same reference signal configured as the reference signal of the QCL info.

### Method for Supporting Out-of-Order Scheduling During Multi-DCI-Based Uplink Simultaneous Multi-Panel Transmissions

This method describes RRC configurations and operations required by a base station to schedule multiple overlapping PUSCHs when the UE is capable of supporting multi-DCI-based uplink simultaneous multi-panel transmission techniques and capable of supporting the overlapping PUSCHs in an out-of-order manner in a time domain scheduled with multiple pieces of DCI.

To define in-order and out-of-order scheduling, multiple (for example, two) pieces of DCI that are associated with different coresetPoolIndex may be defined. Among the two pieces of DCI (possible to expand to multiple pieces of DCI, but described as two for convenience of explanation), ‘earlier received DCI (or first DCI)’ may be defined as the DCI for which reception is completed at a predetermined symbol i, and ‘later received DCI (or second DCI)’ may be defined as the DCI for which reception is completed after a predetermined symbol i. The earlier received DCI may schedule a PUSCH for initiating transmission in a predetermined symbol j. In-order-based scheduling refers to a scheduling situation in which the end of a PUSCH for initiating transmission in a symbol j scheduled with earlier received DCI may be followed by the transmission of another PUSCH scheduled with later received DCI. The later received DCI may be received first before the end of the PUSCH scheduled with the earlier received DCI. On the other hand, out-of-order-based scheduling refers to a scheduling situation in which another PUSCH scheduled with the later received DCI may be transmitted even if the PUSCH for initiating transmission in the symbol j scheduled with the earlier received DCI has not ended.

The UE may report UE capabilities for supporting multi-DCI-based uplink simultaneous multi-panel transmissions (hereinafter referred to as mDCI-based STxMP) to the base station. PUSCHs scheduled with DCI associated with different coresetPoolindexes may partially or completely overlap in the time domain. In addition to the UE capabilities to report that supporting of multi-DCI-based uplink simultaneous multi-panel transmissions is possible, the UE may report, to the base station, additional UE capabilities to support out-of-order-based scheduling when supporting multi-DCI-based uplink simultaneous multi-panel transmissions.

When the UE reports, to the base station, additional UE capabilities (hereinafter referred to as mDCI STxMP out-of-order UE capabilities) to support out-of-order-based scheduling when supporting multi-DCI-based uplink simultaneous multi-panel transmissions, the base station may configure additional RRC parameters to support the out-of-order scheduling operations during mDCI-based STxMP operation. That is, when the UE has reported the mDCI STxMP out-of-order UE capability to the base station and the base station configures additional RRC parameters (e.g., out-of-orderformDCISTx2P) based on this report, the UE may expect a PUSCH scheduled with the later received DCI to be overlapped and transmitted before transmitting the PUSCH scheduled with the earlier received DCI is completed. When the UE does not report mDCI STxMP out-of-order UE capability to the base station, or when the UE reports mDCI STxMP out-of-order UE capability to the base station but the base station does not configure additional RRC parameters in the UE to support out-of-order operation, the UE may not expect to be supported with out-of-order operation. In this case, when the earlier received DCI (e.g., first DCI) is defined as DCI for which reception is completed at a timepoint of a symbol i, the later received DCI (e.g., second DCI) may be defined as DCI that is received later than the timepoint of the symbol i. The PUSCH for initiating transmission in the symbol j may be scheduled with the earlier received (or first) DCI, and another PUSCH may be scheduled with the later received (or second) DCI. In this case, if out-of-order operation is not possible, the UE may not be expected to transmit another PUSCH with the later received DCI until all PUSCHs initiating transmission in the symbol j with the earlier received DCI are transmitted. If the UE is capable of out-of-order operation, the UE may be scheduled to transmit another PUSCH with the later received DCI before all PUSCHs initiating transmission in symbol j with the earlier received DCI.

To configure additional RRC parameters in a UE that supports the above-described mDCI STxMP out-of-order UE capabilities, RRC parameters to support mDCI-based STxMP may need to be configured first. For example, to configure additional RRC parameters (e.g., out-of-orderformDCISTx2P), RRC parameters for mDCI-based mTRP STxMP operation (e.g., sTx-2Panel or enableSTx2PofmDCI) may need to be configured. If the base station does not configure the RRC parameters (e.g., sTx-2Panel or enableSTx2PofmDCI) for mDCI-based mTRP STxMP operation, the base station is unable to configure, in the UE, additional RRC parameters (e.g., out-of-orderformDCISTx2P) for indicating that out-of-order scheduling according to the mDCI STxMP out-of-order UE capability is supportable.

In addition to the RRC parameter for indicating whether out-of-order operation is possible when supporting mDCI-based mTRP STxMP, another RRC parameter may be introduced to indicate whether out-of-order operation is possible when transmitting mDCI-based PUSCHs. This supports mDCI-based PUSCH transmissions independent of mDCI-based mTRP STxMP, and here two non-overlapping PUSCHs may be scheduled in out-of-order manner (a scheduling method in which a PUSCH scheduled with later received DCI may be transmitted before a PUSCH scheduled with an earlier received DCI).

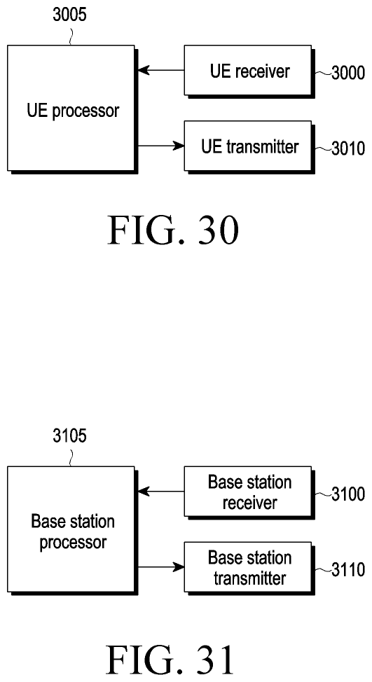

FIG. 30 illustrates a structure of a UE in a wireless communication system according to an embodiment.

Referring to FIG. 30, the UE may include a transceiver, which refers to a UE receiver 3000 and a UE transmitter 3010 as a whole, a memory (not illustrated), and a UE processor 3005 (or UE controller or processor). The UE transceiver 3000 and 3010, the memory, and the UE processor 3005 may operate according to the above-described communication methods of the UE. Components of the UE are not limited to the above-described example. For example, the UE may include a larger or smaller number of components than the above-described components. The transceiver, the memory, and the processor may be implemented in the form of a single chip.

The transceiver may transmit/receive signals with the base station. The signals may include control information and data. this end, the transceiver may include an RF transmitter configured to up-convert and amplify the frequency of transmitted signals, an RF receiver configured to low-noise-amplify received signals and down-convert the frequency thereof, and the like. However, this is only an embodiment of the transceiver, and the components of the transceiver are not limited to the RF transmitter and the RF receiver.

In addition, the transceiver may receive signals through a radio channel, output the same to the processor, and transmit signals output from the processor through the radio channel.

The memory may store programs and data necessary for operations of the UE. In addition, the memory may store control information or data included in signals transmitted/received by the UE. The memory may include storage media such as a ROM, a RAM, a hard disk, a CD-ROM, and a DVD, or a combination of storage media. In addition, the memory may include multiple memories.

The processor may control a series of processes such that the UE can operate according to the above-described embodiments. For example, the processor may control components of the UE to receive DCI configured in two layers so as to simultaneously receive multiple PDSCHs. The processor may include multiple processors, and the processor may perform operations of controlling the components of the UE by executing programs stored in the memory.

FIG. 31 illustrates a structure of a base station in a wireless communication system according to an embodiment.

Referring to FIG. 31, the base station may include a transceiver, which refers to a base station receiver 3100 and a base station transmitter 3110 as a whole, a memory (not illustrated), and a base station processor 3105 (or base station controller or processor). The base station transceiver 3100 and 3110, the memory, and the base station processor 3105 may operate according to the above-described communication methods of the base station. However, components of the base station are not limited to the above-described example. For example, the base station may include a larger or smaller number of components than the above-described components. The transceiver, the memory, and the processor may be implemented in the form of a single chip.

The transceiver may transmit/receive signals with the UE. The signals may include control information and data. To this end, the transceiver may include an RF transmitter configured to up-convert and amplify the frequency of transmitted signals, an RF receiver configured to low-noise-amplify received signals and down-convert the frequency thereof, and the like. However, this is only an embodiment of the transceiver, and the components of the transceiver are not limited to the RF transmitter and the RF receiver.

In addition, the transceiver may receive signals through a radio channel, output the same to the processor, and transmit signals output from the processor through the radio channel.

The memory may store programs and data necessary for operations of the base station. In addition, the memory may store control information or data included in signals transmitted/received by the base station. The memory may include storage media such as a read only memory (ROM), a random access memory (RAM), a hard disk, a CD-ROM, and a digital versatile disc (DVD), or a combination of storage media. In addition, the memory may include multiple memories.

The processor may control a series of processes such that the base station can operate according to the above-described embodiments of the disclosure. For example, the processor may control components of the base station to configure DCI configured in two layers including allocation information regarding multiple PDSCHs and to transmit the same. The processor may include multiple processors, and the processor may perform operations of controlling the components of the base station by executing programs stored in the memory.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

The programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

Herein, each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. The “unit” in embodiments may include one or more processors.

While the disclosure has been illustrated and described with reference to various embodiments of the present disclosure, those skilled in the art will understand that various changes can be made in form and detail without departing from the spirit and scope of the present disclosure as defined by the appended claims and their equivalents.

What is claimed is:

1. A method performed by a user equipment (UE) in a wireless communication system, the method comprising:
receiving, through a multi-panel from a base station, multiple reference signals;
receiving, from the base station, a request for group-based beam reporting associated with the multiple reference signals; and
transmitting, to the base station, group-based beam report by grouping indexes of reference signal resources which is received simultaneously by the UE through multi-panel into a single group.

2. The method of claim 1, further comprising:
selecting one or more resource groups based on a UE capability and a higher layer parameter configured by the base station based on the UE capability; and
reporting, to the base station, the selected resource one or more resource groups.

3. The method of claim 1, further comprising:
reporting, to the base station, a resource set indicator for indicating a CSI resource set including a reference signal received with largest reference signals received power (RSRP) among RSRP values measured through the multiple reference signals, and a value expressed in bits by quantizing RSRP values of reference signals received with the largest RSRP and a differential RSRP.

4. The method of claim 1, further comprising:
simultaneously transmitting multiple uplink signals to the base station by using the multi-panel.

5. The method of claim 1, further comprising:
receiving, from the base station, a transmission configuration indicator (TCI) state in which reference signal in combination of the corresponding reference signals is indicated as the reference signal of quasi co location (QCL) information.

6. A user equipment (UE) in a wireless communication system, the UE comprising:
a transceiver; and
a controller configured to:
receive, through a multi-panel from a base station, multiple reference signals,
receive, from the base station, a request for group-based beam reporting associated with the multiple reference signals, and
transmit, to the base station, group-based beam report by grouping indexes of reference signal resources which is received simultaneously by the UE through multi-panel into a single group.

7. The UE of claim 6, wherein the controller is configured to:
select one or more resource groups based on a UE capability and a higher layer parameter configured by the base station based on the UE capability, and
report, to the base station, the selected resource one or more resource groups.

8. The UE of claim 6, wherein the controller is configured to:
report, to the base station, a resource set indicator for indicating a CSI resource set including a reference signal received with largest reference signals received power (RSRP) among RSRP values measured through the multiple reference signals, and a value expressed in bits by quantizing RSRP values of reference signals received with the largest RSRP and a differential RSRP.

9. The UE of claim 6, wherein the controller is configured to:
simultaneously transmit multiple uplink signals to the base station by using the multi-panel.

10. The UE of claim 6, wherein the controller is configured to:
receive, from the base station, a transmission configuration indicator (TCI) state in which reference signal in combination of the corresponding reference signals is indicated as the reference signal of quasi co location (QCL) information.

11. A method performed by a base station in a wireless communication system, the method comprising:
transmitting, to a user equipment (UE), multiple reference signals;
transmitting, to the UE, a request for group-based beam reporting associated with the multiple reference signals; and
receiving, from the UE, group-based beam report by grouping indexes of reference signal resources which is received simultaneously by the UE through multi-panel into a single group.

12. The method of claim 11, further comprising:
receiving, from the UE, one or more resource groups selected based on a UE capability and a higher layer parameter configured by the base station based on the UE capability.

13. The method of claim 11, further comprising:
receiving, from the UE, a resource set indicator for indicating a CSI resource set including a reference signal received with largest reference signals received power (RSRP) among RSRP values measured through the multiple reference signals, and a value expressed in bits by quantizing RSRP values of reference signals received with the largest RSRP and a differential RSRP.

14. The method of claim 11, further comprising:
receiving, from the UE, multiple uplink signals to the base station by using the multi-panel.

15. The method of claim 11, further comprising:
transmitting, to the UE, a transmission configuration indicator (TCI) state in which reference signal in combination of the corresponding reference signals is indicated as the reference signal of quasi co location (QCL) information.

16. A base station in a wireless communication system, the base station comprising:
a transceiver; and
a controller configured to:
transmit, to a user equipment (UE), multiple reference signals,
transmit, to the UE, a request for group-based beam reporting associated with the multiple reference signals, and
receive, from the UE, group-based beam report by grouping indexes of reference signal resources which is received simultaneously by the UE through multi-panel into a single group.

17. The base station of claim 16, wherein the controller is configured to:
receive, from the UE, one or more resource groups selected based on a UE capability and a higher layer parameter configured by the base station based on the UE capability.

18. The base station of claim 16, wherein the controller is configured to:
receive, from the UE, a resource set indicator for indicating a CSI resource set including a reference signal received with largest reference signals received power (RSRP) among RSRP values measured through the multiple reference signals, and a value expressed in bits by quantizing RSRP values of reference signals received with the largest RSRP and a differential RSRP.

19. The base station of claim 16, wherein the controller is configured to:
receive, from the UE, multiple uplink signals to the base station by using the multi-panel.

20. The base station of claim 16, wherein the controller is configured to:
transmit, to the UE, a transmission configuration indicator (TCI) state in which reference signal in combination of the corresponding reference signals is indicated as the reference signal of quasi co location (QCL) information.
